(19) United States
(12) Patent Application Publication
(10) Pub. No.: US 2003/0110344 A1
(43) Pub. Date: Jun. 12, 2003

(54) Communications systems, apparatus and methods

(76) Inventors: Andre Szczepanek, Hartwell (GB); Denis R. Beaudoin, Missouri City, TX (US)

Correspondence Address: TEXAS INSTRUMENTS INCORPORATED, P O BOX 655474, M/S 3999, DALLAS, TX, 75265

(21) Appl. No.: 10/176,215

(22) Filed: Jun. 20, 2002

Related U.S. Application Data
(62) Division of application No. 08/718,148, filed on Sep. 18, 1996.

(51) Int. Cl. G06F 12/00; G06F 15/16; G06F 13/28; G06F 12/16

(52) U.S. Cl. 711/100; 709/200

(57) ABSTRACT

An improved communications system with a circuit having a plurality of communications ports capable of multispeed operation and operable in a first mode that includes address resolution and in a second mode that excludes address resolution is provided. More particularly, the system has a first memory, a plurality of protocol handlers, a bus connected to said protocol handlers, a second memory connected to said bus, and a memory controller connected to said bus and said second memory for selectively comparing addresses, transferring data between said protocol handlers and said second memory, and transferring data between said second memory and said first memory. A first embodiment is a local area network controller having a first circuit having a plurality of communications ports capable of multispeed operation and operable in a first mode that includes address resolution and in a second mode that excludes address resolution, and an address lookup circuit interconnected to said first circuit. An integrated circuit having a plurality of protocol handlers, a bus connected to said protocol handlers, a memory connected to said bus, and a memory controller connected to said bus and said memory for selectively comparing addresses, transferring data between said protocol handlers and said memory, and transferring data between said memory and an external memory is provided. The address matching circuit has a memory for containing addresses arranged in a linked list, a first state machine for creating and updating the linked list of addresses, a second state machine for providing routing information for a selected address based upon the linked list of addresses, and a bus watcher circuit for monitoring data traffic on a bus to detect addresses. Alternatively, the address matching circuit has an address memory with an address memory bus, a bus watcher circuit connected to an external data bus for detecting addresses, an arbiter connected to said bus watcher and said address memory bus for generating control signals for prioritizing access to said address memory bus, and a plurality of state machines selectively connectable to said address memory bus in response to said control signals and for providing routing information based upon matching a detected address with an address stored in said address memory, for adding, updating or deleting addresses and associated routing information in said address memory, and for searching for an address in said address memory.

### CROSS-REFERENCE TO RELATED APPLICATIONS

This application is related to co-pending and co-assigned patent application Ser. No. ______ (TI-24005), filed Sep. 18, 1996, filed contemporaneously herewith and incorporated herein by reference.

### NOTICE

(C) Copyright 1989 Texas Instruments Incorporated. A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### FIELD OF THE INVENTION

This invention generally relates to communications systems and integrated electronic devices used therein, and more particularly, to improved communications systems and improved apparatus and methods for use in such systems.

### BACKGROUND OF THE INVENTION

Local area networks (LANs) have become widely accepted and used within many and various industries as a way to interconnect many work stations and/or personal computers (PCs) to allow them to share resources such as data and applications without the need for an expensive mainframe computer and its associated multiple attached terminals. One widely accepted LAN arrangement is an “Ethernet” LAN, which is defined in the IEEE 802.3 standard.

With the widespread acceptance of LANs and the continuing acceleration of technology the demand for LAN arrangements with higher and higher transfer rates continues unabated. Two 100 megabit per second (Mbps) LANs are extending the reach of the installed base of 10 Mbps Ethernet LANs; they are the IEEE 802.3u standard for ‘Fast Ethernet’ or 100 MBITS SCMA/CD and the other is the IEEE 802.12 standard for 100 VG-AnyLAN or Demand Priority. In addition, switched Ethernet has been proposed to meet this demand.

The emergence of switched Ethernet promises to increase network bandwidth to the desktop without the need to replace network cabling or adapters. However, for this promise to be fulfilled the cost of switching hubs needs to fall towards the cost of conventional repeater hubs.

The present invention provides a LAN ethernet switch capable of performing other network functions that allows for improved communications systems and methods for use in such systems and improved apparatus that support this demand in a cost effective and versatile manner.

### SUMMARY OF THE PRESENT INVENTION

Generally, and in one form of the present invention, an improved communications system having a circuit having a plurality of communications ports capable of multispeed operation and operable in a first mode that includes address resolution and in a second mode that excludes address resolution is provided.

An improved communications system having a first memory, a plurality of protocol handlers, a bus connected to said protocol handlers, a second memory connected to said bus, and a memory controller connected to said bus and said second memory for selectively comparing addresses, transferring data between said protocol handlers and said second memory, and transferring data between said second memory and said first memory is provided.

The present invention provides a local area network controller having a first circuit having a plurality of communications ports capable of multispeed operation and operable in a first mode that includes address resolution and in a second mode that excludes address resolution, and an address lookup circuit interconnected to said first circuit.

The present invention provides an integrated circuit having a plurality of protocol handlers, a bus connected to said protocol handlers, a memory connected to said bus, and a memory controller connected to said bus and said memory for selectively comparing addresses, transferring data between said protocol handlers and said memory, and transferring data between said memory and an external memory.

The present invention provides an ethernet switch having a plurality of protocol handlers each having a serializer and deserializer and a holding latch, a bus connected to said holding latches, a memory connected to said bus, and a memory controller connected to said bus and said memory for selectively comparing addresses, transferring data between said latches and said memory and transferring data between said memory and an external memory.

The present invention provides a single chip network protocol handler having a first protocol handler having a serializer and deserializer and a holding latch for operating at a first bit rate, a second protocol handler having a serializer and deserializer and a holding latch for operating at a second bit rate, and a controller connected to said protocol handlers for selecting one of said protocol handlers based on preselected control signals.

The present invention provides an address matching circuit having a memory for containing addresses arranged in a linked list, a first state machine for creating and updating the linked list of addresses, a second state machine for providing routing information for a selected address based upon the linked list of addresses, and a bus watcher circuit for monitoring data traffic on a bus to detect addresses.

The present invention provides an address matching circuit having an address memory with an address memory bus, a bus watcher circuit connected to an external data bus for detecting addresses, an arbiter connected to said bus watcher and said address memory bus for generating control signals for prioritizing access to said address memory bus, and a plurality of state machines selectively connectable to said address memory bus in response to said control signals and for providing routing information based upon matching a detected address with an address stored in said address memory, for adding, updating or deleting addresses and associated routing information in said address memory, and for searching for an address in said address memory.

It is an object of the present invention to provide apparatus and methods for hardware control of network switching functions rather than CPU based control.

It is an object of the present invention to provide apparatus and methods for hardware control based communications systems.

It is an object of the present invention to provide simpler apparatus and methods for networking.

It is an object of the present invention to provide lower cost apparatus and methods for networking.

It is an object of the present invention to provide highly integrated apparatus and methods for networking.

It is an object of the present invention to provide simpler and lower cost apparatus and methods for communications systems.

### BRIEF DESCRIPTION OF THE DRAWINGS

The invention my be understood by reference to the detailed description which follows, read in conjunction with the accompanying drawings in which:

FIG. 1 is a functional block diagram of a circuit that forms a portion of a communications system of the present invention;

FIG. 2 depicts the preferred arrangement of data and flag information in a presently preferred 72 bit length word for use by the circuit of FIG. 1;

FIG. 3 depicts the access sequencing scheme that allows the presently preferred FIFO memory of the circuit in FIG. 1 to be accessed as a time multiplexed resource;

FIG. 4 is depicts the FIFO memory address format of the circuit of FIG. 1;

FIG. 5 shows how the FIFO RAM memory of the circuit of FIG. 1 is preferably physically mapped into transmit and receive blocks for each communication port;

FIG. 6 is a schematic block diagram depicting the flow of normal frame data to the FIFO and from there to the external memory under the control of the queue management block of the circuit of FIG. 1;

FIG. 7 is a schematic block diagram of the address compare block for a representative port of the circuit of FIG. 1;

FIG. 8 shows the format for the eight bit flag byte of the circuit of FIG. 1;

FIG. 9 is a simplified schematic diagram of the use of independent broadcast pointers A-D for each channel of the circuit of FIG. 1;

FIG. 10 is a schematic block diagram depicting the flow of broadcast frame data through the FIFO under control of the queue management block of the circuit of FIG. 1;

FIG. 11 depicts how all valid frames are passed across the DRAM interface from the circuit to the external memory using the DRAM bus of the circuit of FIG. 1;

FIG. 12 depicts the external address match interface information for ports 0 to port 14 of the circuit of FIG. 1;

FIG. 13 is a schematic block diagram of the interconnection of external circuitry with selected signals of the circuit to provide visual status of the circuit of FIG. 1;

FIG. 14 depicts the interconnection of an EEPROM device to the circuit of FIG. 1;

FIG. 15 is a simplified block diagram illustrating the interconnection of DIO port signals with a host for the circuit of FIG. 1;

FIG. 16 depicts the format of the internal registers used by the queue manager to maintain the status of all the queues in external or buffer memory for the circuit of FIG. 1;

FIG. 17 is a schematic diagram depicting the steps the queue manager performs for a cut-through operation for the circuit of FIG. 1;

FIG. 18 is a schematic diagram depicting the steps the queue manager performs for a store and forward operation for the circuit of FIG. 1;

FIG. 19 is a schematic diagram of the arrangement of the buffers in the external memory and the arrangement of the interior of a representative buffer for the circuit of FIG. 1;

FIG. 20 depicts the format of the 36 bit data word used for the circuit of FIG. 1;

FIG. 21 is a simplified block diagram of the receive portion of a representative 10 Mbps MAC for the circuit of FIG. 1;

FIG. 22 depicts the end of buffer flag format for the circuit of FIG. 1;

FIG. 23 depicts the data word types for error/status information for the circuit of FIG. 1;

FIG. 24 is a simplified block diagram of the transmit portion of a representative 10 Mbps MAC for the circuit of FIG. 1;

FIG. 25 is a simplified block diagram of the receive portion of a representative 10/100 Mbps MAC for the circuit of FIG. 1;

FIG. 26 is a simplified block diagram of the transmit portion of a representative 10/100 Mbps MAC for the circuit of FIG. 1;

FIG. 27 depicts the signal timings for a 200 Mbps handshake protocol for the circuit of FIG. 1;

FIG. 28 is a signal timing diagram illustrating that a frame control signal provided on M00_TXER during 200 Mbps uplink operations permits the reconstruction of frames using external logic, if the Uplink Tx FIFO underruns for the circuit of FIG. 1;

FIG. 29 is a signal timing diagram illustrating that there is no handshake or flow control for the receive uplink path on the circuit of FIG. 1;

FIG. 30 depicts the tag fields of FIG. 29;

FIG. 31 depicts receive arbitration selection for the circuit of FIG. 1;

FIG. 32 is a simplified block diagram of the network monitoring port for the circuit of FIG. 1;

FIG. 33 depicts a CPU and a suitable protocol translating device directly connected to one of the ports for the circuit of FIG. 1 for use with SNMP;

FIG. 34 is a signal timing diagram illustrating the Transmit (TX) logic signals for a 10 Mbps port for the circuit of FIG. 1;

FIG. 35 is a signal timing diagram illustrating the Receive (Rx) logic signals for a 10 Mbps port for the circuit of FIG. 1;

FIG. 36 depicts the Mxx_DUPLEX pins implemented as inputs with active pull down circuitry for the circuit of FIG. 1;

FIG. 37 depicts a testing sequence for the circuit of FIG. 1;

FIG. 38 depicts how in step A the DIO registers can be written to and read from directly from the pin interface for the circuit of FIG. 1;

FIG. 39 depicts how frames can be forwarded between internally wrapped ports before transmission of the frame from the source port for the circuit of FIG. 1;

FIG. 40 depicts how in an internal wrap mode the ports can be set to accept frame data that is wrapped at the PHY for the circuit of FIG. 1;

FIG. 41 depicts IDCODE format for networking equipment;

FIG. 42 is a signal timing diagram illustrating a single DRAM read for the circuit of FIG. 1;

FIG. 43 is a signal timing diagram illustrating a single DRAM write for the circuit of FIG. 1;

FIG. 44 is a signal timing diagram illustrating CAS before RAS refresh for the circuit of FIG. 1;

FIG. 45 is a signal timing diagram illustrating a series of eight write cycles for the circuit of FIG. 1;

FIG. 46 is a signal timing diagram illustrating a sequence of eight read cycles for the circuit of FIG. 1;

FIG. 47 depicts the DIO interface timing diagram for a write cycle for the circuit of FIG. 1;

FIG. 48 depicts the DIO interface timing diagram for a read cycle for the circuit of FIG. 1;

FIG. 49 is a signal timing diagram illustrating that the EAM_{—}14:0 pins must be valid by the start of the 14th memory access for the circuit of FIG. 1;

FIG. 50 is a signal timing diagramming illustrating a DRAM buffer access at the start of a frame for the circuit of FIG. 1;

FIG. 51 depicts the stat of frame format for the flag byte for the circuit of FIG. 1;

FIG. 52 depicts the LED timing interface for the LED status information for the circuit of FIG. 1;

FIG. 53 depicts the LED timing interface for the TxQ status information for the circuit of FIG. 1;

FIG. 54 depicts the EEPROM interface timing diagram for the circuit of FIG. 1;

FIG. 55 depicts the 100 Mbps receive interface timing diagram and includes some of the timing requirements for the circuit of FIG. 1;

FIG. 56 depicts the 100 Mbps transmit interface timing diagram and includes some of the timing requirements; for the circuit of FIG. 1;

FIG. 57 is a diagram of the signal groups and names for the circuit of FIG. 1;

FIG. 58 shows several views of a plastic superBGA package for the circuit of FIG. 1;

FIG. 59 depicts the DIO RAM access address mapping for the circuit of FIG. 1;

FIG. 60 depicts the content of a port address register of Table 36 for the circuit of FIG. 1;

FIG. 61 depicts the content of the revision register of Table 33 for the circuit of FIG. 1;

FIG. 62 is a block diagram of one improved communications system of the present invention;

FIG. 63 is a block diagram of another improved communications system of the present invention;

FIG. 64 is a block diagram of another improved communications system of the present invention;

FIG. 65 is a generalized summary flow diagram used by the MAC transmit state machine to control the transmission of a frame for the circuit of FIG. 1;

FIG. 66 is a generalized summary flow diagram used by the MAC receive state machine to control the receiving of a frame for the circuit of FIG. 1;

FIG. 67 is a simplified flow diagram illustrating the major states of the queue manager (QM) state machine for the circuit of FIG. 1;

FIG. 68 depicts the details of the buffer initialization state for the circuit of FIG. 67;

FIG. 69 shows a portion of the queue manager state machine associated with the receive state for the circuit of FIG. 1;

FIG. 70 depicts a more detailed portion of FIG. 72;

FIG. 71 depicts a more detailed portion of FIG. 72;

FIG. 72 depicts the QM receive state for the circuit of FIG. 1;

FIG. 73 shows the transmit portion of the QM state machine for the circuit of FIG. 1;

FIG. 74 is a chip layout map for the circuit of FIG. 1;

FIG. 75 is a block diagram of a portion of another improved communications system of the present invention;

FIG. 76 is a functional block diagram of a circuit that optionally forms a portion of a communications system of the present invention;

FIG. 77 is a graphical representation of the threaded address table look-up structure;

FIG. 78 depicts how each table of FIG. 77 needs to compare 2N possible combinations;

FIG. 79 is an example of a method to be used to look-up an address using the circuit of FIG. 76;

FIG. 80 continues the example of FIG. 79;

FIG. 81 continues the example of FIGS. 79 and 80;

FIG. 82 illustrates an address “tree” for the circuit of FIG. 76;

FIG. 83 illustrates the DIO interface for the circuit of FIG. 76;

FIG. 84 is an example of accessing through a PC Parallel Port Interface for the circuit of FIG. 76;

FIG. 85 is a block diagram of another improved communications system of the present invention;

FIG. 86 is a block diagram of yet another improved communications system of the present invention;

FIG. 87 is a block diagram of yet another improved communications system of the present invention;

FIG. 88 is a block diagram of yet another improved communications system of the present invention;

FIG. 89 is a signal timing diagram illustrating the look-up timing for the circuit of FIG. 76;

FIG. 90 shows the priorities of state machines for the circuit of FIG. 76;

FIG. 91 illustrates the linked address table architecture of the circuit of FIG. 76;

FIG. 92 shows how to access the internal registers for the circuit of FIG. 76;

FIG. 93 is a signal timing diagram illustrating a Write Cycle for the circuit of FIG. 76;

FIG. 94 is a signal timing diagram illustrating a Read Cycle for the circuit of FIG. 76;

FIG. 95 depicts a state machine process for the circuit of FIG. 76;

FIG. 96 indicates the steps that a state machine employs if a message is a multicast message for the circuit of FIG. 76;

FIG. 97 shows the steps a state machine employs if it is a broadcast message for the circuit of FIG. 76;

FIG. 98 is a simplified flow diagram of the internal states of the age state machine for the circuit of FIG. 76;

FIG. 99 is a simplified flow diagram of the internal states of the delete state machine for the circuit of FIG. 76;

FIG. 100 is a simplified flow diagram of the internal states of the find state machine for the circuit of FIG. 76;

FIG. 101 is a simplified flow diagram illustrating the internal states of the look-up state machine for the circuit of FIG. 76; and

FIG. 102 is a simplified flow diagram of the internal states of the add state machine for the circuit of FIG. 76.

Corresponding numerals and symbols in the different Figures refer to corresponding parts unless otherwise indicated.

### DETAILED DESCRIPTION

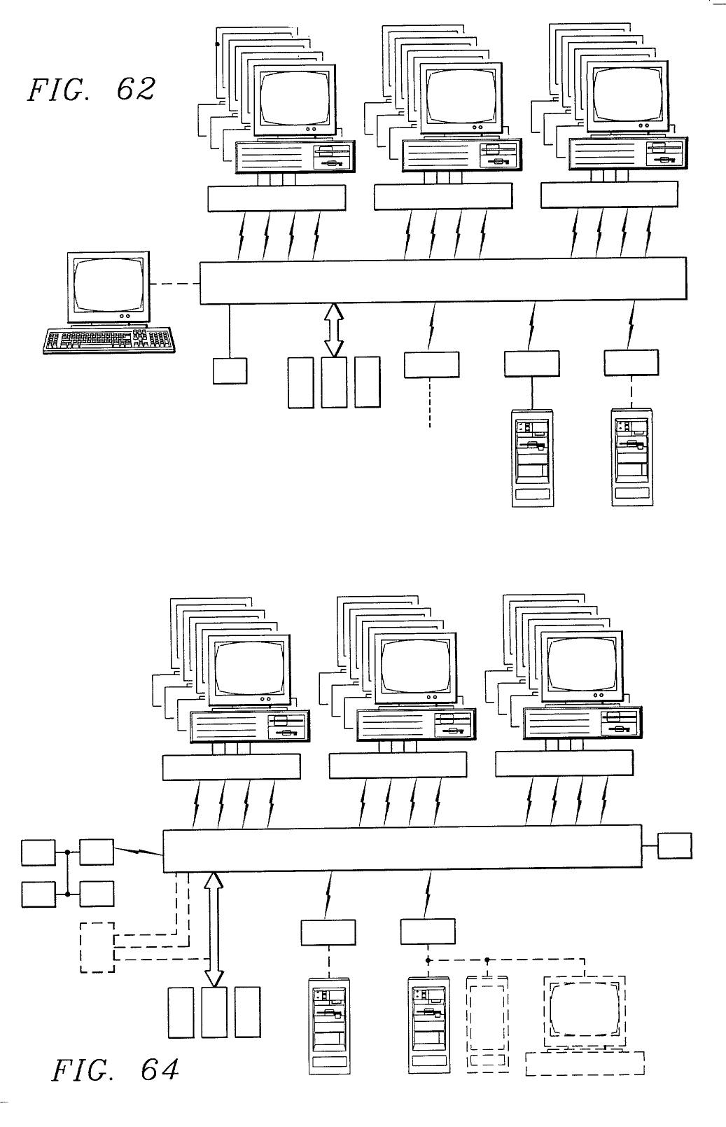

Referring initially to FIG. 62, there may be seen a block diagram of one improved communications system 10 of the present invention. In FIG. 62, the communications system includes a multiport, multipurpose network integrated circuit (chip) 200 having a plurality of communications ports 116,117,118 capable of multispeed operation. The network chip 200 operates in two basic modes, with one mode including address resolution and a second mode that excludes address resolution. The network chip 200 has an external memory 350, which is preferably EEPROM, appropriately interconnected to provide an initial configuration of chip 200 upon startup or reset. The communications system 10 also includes an external memory (DRAM) 300 for use by the network chip 200 to store communications data, such as for example, but not limited to, frames or packets of data representative of a portion of a communications message.

In addition, the communications system depicted in FIG. 62 includes a plurality of known physical layer devices 110′,112,114 that serve as a bridge or interface between the communications system 10 and the servers 500 or clients 400 on the communications system 10. These physical layer devices 110′,112,114 are identified as QuadPHY 110′ blocks or 10/100 Mbps PHY blocks 118. However, the communications system 10 of the present invention also contemplates the incorporation of these physical devices 110′,112,114 and/or memories 300,350 onto or into the chips associated with the network chip 200.

The communications system 10 also includes a plurality of known communications servers 500 and a plurality of known communications clients 400 that are connected to the physical layer devices. The communications system may also include an optional host CPU 600 for managing or monitoring the operations of the communications system; however, the host CPU is not necessary for normal operation of the communications system of the present invention.

The improved communications system of the present invention depicted in FIG. 62 is suitable for use as a low cost switch for a small office or home office (SOHO) workgroup. The improved communications system of the present invention depicted in FIG. 62 provides a minimum of fifteen, 10 Mbps ports 116 (with the 10/100 117 and uplink 118 ports all operating as 10 Mbps ports). The improved communications system of the present invention depicted in FIG. 62 provides a ums of two, 10/100 Mbps full duplex single address ports 117; three 100 Mbps ports could be provided by utilizing the uplink 118 as an additional 100 Mbps port. However, the use of three 100 Mbps ports may exceed the internal bandwidth during worst case network activity. The improved communications system of the present invention depicted in FIG. 62 provides for a stand alone configuration through the use of an EEPROM 350 that stores initial internal register values (the optional host CPU 650 connected to a DIO port 172 is used to monitor status and user configuration). The improved communications system of the present invention depicted in FIG. 62 also provides an Uplink port 118 for future expansion capabilities.

This configuration 10 is designed to accelerate the small business user with a small network. All connections are single address desktop or server connections. No external address matching hardware is used and multiple address devices may not be connected to any of the switched ports.

Unused 100 Mbps ports 117 can be used as additional 10 Mbps 116, if required, enabling a ceiling of thirteen 10 Mbps ports in a switched workgroup. Future expansion can also be achieved by cascading further network chip devices 200 on the uplink port 118, as described later herein.

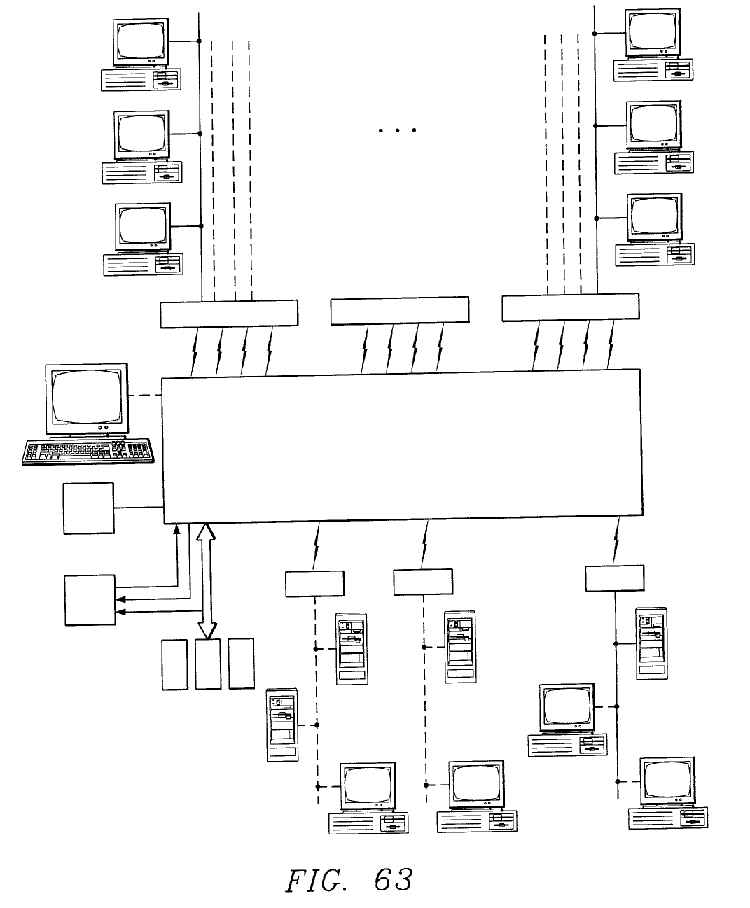

Referring now to FIG. 63, there may be seen a block diagram of another improved communications system 41 of the present invention. In FIG. 63, the communications system 11 includes a multiport, multipurpose network integrated circuit (chip) 200 having a plurality of communications ports 116,117, 118 capable of multispeed operation. The network chip operates in two basic modes, with one mode including address resolution and a second mode that excludes address resolution. The communications system 11 also includes an external address lookup integrated circuit 1000 that is appropriately interconnected to the network chip 200. Both the network chip 200 and the address lookup chip 1000 each have an external memory 350, which is preferably EEPROM (not depicted in FIG. 63 for the address lookup chip), appropriately interconnected to provide an initial configuration of each chip upon startup or reset. The communications system 11 also includes an external memory (DRAM) 300 for use by the network chip 200 to store communications data, such as for example, but not limited to, frames or packets of data representative of a portion of a communications message. The communications system 11 may also optionally include an external memory (SRAM) (not depicted in FIG. 63) for use by the address lookup chip to increase its addressing capabilities.

In addition, the communications system includes a plurality of known physical layer devices 110″,112,114 that serve as a bridge or interface between the communications system and the servers or clients. These physical layer devices are identified as QuadPHY blocks 110″, 10/100 Mbps PHY blocks 112, or as an uplink block 114. However, the communications system of the present invention also contemplates the incorporation of these physical layer devices and/or memories onto or into the chips associated with the network chip and/or the address lookup chip.

The communications system 11 also includes a plurality of known communications servers 500 and a plurality of known communications clients 420,422 that are connected to the physical layer devices. The communications system may also include an optional host CPU 600 for managing or monitoring the operations of the communications system; however, the host CPU is not necessary for normal operation of the communications system of the present invention.

The improved communications system of the present invention depicted in FIG. 63 is suitable for use as a low cost network switch. The improved communications system of the present invention depicted in FIG. 63 provides a maximum of fifteen, 10 Mbps ports. (with the 10/100 and uplink ports all operating as 10 Mbps half duplex ports). The improved communications system of the present invention depicted in FIG. 63 provides a maximum of two, 10/100 Mbps full duplex ports; three 100 Mbps ports could be provided by utilizing the uplink as an additional 100 Mbps port. However, the use of three 100 Mbps ports may exceed the internal bandwidth during worst case network activity. The improved communications system of the present invention depicted in FIG. 63 provides for a stand alone configuration through the use of an EEPROM 350 that stores initial internal register values (the optional host CPU connected to a DIO port 172 is used to monitor status and user configuration).

This configuration is designed to switch the business user with a small network. Connections can be either single address desktop or multiple address devices. External address matching hardware is used to permit network switching and multiple addresses.

Referring now to FIG. 64, there may be seen a block diagram of another improved communications system 12 of the present invention. In FIG. 64, the communications system includes a multiport, multipurpose network integrated circuit (chip) 200 having a plurality of communications ports 116,117,118 capable of multispeed operation. The network chip operates in two basic modes, with one mode including address resolution and a second mode that excludes address resolution. The communications system also includes an optional external address lookup integrated circuit (in dashed lines) 1000 that is appropriately interconnected to the network chip 200. Both the network chip and the address lookup chip each have an external memory 350, which is preferably EEPROM (not depicted in FIG. 64 for the address lookup chip), appropriately interconnected to provide an initial configuration of each chip upon startup or reset. The communications system also includes an external memory (DRAM) 300 for use by the network chip to store communications data, such as for example, but not limited to, frames or packets of data representative of a portion of a communications message. The communications system may also optionally include an optional external memory (SRAM) (not depicted in FIG. 64) for use by the optional address lookup chip to increase its addressing capabilities.

In addition, the communications system includes a plurality of known physical layer devices 110′,112 that serve as a bridge or interface between the communications system and the servers or clients. These physical layer devices are identified as a 10 Mbps QuadPHY blocks 110′, 10/100 Mbps PHY block 112, or as an uplink block 114. However, the communications system of the present invention also contemplates the incorporation of these physical layer devices and/or memories onto or into the chips associated with the network chip and/or the address lookup chip.

The communications system also includes a plurality of known communications servers 500 and a plurality of known communications clients 400 that are connected to the physical layer devices. The communications system also includes a local host CPU 610 connected to a 10 Mbps PHY block 110, a block of MIB counters 612 and a local packet memory 614 for managing or monitoring the operations of the communications system; the host CPU 610 provides the intelligence to make this embodiment of the communications system of the present invention an intelligent switch.

The improved communications system of the present invention depicted in FIG. 64 is suitable for use as a low cost intelligent network switch. The improved communications system of the present invention depicted in FIG. 64 provides a maximum of fourteen, 10 Mbps switched single address ports (with the 10/100 ports operating as 10 Mbps half duplex ports); network connections are supported when the external address lookup integrated circuit (in dashed lines) 1000 is used. The improved communications system of the present invention depicted in FIG. 64 provides a maximum of two, 10/100 Mbps full duplex single address ports; network connections are supported when the external address lookup integrated circuit (in dashed lines) 1000 is used. The improved communications system 12 of the present invention depicted in FIG. 64 provides a local host CPU 610 for intelligent control and switching as a stand alone unit. The improved communications system of the present invention depicted in FIG. 64 provides for configuration control through the use of an EEPROM 350 that stores internal register values (the local host CPU connected to a DIO port or a network SNMP may be used to alter configurations).

This intelligent switch configuration is aimed at the workgroup requiring access and control over the switching unit via the network. Connections can be either single address desktop or multiple address devices. External address matching hardware is used to permit network switching and multiple addresses.

Referring now to FIG. 85, there may be seen a block diagram of another improved communications system 13 of the present invention. In FIG. 85, the communications system includes a multiport, multipurpose network integrated circuit (labeled as “WSWITCH”) 200 having a plurality of communications ports capable of multispeed operation. The network chip operates in two basic modes, with one mode including address resolution and a second mode that excludes address resolution. The communications system also includes an external address lookup integrated circuit (labeled as “EALE”) 1000 that is appropriately interconnected to the network chip. Both the network chip and the address lookup chip each have an external memory 350,1500, which is preferably EEPROM, appropriately interconnected to provide an initial configuration of each chip upon startup or reset. The network chip 200 also has an external oscillator block 360 connected to it to provide the requisite clock signals for use by the network chip.

In addition, the communications system includes a plurality of known physical layer devices 110 that serve as a bridge or interface between the communications system and the servers or clients (not depicted in FIG. 85). These physical layer devices are identified as PHY blocks. However, the communications system 13 of the present invention also contemplates the incorporation of these physical layer devices and/or memories onto or into the chips associated with the network chip and/or the address lookup chip.

The simplest application for the combination of a network chip and an external address lookup chip system 1000 is shown in FIG. 85; this simplest application is a manageless multiport switch. The external address lookup chip 1000 is responsible for matching addresses, learning addresses and for aging out old addresses. Use of an external address lookup chip still provides options to the manufacturer for changes to the network through its EEPROM 1500; that is, the manufacturer may program this EEPROM 1500 through a parallel port interface to the external address lookup chip (not depicted in FIG. 85). Some options which can be set are the aging time, the UNKUNIPorts/UNKMULTIPorts registers (for this application they might be left to broadcast to all ports), and the port-based VLAN registers, PortVLAN. VLAN is supported (on a per-port basis) through the EEPROM 1500. This is the lowest-cost solution for a non-CPU managed, VLAN-capable multinode switch.

The communications system 13 also includes a plurality of known communications servers and a plurality of known communications clients that are connected to the physical layer devices (not depicted for clarity in FIG. 85). The communications system may also include an optional host CPU 600 for managing or monitoring the operations of the communications system; however, the host CPU 600 is not necessary for normal operation of the communications system of the present invention.

The communications system also includes an external memory (DRAM) (not depicted in FIG. 85) for use by the network chip 200 to store communications data, such as for example, but not limited to, frames or packets of data representative of a portion of a communications message. The communications system may also optionally include an external memory (SRAM) 1600 for use by the address lookup chip 1000 to increase its addressing capabilities.

Continuing to refer to FIG. 85, a second variation on the first application can be achieved by adding external SRAM 1600 to the EALE device 1000. Adding external SRAM 1600 increases the capability of the lookup table and increases the number of nodes supported by the switch. A 1K address switch can be achieved by adding 65K×11 of SRAM (typical address spans). The external address lookup chip 1000 supports multiple SRAM 1600 sizes, and switches with varying capacities can be easily built. Again, this is a low-cost solution since no management by an external CPU 600 is needed. The SRAM size is controlled through the EEPROM (RAMsize).

Continuing to refer to FIG. 85, a third variation on the first application can be achieved by adding a microprocessor 600 that interfaces to the external address lookup chip 1000 and network chip 200 through a common DIO interface 172 to provide a managed multiport switch application. This application provides out-of-band management so that the CPU 600 can continue to manage the network even when the rest of the network connected to this network chip goes “down” or ceases to operate. The microprocessor also has the capability to manage any switch PHY registers through an IEEE802.3u interface (SIO register).

The microprocessor's tasks are minimized mainly because the CPU does not have to participate in frame matching. The microprocessor is used to set chip operating modes, to SECURE addresses so that the node does not move ports (useful for routers, attached switches and servers), and for support of destination-address-based-VLANs.

The external address lookup chip 1000 is designed for easy management of the lookup table. Address table lookups, adds, edits and deletes are easily performed through its registers. Interrupt support also simplifies the management's tasks; the external address lookup chip will give an interrupt to the CPU when it changes the lookup table. This minimizes code as the CPU does not have to actively poll a very large address table for changes.

Continuing to refer to FIG. 85, a fourth variation on the first application can be achieved by attaching a MAC 1201 to the CPU 600 to provide an in-band managed switch. The management CPU 600 is able to send and receive frames through the CPU MAC 1201. The external address lookup chip 1000 implements routing registers which are helpful in this application.

The external address lookup chip 1000 has the capability to send all frames whose destination address is not known (UNKUNIPorts, UNKMULTIPorts) to the management CPU 600. At the same time, the external address lookup chip will learn this address and place it in the address table. The management CPU 600 then has the option to edit the port assignment for this address based on information placed in the frame it received.

The CPU 600 can also receive frames destined for other nodes by tagging, in the address table, the CUPLNK bit for that particular node. The CUPLNK bit copies all frames destined to that node to the ports specified in UPLINKPorts. By setting UPLINKPorts to direct these frames to the management CPU, it can receive frames it finds of interest.

The management CPU 600 can use any available port on the network chip since the routing is controlled by the external address lookup chip's registers. This means that traffic which would ordinarily move up to the Uplink (Port 0) can be forced to any other port by using the external address lookup chip. This capability is helpful not only in using a 10 Mbps speed port instead of the 100 Mbps Port 0, but it is the basis for the network chip's cascading capabilities and redundant link capabilities.

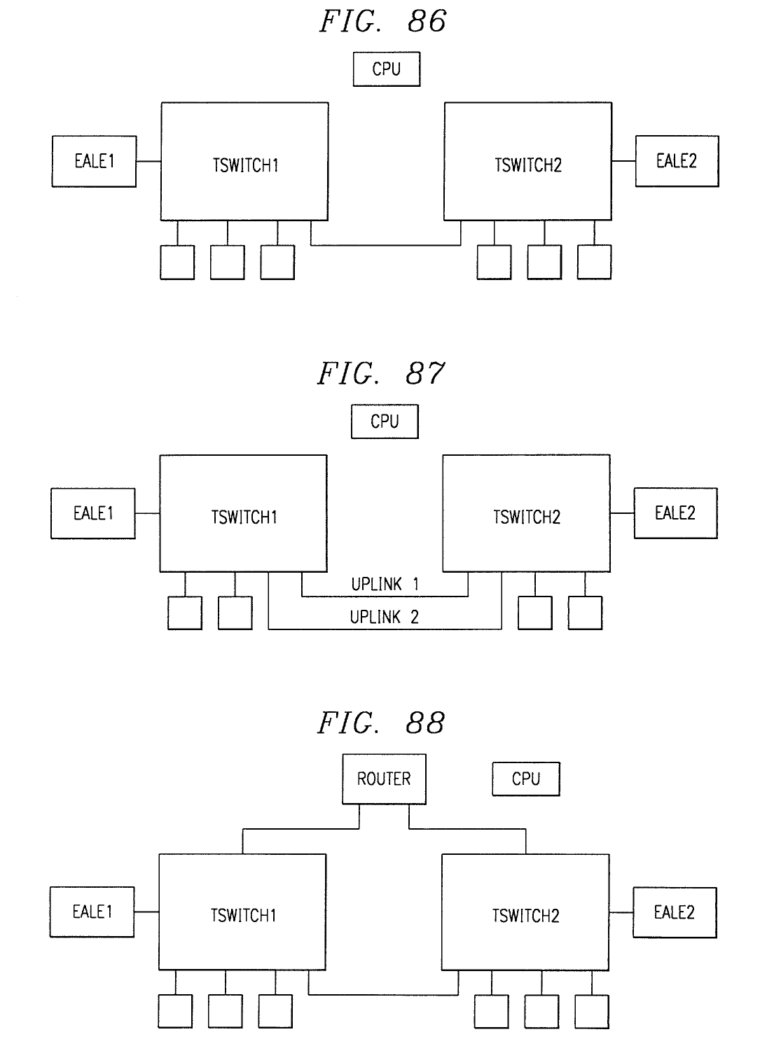

Referring to FIG. 86, there may be seen a block diagram of yet another improved communications system 14 of the present invention. In FIG. 86, the communications system includes two multiport, multipurpose network integrated circuits (labeled as “TSWITCH”) 200 having a plurality of communications ports capable of multispeed operation that are interconnected by their uplink ports 118. Each network chip 200 operates in two basic modes, with one mode including address resolution and a second mode that excludes address resolution. The communications system also includes two external address lookup integrated circuits (labeled as “EALE”) 1000 that are each appropriately interconnected to one of the network chips. Both the network chips and the address lookup chips each have an external memory (not depicted in FIG. 86), which is preferably EEPROM, appropriately interconnected to provide an initial configuration of each chip upon startup or reset. Each network chip also has an external oscillator block (not depicted in FIG. 86) connected to it to provide the requisite clock signals for use by the network chip. The communications system also includes an external memory (DRAM) (not depicted in FIG. 86), for use by each network chip to store communications data, such as for example, but not limited to, frames or packets of data representative of a portion of a communications message. The communications system also includes an external SRAM memory (not depicted in FIG. 86) that increases the capability of the lookup table and increases the number of nodes supported by the switch.

In addition, the communications system 14 depicted in FIG. 86 includes a plurality of known physical layer devices that serve as a bridge or interface between the communications system and the servers or clients on the communications system (not depicted in FIG. 86). Again, the communications system of the present invention also contemplates the incorporation of these physical devices and/or memories onto or into the chips associated with the network chip.

The communications system also includes a plurality of known communications servers and a plurality of known communications clients that are connected to the physical layer devices. The communications system may also include an optional host CPU 600 for managing or monitoring the operations of the communications system; however, the host CPU is not necessary for normal operation of the communications system of the present invention. This communications system may be either managed or unmanaged.

The improved communications system of the present invention depicted in FIG. 86 illustrates a basic way of cascading two network chips 200 of the present invention by connecting their uplink ports 118 together. This way of cascading two network chips is simplified by the use of the external address matching hardware 1000 of the present invention. In the improved communications system 14 of the present invention depicted in FIG. 86, each network chip performs local switching based on their respective external address matching hardware's address table. All addresses which are not known to the external address matching hardware are sent up the uplink to the cascaded network chip.

Both external address matching devices 1000 have the potential of seeing all the nodes on the network. This means that both lookup tables will be mirrored and wastes space on the SRAM (whether internal or external).

An improvement is to place both external address matching devices 1000 in Not Learn Zero mode (NLRN0 bit in Control). Placing each external address matching device in NLRN0 mode forces it not to learn any addresses located in its uplink port (port 0), so now both devices carry a copy of its local addresses, and no lookup table mirroring is needed which saves space.

FIG. 87 is similar to FIG. 86, except that the two network chips are connected or cascaded by use of both the uplink ports 118 to provide load sharing redundant links. Thus, multiple, redundant uplinks for switch load sharing are also supported through external address matching devices and a management CPU 600.

When a frame destined for a node which is not in its address table comes into the first network chip, it is routed to the second network chip through the uplink port. This is the default path for all traffic between switches.

However, the external address matching device can redirect traffic to a second uplink port. The management CPU first commands switch1 to send the node's frames to uplink2 freeing traffic on the uplink1 path, and balancing the load between the two links.

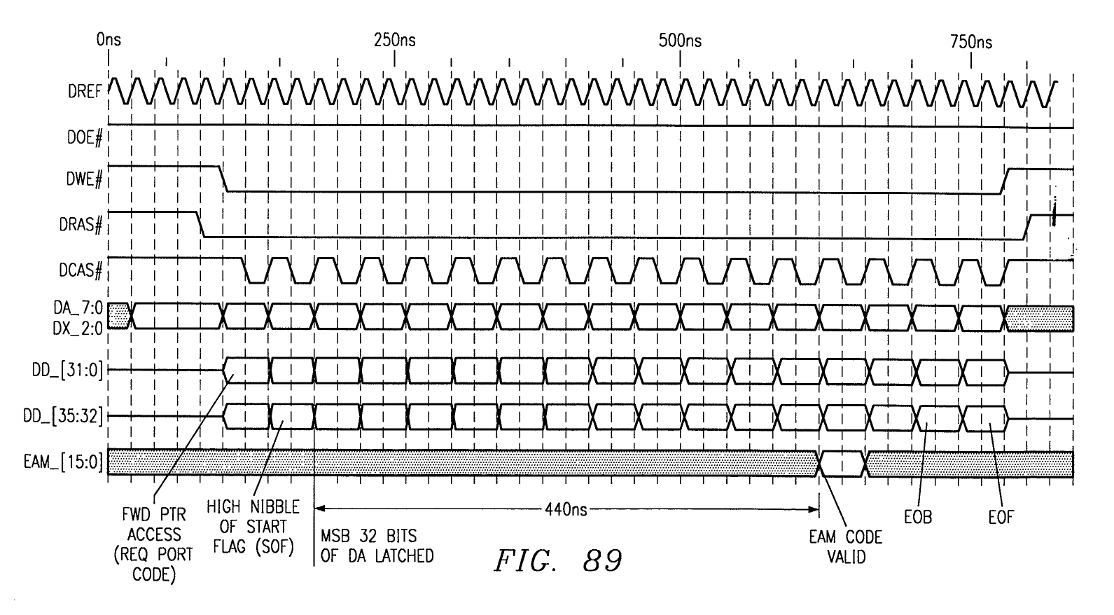

FIG. 88 is similar to FIG. 86, except that the two network chips are also connected to a router 900 to provide an implementation of a spanning tree algorithm. There is also a port 118 connection between the two network chips that bypasses the router. Thus, multiple, redundant uplinks for switch load sharing are also supported through external address matching devices and a management CPU.

The normal frame traffic for a frame which comes into switch one and whose destination address is unknown is this:

Node 1 sends a frame to Node 1

Node 1's frame enters switch one. It is not matched by EALE1, and gets routed to UNKUNIPorts (which should include the Uplink).

EALE1 adds node 1 to the lookup table and assigns it to the originating port.

The router broadcasts the frame to TSWITCH2, and the frame enters TSWITCH2 through the Uplink.

EALE2 does not match the incoming frame, and routes it to its copy of UNKUNIPorts, masking out the Uplink if it was set in the register. Node 2 receives the frame.

EALE2 adds node 1 to its table with the Uplink as the originating port. Now both EALE devices have learned the location of node 1.

Node 2 responds to Node 1's frame. The frame gets routed from TSWITCH2 to TSWITCH1 through the router. EALE2 learns node 2's location, and EALE1 assigns node 2 to its Uplink.

All frames between 1 and 2 are now routed through the router 900. The router 900 also knows the locations of the nodes 1 and 2 for frames which come to it from the rest of the network.

The spanning tree algorithm is designed to minimize traffic through the router. It does this by recognizing that traffic between node 1 and node 2 would be better served if it traveled between the redundant link between TSWITCH1 and TSWITCH2. The management CPU 600 can easily change how the EALEs route frames.

The management CPU changes EALE 1's information about node 2. Node 2's port is changed from the Uplink to the redundant link. From now on all frames destined to port 2 will bypass the router 900.

The management CPU changes EALE2's information about node 1. Node 1's port is, changed from the Uplink to the redundant link. From now on all frames destined to port 1 will bypass the router 900.

All frames between 1 and 2 are now routed to the redundant link and bypass the router 900. The only frames for 1 and 2 which go through the router are those coming from the rest of the network.

The external address matching device 1000 provides the capability to direct spanning tree BPDUs to a management port, so that the local CPU 600 can process the BPDUs according to the spanning tree algorithm, to determine if its the root switch/bridge, or the lowest cost path to the root. The algorithm is also responsible for placing the ports into a forwarding or blocking state to eliminate loops in the network.

To direct BPDUs to the management port the all groups multicast address is programmed into the external address matching device. The VLAN mask associated with this address is programmed to forward all packets with this address to the management port (e.g. if port 14 is the management port, the VLAN mask will be programmed to be 0004Hex). The algorithm will then process the contents of the BPDU and transmit a BPDU back on the same port. To transmit the BPDU on a particular port, the VLAN mask needs to be modified (e.g. to transmit a BPDU to port 9 the mask would be 0024 Hex, as can be seen the mask bit for port 14 is still, however the EALE insures that it never copies a packet back to the source port, hence the BPDU will not be copied back to port 14, but will allow this port to receive BPDUs form other ports).

To place a port in blocking or forwarding state, the local CPU 600 needs to look at all the MAC addresses in the table. If the address is associated with a port that needs to be blocked then the PortCode needs to be changed to a port that is in forwarding state to allow communication to continue via the root switch/bridge.

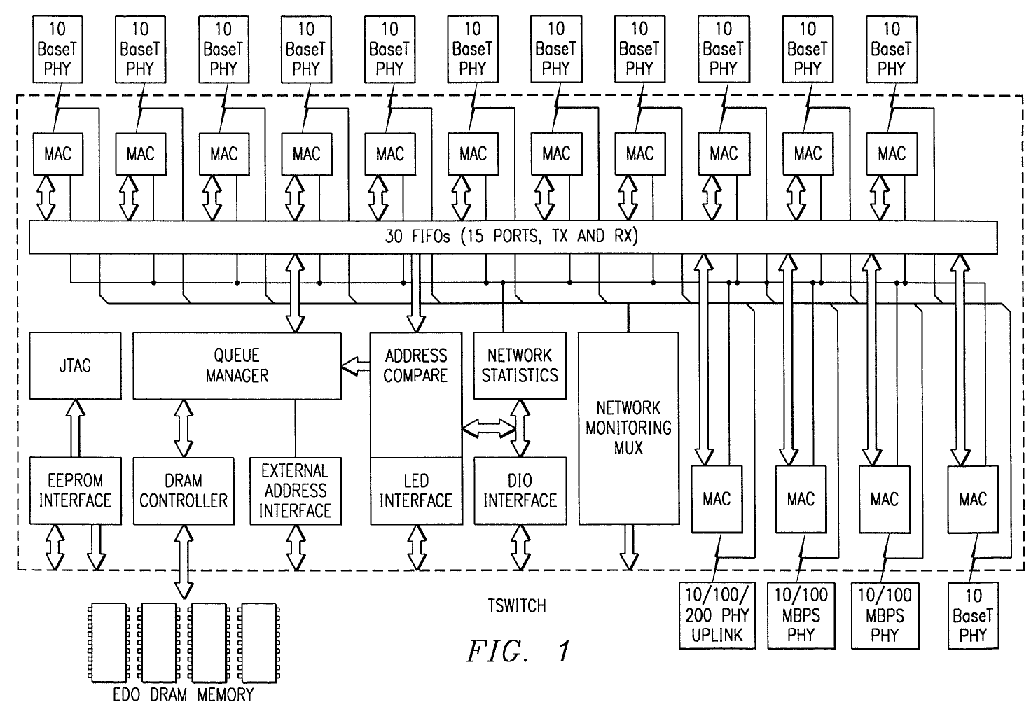

Referring now to FIG. 1, there may be seen a functional block diagram of a circuit 200 that forms a portion of a communications system of the present invention. More particularly, there may be seen the overall functional architecture of a circuit 200 that is preferably implemented on a single chip as depicted by the dashed line portion of FIG. 1. As depicted inside the dashed line portion of FIG. 1, this circuit consists of preferably fifteen Ethernet media access control (MAC) blocks 120,122,124, a firstin firstout (FIFO) RAM block 130, a DRAM controller block 142, a queue manager block 140, an address compare block 150, an EEPROM interface block 80, a network monitoring mutliplexer (mux) block 160, an LED interface block 180, a DIO interface block 170, an external address interface block 184 and network statistics block 168. Each of the MACs is associated with a communications port 116,117,118 of the circuit; thus, the circuit has fifteen available communications ports for use in a communications system of the present invention.

The consolidation of all these functions onto a single chip with a large number of communications ports allows for removal of excess circuitry and/or logic needed for control and/or communications when these functions are distributed among several chips and allows for simplification of the circuitry remaining after consolidation onto a single chip. More particularly, this consolidation results in the elimination of the need for an external CPU to control, or coordinate control, of all these functions. This results in a simpler and cost-reduced single chip implementation of the functionality currently available only by combining many different chips and/or by using special chipsets. However, this circuit, by its very function, requires a large number of ports, entailing a high number of pins for the chip; the currently proposed target package is a 352 pin plastic superBGA cavity down package which is depicted in several views in FIG. 58. The power and ground signals have been assigned to pins in such a way as to ensure all VCC power pins, ground (GND) pins and 5V power pins are rotationally symmetrical to avoid circuit damage from powering up the chip with a misoriented placement of the chip in its holder.

In addition, a JTAG block 90 is depicted that allows for testing of this circuit using a standard JTAG interface that is interconnected with this JTAG block. As more fully described later herein, this circuit is fully JTAG compliant, with the exception of requiring external pull-up resistors on certain signal pins (not depicted) to permit 5v inputs for use in mixed voltage systems.

In addition, FIG. 1 depicts that the circuit is interconnected to a plurality of other external blocks. More particularly, FIG. 1 depicts 15 PHY blocks 110,112,114 and a set of external memory blocks 300. Twelve of the Ethernet MACs are each associated with and connected to an off-chip 10 Base10T PHY block 110. Two of the Ethernet MACs (high speed ports) are each associated with and connected to an off-chip 10/100 Base10T PHY block 112. One of the Ethernet MACs (uplink port) is associated with and connected to an off-chip 10/100/200 Base10T PHY block 114. Preferably, the external memory 300 is an EDO DRAM, although clearly, other types of RAM may be so employed. The external memory 300 is described more fully later herein. The incorporation of these PHY blocks and/or all or portions of the external memories onto the chip is contemplated by and within the scope of the present invention.

Referring now to FIG. 57, there may be seen a diagram of the circuit's signal groups and names. More particularly, it may be seen that the JTAG test port has four input signals and one output signal. The pin signal name (“pin name”), type (“in”/“out”), and “function” for these five JTAG pins are described in Table 14 below.

TABLE 14

| Pin Name | Type | Function |
|---|---|---|
| TRST | in | Test Reset: Used for Asynchronous reset of |
| | | the test port controller. |
| | | An external pull up resistor must be used on |
| | | TRST, to be JTAG compliant. No internal |
| | | pull-up resistors are provided to permit the |
| | | input to be 5 v tolerant. |
| TMS | in | Test Mode Select: Used to control the state |
| | | of the test port controller. |
| | | An external pull up resistor must be used on |
| | | TMS, to be JTAG compliant. No internal |
| | | pull-up resistors are provided to permit the |
| | | input to be 5 v tolerant. |
| TCLK | in | Test Clock: Used to clock state information |
| | | and test data into and out of the device |
| | | during operation of the test port. |
| TDI | in | Test Data Input: Used to serially shift test |
| | | data and test instructions into the device |
| | | during operation of the test port. |
| | | An external pull up resistor must be used on |
| | | TDI, to be JTAG compliant. No internal pull- |
| | | up resistors are provided to permit the input |
| | | to be 5 v tolerant. |
| TDO | out | Test Data Output:: Used to serially shift test |
| | | data and test instructions out of the device |
| | | during operation of the test port. |

It may be seen that the uplink port (10/100 Mbps/200 Mbps) or port 00 has 20 input signals and 10 output signals. The pin signal name (pin name), type (in/out), and function for these pins are described in Table 15 below. However, M00_DUPLEX is not a true bi-directional pin, it is an input with an open collector pull-down.

TABLE 15

| Pin Name | Type | Function |
|---|---|---|
| M00_TCLK | in | Transmit Clock: Transmit Clock source |
| | | from the attached PHY or PMI device. |
| M00_TXD7 | out | Transmit Data: Nibble/Byte Transmit |
| . . . | | data. When M00_TXEN is asserted |
| M00_TXD1 | | these signals carry transmit data. The |
| M00_TXD0 | | source port number appears on |
| | | TXD[3::0] one cycle prior to |
| | | M00_TXEN being asserted. |
| | | Data on these signal is always |
| | | synchronous to M00_TCLK |
| | | The uplink can transmit 4 bit or 8 bit |
| | | data, this is determined strapping |
| | | signal M00_UPLINK# (active low) |

When low the uplink will operate in
wide (8 bit mode).
When high the upper nibble
bits[4:7] are not driven

| | | |
|---|---|---|
| M00_TXEN | out | Transmit Enable: This signal indicates |
| | | valid transmit data on M00_TXDnn. |
| M00_TXER | out | Transmit Error: This signal allows |
| | | coding errors to be propagated across |
| | | the MII. |
| | | When M00_UPLINK# is low, (200 |
| | | Mbps uplink), TXER is taken high |
| | | whenever an under-run in the TX FIFO |
| | | for port 00 occurs and causes fill data |
| | | is transmitted. This enables external |
| | | logic to reconstruct and resend the |
| | | frame. |
| | | In non-uplink mode |
| | | (M00_UPLINK#=1), M00_TXER will be |
| | | asserted at the end of an under |
| | | running frame, enabling a forced |
| | | coding error. |
| M00_COL | in | Collision Sense: |

In CSMA/CD mode assertion of this
signal indicates network collision.
In Demand Priority mode this signal
is used to begin frame
transmission.
In Full Duplex, M00_col can be
used as a flow control signal

| | | |
|---|---|---|
| M00_CRS | in | Carrier Sense: This signal indicates a |
| | | frame carrier signal is being received. |
| M00_RCLK | in | Receive Clock: Receive clock source |
| | | from the attached PHY or PMI device. |
| M00_RXD7 | in | Receive Data: Nibble/Byte Receive |
| . . . | | data from the PMD (Physical Media |
| M00_RXD1 | | Dependent) front end. Data is |
| M00_RXD0 | | synchronous to M00_RCLK. |
| | | Port 00, can transmit 4 bit or 8 bit data, |
| | | this is determined strapping signal |
| | | M00_UPLINK# (active low) |

When low the uplink will operate in
wide (8 bit mode).
When high the upper nibble bits
[4:7] are not driven

| | | |
|---|---|---|
| M00_RXDV | in | Receive Data Valid: Indicates data on |
| | | M00_RXD0 is valid for 10/100 Mbps |
| | | operation. Whilst operating in 200 |
| | | Mbps mode, in conjunction with the |
| | | M00_RXDVX signal, it indicates the |
| | | following: |
| | | M00_RXDVX(MSB), |
| | | M00_RXDV(LSB) |

00-Idle (Interframe gap)
01-data frame available
10-Idle (waiting for keytag)
11-Keytag data available.

| | | |
|---|---|---|
| M00_RXDVX | in | This signal is only valid during |
| | | operation in 200 Mbps mode. In |
| | | conjunction with the M00_RXDVX |
| | | signal, it indicates the following: |
| | | M00_RXDVX(MSB), |
| | | M00_RXDV(LSB) |

00-Idle (Interframe gap)
01-data frame available
10-Idle (waiting for keytag)
11-Keytag data available.

| | | |
|---|---|---|
| M00_RXER | in | Receive Error: Indicates reception of a |
| | | coding error on received data. |
| M00_SPEED | in | Bit rate selection. The speed of the |
| | | MAC interface is determined by the |
| | | level on this signal. (1 = 100 Mbps, 0 = |
| | | 10 Mbps) |
| M00_DPNET | in | Demand Priority Selection. The |
| | | protocol of the 100 Mbps interface is |
| | | determined by the level on this signal. |
| | | (high = 100 MbitVG Demand Priority or |
| | | low = 100 Mbps CSMA/CD). Note |
| | | there is no comprehension of the |
| | | priority of DP frames. No change in |
| | | port arbitration is implemented for DP |
| | | frame handling. |
| M00_DUPLEX | inout | Switches the interface between full |
| | | and half duplex. (low = Half Duplex, |
| | | high = full duplex) |
| | | Input has an open collector pull down, |
| | | used to take line low when FORCEHD |
| | | bit is set. |
| M00_LINK | in | Indicates the presence of port |
| | | connection. |
| | | (low = no link, high = link ok) |
| M00_UPLINK# | in | Active low, mode selection signal for |
| | | wide 8 bit uplink protocol. When low the |
| | | uplink transmits data at 200 Mbps. |

It may be seen that the twelve 10 Mbps ports, or ports 03-14, each have 11 input signals and 3 output signals, where ‘xx’ is any one of port numbers 03 through 14. The pin signal name (pin name), type (in/out), and function for these pins are described in Table 17 below. However, Mxx_DUPLEX is not a true bi-directional pin, it is an input with an open collector pull-down.

TABLE 17

| Pin Name | Type | Function |
|---|---|---|
| Mxx_TCLK | in | Transmit Clock: Transmit Clock source |
| | | from the attached PHY or PMI device. |
| Mxx_TXD | out | Transmit Data: Transmit data from |
| | | port_xx. When Mxx_TXEN is asserted |
| | | this signal carries data. |
| Mxx_TXEN | out | Transmit Enable: This signal indicates |
| | | valid transmit data on Mxx_TXD. |
| Mxx_COL | in | Collision Sense: In CSMA/CD mode, |
| | | assertion of this signal indicates |
| | | network collision. |
| Mxx_CRS | in | Carrier Sense: This signal indicates a |
| | | frame carrier signal is being received. |
| Mxx_RCLK | in | Receive Clock: Receive clock source |
| | | from the attached PHY or PMI device. |
| Mxx_RXD | in | Receive Data: Receive data from the |
| | | PMD Front End. Data is synchronous to |
| | | Mxx_RCLK. |
| Mxx_DUPLEX | inout | Switches the interface between full and |
| | | half duplex. (low = Half Duplex, high = |
| | | full duplex) |
| | | Input has an open collector pull down, |
| | | used to take line low when FORCEHD |
| | | bit is set |
| Mxx_LINK | in | Indicates the presence of port |
| | | connection. |

It may be seen that the two high speed ports (10/100 Mbps), or ports 01-02, each have 13 input signals and 5 output signals, where “xx” is port number 01 or 02. The total pin count table says this should add up to 20 pins per port. The pin signal name (pin name), type (in/out), and function for these pins are described in Table 16. However, Mxx_DUPLEX is not a true bi-directional pin, it is an input with an open collector pull-down.

TABLE 16

| Pin Name | Type | Function |
|---|---|---|
| Mxx_TCLK | in | Transmit Clock: Transmit Clock source |
| | | from the attached PHY or PMI device. |
| Mxx_TXD3 | out | Transmit Data: Nibble Transmit data |
| . . . | | from TSWITCH. When Mxx_TXEN is |
| Mxx_TXD1 | | asserted these signals carry transmit |
| Mxx_TXD0 | | data. |
| | | Data on these signals is always |
| | | synchronous to Mxx_TCLK |
| Mxx_TXEN | out | Transmit Enable: This signal indicates |
| Mxx_TXER | out | Transmit Error: This signal allows |
| | | coding errors to be propagated across |
| | | the MII. |
| Mxx_COL | in | Collision Sense: |

In CSMA/CD mode assertion of this
signal indicates network collision.
In Demand Priority mode this signal
is used to begin frame transmission.

| | | |
|---|---|---|
| Mxx_CRS | in | Carrier Sense: This signal indicates a |
| | | frame carrier signal is being received. |
| Mxx_RCLK | in | Receive Clock: Receive clock source |
| | | from the attached PHY or PMI device. |
| Mxx_RXD3 | in | Receive Data: Nibble Receive data from |
| . . . | | the PMD (Physical Media Dependent) |
| Mxx_RXD1 | | front end. Data is synchronous to |
| Mxx_RXD0 | | Mxx_RCLK. |
| Mxx_RXDV | in | Receive Data Valid: Indicates data on |
| | | Mxx_RXDn is valid. |
| Mxx_RXER | | Receive Error: Indicates reception of a |
| | | coding error on received data. |
| Mxx_SPEED | in | Bit rate selection. The speed of the |
| | | MAC interface is determined by the |
| | | level on this signal. (1 = 100 Mbps, 0 = |
| | | 10 Mbps) |
| Mxx_DPNET | in | Demand Priority Selection. The protocol |
| | | of the 100 Mbps interface is determined |
| | | by the level on this pin. (high = 100 |
| | | MbitVG Demand Priority or low = 100 |
| | | Mbps CSMA/CD). Note there is no |
| | | comprehension of the priority of DP |
| | | frames. No change in port arbitration is |
| | | implemented for DP frame handling. |
| Mxx_DUPLEX | inout | Switches the interface between full and |
| | | half duplex. (low = Half Duplex, high = |
| | | full duplex) Input has an open collector |
| | | pull down, used to take line low when |
| | | FORCEHD bit is set |
| Mxx_LINK | in | Indicates the presence of port |
| | | connection. |
| | | (low = no link, high = link ok) |

It may be seen that the control port has 2 input signals and 1 output signal. The pin signal name (pin name), type (in/out), and function for these pins are described in Table 18.

TABLE 18

| Pin Name | Type | Function |
|---|---|---|
| OSCIN | in | clock input (50 Mhz) |
| RESET# | in | reset input (Active Low) |
| DREF | out | DRAM reference clock for test purposes |
| | | only |

It may be seen that the DIO port has 8 input/output signals, 3 input signals and 1 output signal. The pin signal name (pin name), type (in/out), and function for these pins are described in Table 20 below.

TABLE 20

| Pin Name | Type | Function |
|---|---|---|
| SDATA_7:0 | inout | Byte wide bi-directional dio port |
| SAD_1:0 | in | DIO address port, these select the |
| | | TSWITCH host registers. |
| SRNW | in | DIO read not write signal. When low this |
| | | indicates a write cycle on the DIO port |
| SCS# | in | DIO Chip Select signal, when low this |
| | | indicates a port access is valid. |
| SRDY# | out | DIO Ready signal. When low |

indicates to the host when data is
valid to be read (read cycle)
indicates when data has been
received (write cycle)

This signal is driven high for one clock
cycle before placing the output in hi-
impedance after SCS# is taken high.
SRDY# should be pulled high with an
external pull up resistor.

It may be seen that the EEPROM port has 1 input/output signal and 1 output signal. The pin signal name (pin name), type (in/out), and function for these pins are described in Table 21 below.

TABLE 21

| Pin Name | Type | Function |
|---|---|---|
| ECLK | out | EEPROM Data Clock: Serial |
| | | EEPROM Clock Signal. |
| | | ECLK requires an external pull-up |
| | | resistor. |
| EDIO | inout | EEPROM Data I/O: Serial EEPROM |
| | | Data I/O signal requires an external |
| | | pull-up (See EEPROM data sheet) |
| | | for EEPROM operation. Tying this |
| | | signal to ground will disable the |
| | | EEPROM interface and prevent auto- |
| | | configuration. |
| | | EDIO requires an external pull-up |
| | | resistor. |

It may be seen that the DRAM port has 36 input/output signals and 15 output signals. The pin signal name (pin name), type (in/out), and function for these pins are described in Table 19.

TABLE 19

| Pin Name | Type | Function |
|---|---|---|
| DD_35:0 | inout | DRAM Data bus, bi-directional |
| DA_7:0 | out | DRAM Address bus (time multiplexed |
| | | with Row and Column address strobes) |
| DX_2:0 | out | DRAM Extended Address lines (time |
| | | multiplexed with Row and Column |
| | | address strobes) |
| DRAS# | out | DRAM Row Address Select signal |
| DCAS# | out | DRAM Column Address Select signal |
| DWE# | out | DRAM Write Enable signal |
| DOE# | out | DRAM Output enable signal |

It may be seen that the external address match port has 16 input signals. The pin signal name (pin name), type (in/out), and function for these pins are described in Table 22 below.

TABLE 22

| Pin Name | Type | Function |
|---|---|---|
| EAM_00 | in | External routing signal, when |
| | | EAM_15 is low and this signal is |
| | | high it indicates the frame should |
| | | be transmitted from port 00. |
| EAM_01 | in | External routing signal, when |
| | | EAM_15 is low and this signal is |
| | | high it indicates the frame should |
| | | be transmitted from port 01 |
| EAM_02 | in | External routing signal, when |
| | | EAM_15 is low and this signal is |
| | | high it indicates the frame should |
| | | be transmitted from port 02 |
| EAM_03 | in | External routing signal, when |
| | | EAM_15 is low and this signal is |
| | | high it indicates the frame should |
| | | be transmitted from port 03 |
| EAM_04 | in | External routing signal, when |
| | | EAM_15 is low and this signal is |
| | | high it indicates the frame should |
| | | be transmitted from port 04 |
| EAM_05 | in | External routing signal, when |
| | | EAM_15 is low and this signal is |
| | | high it indicates the frame should |
| | | be transmitted from port 05 |
| EAM_06 | in | External routing signal, when |
| | | EAM_15 is low and this signal is |
| | | high it indicates the frame should |
| | | be transmitted from port 06 |
| EAM_07 | in | External routing signal, when |
| | | EAM_15 is low and this signal is |
| | | high it indicates the frame should |
| | | be transmitted from port 07 |
| EAM_08 | in | External routing signal, when |
| | | EAM_15 is low and this signal is |
| | | high it indicates the frame should |
| | | be transmitted from port 08 |
| EAM_09 | in | External routing signal, when |
| | | EAM_15 is low and this signal is |
| | | high it indicates the frame should |
| | | be transmitted from port 09 |
| EAM_10 | in | External routing signal, when |
| | | EAM_15 is low and this signal is |
| | | high it indicates the frame should |
| | | be transmitted from port 10 |
| EAM_11 | in | External routing signal, when |
| | | EAM_15 is low and this signal is |
| | | high it indicates the frame should |
| | | be transmitted from port 11 |
| EAM_12 | in | External routing signal, when |
| | | EAM_15 is low and this signal is |
| | | high it indicates the frame should |
| | | be transmitted from port 12 |
| EAM_13 | in | External routing signal, when |
| | | EAM_15 is low and this signal is |
| | | high it indicates the frame should |
| | | be transmitted from port 13 |
| EAM_14 | in | External routing signal, when |
| | | EAM_15 is low and this signal is |
| | | high it indicates the frame should |
| | | be transmitted from port 14 |
| EAM_15 | in | When high indicates the least |
| (MODE_SELECT) | | significant nibble encodes a single |
| | | port routing code. |

It may be seen that the LED activity port has 4 output signals. The LED driver interface signals provide port state information. The pin signal name (pin name), type (in/out), and function for these pins are described in Table 23.

TABLE 23

| Pin Name | Type | Function |
|---|---|---|
| LED_STR1 | out | TxQ data strobe, pulses high |
| | | for one LED_CLK cycle, one |
| | | LED_CLK cycle after the end |
| | | of valid led data for TxQ status |
| LED_STR0 | out | Port status strobe, pulses high |
| | | for one LED_CLK cycle, one |
| | | LED_CLK cycle after the end |
| | | of valid led data for port |
| | | status. |
| LED_DATA# | out | Active Low, Serial LED status |
| | | data |
| LED_CLK | out | Serial Shift clock for the LED |
| | | status data |

It may be seen that the network monitoring port has 7 output signals. The network monitoring (NMON) interface signals provide traffic information for monitoring purposes without interrupting normal traffic operation. The output of the NMON pins is controlled by the bits MONWIDE and MONRXTI, which are in the system network monitoring (NMON) register described later herein. The pin signal name (pin name), type (in/out), and function for these pins are described in Table 24, where “xx” is the port number of the port being monitored.

TABLE 24

| | | Function | | |
|---|---|---|---|---|
| | | | MONWIDE = | MONWIDE = |
| | | | 1 | 1 |
| | | MONWIDE = | MONRXTX = | MONRXTX = |
| Pin Name | Type | 0 | 0 | 1 |
| NMON_00 | Out | Mxx_Rxd | Mxx_RXD[0] | Mxx_TXD[0] |
| NMON_01 | Out | Mxx_CRS | Mxx_RXD[1] | Mxx_TXD[1] |
| NMON_02 | Out | Mxx_RCLK | Mxx_RXD[2] | Mxx_TXD[2] |
| NMON_03 | Out | Mxx_TxD | Mxx_RXD[3] | Mxx_TXD[3] |
| NMON_04 | Out | Mxx_TXEN | Mxx_RXDV | Mxx_TXEN |
| NMON_05 | Out | Mxx_TCLK | Mxx_RCLK | Mxx_TCLK |
| NMON_06 | Out | Mxx_COL | Mxx_SPEED | Mxx_SPEED |

It should be noted that the “function” description for each of the foregoing signal pin tables represents the presently preferred function, operation and operative level, if noted therein.

Referring again to FIG. 1, it may be seen that each of the MACs interface to individual FIFOs associated with each port and provide network “media access control” functions, for that port. Such network “media access control” functions include, for example, but are not limited to, basic data framing/capture functions (such as preamble generation/check, data serialization/deserialization, etc.), Ethernet binary exponential backoff (with FIFO based retries), filtering of runt packets (<64 byte frames are discarded in FIFO), network statistics capture, and adaptive performance optimization (APO) capability.

Briefly, the circuit 200 switches communications packets between networks (or other devices, circuitry or hardware) associated with one or more ports by storing all incoming packets in a common buffer memory 130, then reading them back for transmission on the appropriate output port or ports. A single common memory sub-system for buffer memory keeps system costs down. More particularly, data received from a MAC interface 110 is buffered in an associated receive (Rx) FIFO 130, before storage in external memory 300 under control of the queue manager logic 140. Preferably, the external (buffer) memory 300 is EDO DRAM. Queue manager state machine logic applies round robin arbitration to maintain bandwidth and fast data transfer without contention. The address compare block 150 determines the destination port for a packet. The queue on which the data from the FIFO is appended is determined by the address compare block 150.

On transmission, frame data is obtained from the buffer memory 300 and buffered temporarily in the transmit (Tx) FIFO 130, before transmission on the associated MAC 110 for that port. The FIFO 130 allows data bursting to and from the preferred DRAM external memory 300. If a collision occurs during transmission, data recovery and re-transmission occurs from the FIFO 130. Preferably, all DRAM memory transfers are made within a memory page boundary, permitting fast burst accesses.

Statistics compilation logic is integral to the queue manager unit 140. Statistics on the frame data being switched and port activity are collected, collated and stored for each port 168. Access to the statistics registers 168 is provided via the Direct Input/Output (DIO) block 170 to a host interface. The host interface is primarily intended for low speed configuration and monitoring operations and is not needed to manage or control the flow of data through the circuit. Statistics information may be monitored by an external CPU or host computer.

The circuit allows any port configuration, including those which may exceed the maximum internal and/or external memory bandwidth. This can cause packets to be dropped; in order to avoid these conditions, the port configurations are preferably restricted so that the maximum allowable bandwidth to the external memory is not exceeded.

Preferably, all the 10 Mbps ports internally support a single MAC address per port; preferably, external address compare logic or address matching circuitry (described more fully later herein) is required to support multiple addresses or users on any one of these ports. Preferably, ports 1 and 2 (the 10/100 Mbps high speed connections) are similarly restricted. As discussed later herein, the address compare block 150 preferably contains only one address compare register for ports 1 through 14, precluding assignment of multiple address networks to these ports without utilizing some kind of external address compare logic. Preferably, the uplink port (Port 0) does not have any internal address associated with it and can thus support multiple addresses.

In operation, packets are normally routed to local ports based on the destination MAC address. However,, the circuit also allows for frame cut-through; cut-through, if enabled, starts transmission on the destination port before complete reception of the frame. This reduces the switch latency, since the frame is re-transmitted before reception is complete. For cut-through, the circuit will not be able to flag any errors until after the retransmission has already started; this potentially wastes bandwidth. Cut-through may be employed for all situations where the transmission port's data rate is slower than, or equal to, the data rate on the receiving port; for example, a 100 Mbps port may cut-through to another 100 Mbps port or a 10 Mbps port. However, a 10 Mbps port preferably can not cut-through to a 100 Mbps port; for this case, local cut-through will be disabled to prevent under flow. Instead, packet based switching will be used. Further, cut-through is not permitted for broadcast frames and cut-through may be selectively disabled by either the receiving port or transmitting port, on a per port basis, by appropriately setting the store and forward bits in the port control register for that port.

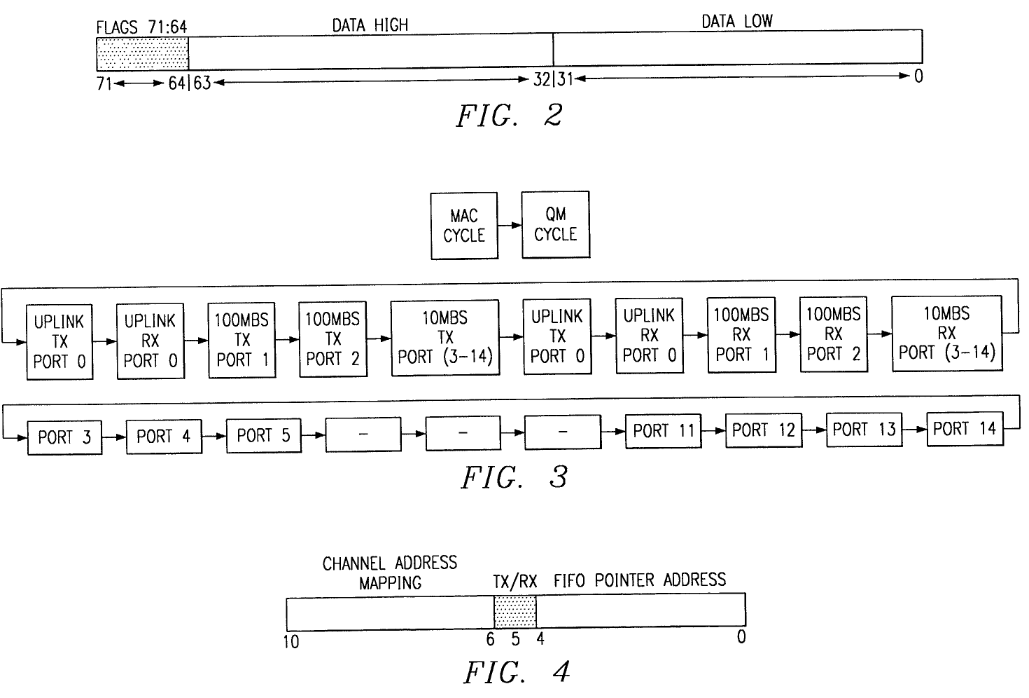

FIG. 2 depicts the preferred arrangement of data and flag information in a presently preferred 72 bit length word 210. More particularly, FIG. 2 depicts the use of a low 220 and high 230 data word, each of 32 bits length, and 8 bits of flag information 240. The flag information 240 is generated by the MAC interfaces, provides useful status and control information, and is passed along with the data 220,230 to the FIFO 130.

The FIFO 130 buffers the data between the MAC interfaces 120 and external or buffer memory 300 under control of the queue manager block 140. The FIFOs 130 are preferably implemented as a single port SRAM. There are independent FIFOs 130 allocated for transmit and receive for each port. Preferably, the depth of the FIFO storage is 256 bytes per direction, per port. The RAM space for each direction of a port is further subdivided into four 64 byte buffers. There is an additional FIFO 130 storage block allocated for storage of a broadcast frame. The total FIFO RAM 130 memory size is presently preferably organized as 1152×72 bit words. Clearly, more or less FIFO RAM may be provided, and/or organized in different sized words and different buffer sizes and numbers of buffers.

The FIFO RAM 130 provides for temporary storage of network or communications data and allows burst transfers to and from the external memory or DRAM 300. The FIFO RAM 130 also provides for network retries and allows runt frame filtering to be handled on-chip.

Preferably, each access to a FIFO 130 provides 8 bytes of data and 1 byte of flag information. To ensure sufficient bandwidth, the access sequencing scheme depicted in FIG. 3 allows the presently preferred FIFO memory 130 to be accessed as a time multiplexed resource. That is, access to the FIFO memory is allocated on a time division multiplexed basis rather than on a conventional shared memory bus or separate buses basis; this removes any need for bus arbitration (and any bus arbitration logic) and provides a guaranteed minimum bandwidth even under maximum communications loading circumstances.

More particularly, FIG. 3 depicts that the first access level to the FIFO RAM is equally divided between queue manager access (QM Cycle) 320 and MAC (or port) access cycles (MAC Cycle) 310. That is, half the FIFO accesses (every other cycle) are allocated by the queue manager; however, if the queue manager has no need to access the FIFO it passes the access on to the MAC access cycle 310. During the queue manager cycle 320, data collated into a FIFO buffer 130 is transferred between the FIFO 130 and the external DRAM 300 under the control of the queue manager logic 140.

During the port access cycle (MAC Cycle) 310, the port that is able to access the FIFO is based on the round robin scheme shown in the second and third access levels depicted in FIG. 3. The second access level depicts the allocation between individual transmit (Tx) 330Tx and receive (Rx) 330Rx slots for the lower ports (ports 0-2) and transmit (Tx) and receive (Rx) slots as a group for the upper ports (ports 3-14). That is, for the first port access cycle (MAC Cycle) depicted in the second access level, the uplink port (port 0) has a transmit (Tx) 330Tx slot available which it either uses or passes access to the QM cycle; when the next port access cycle (MAC Cycle) occurs, the uplink port (port 0) has a receive (Rx) 330Bx slot available which it either uses or passes. Thus, for each access slot from the first level of FIG. 3, the second level depicts the sequence of accesses. The third access level depicts the allocation between individual transmit (Tx) or receive (Rx) slots 340-XX for each of the upper ports (ports 3-14) that make up a group access slot at the second access level. Thus, for each port 3-14 access slot, 330Tx or 330Rx, from the second level of FIG. 3, the third level depicts the sequence of accesses. The “line” in the center of the three blank boxes (a)(b)(c) between port 5 and port 11 on the third access level represent the remaining ports between 5 and 11.

Each MAC port block has a number of FIFO pointers associated with it. These pointers are maintained by the queue manager 140 and are used by the queue manager logic 140 to point to the locations within the FIFO 130 where data can be stored or removed from. Independent pointers for receive (Rx) and transmit (Tx) operations exist for the queue manager and each MAC port. The five bit FIFO pointers address one of a possible 32 locations in the memory, corresponding to a total data access of 32×[64 bits (data)+8 bit (flags)]. The FIFO address format is depicted in FIG. 4. More particularly, FIG. 4 depicts that the channel address 420 is a 5 bit encoding of the channel, with which the information is associated, found in bit positions six through ten. (For example, channel 0 maps to 00011, channel 1 to 00100, and channel 14 to 10001) Bit 5 422 is set, or reset, depending upon the operation being a transmit or a receive, respectively. Bit positions zero through four in FIG. 4 are the five bit FIFO pointer address 424.

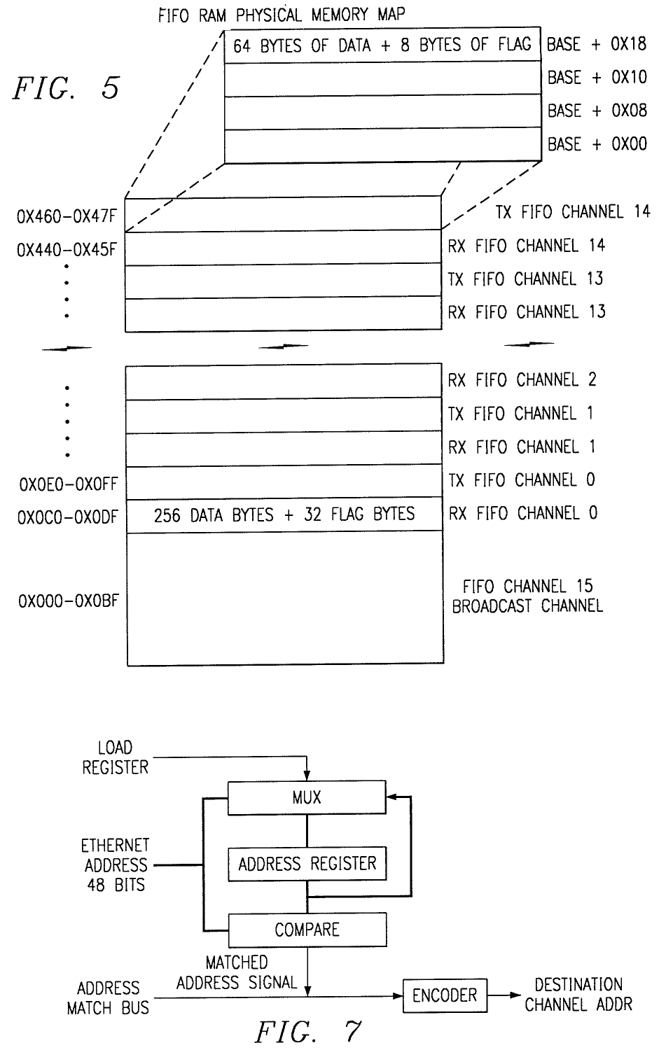

Referring now to FIG. 5, it may be seen how the FIFO RAM memory 130 is preferably physically mapped into transmit and receive blocks for each port. Further, it may be seen that each of the 32 FIFO blocks 520-538 is subdivided into 4 buffers A-C, with each buffer holding 64 bytes of data and 8 bytes of flag information. Channel 15 538 is for broadcast frames and is sized to be able to completely store a maximum length frame. The flag byte records end of buffer information for the last buffer in a frame, where the buffer may be incompletely used.

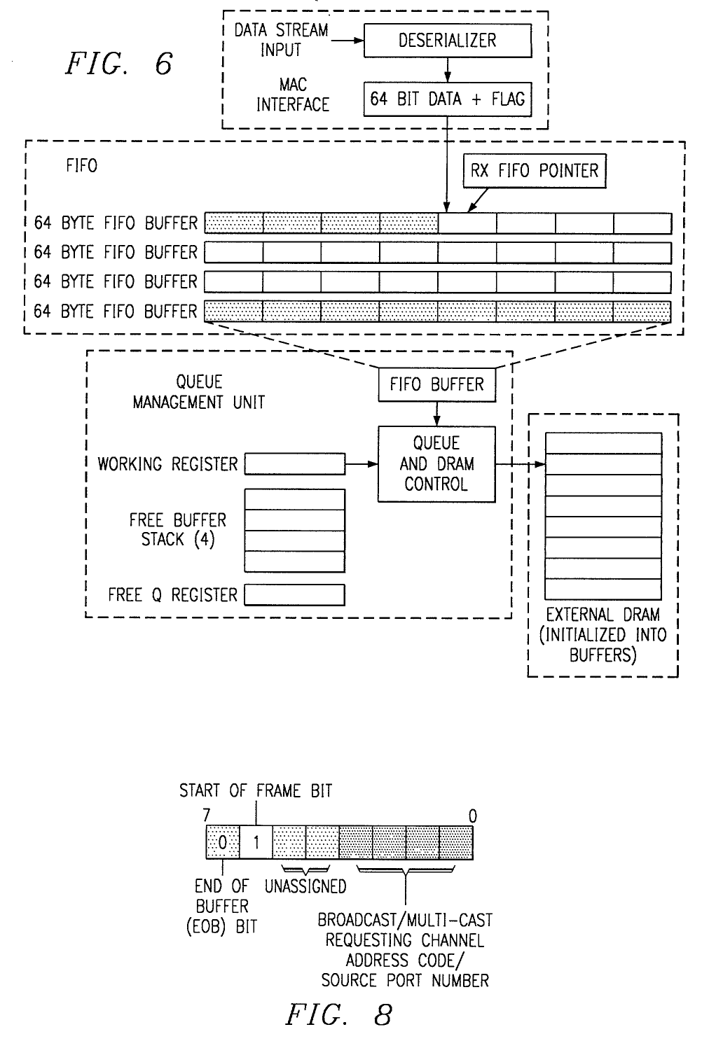

Referring now to FIG. 6, there may be seen a schematic block diagram depicting the flow of normal frame data to the FIFO 130 and from there to the external memory 300 under the control of the queue management block 140. More particularly, it may be seen how a data stream is received by a MAC 110 and deserialized by deserializer 610 into a 64 bit word and associated flag 620. Further, it may be seen that upon data reception, the data is loaded in a FIFO 130 buffer location “A5” pointed to by a Rx FIFO pointer 630 for that port. As illustrated by the bottom FIFO buffer D, when a FIFO buffer becomes full, that full buffer D is archived or transferred to the external memory 300, while the next buffer A is used to receive data. Fast page access of the external memory 300 enables swift data transfer. The queue manager 140 uses the pointer from the working register 640 to archive or transfer the full FIFO buffer D to the external or buffer memory 300 at location X+1. The working register value 640 is then replaced by the next pointer in the free buffer stack 650. When all the pointers in the free buffer stack 650 have been used, the free queue (Q) register 660 will be loaded on demand with buffers from the free buffer queue.

If the FIFO 130 becomes full and the external buffer memory 300 is also full, then any subsequent frame data will be lost and an error logged. If this condition occurs then the health of the network at large is questionable. That is, more data is entering than can leave the circuit over a sustained period, for which, the buffer depth is insufficient, resulting in storage overflow.

FIFO RAM 130 access for test is preferably provided via the DIO interface 172. This allows full RAM access for RAM testing purposes. Any access to the FIFO should only be allowed following a soft reset but before the start bit is written (or after power up, but before the start bit is written). As noted more fully later herein, the soft reset bit should be asserted then deasserted; if the soft reset bit is not cleared, the circuit will hold the DRAM refresh state machine in reset and the contents of the external memory will become invalid.

Referring now to FIG. 7, there may be seen a schematic block diagram of the address compare block 150 for a representative port. The address compare block provides the switching information required to route the data packets. The source and destination Ethernet addresses are examined by the address compare logic; the address compare logic uses source addresses to determine the ports address, while destination addresses are used to determine the destination of a packet. If a match is found the appropriate destination channel address is generated and provided to the other circuit blocks.

Each port (except the uplink port) has an address compare register associated with it. Each register holds a 48 bit Ethernet address. The Ethernet source address will be taken from a received frame and assigned to the channel it was received on; this occurs for each frame received. The destination address is compared to the address registers for all the ports. If matched, the channel address for that port or ports is assigned. If no match is found for the destination address then the frame will preferably be sent to the uplink port.

The address compare registers learn their Ethernet address, used for comparison, from the source address of a received frame. The address registers may be accessed via the DIO interface, this allows the ports to be setup and secured under management control, or port addresses monitored.

An address compare state machine handles the extraction and comparison of both the source and destination Ethernet addresses from the queue management block.

Continuing to refer to FIG. 7, it may be seen that as the frame is loaded the source address is compared against the source address 722 already attributed to that port. If the address has changed and the port address 728 acquired by the circuit was secure, an error is logged. During this comparison, it is possible to detect multiple entries of the same address in the compare unit. This is also an error, it is erroneous to have the same address applied to multiple ports.

If external address matching logic 1000 is not used, the switched ports (1-14) must be confined to a single address (desktop) rather than network (multiple address) switching. The uplink is a switched port and accordingly, a network (multiple address devices) may be connected to this port.

For a single address per port (desktop configuration), the circuit provides internal registers 722 to hold the Ethernet address associated with each port. These addresses can be assigned explicitly or dynamically. An address is explicitly assigned by writing it to the port address registers 722 via the DIO interface. An address is assigned dynamically by the circuit hardware loading the register from the source address field of the received frames. If the port is in a secured mode, the address will be loaded only once from the first frame. In an unsecured mode the address is updated on every frame received.

The uplink port (port 0) does not have any port address. This port can be connected to a network segment, so suspension of port activity due to source address mismatch is not supported for this port; there may be many different source addresses on this port. However, port 0 may become disabled due to duplication if the SECDIS bit is set to 1 (in the system control register portion of a port's VLAN register) and a duplicate address is detected.

The circuit provides two different methods for handling broadcast/multi-cast traffic. One method is out of order broadcast operation. For this method, channel 15 (the broadcast channel) is an area of shared memory 538 within the internal FIFO RAM 130 reserved for broadcast frame handling. A broadcast frame is transferred in its entirety to this area of the FIFO RAM. Each port has a local set of pointers to access this area of RAM. All ports can access this region of RAM independently under the round robin FIFO access arbitration outlined earlier. Allowing multiple (independent) access, prevents the necessity to replicate the broadcast frame for each port explicitly in the external memory buffers.

The maximum broadcast bandwidth is determined by the speed of the slowest port. Broadcast frames are not permitted to operate in cut-through mode. Broadcast frame requests are interleaved with normal frame switching to prevent multiple broadcast requests from stalling normal frame transfers for extended periods of time. During normal operation of the presently preferred circuit of the present invention, the maximum broadcast bandwidth will be reduced to approximately 5 Mbps due to this interleaving. The circuit will not block the inputs; all the data is written to the external buffer memory. Data will be discarded at the output queues, when the queues reach maximum length.

Transmission of an out-of-order broadcast frame only starts when a port becomes free (i.e. after the end of a frame previously being transmitted). To prevent broadcast frames being sent to ports which are not linked (stalling the circuit), a port's Mxx_LINK signal is sampled prior to the start of transmission. For each port without link, the broadcast frame is not transmitted on that port. This only occurs prior to the start of transmission not when the broadcast frame is queued.

If the address compare unit determines that the first bit of the address is set to a ‘1’, the frame is multi-cast to all the other ports of the circuit (excluding the port that initiated the multi-cast frame) via the broadcast channel; the broadcast address is a special case of the multi-cast address.

To prevent echoing a multi-cast or broadcast frame back to the receiving port, the channel address on which the request was made is recorded in the flag byte. The format for the eight bit flag byte is shown in FIG. 8. More particularly, FIG. 8 depicts that the format of the flag byte depends on the state of the end of buffer (EOB) bit, which is the eighth bit. If the EOB bit is reset, the format shown in FIG. 8 is applicable, with the lowest “nibble” of four bits (bits 0-3) storing the requesting channel code information. If the EOB bit is set, the format of the flag byte changes, as noted later herein in the discussion of the 10 Mbps MAC interface.

The requesting channel code is used to clear the respective bit in the channel mask applied for the multi-cast/broadcast frame, hence the frame is not echoed to the requesting channel.

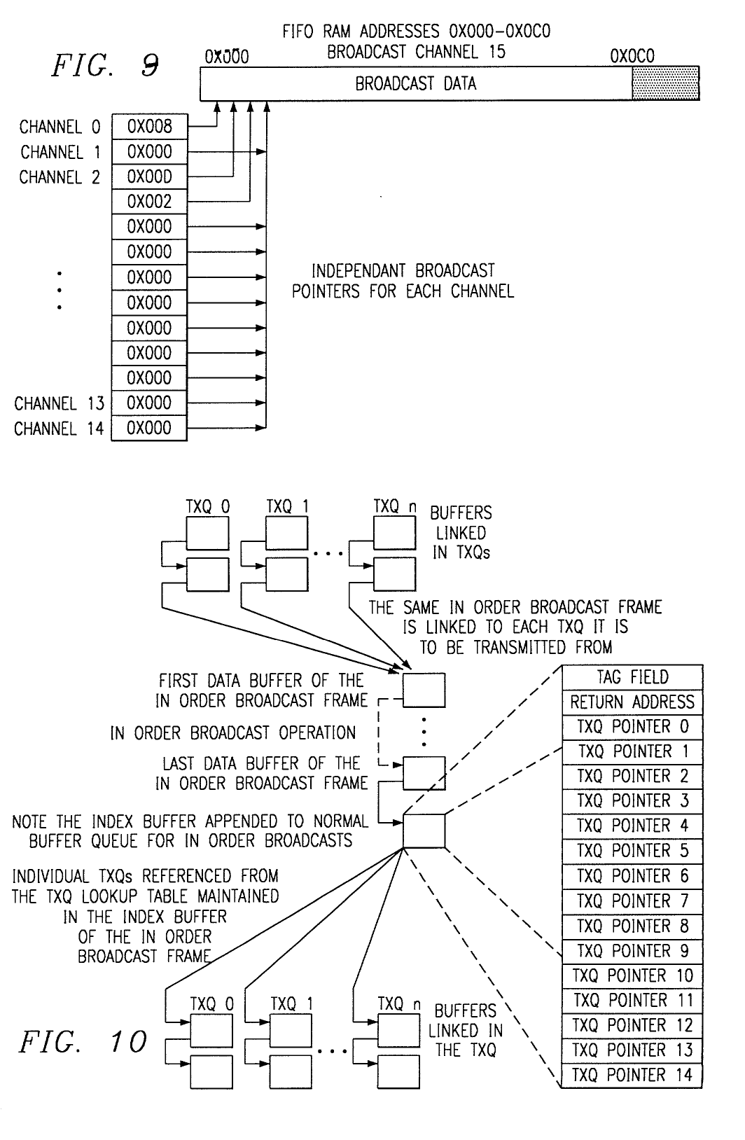

The other method for handling broadcast/multicast traffic is in order broadcast operation. This method of handling broadcast traffic is selected by setting the in order broadcast mode (IOBMOD) bit (in the system control register portion of a port's VLAN register). Unlike out of order broadcast handling, in order broadcast (IOB) handling ensures that frames which are broadcast, follow the strict order in which they were received. This cannot be guaranteed for out of order broadcast operation. Referring now to FIG. 9, there may be seen a simplified schematic diagram of the use of independent broadcast pointers A-D for each channel. Again, as depicted in FIG. 9, the channel 15 shared memory portion 538 of the internal FIFO RAM 130 is used to store the broadcast frames.

Referring now to FIG. 10, there may be seen a schematic block diagram depicting the flow of broadcast frame data through the FIFO 130 under control of the queue management block 140. More particularly, it may be seen how on data reception, when a multi-cast frame is detected in IOB mode, the reception continues as for a normal store and forward frame. The buffers comprising the received frame are linked together in the receive queues (RxQ), as depicted by buffer “F” with dotted line to buffer “L”.

When the end of frame is detected an additional buffer “I” is linked to the end buffer “L” of the RxQ link. This buffer “I” is exactly similar in size to a normal data buffer but contains indexed queue information rather than frame data. To distinguish between the types of buffer, bit 23 of the forward pointer pointing to the “index” buffer is set.

The linked RxQs “F”-“L” are then linked to the transmit queues (TxQs) on which the multi-cast data is to be transmitted, as depicted by the solid lines a,b,c. The ports to which the data is sent can be defined two ways. If no external addressing logic is used, the multi-cast data will be linked to all currently active ports, defined in the port bitmap held in the Virtual LAN (VLAN) register for the port on which the data was received. Alternatively the port bitmap presented on the external address interface (EAM) pins will be used, the data will be linked to the active port subset of that defined on the pins.

Having determined the TxQs onto which the IOB data will be linked, the forward pointer a,b,c for each TxQ is updated to point to the head of the RxQ (IOB data). In this way, the multi-cast data buffers will appear linked on to multiple queues without the overhead of replicating the multi-cast data. The index buffer “I” is used to preserve the separate TxQs as they form following the IOB data frame. Each index buffer contains a forward pointer x,y,z referencing the continuation of the TxQ for every port. As new TxQ data is enqueued, the forward pointers in the index buffer are updated to reflect the continuation of the independent TxQs.

The IOB frame buffers can only be returned to the free buffer queue when all ports have transmitted the IOB data. Since there could be a large discrepancy between the first port completing transmission and the last (due to a long TxQ prior to the IOB data), a tag field 910 is used to record which ports have transmitted the IOB data, from the list of ports that the data was to be sent to originally. The tag field 910 is also stored in the index buffer. When the last port tag is cleared all the buffers can be returned to the free pool of buffers.

The buffers can only be freed after the last transmission, by which stage the forward pointer pointing to the head of the IOB buffers will itself have been freed. The return address field 912 of the index buffer is used to store the head address of the IOB buffers. Thus even after the last IOB transmission the head of the IOB buffers remain known. Freeing the buffers then becomes the simple matter of writing the pointer to the top of the freeQ to the last forward pointer of the IOB buffers and moving the return address into the top of the freeQ, thereby placing the used IOB buffers onto freeQ.

If a frame enters on a port whose address matches the destination address' of the frame, the frame is not echoed back on that port. As a general rule, no frame is echoed back to the port it was received upon. If frame routing is being performed by an external address matching (EAM) circuit connected to the EAM interface, it is the system/user's responsibility to enforce this; the circuit will not enforce this.

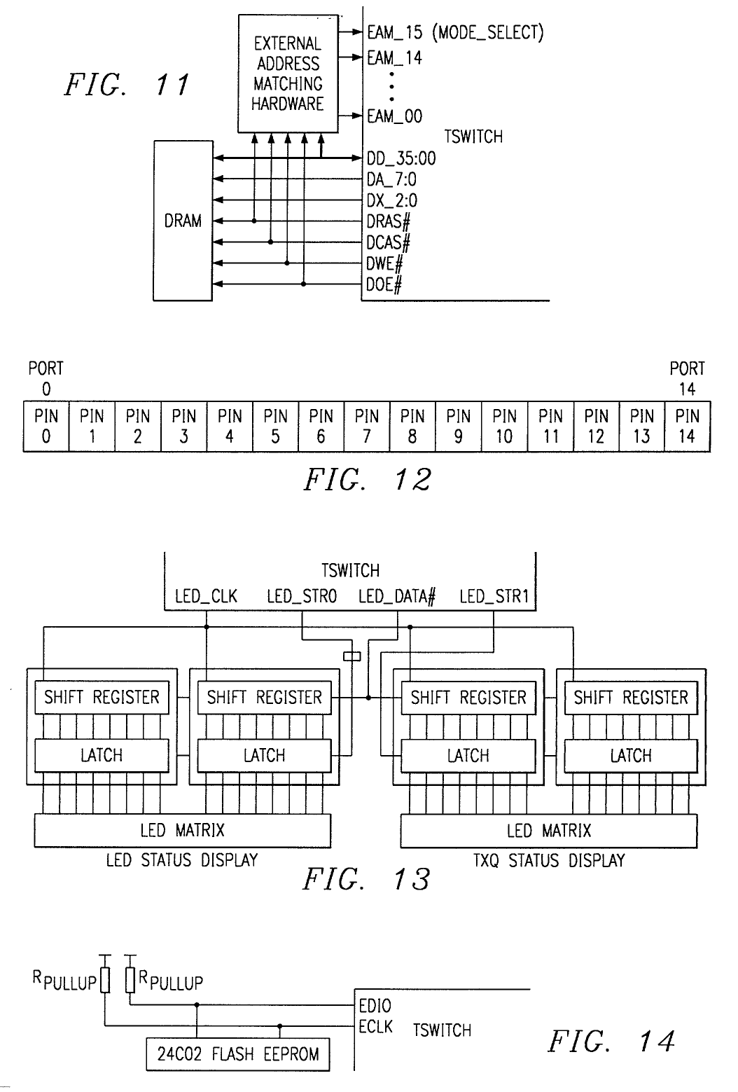

As depicted in FIG. 11, all valid frames are passed across the DRAM interface 88 from the circuit 200 to the external memory 300 using the DRAM bus. The EAM circuit or hardware 1000 can detect the start of a new frame from the flag byte information. That is, the first flag nibble on the DRAM data bus (DD bits 35:32) correspond to bits 7:4 of the frame flag. In conjunction with the DRAM column address strobe (DCAS), external EAM logic 1000 can access the frame addresses and perform external address look up.

The external EAM logic 1000 may use the row address strobe DRAS and column address strobe DCAS to identify the position of the forward pointer, the top nibble of the flag byte and whether the nibble contains the start of frame code 01XX. For example, bit 35 of the forward pointer should be zero if denoting a start of frame. If it is high the frame is an IOB link buffer and not the start of data frame (bits 34, 33, 32 contain parity information for the 3 forward pointer data bytes). Bits 28 thru 24 of the forward pointer will denote the active channel code. Bit 28 denotes TX (1) or RX (0). Bits 27 thru 24 denote the active port number Port 00=0000 Port 01=0001 etc.

The external EAM logic 1000 may also use the DRAM column address select to identify the presence of destination and source address data on the DRAM interface and then perform appropriate address processing. The external EAM logic 1000 may then provide the destination channel bit map 12 memory cycles after the high nibble of the start flag is transmitted on the DRAM interface. These activities are described more fully later herein in reference to the external address compare logic of the present invention. FIG. 11 depicts the interconnection of external address matching hardware 1000 (address compare logic or EAM logic) with the circuit 200 and its associated external DRAM 300. For FIG. 11 and the discussion herein any signal that ends with a “#” is an active low signal. As may be seen from FIG. 11, the EAM hardware block 1000 is interconnected to the DRAM bus 88 and its associated control signals, as well as the EAM interface 86 of the circuit 200.

The circuit 200 will use the external channel address in priority over the internal channel address match information, to route the frame to the appropriate channel. To disable the EAM interface, a ‘no-op’ code should be used. If there is no EAM hardware present the ‘no-op’ code should be hardwired onto the interface. The ‘no-op’ code causes the internal destination selection to be used.

Table 1 below provides the 4 bit code needed to identify the destination port when using the EAM interface with EAM_{—}15 (MODE SELECT) bit set. When the EAM_{—}04 bit is set and the EAM_{—}15 bit (MODE_SELECT) is set, all other EAM bits will be ignored (this is the “no-op” code); the frame will use the internal address match information. When the EAM_{—}04 is reset then the four EAM_{—}03:00 bits will be used to identify a single destination port or broadcast queue.

To discard a frame the external interface should provide a no-match code and all internal address registers should be disabled with the address disable bit (port control register bit 3).

TABLE 1
External Address Match Port Codes

| | | | |
|---|---|---|---|
| | EAM_15 | EAM_04 | |
| Port | MODE_SELECT | ‘no-match’ | EAM_03:00 |

| | | |
|---|---|---|
| Port 0 (uplink) | 1 | 0 0000 |
| Port 1 (10/100 Mbit) | 1 | 0 0001 |
| Port 2 (10/100 Mbit) | 1 | 0 0010 |
| Port 3 (10 Mbit) | 1 | 0 0011 |
| Port 4 (10 Mbit) | 1 | 0 0100 |
| Port 5 (10 Mbit) | 1 | 0 0101 |
| Port 6 (10 Mbit) | 1 | 0 0110 |
| Port 7 (10 Mbit) | 1 | 0 0111 |
| Port 8 (10 Mbit) | 1 | 0 1000 |
| Port 9 (10 Mbit) | 1 | 0 1001 |
| Port 10 (10 Mbit) | 1 | 0 1010 |
| Port 11 (10 Mbit) | 1 | 0 1011 |
| Port 12 (10 Mbit) | 1 | 0 1100 |
| Port 13 (10 Mbit) | 1 | 0 1101 |
| Port 14 (10 Mbit) | 1 | 0 1110 |
| Broadcast channel | 1 | 0 1111 |
| (Out of | | |
| Order Broadcast) | | |
| No-Op | 1 | 1 XXXX |
| Bitmap mode | 0 | EAM(14:0) = port |
| | | destination bitmap |

When the EAM_{—}15 bit (MODE_SELECT) is reset (0), the EAM_{—}14:00 inputs, provide a mechanism for the EAM interface to specify which destination port or group of destination ports will be used to transmit the frame. Each signal represents one destination port, asserting just one signal will send the frame to one destination port, asserting more than one signal will send the same frame to multiple ports. This allows the EAM interface to limit the broadcast/multi-cast traffic within a virtual LAN. By “virtual Lan” (VLAN) it is meant that portion or subset of the many nodes connected to network that form a smaller “virtual” LAN so that messages may be sent to only those nodes that are part of the virtual LAN, rather than the entire network and thereby avoid unnecessary traffic congestion. This mode of operation employs the IOB mechanism to append the frames onto the transmit queues of the ports the frame is to be transmitted from. However, the IOB mechanism is an inefficient way to send frames to single ports; when possible individual port codes should be used for this task.

For the single address per port mode, the circuit provides a VLAN register per port. Each register contains a bit map to indicate the VLAN group for the port. All broadcast/multi-cast traffic received on that port is then only sent to the ports that are a part of the same VLAN. FIG. 12 depicts the external address match interface information for ports 0 to port 14. More particularly, it may be seen that each pin number corresponds to its numeric port number, and as noted earlier herein, asserting a signal on a pin results in the frame/traffic being transmitted on the port number corresponding to that pin number with a signal on it.

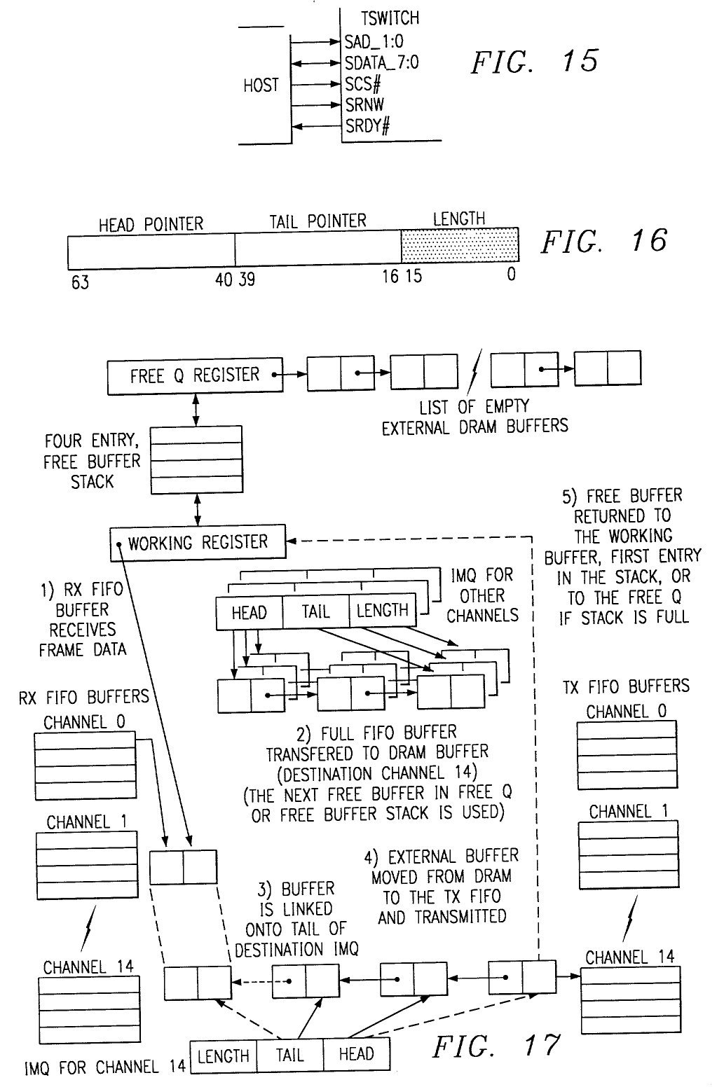

The circuit 200 includes an interface 180 allowing a visual status for each port to be displayed. FIG. 13 depicts a schematic block diagram of the interconnection of external circuitry with selected signals of the circuit 200 to provide this visual status. More particularly, as seen in FIG. 13, the data supplied by the circuit 200 is multiplexed between port status (status display) 1320 and TxQ congestion (TxQ status) 1322 information. The data type is determined by the two strobe signals (LED_STR0 and LED_STR1). As depicted in FIG. 13, port status information is latched on the LED_STR0 signal, while Transmit Q congestion information is latched on the LED_STR1 signal.

The LED port status output 1320 will be driven low when the port state is “suspended” or “disabled”, except where the suspension is caused by a link loss. During normal operation the output will be high. The TxQ congestion status 1322 will be driven low when the TxQ length has become negative for a port (indicating no further frames can be queued). For uncongested operation the latched output will be high. The LED_DATA# signal is active low since TTL is more efficient at driving low than high.

Whenever a change is detected in the port status or TxQ congestion status, the interface 180 will update the LED data. Although sixteen bits of status are shifted out serially into a shi register 1300 at each update, as described later herein, the sixteenth bit is reserved. The LED_STR0 or LED_STR1 signal is pulsed once upon completion of the shift, to latch the data in the shift register 1300 into a latch 1310. The latch is then used to drive an LED matrix 1320,1322 which provides the requisite visual status of the ports.

A flash EEPROM interface 80 is provided on the circuit 200 to allow for pre-configuring a system alternatively, this interface 80 allows the system to be changed or reconfigured and such preferences retained between any system power downs. The flash EEPROM 350 contains configuration and initialization information which is accessed infrequently; that is, information which is typically accessed only at power up and reset.

The circuit preferably uses an industry standard 24C02 serial EEPROM device (2048 bits organized as 256×8). This device uses a two wire serial interface for communication and is available in a small footprint package. Larger capacity devices are available in the same device family, should it be necessary to record more information. FIG. 14 depicts the interconnection of such an EEPROM device 350 to the circuit 200, and associated pull-up resistors.

The EEPROM 350 ‘may be programmed in ’ one of two ways. It may be programmed via the DIO/host interface 170 using suitable driver software. Alternatively, it may be programmed directly without need for any circuit interaction by use of suitable external memory programming hardware and an appropriate host interface.

The organization of the EEPROM data is in the same format as the circuits internal registers, preferably at addresses 0x00 thru 0xC3, which are described later herein. This allows a complete initialization of circuit 200 to be performed by down loading the contents of the EEPROM into the circuit 200. During the download, no DIO operations are permitted. The download bit cannot be set during a download, preventing a download loop. The download bit is reset after completion of the download.

The circuit 200 auto-detects the presence or absence of the EEPROM 350. If it is not installed the EDIO pin should be tied low. As depicted in FIG. 14, for EEPROM operation the pin will require an external pull up. When no EEPROM is detected the circuit assumes default modes of operation at power up and downloading of configuration from the EEPROM pins will be disabled. The signal timing information for the EEPROM interface is discussed later herein.

The DIO interface (Direct Input Output) 120 allows a host CPU to access the circuit. The DIO interface 120 provides a system/user and a test engineer with access to the on-chip registers and statistics. The test engineer is interested in quickly configuring and setting the circuit's registers to minimize testing time. The system/user is interested in monitoring the device using a host and tailoring the device's operations based on this monitoring activity.

The DIO port provides a host CPU 600 with access to network statistics information that is compiled and stored in the statistics RAM. The DIO port allows for setting or changing operation of the circuit. The DIO port also provides access to port control, port status and port address registers permitting port management and status interrogation. The DIO port also allows for test access, allowing functional testing.

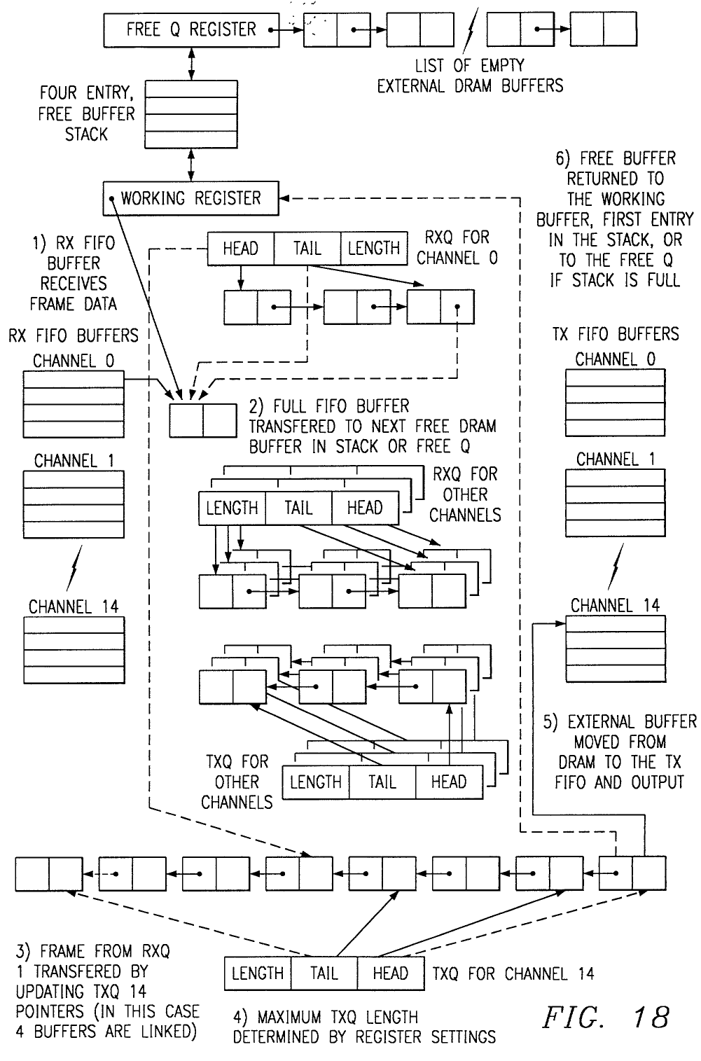

Referring now to FIG. 15, there may be seen a simplified block diagram illustrating the interconnection of DIO port signals 172 with a host 600. To reduce design overheads and to simplify any interfacing logic, a byte wide asynchronous bi-directional data interface (SDATA_{—}7:0) is utilized by the circuit, as illustrated in FIG. 15. The host synchronizes the interface signals.

Access to the internal registers of the circuit is available, indirectly, via the four host registers that are contained in the circuit 200. The details of this access is provided later herein, but the access is similar to that depicted in FIG. 92. Table 2 below identifies these four host registers and the signal combinations of SAD_{—}1 and SAD_{—}0 for accessing them.

TABLE 2

| SAD_1 | SAD_0 | Host Register |
|---|---|---|
| 0 | 0 | DIO_ADR_LO |
| 0 | 1 | DIO_ADR_HI |
| 1 | 0 | DIO_DATA |
| 1 | 1 | DIO_DATA_INC |

More particularly, the four host registers are addressed directly from the DIO interface via the address lines SAD_{—}1 and SAD_{—}0. Data can be read or written to the address registers using the data lines SDATA_{—}7:0, under the control of Chip Select (SCS#), Read Not Write (SRNW) and Ready (SRDY#) signals.

The queue manager unit 140 performs a number of functions or tasks. At the top level it provides the control for the transfer of data between the DRAM memory 300 and the FIFOs 130. The queue manager 140 uses an internal 64 bit memory to maintain the status of all the queues. The queue manager 140 is preferably implemented as a hardware state machine. That is, the queue manager state chine is preferably sequential logic configured to realize the functions described herein. The queue manager 140 uses three queues to transfer data between the DRAM memory and the FIFOs. The three queues are associated with each port and are the receive queue (RxQ), the transmit queue (TxQ) for store and forward operation, and the immediate queue (ImQ) for cut-through operation.

FIG. 16 depicts the format of the internal registers used by the queue manager to maintain the status of all the queues in external or buffer memory, As depicted in FIG. 16, the head pointer of 24 bits records the starting address of the queue in the external or buffer memory. The tail pointer of 24 bits records the last (or the tail) address of the queue. For transmits (Ta) the length field of 16 bits is a residual length indication and provides an indication of how many buffers are available to the queue. As described more fully later herein, the number of buffers allocated to a queue at initialization is dependent upon the size and the configuration of the external memory; this information can be stored in an EEPROM connected to the EEPROM interface or written to the registers directly. For receives (Rx) the length recorded is the absolute number of buffers enqueued.

The receive queue (RxQ) collates buffer data for frames that can not be cut-through to the destination port. All the frame data to be switched is collated on the appropriate RxQ. It is then concatenated to the end of the destination TxQ. Concatenation entails placing the head pointer of the RxQ in the forward pointer of the last buffer in the TXQ. The length of the RxQ (number of buffers used) is subtracted from the number of free TxQ buffers available. The tail pointer of the Rx data becomes the new tail pointer for the TxQ. There is one RxQ for every channel. If the destination port becomes idle and the frame collated on the RxQ can be cut-through, the RxQ will be written to the IMQ for transmission.

The transmit queue (TxQ) stores complete frames that are ready for transmission. Once placed on the transmission queue the data will be transmitted; the Tx queues are not stalled pending the completion of receive data. The queues will only be stalled if transmission can not occur. There is one TxQ for every channel.

The immediate queue (ImQ) collates cut-through mode buffer information. If there is data enqueued to the ImQ and the destination port is available, the data will be transmitted. New frame data will only be placed onto the immediate queue if (a) the data can cut-through from source to destination, (b) the transmitter is currently idle on the destination port, and (c) there is no existing frame transfer occurring on either TxQ or ImQ.

If the number of buffers, in the buffer pool becomes less than or equal to zero, no further data will be accepted. Rx frame data will be discarded until the free queue contains free buffers again. Additionally individual queues can overflow, in particular the TxQ. The TxQ length is recorded as a residual figure (i.e., number of buffers remaining, rather than number of buffers queued). If this becomes negative, no further frame data will be queued and frames will be discarded.

Referring now to FIG. 17, there may be seen a schematic diagram depicting the steps the queue manager performs for a cut-through operation. More particularly, it may be seen that initially a Rx FIFO buffer receives frame data. After a full frame of FIFO buffer of data is accumulated the data is transferred to an external memory buffer and is designated for transmission by channel 14; the external buffer used to store the data is the next free buffer in the free Q or the free buffer stack. The buffer is then linked onto the tail of channel 14's IMQ; the IMQ for channel 14 has its tail pointer modified to reflect the addition of this buffer to the list of IMQ buffers. After the data in a buffer on top of the channel 14 IMQ buffer list is transferred to a channel 14 Tx FIFO buffer, the head pointer is modified and buffer on top is returned to the working register, free buffer stack, or free Q if the stack is full. Once the Tx FIFO buffer is loaded, the data is transmitted by channel 14.

Referring now to FIG. 18, there may be seen a schematic diagram depicting the steps the queue manager performs for a store and forward operation. More particularly, it may be seen that initially a Rx FIFO buffer for channel 0 receives frame data. After a full frame of FIFO buffer of data is accumulated the data is transferred to an external memory buffer and is designated for the receive Q (RxQ) for channel 0; the external buffer used to store the data is the next free buffer in the free Q or the free buffer stack. The buffer is then linked onto the tail of channel 0's RxQ; the RxQ for channel 0 has its tail pointer modified to reflect the addition of this buffer to its list of RxQ buffers.

The four buffers in channel 0's RxQ are designated for channel 14 to transmit. So the head of the four buffer chain is added to the tail of channel 14's existing TxQ and the end of the four buffer chain becomes the new tail pointer; this assumes the maximum length TxQ of channel 14 is not exceeded as determined by various internal register settings. After the data in a buffer on top of the channel 14 TxQ buffer list is transferred to a channel 14 Tx FIFO buffer, the head pointer is modified and buffer on top is returned to the working register, free buffer stack, or free Q if the stack is full. The length of the TxQ of channel 14 is modified to reflect the removal of this buffer. Once the Tx FIFO buffer is loaded, the data is transmitted by channel 14.

Referring now to FIG. 19, there may be seen a schematic diagram of the arrangement of the buffers in the external memory 300 and the arrangement of the interior of a representative buffer. Each buffer is capable of holding the complete contents of one of the internal FIFO buffers (which corresponds to the minimum size Ethernet frame). The buffers are aligned to fit within a page of the external memory. No buffer crosses a page boundary; this allows for consistent access times to be attained at the expense of a small amount of unused memory. The external memory, organized in this way, permits fast data bursts between the internal FIFO and external memory. This reduces the amount of intermediate data management that is needed and in turn increases the internal bandwidth.

At initialization, the circuit loads the configuration information from the EEPROM (if present) or uses its reset values to set the length field for each of the queues, unless initialized by DIO access. This fixes the maximum number of buffers that a port can use for transmit queues. As buffers are used by these queues the length field is adjusted to indicate the number of buffers that are still allocated for use by that particular queue.

The total number of buffers available to the circuit is determined by the size of the external memory 300. The RSIZE (RAM Size) field of the RAM size register (which is a portion of the VLAN register map), is loaded from the EEPROM or from the DIO interface with the appropriate system ram code. The circuit uses this sizing information to modify the DRAM addressing limit when initializing the data buffer structures in the external memory. The external memory (DRAM) 300, as depicted in FIG. 19, is initialized to contain a single list of data buffers (free buffer queue) available to all queues. Each buffer is preferably 76.5 bytes in size; the least significant byte of the DRAM address is incremented in steps of 17. During initialization, normal circuit operation is disabled. Once the buffer structure has been created in the DRAM, no further use is made of the sizing information.

The queue size for the transmit queues can be increased by adding a two's compliment number (representing the number of buffers that need to be added to the queue) to the TxQ length field. Reducing the number of buffers allocated to the ports is done in the same way by adding a negative length field. The length is updated after the transmission of a buffer. The update bit is cleared once the update has occurred.

There is no checking between the number of free buffers physically available in memory and the number of buffers allocated to each queue. It is possible to oversubscribe the memory between the queues. If a frame is being buffered when the buffer ceiling is reached, all buffers constituting that incomplete queue of buffers will be purged and replaced on the free buffer stack or queue. Thus, when memory is limited, large frames will be inherently ‘filtered’ in favor of smaller frames. When all buffers are subscribed and none are available for use, the circuit will accept no new frames, but will wait for buffers to be freed before continuing.

Referring now to FIG. 67, there may be seen a simplified flow diagram illustrating the major states of the main queue manager state machine, its interconnection with the queue manager channel arbitration state machine, and the main states of the queue manager channel arbitration state machine. More particularly, it may be seen that the queue manager arbitration state machine is a state machine that implements the QM portion of the multi-level access sequencing scheme discussed earlier with respect to FIG. 3. There is a corresponding hardware state machine for the MAC portion of FIG. 3 that is depicted on the left-hand side of FIG. 31. The MAC state machine depicted in FIG. 31 is a much simpler state machine, as it does not have changing priorities; when inactive transmits are canceled, their time slot is left in place and not used.

Continuing to refer to FIG. 67, it may be seen that the main queue manager state machine sends a request next channel code to the queue manager arbitration state machine. This request comes into a portion of the arbitration state machine that is identified as the null channel block. More particularly, the null channel block returns a channel code of null when there is no request and has a loop to keep looping back on itself when there is no request present.

When a request comes in, the null channel block determines whether the next request should be a receive request (Rx_request) or a transmit request (Tx_request). Both of these requests then go to a block that is either the next receive or transmit channel. This block determines which channel is next in sequence according to the sequencing scheme of FIG. 3. The output from the blocks for the next channel goes into two parallel blocks for the receive and transmit sides that deal with setting the channel according to the channel priority. The output from these blocks are then fed to a toggle either transmit or receive channel block which then outputs the channel code to the main queue manager state machine.

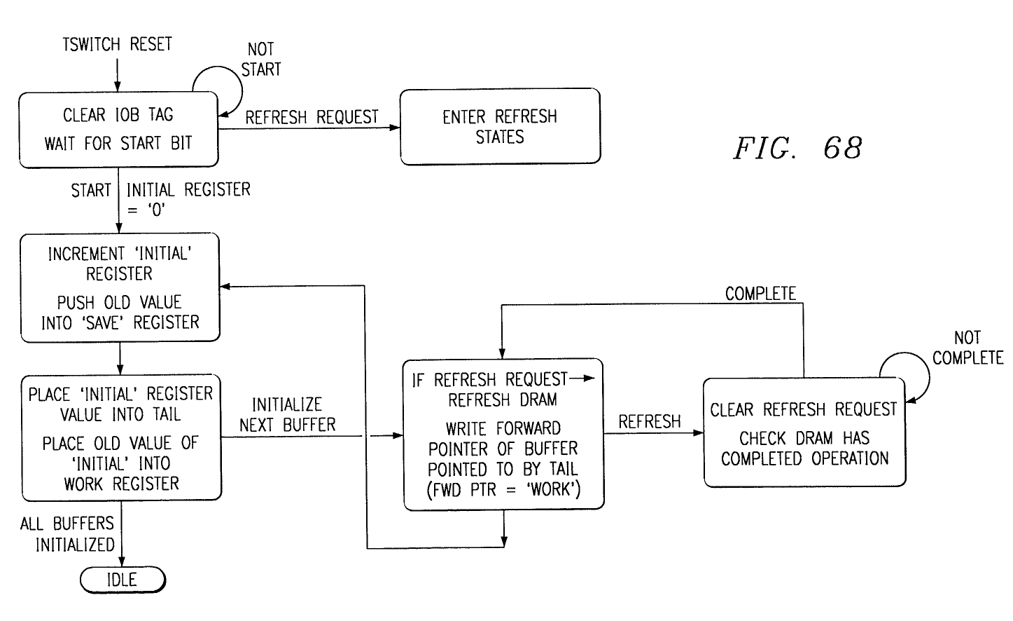

The main queue manager state machine is first initialized in the buffer initialization state. The details of the activities that occur in this block are further described in FIG. 68. In essence, this block is directed to setting up the chain of buffers in the external memory 300. This block looks at things like RAM size to determine how many blocks of queues should be set up in the external memory 300. After the external memory 300 has been initialized, the queue manager state machine passes into an idle state.

While in the idle state, the main queue manager state machine determines if it has a refresh request pending. If it does, it then enters the refresh state. This is depicted by the enter refresh states block which is entered by the arrow between the idle state and this enter refresh states block. The refresh request comes from a timer that starts at some preselected value and counts down and when it gets to zero generates the refresh request. Upon generation of the request, the state machine then enters the refresh state and performs the CAS before RAS on a portion of the external memory 300 to maintain it in a refreshed state. In addition, the address where this refresh takes place is incremented so that the refresh occurs in different portions of memory, but covers all of the memory locations within the specified refresh time.

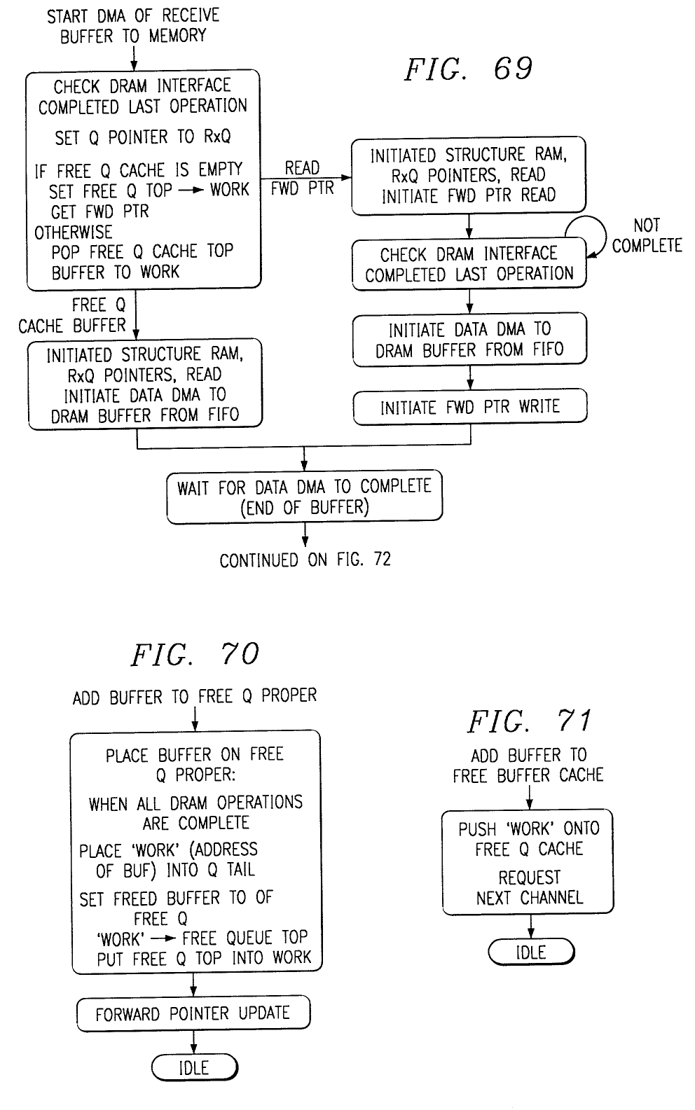

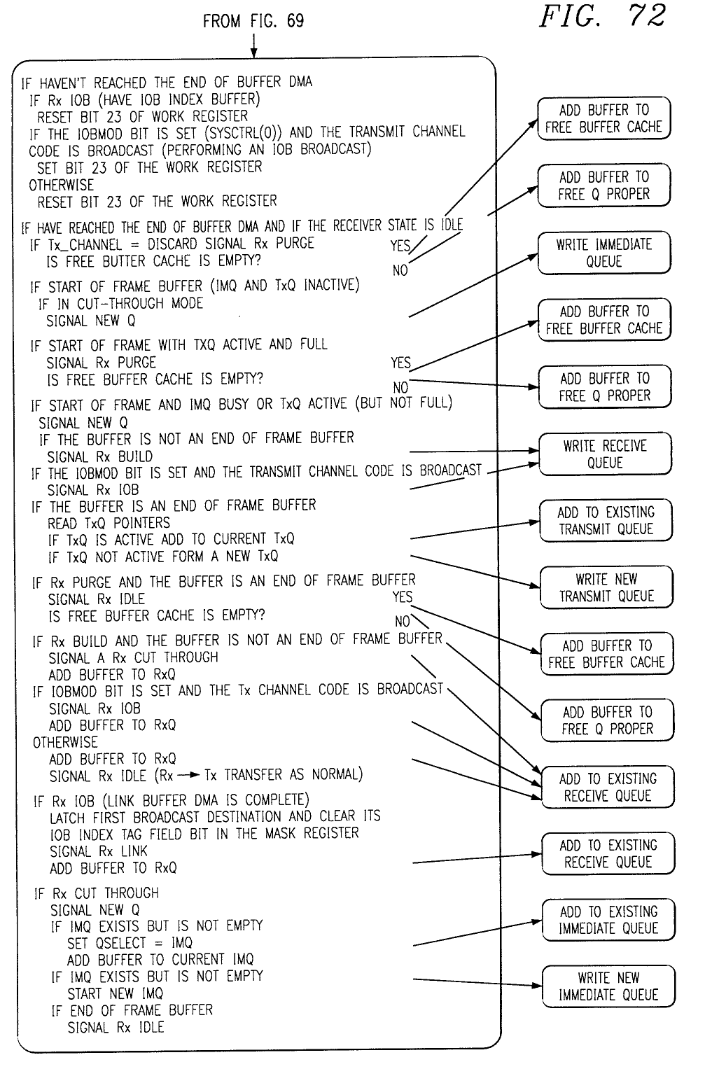

The main queue manager state machine then looks at the channel code and determines if it is a receive or transmit code. If it is a receive channel code it enters the receive state. This is depicted by the arrow from the idle state block to the enter receive state block. The enter receive state block is more completely described in FIGS. 69 and 72. If a transmit channel code has been provided, then the state machine determines if the intermediate queue is active for that transmit channel code. It sets the queue select to the immediate queue if the immediate queue is active for that transmit channel. Otherwise, the queue select is set to TXQ and the machine then enters the transmit state. There are two arrows from the out of state machine shifts to one of the enter transmit state blocks with one transmit state corresponding to the TXQ and the other transmit state block corresponding to the immediate queue (IMQ). After completing the activities with either the refresh state block or the transmit state blocks or the receive state blocks, there is a return back to the idle state. The idle state then again loops through the various steps described herein above. As noted in FIG. 67, refresh takes priority in selection over both of the transmit states and the receive state. If there is a pending refresh request, then that refresh request will occur before anything else occurs and the transmit or receive states are merely pushed back in time.

Referring now to FIG. 68, there may be seen more detail of the buffer initialization state portion of the main queue manager state machine depicted in FIGS. 57. 67?? More particularly, it may be seen that when the circuit is reset the initial block is the clear IOB tag, which is the in order buffer tag, and then waits for a start bit. If the start bit is not seen, then it loops in the not start loop. While in this block, if a refresh is requested, then the state machine enters the refresh states and refreshes a portion of the external memory 300. After the refresh is completed the state machine returns to the clear IOB tag wait for start bit block until the start bit is reset.

After the start bit is reset, the state machine moves to the next block, which is the increment initial register and push old value into save register. This process is the start of the initialization of the buffer chain in the external memory 300. The state machine then proceeds to the next block which is to place the initial register value into the tail and place the old value of the initial register into the work register. In this manner, the state machine starts at the zeroth address and increments up the length of a buffer and then takes the value of the top of that buffer and places it in the save register as the end of that buffer. It then increments up to the bottom of the next buffer and puts a tail pointer which points from the bottom of this new buffer back to the top of the initial buffer. It continues to increment through the initialize next buffer step and goes into the refresh request or write forward pointer buffer pointed to by tail block. If the refresh request is noted, it enters refresh and clears the refresh request and checks that the DRAM has completed its operation. If it is not completed it loops back; once completed it goes back into the write forward pointer of buffer pointed to by the tail block. After this is completed, it goes back to the increment initial register and push the old value into save register and continues to loop like this until all the buffers are initialized.

This again is a function of the RAM size which is the size of the external memory 300. Initially, the all buffers initialize portion is checked by counting cycles, but at some preselected point it then shifts to looking at the addresses to see whether the address has reached the limit of the RAM size. After all the buffers are initialized, the state machine then passes back into the idle state which is again depicted in FIG. 67.

Referring now to FIG. 69, there may be seen a portion of the queue manager state machine associated with the receive state. More particularly, it may be seen that the initial state checks to see if the DMA of the receive buffer to memory is started. That is, it checks to see if the receive FIFO has been transferred to external memory 300. It checks the DRAM interface to ensure that it has completed the last operation associated with this data transfer. After this is completed it then sets the queue pointer to the receive queue (RxQ). It then looks to see if the free Q cache is empty. If so, it sets the free Q top to the work register and gets the forward pointer. Otherwise, it pops the free Q cache top buffer to the work buffer. In the next block it reads the receive queue pointers and initiates a data DMA to the memory buffer 300 from a FIFO. Upon completion of this, it then passes down to the next state which is wait for the data DMA to complete and that is associated with an end of buffer flag. That then completes this block and the remainder of the receive state that is continued on FIG. 72. However, in the initial block after the state machine has obtained a forward pointer it reads the forward pointer and shifts to another block which is to read the receive queue pointers and initiate a forward pointer read. It then passes to the next block which is to check that the DRAM interface has completed its last operation and loops back on itself if the DRAM interface has not completed these operations. It then passes to the next state which is to initiate a data DMA to the DRAM buffer 300 from the FIFO. After this is completed, it then passes to the next state where it initiates a forward pointer write. After completing this it then passes to the same state earlier noted, which is the wait for DMA data to complete, i.e. the end of buffer state (the remainder of the receive state is continued on FIG. 72).

Referring now to FIG. 72, there may be seen a block which corresponds to a main states of the receive state. The state machine initially determines if it has the end of the buffer in memory. It then determines if the receive in order (IOB) is present, and if so, it resets Bit 23 of the work registers. If the in order bit is set and the transmit channel code is broadcast, then Bit 23 of the work register is set. Otherwise, Bit 23 of the work register is reset. After this is completed it then checks to see if it has reached the end of the buffer in the DMA transfer and if the receive state is idle. Then, if the transmit channel is equal to a discard signal, the receive is purged. The machine then checks to see if the free buffer cache is empty. If the answer to this question is yes, then it moves to the add a buffer to free buffer cache block which is more fully described in FIG. 71. If the answer to this is no, then it moves to the add buffer to free queue proper block which is depicted in FIG. 70.

It then checks to see if the start of the frame buffer has been found and if the immediate queue and transmit queue are inactive. If so, then it is in the cut through mode and it signals for a new queue. It then writes to the immediate queue. If it is the start of the frame with the TXQ active and full, then it signals a receive purge and checks to see if the free buffer cache is empty. If the answer to this is yes, it adds a buffer to the free buffer queue. If the answer to this is no, it adds a buffer to free queue proper. The machine then checks to see if it is the start of the frame and the immediate queue is busy or the transmit queue is active but not full. If so, it signals for a new queue. If the buffer is not an end of frame buffer it signals for a receive build.

If the in order broadcast mode bit is set and the transmit channel code is broadcast then it signals for a receive in order buffer. Both the signal receive build and signal in order buffer result in write receive queue block. After this step, if the buffer is not in the frame buffer then the machine reads the transmit Q pointers and if the transmit queue is active it is added to the current transmit queue. The machine then moves to an add to an existing transmit queue block.

If the transmit queue is not active then it forms a new transmit queue and writes it to the new transmit queue. If it is a receive purge and the buffer is an end of frame buffer it signals receive idle and then checks to see is the free buffer cache empty. If the answer to this is yes, it adds a buffer to the free buffer cache. If the answer is no, then it adds a buffer to the free queue proper.

The state machine then determines if it is a receive build and the buffer is not an end of buffer; it signals a receive cut-through. It then adds a buffer to the receive queue. If the end of buffer for IOB mode bit is set and the transmit channel code is broadcast it signals for a receive in order buffer and it adds a buffer to the receive queue. This is added to the existing receive queue as denoted by the add to existing receive queue block. Otherwise the machine adds a buffer to the receive queue and signals receive idle. That is, the receive to transmit transfer is normal.

If there is a receive in order buffer, which means that the link buffer DMA is complete, then the machine latches the first broadcast destination and clears its IOB index tag field in the mask register. It then signals its receive link and adds a buffer to the receive queue. This is added to the existing receive queue. If the state machine is in the receive cut-through, then it signals for a new queue and if the immediate queue exists but is not empty it sets the queue select to IMQ and adds a buffer to the current IMQ. This then moves it into the add to existing queue block. If the immediate queue exists but is not empty, then it starts a new immediate queue which then moves it to the write new immediate queue block. If it is the end of frame buffer, it signals receive idle.

Referring now to FIG. 70, there may be seen the steps associated with a state machine to add a buffer to the free queue proper. More particularly, it may be seen that it places the buffer on the free queue proper when all the memory operations are complete and it places the address of the work buffer into the queue tail. It then sets the freed buffer to the top of the freed queue. The work buffer is then moved to the top of the free queue buffer and it puts the free queue top address into the work buffer. After this it exits and does a forward pointer update and then shifts back into the idle mode.

Referring now to FIG. 71, it may be seen the steps associated with a state machine to add a buffer to the free buffer cache. More particularly, the state machine pushes the work buffer address onto the free Q cache and requests the next channel. It then shifts to the idle state.

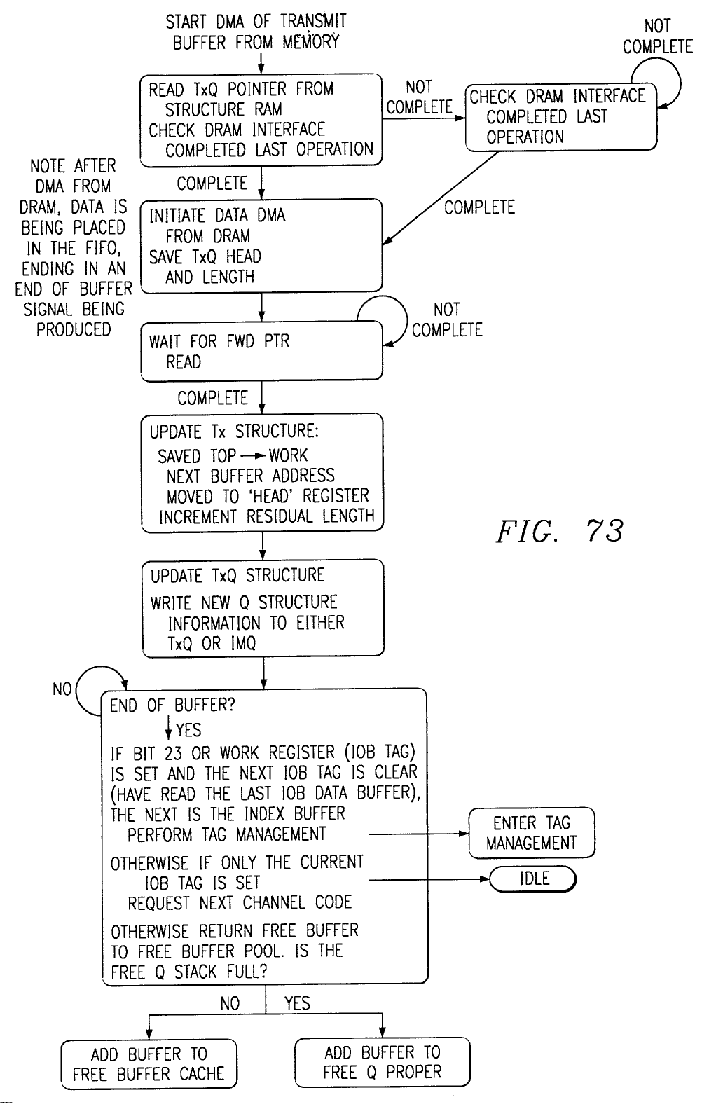

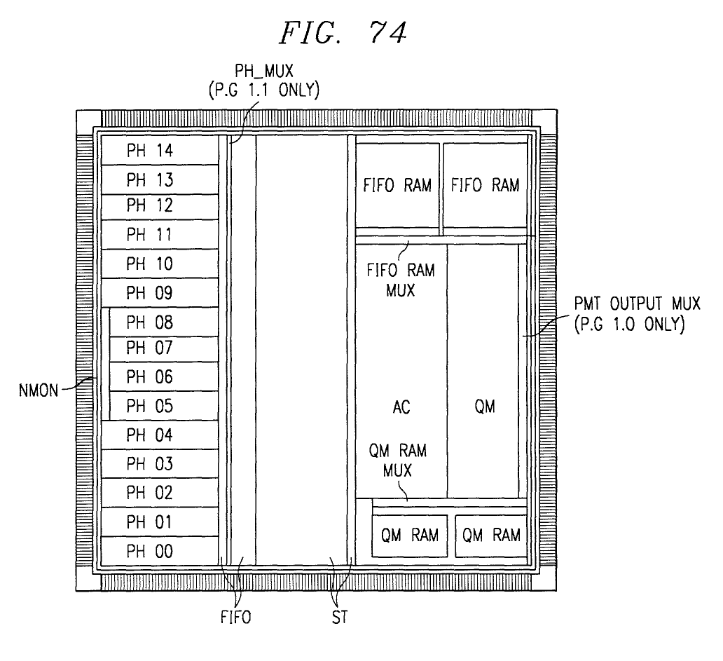

Referring now to FIG. 73, there may be seen the detailed steps associated with the transmit portion of the state machine. More particularly, it may be seen that it starts with the DMA of the data from the external memory 300 to a transmit buffer. The initial block reads the transmit pointer from the structure of the RAM. It then checks the DRAM interface to ensure that it has completed its last operation. If it has not, then it goes along the not complete path and continues to check until it is completed and then passes to the next block. It also has the capability to keep looping while not complete until it is complete. For both the DRAM interface completes its last operation passes to the block that deals with initiating the data DMA from the memory. The state machine saves the transmit queue head and length. As part of the DMA from the memory, the data is being placed into the transmit FIFO. This ultimately results in ending with an end of buffer signal being produced. The state machine then passes to the next block which is delayed for the forward pointer read and it loops back on itself until that is complete. Once it is complete it moves to the next state. In the next state, it updates the transmit structure by saving the top buffer to the work buffer. The next buffer address is then moved to the head register and the residual length of the transmit queue is incremented for this removal of the buffer. It then moves to the update transmit queue structure.

It does this by writing the new queue structure to either the transmit queue or the immediate queue. It then moves to the next block where it checks for the end of the buffer. If the answer is no then it loops back until the answer is yes. Once the answer is yes, it determines if Bit 23 or the work register IOB tag is set and the next IOB tag is cleared. This is checking to see if it has read the last IOB data buffer. It next performs tag management in the index buffer to clear this tag. It then enters the tag management block, clears the tag and comes back. Otherwise the state machine checks to see if it is the only current IOB tag set and if so requests the next channel code. In requesting the next channel code, it passes to the idle state. Otherwise it returns the free buffer to the free buffer pool. It then determines is the free queue stack full. If the answer to this is yes, it adds the buffer to the free queue proper. If the answer to this is no, then it adds the buffer to the free buffer cache.

The statistics for the ports will be updated using different strategies depending on the frequency of updates required, in order to maintain a constant bandwidth to the statistics RAM. This will ensure a recordable event is not ignored or dropped. The memory map for one port of the statistics RAM is described later herein.

The majority of the 10 Mbps port statistic records will be incremented using read, modify (increment), write cycles to the statistics RAM. The worst case update cycle time (including access made to the port structures for buffer updates and DIO access to the RAM) for all port statistics is less than the time required for a minimum length Ethernet frame to be received. The exceptions to this, relate to statistics which apply to less than minimum length frames or hardware errors. (Namely: UnderSize Rx Frames, Rx Fragments, Tx H/W errors and Rx H/W errors). For these exceptional cases an intermediate counter is incremented for each recordable event, and the resulting count is used to update the statistics records using the normal read modify write cycle. This causes some statistics latency.

For the 100 Mbps ports read, modify, write cycles, cannot be used without over subscribing the SRAM bandwidth. To accommodate the maximum statistics backlog count that might accrue before an update could be guaranteed, intermediate counters are used. These counters are small, storing the incremental change between SRAM updates. The contents of the counter will be used to modify the RAM using a read, modify, write cycle, before being reset. Longer intermediate counters are used for the faster updating statistics outlined above and for 200 Mbps operations on the uplink port.

A hardware statistics state machine arbitrates access to the ports and the statistic updates. That is, the hardware statistics state machine is preferably sequential logic configured to realize the functions described herein.

When accessing the statistics values from the DIO port, it is necessary to perform four 1 byte DIO reads, to obtain the full 32 bits of a counter. To prevent the chance of the counter being updated while reading the four bytes, the low byte should be accessed first, followed by the upper 3 bytes. On reading the low byte, the counter statistic value is transferred to a 32 bit holding register, before being placed on the DIO bus. The register is only updated when reading the low byte of the counter statistic. By accessing in this way, spurious updates will not be seen.

Test access to the statistics RAM is provided via the DIO port after the circuit has been soft reset (or following power on before the start bit has been set). In this mode all locations of the RAM can be written to and read from. Once the start bit has been set, only read access is permitted to the RAM. When asserting soft reset, it is important to clear the soft reset bit immediately after setting it. This ensures the DRAM refresh state machine is not held at reset, allowing normal DRAM refreshing to occur. Failure to clear the soft reset bit will result in the DRAM contents becoming invalid.

The statistics RAM may be requested to be cleared at any time during operation. This is achieved by setting the CLRSTS bit in the system control register. The state of this bit is latched. When set, the next statistics update cycle will write zero to all counters in the statistics RAM, before resetting the latched bit. If the CLRSTS bit has not subsequently been reset (by the system/user), the latched bit will be set again, causing the circuit to load zero into the statistics counters again. This will continue, until such time as the CLRSTS bit is reset. It should be noted that soft reset has no effect on the statistics counters, their contents are not cleared during a soft reset. A hard reset will cause the statistics counters to be reset to zero.

Within the queue manager the DRAM control block provides control for the interface to the external DRAM buffer memory. This provides a cost effective memory buffer. The interface control signals required are produced by the queue manager unit which controls the data transfer with the DRAM.

The interface relies on the use of EDO DRAM to minimize the access time, while maintaining RAM bandwidth. The circuit preferably uses EDO-DRAM (Extended Data Output—Dynamic Memory) operating at 60 ns. EDO-DRAM differs from normal DRAM memory by the inclusion of data latches on the outputs, preventing the output from becoming tristate with the de-assertion of CAS in preparation for the next access. The data bus is released when CAS is next taken low. The use of EDO DRAM permits the high data transfer rates required by the circuit.

The external memory 300 is accessed in a number of ways. Single access is used during initialization and forward pointer writes, and is the slowest access method; single access transfers a single 36 bit word. Each access takes 7, 20 ns clock cycles.

Page mode burst access is used for fast data transfer of one 64 byte buffer from the FIFO RAM to the external memory. The locations used are located within the DRAM's page boundary permitting fast burst accesses to be made. Each successive burst access only requires 2 clock cycles after the initial row address has been loaded.

CAS before RAS access is used as a refresh cycle. Dynamic memories must be refreshed periodically to prevent data loss. This method of refresh requires only a small amount of control logic within the circuit (the refresh address is generated internally). Each row refresh cycle requires a minimum of 7 clock cycles and must be performed such that the whole device is refreshed every 16 ms. A normal read or write operation refreshes the whole row being accessed.

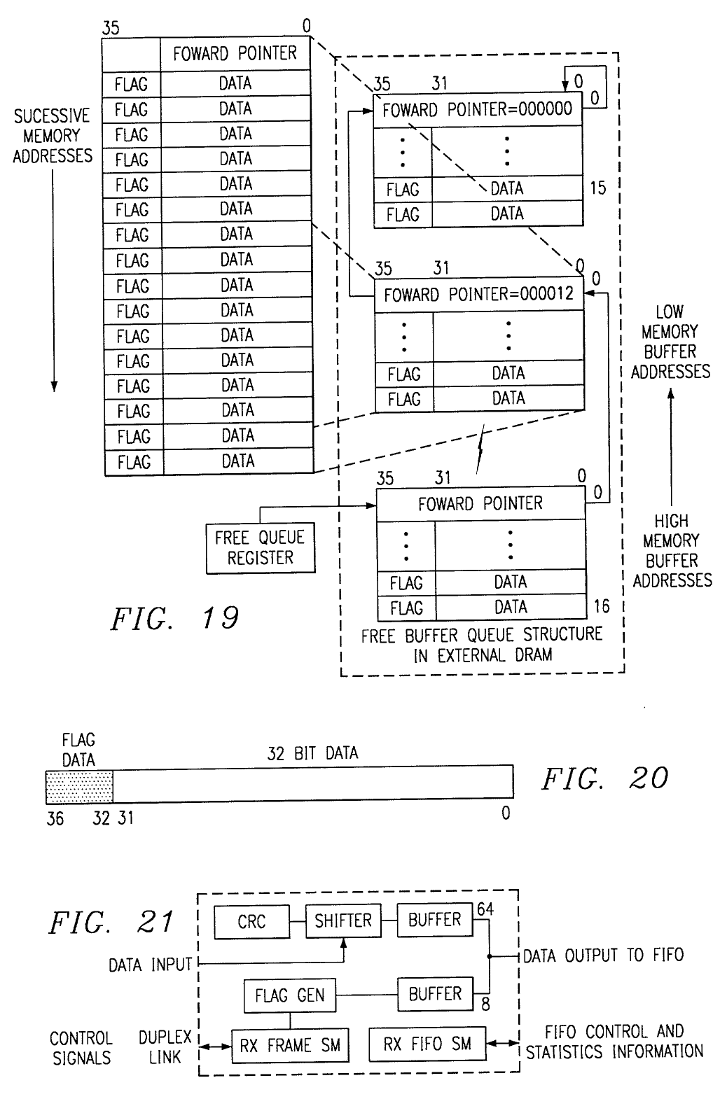

The external memory data bus (DRAM bus) is 36 bits wide. Buffered data is accessed over two memory cycles from the external memory 300, before it is concatenated into an 8 byte data word and one byte of flag data, for use by the circuit 200. FIG. 20 depicts the format of the 36 bit data word used.

The address lines for the external memory are arranged to permit a wide range of memory sizes to be connected, with a maximum of 22 address lines. The address lines are organized as shown in Table 3 below.

TABLE 3

| | Pin Name | | | | | | | | | | |
|---|---|---|---|---|---|---|---|---|---|---|---|
| | DX_2 | DX_1 | DX_0 | DA_7 | DA_6 | DA_5 | DA_4 | DA_3 | DA_2 | DA_1 | DA_0 |
| Address | 21 | 19 | 17 | 15 | 14 | 13 | 12 | 11 | 10 | 9 | 8 |
| bit valid | | | | | | | | | | | |
| during | | | | | | | | | | | |
| RAS | | | | | | | | | | | |
| Address | 20 | 18 | 16 | 7 | 6 | 5 | 4 | 3 | 2 | 1 | 0 |
| bit valid | | | | | | | | | | | |
| during | | | | | | | | | | | |
| CAS | | | | | | | | | | | |

This permits buffers to be aligned so as not to cross a page boundary (which would reduce the bandwidth available.)

A 10 Mbps MAC links the FIFO 130 and data handling mechanisms of the circuit 200 to the MAC interface and the network beyond. Network data will flow into the circuit 200 through the 10 Mbps or 100 Mbps MACs.

Although similar, there are some differences between the receive and transmit operations of a MAC. Accordingly, each operation is separately considered herein below.

Referring now to FIG. 21, there may be seen a simplified block diagram of the receive portion of a representative 10 Mbps MAC. The raw input data 120a is deserialized by a shifter 120e before further processing. This is accomplished by shifting in the serial data and doing a CRC check 120b while this is occurring. The data is formed into 64 bit words and stored in a buffer 120d before being transferred to an RE FIFO buffer. The received data is synchronized with the internal clock of the circuit 200.

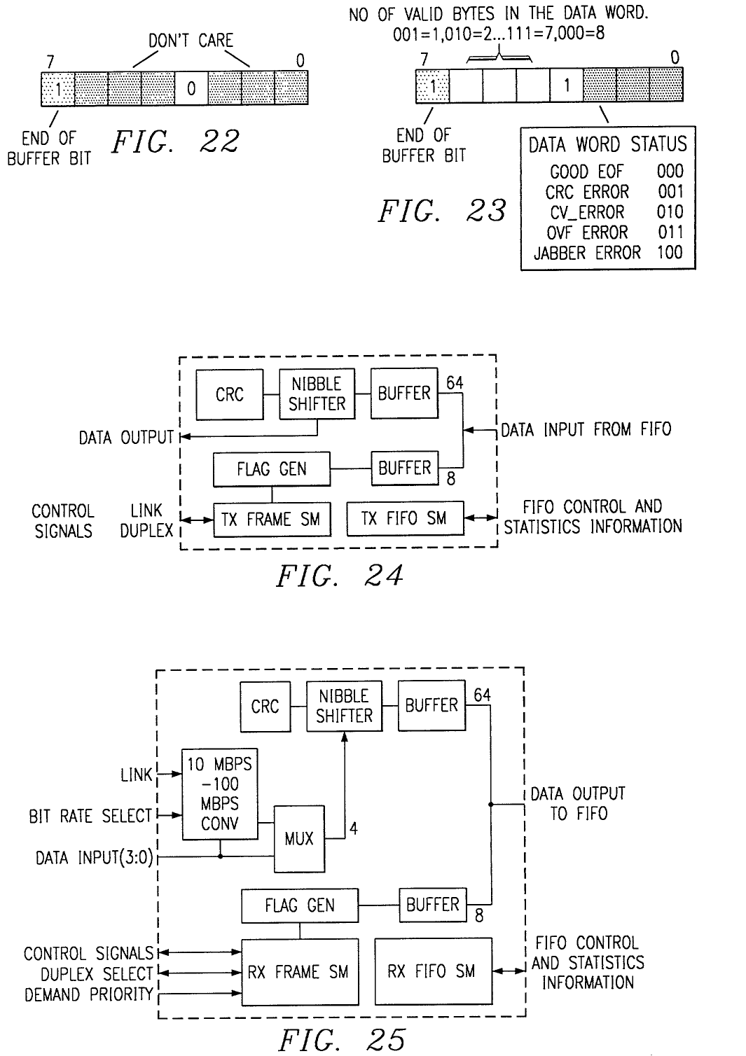

Flag attributes 120h are assigned to the deserialized data word, identifying key attributes. The flags are used in later data handling. The flag field is assigned to every eight data bytes. The format of the sub-fields within the flag byte change depending on the flag information. The start of frame format was described in earlier in reference to FIG. 8. The format depicted in FIG. 22 is the end of buffer flag format. When the most significant (MS) bit (MSB) or End of Buffer bit is set, the remaining bits of the MS nibble contain the number of bytes in the data word, while the least significant (LS) nibble contains error/status information. The data word types for error/status information is depicted in FIG. 23. The end of buffer (EOB) bit is asserted after each 64 data byte transfer; the end of frame is when bit 3 of the flag byte is set to “1” as depicted in FIG. 23.

The receive frame state machine 120e (control block) of FIG. 21 schedules all receive operations (detection and removal of the preamble, extraction of the addresses and frame length, data handling and CRC checking). Also included is a jabber detection timer, to detect greater than maximum length frames, being received on the network.

The receive FIFO state machine 120f (control block) of FIG. 21 places the received data into the FIFO buffers while also detecting and flagging erroneous data conditions in the flag byte.

Referring now to FIG. 66, there may be seen a generalized summary flow diagram used by the receive state machine 120e to control the receiving of a frame. When data is received from the network into the physical layer interface, it is reshaped into distortion-free digital signals. The Ethernet physical layer interface performs Manchester encoding/decoding. The Ethernet provides synchronization to the received data stream and level translation to levels compatible with TTL. The arrival of a frame is first detected by the physical layer circuitry, which responds by synchronizing with the incoming preamble, and by turning on the carrier sense signal. As the encoded bits arrive from the medium, they are decoded and translated back into binary data. The physical layer interface passes subsequent bits up to the MAC, where the leading bits are discarded, up to and including the end of the Preamble and Frame Starting Delimiter (SDEL).

The MAC, having observed carrier sense, waits for the incoming bits to be delivered. The MAC collects bits from the physical layer interface as long as the carrier sense signal remains on. When the carrier sense signal is removed, the frame is truncated to a byte boundary, if necessary. Synchronization is achieved via an integrated phase-locked loop (PLL); which locks to the bit stream signaling rate. This clock is boundary/aligned to the bit stream and is passed to the MAC for data extraction.

The MAC, as the first step during data receive, provides deserialization of the bit stream to 64 bit data words by counting clock pulses received from the physical layer interface. Parity bits are generated on the received data, so that the integrity of the received data may optionally be continuously monitored as it passes from the MAC to the FIFO RAM.

The destination and source addresses, the LLC data portions, and the CRC field of the current receive packet are passed to the FIFO RAM in the appropriate sequence. When the end of the CRC-protected field is received, the calculated value is compared to the CRC value received as part of the packet. If these two values disagree, the MAC signals an error has occurred and the frame should be ignored. The MAC also checks to see if the frame is too small.

After a valid frame has been received and buffered in the MAC's buffer, the Rx FIFO state machine transfers the frame to the Rx FIFO buffer pointed to by the MAC's Rx FIFO pointer. When the transfer is complete, the Rx FIFO state machine completes the receive operation by reporting the status of the transfer to the statistics system and updating the MAC's Rx FIFO pointer to point to the next buffer block, or buffer depending upon receipt of an end of a frame.

Data transmission requires more processing and data handling than data reception. This is due to the overhead of implementing collision detection and recovery logic. Referring now to FIG. 24, there may be seen a simplified block diagram of the transmit portion of a representative 10 Mbps MAC. Data 120p entering from a Tx FIFO as a 64 bit word is serialized by nibble shifter 120n for transmission at the transmit clock rate; this also requires the data to be synchronized to the transmit clock rate from the circuit's internal clock.

The transmit frame state machine (Tx frame sm) 120s of FIG. 24 schedules all transmit operations (generation and insertion of the preamble, insertion of the addresses and frame length, data handling and CRC checking). The CRC block 120m is only used to check that the frame still has a valid CRC, it is not used to re-calculate a new CRC for the frame. If the CRC does not match, then this indicates that the frame contents were somehow corrupted and will be counted in the Tx Data errors counter.

The transmit frame state machine block 120s handles the output of data into the PHYs. A number of error states are handled. If a collision is detected the state machine jams the output. Each MAC implements the 802.3 binary exponential backoff algorithm. If the collision was late (after the first 64 byte buffer has been transmitted) the frame is lost. If it is an early collision the controller will back off before retrying. While operating in full duplex both carrier sense (CRS) mode and collision sensing modes are disabled.

The transmit FIFO state machine (control block) 120t of FIG. 24 handles the flow of data from the TX FIFO buffers into the MAC internal buffer 120o for transmission. The data within a TX FIFO buffer will only be cleared once the data has been successfully transmitted without collision (for the half duplex ports). Transmission recovery is also handled in this state machine. If a collision is detected frame recovery and re-transmission is initiated.

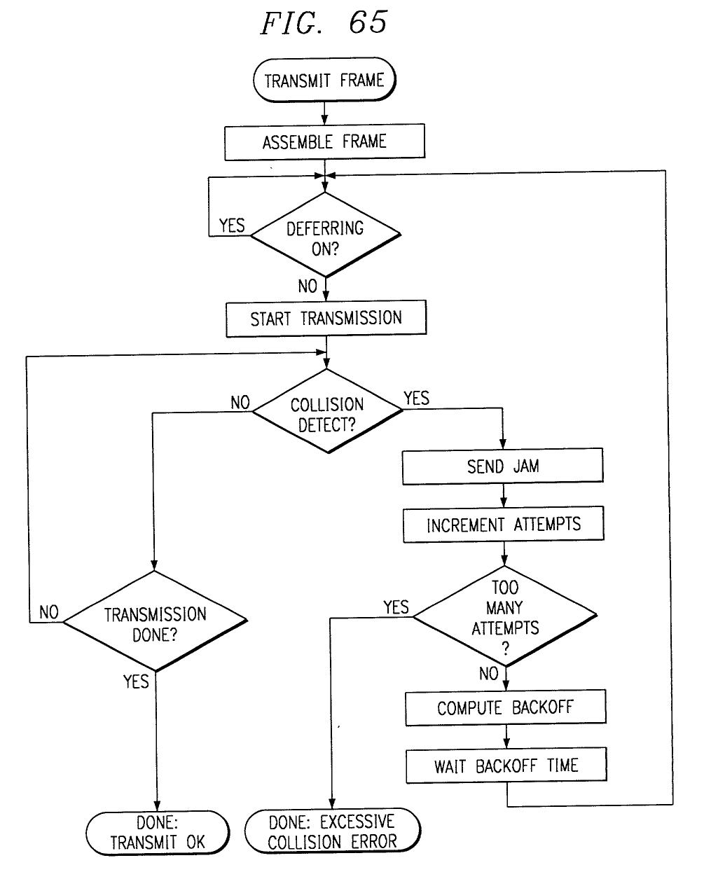

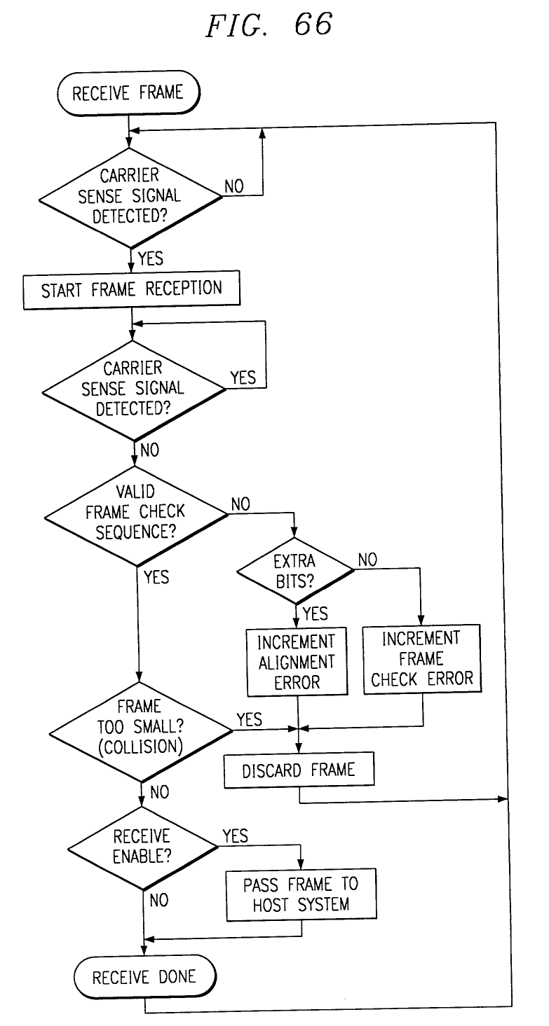

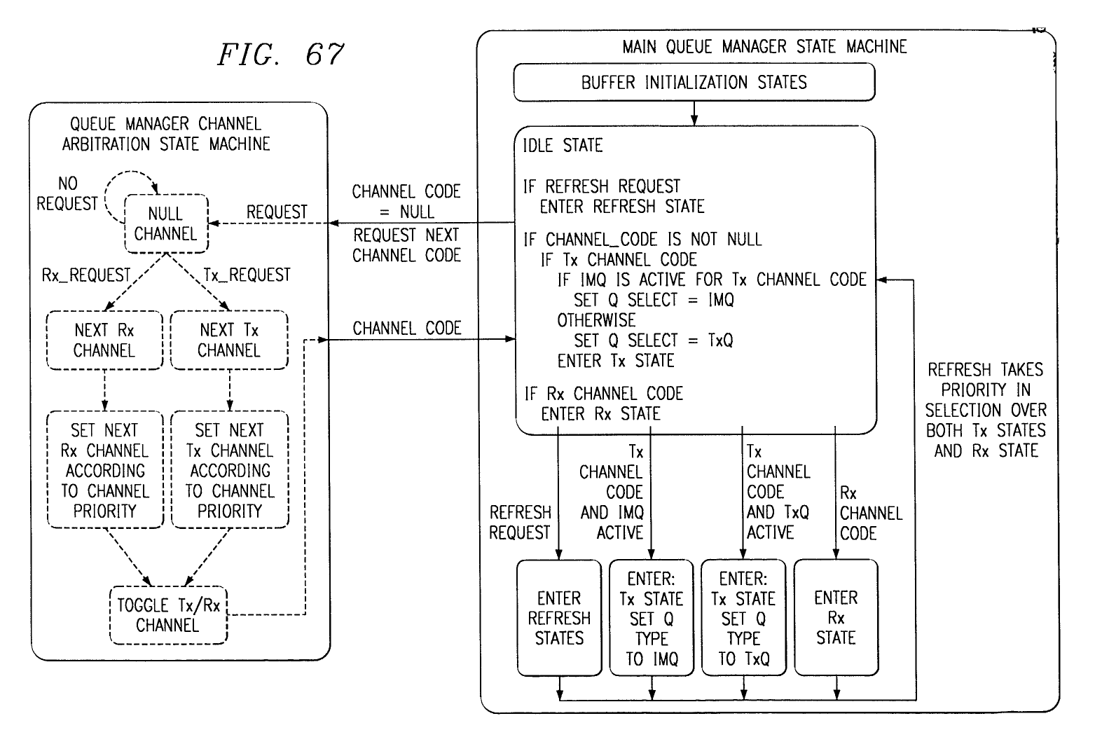

Referring now to FIG. 65, there may be seen a generalized summary flow diagram used by the transmit state machine 120s to control the transmission of a frame. When the transmission of a frame is requested, the transmit data encapsulation function constructs the frame from the supplied data. It appends a preamble and a frame starting delimiter (SDEL) to the beginning of the frame. If required, it appends a pad at the end of the Information/Data field of sufficient length to ensure that the transmitted frame length satisfies a minimum frame size requirement. It also overwrites the Source Addresses, if specified, and appends the Frame Check Sequence (CRC) to provide for error detection.

The MAC then attempts to avoid contention with other traffic on the medium by monitoring the carrier sense signal provided by the physical layer circuitry and deferring if the network is currently being used by another transmitting station. When the medium is clear, frame transmission is initiated (after a brief interframe delay to provide recovery time for other nodes and for the physical medium). The MAC then provides a serial stream of bits to the physical layer interface for transmission.

The physical layer circuitry performs the task of actually generating the electrical signals on the medium that represent the bits of the frame. Simultaneously, it monitors the medium and generates the collision detect signal to the MAC, which in the contention-free case under discussion, remains off for the duration of the frame. When transmission has completed without contention, the MAC informs the statistics system and awaits the next request for frame transmission.

If multiple MACs attempt to transmit at the same time, it is possible for them to interfere with each other's transmission, in spite of their attempts to avoid this by deferring. When transmissions from two stations overlap, the resulting contention is called a collision. A given station can experience a collision during the initial part of its transmission (the collision window) before its transmitted signal has had time to propagate to all stations on the CSMA/CD network. Once the collision window has passed, a transmitting station is said to have acquired the network; subsequent collisions are avoided since all other (properly functioning) stations can be assumed to have noticed the signal (by way of carrier sense) and to be deferring to it. The time to acquire the network is thus based on the round-trip propagation time of the physical layer.

In the event of a collision, the transmitting station's physical layer circuitry initially notices the interference on the medium and then turns on the collision detect signals. This is noticed in turn by the MAC, and collision handling begins. First, the MAC enforces the collision by transmitting a bit sequence called jam. This ensures that the duration of the collision is sufficient to be noticed by the other transmitting station(s) involved in the collision. After the jam is sent, the MAC terminates the transmission and schedules another transmission attempt after a randomly selected time interval (backoff). Retransmission is attempted until it is successful or an excessive collision condition is detected. Since repeated collisions indicate a busy medium, however, the MAC attempts to adjust to the network load by backing off (voluntarily delaying its own retransmissions to reduce its load on the network). This is accomplished by expanding the interval from which the random transmission time is selected on each successive transmit attempt. Eventually, either the transmission succeeds, or the attempt is abandoned on the assumption that the network has failed or has become overloaded.

At the receiving end, the bits resulting from a collision are received and decoded by the physical layer circuitry just as are the bits of a valid frame. Fragmentary frames received during collisions are distinguished from valid transmissions by the MAC. Collided frames or fragmentary frames are ignored by the MAC.

The 100 Mbps MAC 122 links the high speed MAC interfaces to the FIFO and data handling mechanisms of the circuit. The 10/100 Mbps ports support a number of options, such as full/half duplex, bit rate switching and demand priority mode. Referring now to FIG. 25, there may be seen a simplified block diagram of the receive portion of a representative 10/100 Mbps MAC.

The architecture for the 100 Mbps MAC is similar to that for 10 Mbps. This permits the interface to support both 10 and 100 Mbps operation. When operated at 10 Mbps, the 10/100 Mbps ports, can operate either in nibble serial, or bit serial interface mode. The bit serial mode is identical to the dedicated 10 Mbps ports (ports 3-14) operation.

The data received 122a from the external PHY is de-nibblized in the shifter 122c, forming 64 bit words. The data is synchronized to the internal clock of the circuit. After deserialization, a flag byte is assigned to the data word by flag generator 122h, identifying attributes for later data handling. The format of the flag byte data is common for both 10 and 10/100 Mbps ports. Once the 100 Mbps data has been de-serialized it is handled no differently to the 10 Mbps data.

The receive frame state 122e machine of FIG. 25 schedules all receive operations (detection and removal of the preamble, extraction of the addresses and frame length, data handling and CRC checking). Also included is a jabber detection timer, to detect greater than maximum length frames, being received on the network.

The receive FIFO state machine 122e of FIG. 25 places the received data into the FIFO buffers 130 while also detecting and flagging erroneous data conditions in the flag byte.

Referring now to FIG. 26, there may be seen a simplified block diagram of the transmit portion of a representative 10/100 Mbps MAC 122. Data from the FIFO 122p, is nibblized 122n for transmission at the interface clock rate. The nibbles are transmitted and also are used to generate the CRC 122m to be appended to the transmitted frame. If the port is operating at 10 Mbps, the nibbles are synchronized to a 10 Mhz clock and transmitted serially. The 100 Mbps ports have separate CRC logic for both Rx and Th frames, to support full duplex operation. The two Tx state machines 122s,122t are essentially the same as those described earlier in reference to FIG. 24, but also have to control the two bit rates.

The CRC block 122m is only used to check that the frame still has a valid CRC, it is not used to re-calculate a new CRC for the frame. If the CRC does not match this indicates that the frame contents were corrupted and will be counted in the IX CRC error counter.

The uplink port can be used as a fifteenth 10/100 Mbps switched port, even though no address compare register exists for it. Packets will be switched by default since the destination address will not be matched to any of the other fourteen switched ports.

The port 0 implementation is similar to the 10/100 Mbps port described above, however modifications are included to make it 200 Mbps capable; byte wide data transfers rather than nibble transfers are employed. The 200 Mbps wide uplink mode is selected by taking the M00_UPLINK# (active low) signal low.

With M00_IPLINK# set low, all packets are sent to the uplink port by default. The address compare disable option bits (ADRDIS), (in the port control register), are set for all ports except port 0. Local address comparison is possible by clearing the ADRDIS bits, for the ports that will take part in address comparison. Alternatively the EAM interface can be used in the normal manner. Frames received on the uplink port cannot be routed using local address comparisons or EAM interface, post frame tagging, must be used. Broadcast and Unicast traffic received on ports 01-14 are treated similarly, (forwarded to the Uplink only, if no local addressing is enabled). Identification of broadcast traffic is retained for statistic counting purposes. Setting M00_UPLINK# low also selects store and forward operation on all ports, to prevent data underflows and to permit errored frame filtering. If local frame switching is employed, clearing the relevant STFORRX bits from ports 01-14 and ensuring both STFORRX and STFORIX bits are set for port 00 (uplink), will improve performance, by permitting cut-through where possible to do so. Store and forward permits errored frame filtering, cut-through does not.

Flow control is available on all ports and is applicable in full duplex mode only. In this mode, asserting the collision signal before the circuit begins the transmission of a frame, will force the circuit to wait for the collision signal to be de-asserted before the frame is transmitted. The collision pin is sampled immediately prior to transmission. If it is not asserted frame transmission will continue. If subsequent to transmission the collision signal is asserted, the current frame continues transmission, however the circuit will hold off all future frames transmissions until the collision signal is deasserted. The interfacing hardware must be capable of storing up to a maximum length Ethernet frame, if it is not to drop frames due to congestion.

The frame will be transmitted immediately following the de-assertion of the collision signal. It is the duty of the flow control requesting device to be ready to accept data whenever the collision signal is de-asserted following a flow controlled frame, no inter-frame gap is imposed by the circuit in this mode of operation. This provides maximum flexibility and control to the interfacing hardware on the uplink.

When the circuit is used in the multiplex mode, it is desirable to have an indication of which port received the frame. This permits an address look up device to be connected to the uplink port, allowing incorporation of the circuit into a larger switch fabric. The circuit will provide one byte of information (to identify the source port) on the MII interface data pins prior to M00_TXEN being asserted.

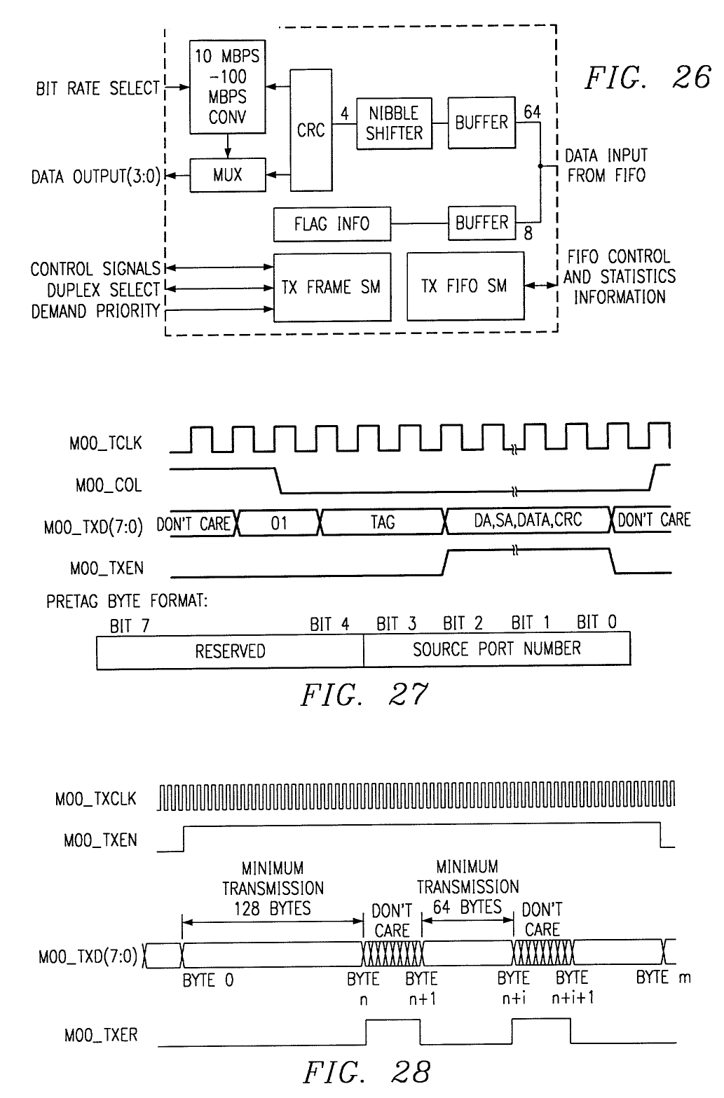

The 200 Mbps handshake protocol depicted in FIG. 27 is as follows:

Upstream device is holding flow control signal (M00_COL) high, preventing the circuit from transmitting frames on the uplink.

When a frame is ready to transmit, make a request to the upstream device by taking the signal M00_XD(00) high.

When ready to receive, the upstream device in response to seeing M00_TXD(00) go high, takes M00_COL low.

The circuit places the source port address on bits M00_XD(00) thru M00_TXD(03).

Four M00_TCLK clock cycles after M00_COL was driven low, M00_TXEN is taken high and normal data transfer occurs, starting with the destination address. No preamble is provided prior to the destination address within the frame.

When M00_IXEN is taken low at the end of frame. M00_COL is taken high in preparation for the next handshake. If the upstream device is busy, M00_COL should be kept high (even after M00_TXD(00) is taken high), until such time that the upstream congestion has cleared and transmission can continue. The next frame transmission will not proceed until the handshake is performed. M00_COL must be cycled prior to each transmission. (To operate in this mode, M00_UPLINK# (active low) should be held low, M00_DUPLEX and M00_DPNET should be held high and the IOB option bit in the SYS_CTRL register must be set).

The source port number of FIG. 27 is coded as indicated in Table 4 below.

TABLE 4

| Source Port | | |
|---|---|---|
| Number | | |
| (3:0) | Port | |
| 0000 | Reserved | |
| 0001 | Port 1 | (10/100) |
| 0010 | Port 2 | (10/100) |
| 0011 | Port 3 | (10 Mbps) |
| 0100 | Port 4 | (10 Mbps) |
| 0101 | Port 5 | (10 Mbps) |
| 0110 | Port 6 | (10 Mbps) |
| 0111 | Port 7 | (10 Mbps) |
| 1000 | Port 8 | (10 Mbps) |
| 1001 | Port 9 | (10 Mbps) |
| 1010 | Port 10 | (10 Mbps) |
| 1011 | Port 11 | (10 Mbps) |
| 1100 | Port 12 | (10 Mbps) |
| 1101 | Port 13 | (10 Mbps) |
| 1110 | Port 14 | (10 Mbps) |

| | |
|---|---|
| 1111 | Reserved |

Port 00 operated at 100 Mbps (i.e. M00_UPLINK#=1) will provide a tag nibble on the cycle prior to M00_IXEN being asserted. A preamble will be provided on this port when operated at 100 Mbps. The nibble format will be as shown in FIG. 27.

As depicted in FIG. 28, a frame control signal is provided on M00_TXER during 200 Mbps uplink operations to permit the reconstruction of frames using external logic, if the Uplink Tx FIFO underruns.

In uplink mode, M00_TXER will be low throughout a successfully transmitted frame. If a FIFO underrun occurs (due to high simultaneous activity on the ethernet ports), the data in the FIFO will continue to be transmitted until empty, at which point the M00_TXER signal will be taken high as depicted in FIG. 28. While high the data transmitted from the uplink should be discarded. When the next 64 byte data buffer has been forwarded to the uplink TX port, M00_TXER will be taken low and normal transmission will continue. If following buffer updates are delayed, the FIFO will again underrun, causing M00_TXER to be taken high once the data present in the FIFO has been transmitted as depicted in FIG. 28.

The FIFO is preferably loaded with two buffers before transmission commences, this guarantees a minimum transmission of 128 bytes before any potential underrun can occur. Following an underrun, only one buffer has been transferred guaranteeing a minimum of 64 bytes following an underrun. During transmission of a long frame during high traffic loads, multiple underruns may occur.

The circuit relies on an external switch fabric to make switching decisions when used in 200 Mbps mode. The external hardware must provide an indication of the destination ports for the frame received on the uplink. This indication will consist of four bytes; if a single port bit is set, then the frame will be sent to the port associated with that bit. If multiple bits are set, then the frame will be sent to multiple ports, this permits broadcast and multi-cast traffic to be limited, supporting external virtual LAN configurations.

No local switching using the circuit's internal address registers or the EAM interface is possible for routing frames received on the uplink port at 200 Mbps.

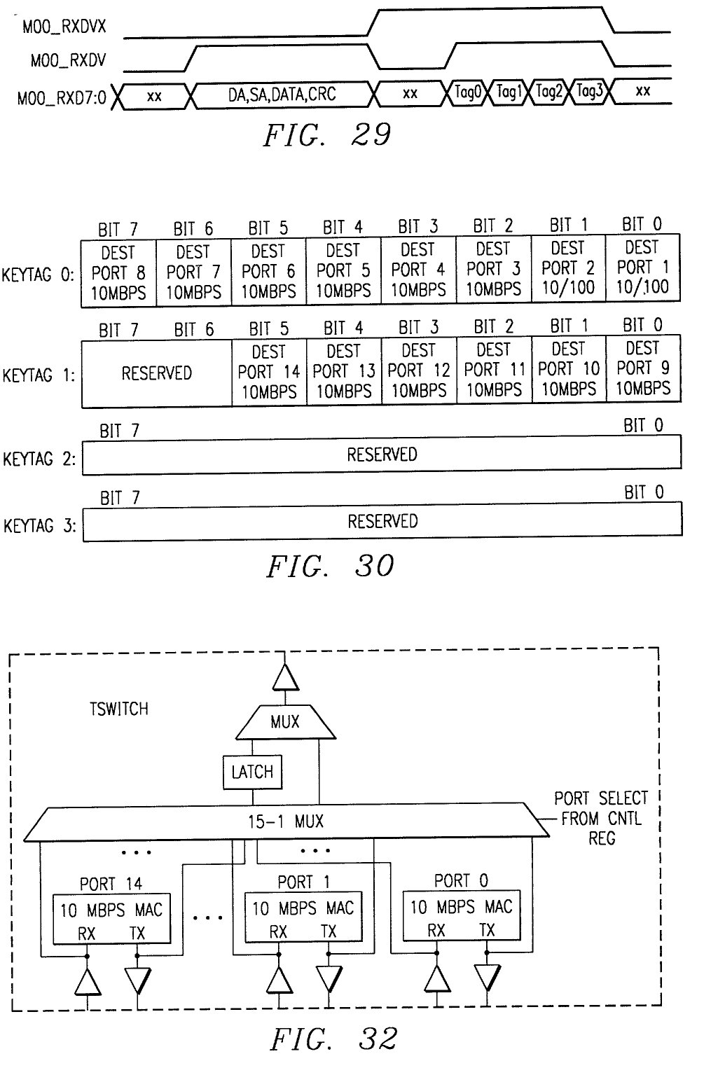

As depicted in FIG. 29, there is no handshake or flow control for the receive uplink path on the circuit 200. If required this must be implemented in upstream devices. No preamble will be expected on data received by the uplink port at 200 Mbps. As shown in FIG. 29 an ethernet frame of data (destination address, source address, data, and CRC) is sent when M00_RXDV goes high and ends when M00_RXDV goes low. Following this, M00_RXDVX goes high and the next time M00_RXDV goes high a four byte tag (Tag0-Tag3) is appended to the ethernet frame. The edges of the packets are synchronous with the rising edge of M00_RXDV. The four keytag fields will not immediately follow the frame data, but will be presented after the end of data, and following an idle period, qualified by M00_RXDVX=1 and M00_RXDV=1.

The tag fields of FIG. 29 are coded as keytags as depicted in FIG. 30. If only one bit is set in the destination port field, the packet is a unicast one, i.e. Keytag 0=00000000 and Keytag 1=xx000100, the packet is unicast and destined for port 11.

If more than one bit is set, the packet is a VLAN multi-cast packet. For example, if Keytag 0=11001010 and Keytag 1=xx001001, the packet will be transmitted from ports 12,9,8,7,4 & 2

If all bits are clear in the tags, the packet is invalid and will be discarded.

Receive arbitration biases the prioritization of the arbitration for received frames over transmitted frames. This utilizes the circuit's 200 buffering capability during heavy traffic loading, while increasing the transmission latency of the circuit. Receive arbitration can be selected by setting the RXARB bit (bit 5) in the SIO Register. The arbitration this selects is shown in FIG. 31.

The normal arbitration scheme is extended to bias the receive priority and active transmissions over inactive transmissions. The queue manager services buffer transfer requests between the port FIFOs and DRAM in the order shown. Rx requests and ongoing Th requests take priority over transmission that have yet to start (inactive transmissions). If there are spare DRAM accesses available, an inactive request will be promoted to an active request. If there are no spare DRAM accesses, the TX requests will be arbitrated in the inactive priority shown, all ongoing transmits will be allowed to finish with no new transmission started until the Rx requests have been exhausted.

Port 00, when operated in uplink mode, is always assigned the TX Inactive priority. Even after being granted an active TX slot, one buffer will be guaranteed to be transferred (following the initial 2 buffers accrued before a frame start), before the port will have to renegotiate another TX active slot. Thus Port 00 TX in uplink mode has the lowest possible priority, reducing the probability of frame loss through oversubscribed bandwidth, while increasing frame latency and buffering requirements. When operated in this mode, external hardware to reconstruct the frame due to Port 00 underrunning must be provided.

The Network monitoring mux 160 will provide complete Network Monitoring (NMON) capability at 10 Mbps and a partial capability at 100 Mbps for the 10/100 ports. Port selection is based on the NMON register.

The interface will permit the following formats. A 7 wire SNI, 10 Mbps signals (ports 0, 1 & 2 must be used in bit serial 10 Mbps SNI) mode of operation. The signals that will be provided by the interface will be 10 Mbps bit serial, RxD, RClk, CRS, COL, TxD, TClk, TxEn. A 4 bit, nibble interface (either RX or TX), if ports 0,1 & 2 are operated in 100 Mbps mode (or 10 Mbps non-SNI). The system/user may select which half of the interface to access, Rx or Tx. If ports 3-14 are monitored while in this mode enabled by setting the MONWIDE bit high, only the least significant bus of the interface will contain network data, bits 1 thru 3 will not be driven. When monitoring Rx data RxD[3:0], RSDV, RXCLK and Mxx_SPEED will be provided. When monitoring Th data TxD[3:0], TXEN, TXCLK and Mxx_SPEED will be provided.

The interface monitors the signal directly after the pad buffers, before any MAC processing is performed by the circuit. An NMON probe can monitor every packet on the segment connected to the port. The port selection is made by writing network monitor (NMON) codes to the network monitor control field as shown in Table 5 below.

TABLE 5

| | Monitoring port | |
|---|---|---|
| NMON | Uplink 200 Mbps signals | |
| Code | Port Number | |
| 0000 | 0 | (10/100 Mbps) |
| 0001 | 1 | (10/100 Mbps) |
| 0010 | 2 | (10/100 Mbps) |
| 0011 | 3 | (10 Mbps) |
| 0100 | 4 | (10 Mbps) |
| 0101 | 5 | (10 Mbps) |
| 0110 | 6 | (10 Mbps) |
| 0111 | 7 | (10 Mbps) |
| 1000 | 8 | (10 Mbps) |
| 1001 | 9 | (10 Mbps) |
| 1010 | 10 | (10 Mbps) |
| 1011 | 11 | (10 Mbps) |
| 1100 | 12 | (10 Mbps) |
| 1101 | 13 | (10 Mbps) |
| 1110 | 14 | (10 Mbps) |

| | |
|---|---|
| 1111 | Disable NMON monitoring |

The network monitoring control field is mapped to the lower 4 bits of the System NMON register DIO register.

For 10 Mbps monitoring, the network monitoring signals will be provided as shown in Table 6 below. The NMON register option bits are: MONRXTX=X, MONWIDE=0.

TABLE 6

| | Network |
|---|---|
| | Monitoring Mode |
| Pin Name | (uplink) |
| NMON_00 | Mxx_RXD |
| NMON_01 | Mxx_CRS |
| NMON_02 | Mxx_RCLK |
| NMON_03 | Mxx_TXD |
| NMON_04 | Mxx_TXEN |
| NMON_05 | Mxx_TCLK |
| NMON_06 | Mxx_COL |

For 100 Mbps monitoring, network monitoring signals will be provided for Tx as shown in Table 7 below. The NMON register option bits are: MONRXTX=1, MONWIDE=1.

TABLE 7

| Normal | Network |
|---|---|
| Operation Pin | Monitoring Mode |
| Description | (uplink) |
| NMON_00 | Mxx_TXD[0] |
| NMON_01 | Mxx_TXD[1] |
| NMON_02 | Mxx_TXD[2] |
| NMON_03 | Mxx_TXD[3] |
| NMON_04 | Mxx_TXEN |
| NMON_05 | Mxx_TXCLK |
| NMON_06 | Mxx_SPEED |

For 100 Mbps monitoring, network monitoring signals will be provided for Rx as shown in Table 8 below. The NMON register option bits are: MONRXTX=0, MONWIDE=1.

TABLE 8

| Normal | Network |
|---|---|
| Operation Pin | Monitoring Mode |
| Description | (uplink) |
| NMON_00 | Mxx_RXD[0] |
| NMON_01 | Mxx_RXD[1] |
| NMON_02 | Mxx_RXD[2] |
| NMON_03 | Mxx_RXD[3] |
| NMON_04 | Mxx_RXDV |
| NMON_05 | Mxx_RCLK |
| NMON_06 | Mxx_SPEED |

Referring now to FIG. 32, there may be seen a simplified block diagram of the network monitoring port. More particularly, it may be seen that it consists of a final multiplexer (mux) 1342 for Rx selection only in the 10/100 mode, whose output is the output of the network monitoring mux block of FIG. 1 and whose outputs were described earlier herein. The two inputs are the latched 1344 and unlatched outputs of a 15 to 1 mux 1346 that selects the port to be monitored, based upon values in the control register. Note that ports 0-2 are operated in the 10 Mbps mode. Representative MACs 120 are shown connected to the inputs of the 15 to 1 mux 1346. RX signals will be latched 1344 and provided 1 RX Clock cycle delayed. TX signals are the same as the TX pins (no latching).

All frames less than 64 bytes, received into any port will be filtered by the circuit within the receiving FIFOs, they will not appear on the DRAM bus.

The circuit 200 has the ability to handle frames up to 1531 bytes, to support 802.10. This is selected by setting the LONG option bit in the SYSCTRL register. Setting this bit will cause all ports to handle giant frames. The statistics for giant frames will be recorded in the Rx+Tx-frames 1024-1518 statistic (which will become Rx+Tx-frames 1024-1531 with this option selected).

If possible a MAC will filter errored RX frames (CRC, alignment, Jabber etc.). This is only possible if the frame in question is not cut-through. A frame may be non-cut-through if its destination is busy. The error will be recorded in the relevant statistic counter with all used buffers being recovered and returned to the free Q.

The measurement reference for the interframe gap of 96 μs, when transmitting on at 10 Mbps, is changed, dependent upon frame traffic conditions. If a frame is successfully transmitted (without collision), 96 μs is measured from Mxx_TXEN. If the frame suffered a collision, 96 μs is measured from Mxx_CRS.

Each Ethernet MAC 120,122,124 incorporates Adaptive Performance Optimization (APO) logic. This can be enabled on an individual basis by setting the TXPACE bit, (bit 1) of the Port Control registers. When set the MACs use transmission pacing to enhance performance (when connected on networks using other transmit pacing capable MACs). Adaptive performance pacing, introduces delays into the normal transmission of frames, delaying transmission attempts between stations and reducing the probability of collisions occurring during heavy traffic (as indicated by frame deferrals and collisions) thereby increasing the chance of successful transmission.

Whenever a frame is deferred, suffers a single collision, multiple collisions or excessive collisions, the pacing counter is loaded with the initial value loaded into the PACTST register bits 4:0. When a frame is transmitted successfully (without experiencing a deferral, single collision, multiple collision or excessive collision) the pacing counter is decremented by one, down to zero.

With pacing enabled, a frame is permitted to immediately (after one IPG) attempt transmission only if the pacing counter is zero. If the pacing counter is non zero, the frame is delayed by the pacing delay, a delay of approximately four interframe gap delays.

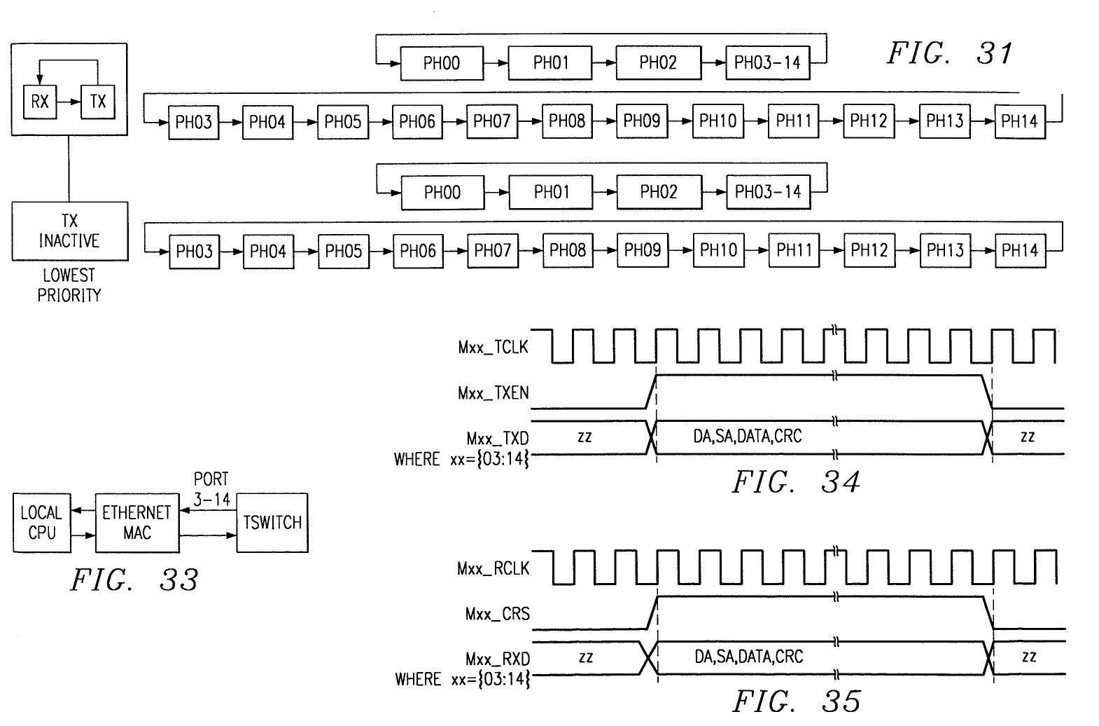

A CPU 600 via an Ethernet MAC 120 or suitable protocol translating device can be directly connected to one of the circuit's ports for use with SNMP as depicted in FIG. 33.

The Transmit (Tx) logic signals for a 10 Mbps port are depicted in FIG. 34. FIG. 34 depicts a normal ethernet frame (DA, SA, data, CRC) on Mxx_XD that is framed by the rise and fall of Mxx_IXEN, and with the rise and fall of Mxx_IXEN framed by the rising edge of Mxx_TCLK

The Receive (Rx) logic signals for a 10 Mbps port are depicted in FIG. 35. FIG. 35 depicts a normal ethernet frame (DA, SA, data, CRC) on Mxx_RXD that is framed by the rise and fall of Mxx_CRS, and with the rise and fall of Mxx_CRS framed by the rising edge of Mxx_TCLK

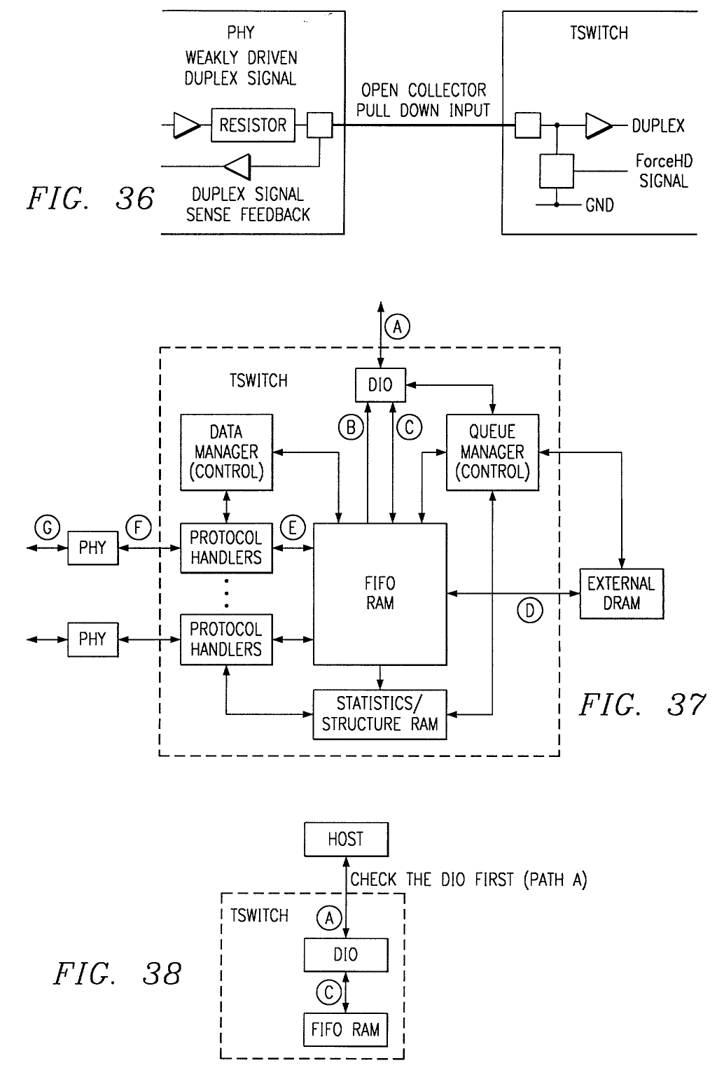

As depicted in FIG. 36, the MXK_DUPLEX pins are implemented as inputs with active pull down circuitry, producing a ‘pseudo’ bi-directional pin.

An external PHY can weakly drive the DUPLEX line high, indicating an intention for duplex operation. The circuit can override this DUPLEX pin input by pulling the line low. This is detected by the PHY, which monitors the sense of the DUPLEX signal, causing it to operate in a Half Duplex mode. Thus, the circuit 200 can force the PHY into half duplex operation when desired (during testing for example).

If the PHY is to be driven only in half duplex operation, a pull down resistor should be permanently attached to the DUPLEX signal.

If the PHY is to be operated in Full Duplex (with the option of forcing half duplex), a pull up resistor should be placed on the DUPLEX signal. If the PHY is to operate in auto negotiate mode, no external resistor should be added, allowing the PHY to control the DUPLEX signal.

FIG. 37 depicts a sequence of testing. This sequence of tests is aimed at simplifying burn-in testing, system level testing and debug operations. All tests are based on an incremental approach, building upon tested truths before reaching the final goal. For tests using the DIO interface for example, the external DIO interface should be tested (step A) first, and once found to be functioning correctly, the next depth of testing can be performed (i.e. internal circuit testing), (such as step B followed by Steps C-G). If a test fails using this methodology the cause of the failure can be determined quickly and test/debug time can be reduced. The protocol handlers 120 in FIG. 37 are the MACs 120 of FIG. 1.

As depicted in FIG. 38, for step A the DIO registers can be written to and read from directly from the pin interface. This level of testing is trivial, but essential before continuing to test the internals of the circuit.

When implementing an architecture that employs embedded RAM structures, it is necessary to ensure test access over and above JTAG connectivity testing via standard interfacing. The DIO interface used by the circuit enables the system/user to interrogate the internal RAMs of the circuit, giving the required observability for the RAMs themselves and the data they contain.

RAM test access is desirable at all levels of testing. Silicon production level to enable defective devices to be filtered. System production level to permit diagnostic testing to be performed. In the field, permitting diagnostic and debug to be performed.

FIFO RAM access for test is provided via the DIO interface. This allows full RAM access for RAM testing purposes. Access to the FIFO shall only be allowed following a soft reset and before the start bit is written (or after power up and before the start bit is written). The soft reset bit should be set then immediately reset, if the soft reset bit is not cleared, the circuit will hold the DRAM refresh state machine in reset and the contents of the external memory will become invalid.

To access the FIFO RAM from the DIO, bytes are written to a holding latch the width of the RAM word (72 bits). Because of this latch between the FIFO RAM and the DIO, whenever a byte is accessed, the whole word is updated in FIFO RAM. If the same pattern is to be loaded throughout the memory, it only requires a new FIFO RAM address to be set up between accesses on a single byte within the word, the data in the latch will not change. (i.e. a read-modify-write is not performed)

Test access to the statistics RAM 168 is provided via the DIO port after the circuit has been soft reset (or following power before the start bit has been set). In this mode all locations of the RAM can be written to and read from. Once the start bit has been set, only read access is permitted to the RAM. When asserting soft reset, it is important to clear the soft reset bit immediately after setting it. This ensures the DRAM refresh state machine is not held at reset. If held at reset normal DRAM refreshes will fail to occur resulting in the DRAM contents becoming invalid.

To access the statistics RAM 168 from the DIO, bytes are written to a holding latch the width of the RAM word (64 bits). Whenever a byte is accessed, the whole word is updated in RAM. If the same pattern is to be loaded throughout the memory, it only requires a new statistics RAM address to be set up between accesses on a single byte within the word, the data in the latch will not change. (i.e. a read-modify-write is not performed)

Frame wrap mode, allows the system/user to send a frame into a designated source port, selectively route the frame successively to and from ports involved in the test or return the frame directly, before retransmitting the frame on the designated source port. By varying the number of ports between which the frame is forwarded, the potential fault capture area can be expanded or constrained. Initially, it is desirable to send data to and from each port in turn, allowing the MAC (protocol handler) to FIFO interface, and MAC pins to be tested for each port.

The circuit 200 provides an internal loopback test mode: Internal loopback allows the frame datapath to be tested, and is useful for individual die burn in testing and system testing with minimal reliance on external parts. Internal loopback is selected by suitably setting the INTWRAP field of the DIATST register described later herein. Port 00 (uplink), Port 02 or Port 14 can be selected as the source port for injecting frames into the circuit when internal wrap is selected. All other ports will be set to internally wrap frames.

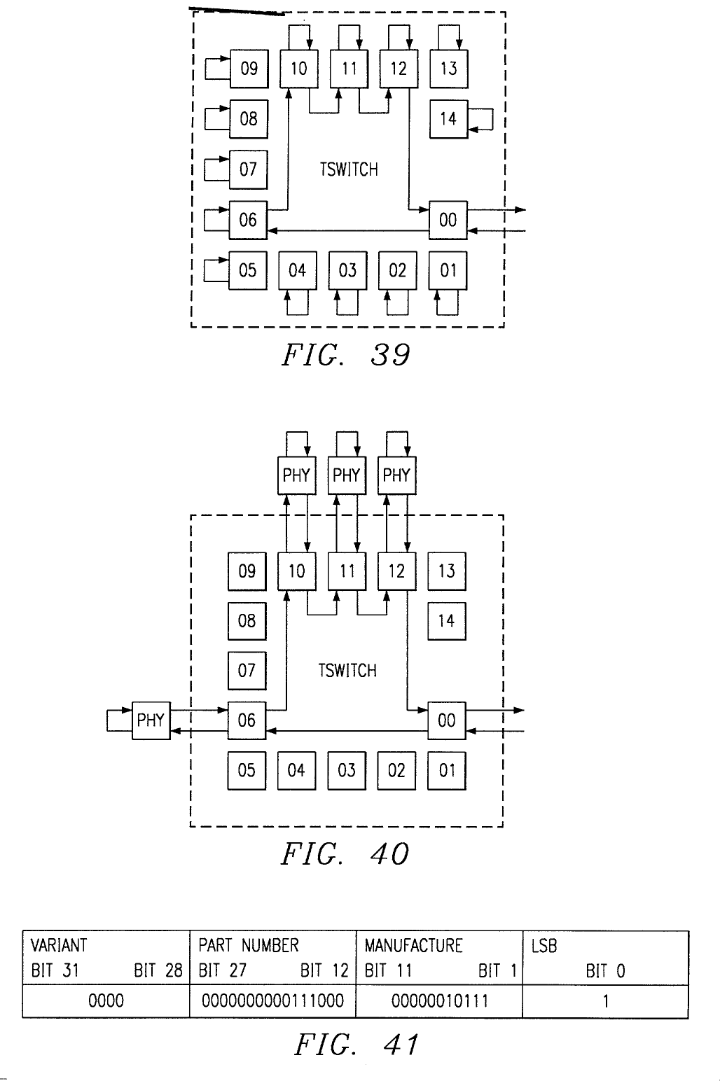

As depicted in FIG. 39, by injecting broadcast or multicast frames into the source port (port 0) and suitably setting the VLAN registers, frames can be forwarded between internally wrapped ports before transmission of the frame from the source port.

The operational status of the PHY or external connections to the circuit do not have to be considered or assumed good, when in the internal loopback mode.

The internal RAM access will only infer that both DIO port and Internal RAM structures are functioning correctly. It doesn't provide information on the circuit's data paths to and from the RAMs during normal frame operations or an indication of the control path functionality. To assist with this, further tests proposed are:

DRAM access—proves the data path between FIFO and DRAM is functioning, as are certain sections of the queue manager and FIFO state machines

Frame forwarding—frame data is forwarded from one port to the next using a loop back mode. This builds on the previous tests, and tests that the data path to and from the MACs and control paths are operational. The number of ports that take part in frame forwarding can be controlled using the VLAN registers, allowing any number of ports to be tested in this mode. Single connections can be tested allowing individual MAC data paths to FIFO connections to be tested or multiple port testing allowing for reduced system test time.

Using the incremental test approach, once the FIFO has been tested and verified, the data path to and control of the external DRAM memory should be verified.

DRAM writes are carried out by first constructing a buffer in the FIFO (64 data bytes), then initiating a buffer write from the FIFO to the DRAM. The buffer is transferred as for a normal buffer transfer in a 17 write DRAM burst. The forward pointer field is mapped to the DRAM_data register, the flag data fields are mapped to the DRAM_flag register.

Reading from the DRAM performs a buffer transfer to the FIFO from which individual bytes can be read (and tested) via the DIO interface. The flag bytes and forward pointer bytes are transferred from the DRAM to the DRAM_data and DRAM_flag registers for reading.

The buffer transfer mechanism when operated in DRAM test access mode does not check the flag status. No actions will be performed depending on the status of the flags. The transfer is purely a test data transfer with no attempt made to comprehend flag contents.

After completion of the DRAM testing, the circuit should be reset before normal switching activity is resumed. This ensures the circuit is returned to a defined state before normal functionality is resumed. This mechanism is primarily intended for DRAM testing and not as part of a breakpoint/debug mechanism. More information about the Test Registers is provided later herein.

Similar to internal wrap mode, the ports can be set to accept frame data that is wrapped at the PHY as depicted in FIG. 40. This permits network connections between the circuit and the PHY to be verified. Any port can be the source port (not just port 00 as illustrated). By using multicast/broadcast frames, traffic can be routed selectively between ports involved in the test or return the frame directly, before retransmission on the uplink. Software control of the external PHYs will be required to select loopback.

The External Frame Wrap Test Mode is selected by setting the FDWRAP bit (bit 3) of the DIATST register. When selected the port is forced into FULL-DUPLEX allowing it to receive frames it transmits. Note most external PHYs do not assert DUPLEX in wrap mode.

By using broadcast or multicast frames and suitably setting the VLAN registers, frames can be forwarded between internally wrapped ports before transmission from the frame the source port.

The circuit 200 is fully JTAG compliant with the exception of requiring external pull up resistors on the following pins: TDI, TMS and TRST. To implement internal pull-up resistors, the circuit would require the use of non-5v tolerant input pads. The use of 5v tolerant pads is more important for mixed voltage system boards, than to integrate the required pull up resistors required to be in strict compliance with the JTAG specification. Strict compliance with the JTAG specification is not claimed for this reason. Clearly, other choices may be made.

Supported JTAG instructions are

Mandatory: EXTEST, BYPASS & SAMPLE/PRELOAD

Optional Public: HIGHZ & IDCODE

Private: ATPG & SELF EXERCISE

TABLE 9

| The | | |
|---|---|---|
| opcodes for | | |
| the various | | |
| instructions | | |
| (4 bit | | |
| instruction | | |
| register) are | | |
| noted in | | |
| Table 9 | | |
| below. | | |
| Instruction | | JTAG |
| Type | Instruction Name | Opcode |
| Mandatory | EXTEST | 0000 |
| Mandatory | SAMPLE/PRELOAD | 0001 |
| Private | ATPG | 0010 |
| Private | SELF EXERCISE | 0011 |
| Optional | IDCODE | 0100 |
| Optional | HIGHZ | 0101 |
| Mandatory | BYPASS | 1111 |

In ATPG mode all the flip flops are linked into a scan chain with TDI and TDO as the input and output respectively. Clocked scan flip flops are used to implement the chain.

In Self Exercise mode, taps are taken off the 19th and 21st flip flops in the scan chain, XOR'ed and fed back to the start of the scan chain. This causes the scan chain to act as a linear feedback shift register. This is useful during life testing.

The IDCODE format is depicted in FIG. 41 and consists of a four bit variant field, a 16 bit part number field, a 12 bit manufacturer field, and a 1 bit LSB field.

In both ATPG and SELF EXERCISE modes, pin EAM_{—}00 can be used to control the RNW signals to each of the embedded RAMs.

Parallel Module Test uses the JTAG TAP controller during testing to control test access to the embedded RAM blocks directly from the external pins.

When selected, external pin inputs will be multiplexed to drive the embedded RAM inputs directly, while the embedded RAM outputs are multiplexed onto output pins. Four embedded ram cells are used to implement the two internal circuit memory maps. Only one embedded ram cell may be tested using PMT, reducing the routing overhead otherwise incurred.

Four instructions are used to implement parallel module test mux out the pins of one of the four rams to top level pins as set forth in Table 10 below.

TABLE 10

| Instruction | Instruction | JTAG | |
|---|---|---|---|
| Type | Name | Opcode | Description |
| Private | MUX_FIFO_RAM_{—} | 0110 | Provide Parallel Module |
| | LO | | Test (PMT) access to the |
| | | | low FIFO ram |
| Private | MUX_FIFO_RAM_{—} | 0111 | Provide PMT access |
| | HI | | to the high FIFO ram |
| Private | MUX_STAT_RAM_{—} | 1000 | Provide PMT access |
| | LO | | to the low FIFO ram |
| Private | MUX_STAT_RAM_{—} | 1001 | Provide PMT access |
| | HI | | to the high FIFO ram |

Parallel Module test is intended for production testing only. It is not envisaged that target system hardware will make use of this functionality. During normal system operation, internal RAM access can be effected using the DIO interface, after power-up or soft reset and prior to setting the start bit.

The circuit 200 preferably uses EDO DRAM with an access time of 60 ns. The DRAM interface requires extended data out to simplify the DRAM interface and maintain a high data bandwidth.

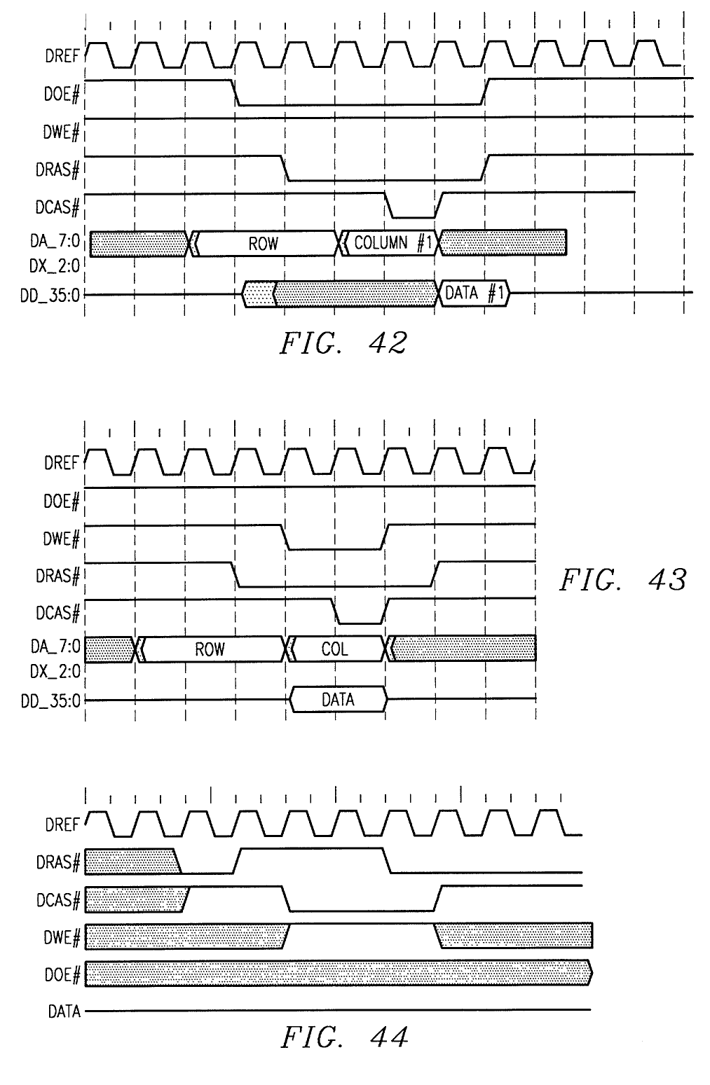

FIG. 42 depicts a single DRAM read (next free buffer access). All DRAM signals are synchronous to the DREF clock signal, with preferably a maximum 3 ns delay from the rise of DREF to the signals being valid.

Data from the DRAM, must be stable and valid preferably after a maximum of 25 ns from the DREF edge coincident with CAS falling. The data is preferably held stable until 3 ns after the next rising edge of DREF.

FIG. 43 depicts a single DRAM write (forward pointer update). All DRAM signals are synchronous to the DREF clock signal, with a maximum 3 ns delay from the rise of DREF to the signals being valid.

As depicted in FIG. 44, the circuit uses CAS before RAS refresh for simplicity. A refresh counter will be decremented causing periodic execution of CAS before RAS refresh cycles. A refresh operation must be performed at least once every 16 ms to retain data.

All DRAM signals are synchronous to the DREF clock signal, with a maximum 3 ns delay from the rise of DREF to the signals being valid.

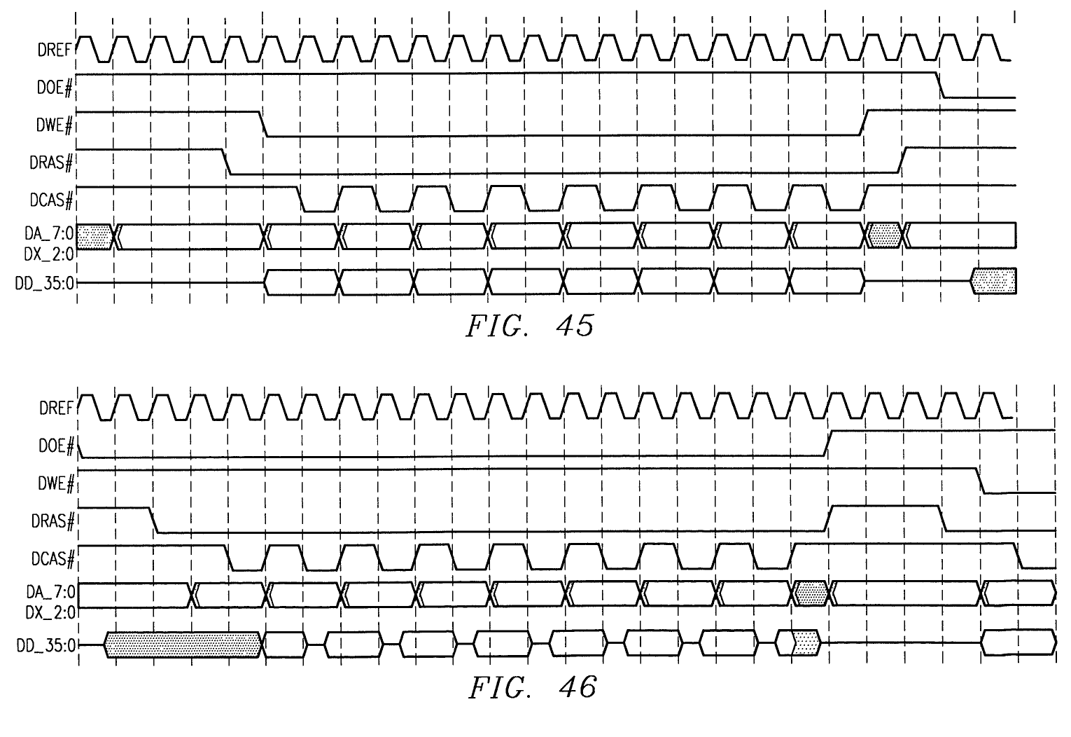

FIG. 45 depicts a series of eight write cycles (buffer access uses 17 write cycles). FIG. 46 depicts a sequence of eight read cycles (buffer access uses 17 read cycle).

All DRAM signals are synchronous to the DREF clock signal, with a maximum 3 ns delay from the rise of DREF to the signals being valid.

Data from the DRAM (Read Cycle), must be stable and valid after a maximum of 25 ns from the DREF edge coincident with the first and following CAS falling edges. The data must be held stable until 3 ns after the next rising edge of DREF.

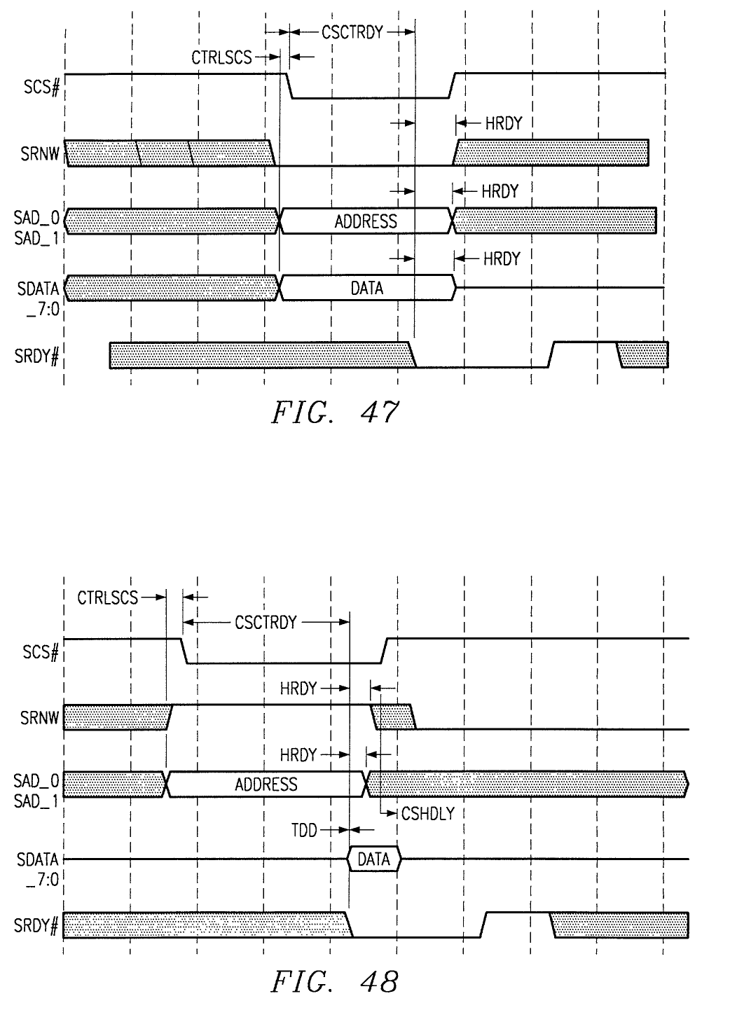

The DIO interface has been kept simple and made asynchronous, to allow easy adaptation to a range of microprocessor devices and computer system interfaces. FIG. 47 depicts the DIO interface timing diagram for a write cycle. In particular, for a write cycle:

Host register address data SAD_{—}1:0 and SDATA_{—}7:0 are asserted, SRNW is taken low.

After setup time, SCS# is taken low initiating a write cycle.

Pull SRDY# low as the data is accepted, SDATA_{—}7:0, SAD_{—}1:0 and SRNW signal can be deasserted after the hold time has been satisfied.

SCS# taken high by the host completes the cycle, causing SRDY# to be deasserted, SRDY# is driven high for one cycle before tristating.

TABLE 11

| Name | Min | Max | Comment |
|---|---|---|---|
| ctrlscs | 0 | — | Control Signal setup to SCS# |
| tdd | 0 | — | Delay to data driven after SRDY# |
| | | | low |
| hrdy | 0 | — | Minimum hold time after SRDY# |
| | | | low |
| scsh | 40 | — | Minimum SCS# high |

Table 11 illustrates some of the timing requirements for portions of FIG. 47.

FIG. 48 depicts the DIO interface timing diagram for a read cycle. In particular, for a read cycle:

Host register address data is placed on address pins SAD_{—}1:0 while SRNW is held high.

After setup time, SCS# is taken low initiating the read cycle.

After delay time, cstdr from SCS# low, SDATA_{—}7:0 is released from tristate.

After delay time, cstrdy from SCS# low, SDATA_{—}7:0 is driven with valid data and SRDY# is pulled low. The host can access the data.

SCS# taken high by the host, signals completion of the cycle, causes SRDY# to be deasserted, SRDY# is driven high for one clock cycle before tristating, SDATA_{—}7:0 are also tristated.

TABLE 12

| Name | Min | Max | Comment |
|---|---|---|---|
| ctrlscs | 0 | — | Control Signal setup to SCS# |
| tdd | 0 | — | Delay to data driven after SRDY# low |
| hrdy | 0 | — | Minimum hold time after SRDY# low |
| scsh | 40 | — | Minimum SCS# high |
| cshdly | 0 | — | Hold required after SCS# high |

Note: SRDY# should be pulled high externally by a pull up resistor, for correct system operation.

Table 12 illustrates some of the timing requirements for portions of FIG. 48.

To determine the start of frame, the external address hardware must test bit 35 of the forward pointer and decode the first flag nibble placed on the external memory data bus, Bit 35 should be ‘0’ indicating a valid data frame start as opposed to an IOB link buffer transfer. By using the DCAS signal, the destination address and source address of the frame can be extracted for external processing.

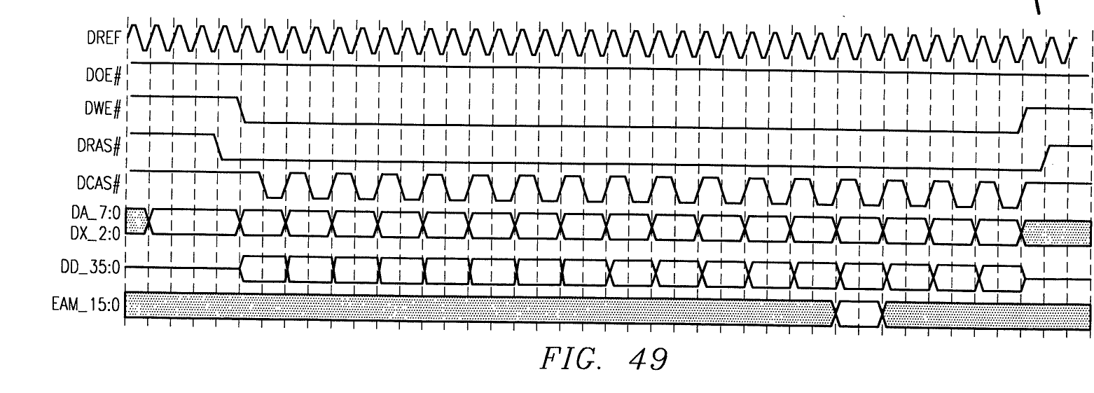

The channel destination can be returned in one of two methods. If only one port address is to be specified (effectively a unicast), the EAM_{—}15 (MODE_SELECT) signal can be asserted, and a 5 bit port code placed on EAM_{—}04:00. If a group multicast is required, the channel bit map is applied directly to the EAM interface with EAM_{—}15 (MODE_SELECT) low. The EAM_{—}14:0 pins must be valid by the start of the 14th memory access as depicted in FIG. 49. All signals in the external address checking interface will be synchronous with the DREF clock.

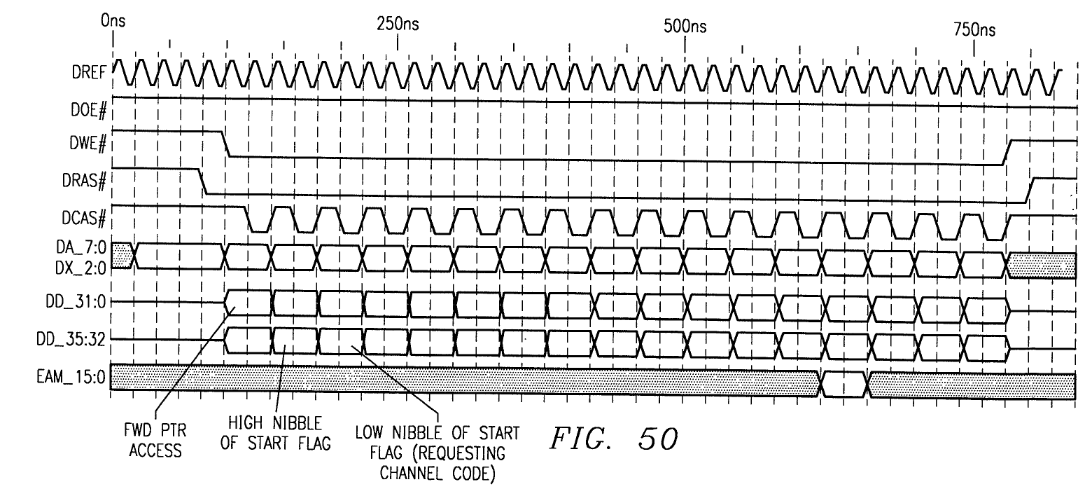

Referring now to FIG. 50, there may be seen the DRAM buffer access at the start of a frame, illustrating the start of frame flag ordering.

FIG. 51 depicts the start of frame format for the flag byte.

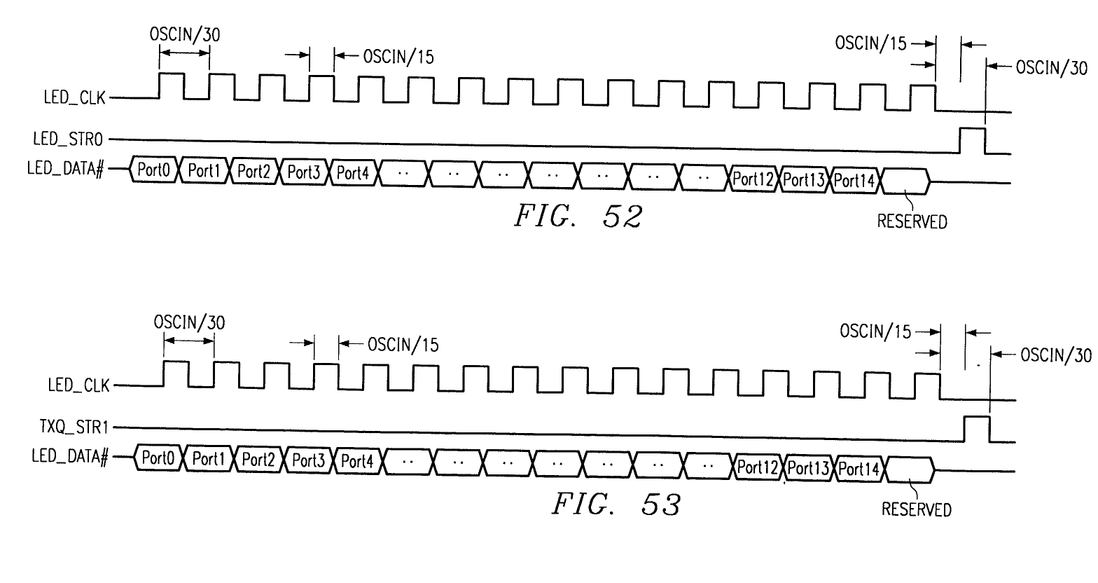

FIG. 52 depicts the LED timing interface for the LED status information.

FIG. 53 depicts the LED timing interface for the TxQ status information.

The LED_STR1 signal will only be pulsed when there has been a change in status for any of the TXQs. An external system monitoring this signal, can use it as a trigger to investigate which TxQ has become congested or has recovered from congestion.

FIG. 54 depicts the EEPROM interface liming diagram.

Table 13 illustrates some of the timing requirements for portions of FIG. 54.

TABLE 13

| Name | Min | Max | Unit | Description |
|---|---|---|---|---|
| ECLK | 0 | 100 | Hz | Clock Frequency (ECLK) |
| tw(L) | 4.70 | | us | Low period clock |
| tw(H) | 4 | | us | High period clock |
| td(ECLKL- | 0.3 | 3.50 | us | ECLK low to EDIO data in valid |
| EDIOV) | | | | |
| td(ECLKL- | 0.3 | | us | Delay time, ECLK low to EDIO |
| EDIOX) | | | | changing (data in hold time) |
| td(EDIO | 4.7 | | us | Time the bus must be free before |
| free) | | | | a new transmission can start |
| td(ECLKH- | 4.7 | | us | Delay time ECLK high to EDIO |
| EDIOV) | | | | valid (start condition setup time) |
| td(ECLKH- | 4.7 | | us | Delay time ECLK high to EDIO |
| EDIOH) | | | | high (stop condition setup time) |
| td(ECLKL- | 0 | | us | Delay time ECLK low to EDIO |
| EDIOX) | | | | changing (data out hold time) |
| td(EDIOV- | 4 | | us | Delay time EDIO valid after ECLK |
| ECLKL) | | | | low (start condition hold time for |
| | | | | the EEPROM) |
| td(EDIOV- | 0.25 | | us | Delay time EDIO valid after ECLK |
| ECLKH) | | | | high (data out setup time) |

For further information on EEPROM interface timing, refer to the device specification.

FIG. 55 depicts the 100 Mbps receive interface timing diagram and includes some of the timing requirements for portions of FIG. 55.

Both Mxx_CRS and Mxx_COL are driven asynchronously by the PHY. Mxx_RXD3:0 is driven by the PHY on the falling edge of Mxx_RCLK Mxx_RXD3:0 timing must be met during clock periods where Mxx_RXDV is asserted. Mxx_RXDV is asserted and deasserted by the PHY on the failing edge of Mxx_RCLK Mxx_RXER is driven by the PHY on the falling edge of Mxx_RCLK (Where xx=00:02)

The above applies to the Uplink (port 00) when operating in 200 Mbps mode, with the exception that Mxx_RXD3:0 becomes Mxx_RXD7:0 and an additional signal Mxx_RXDVX is introduced. The same tsu and timing specifications will be enforced for the 10 Mbps input signals.

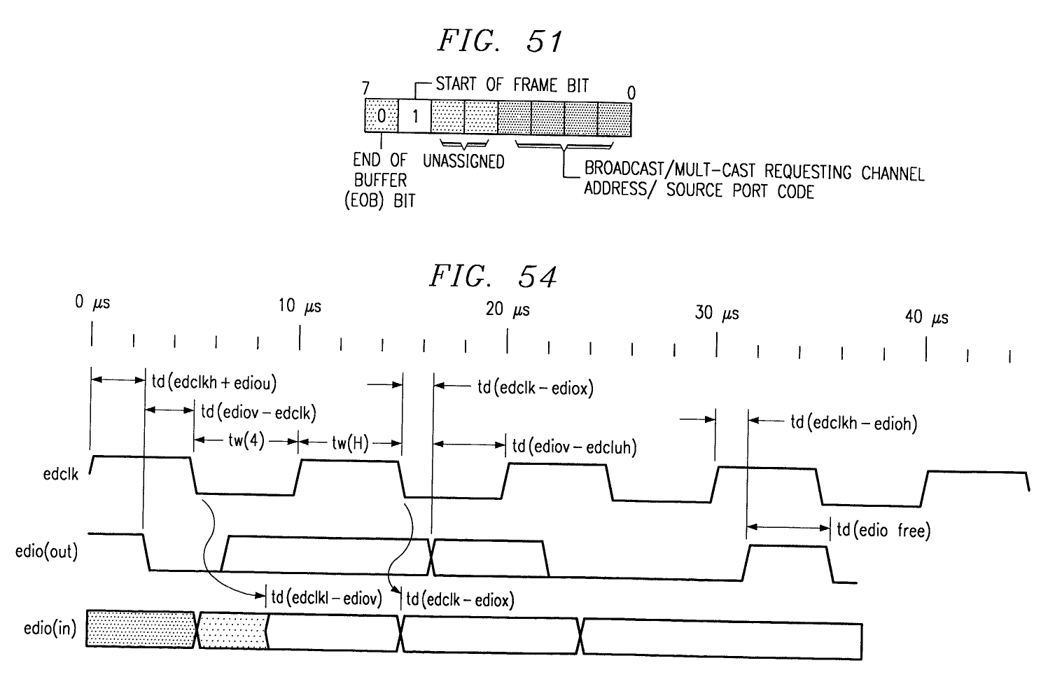

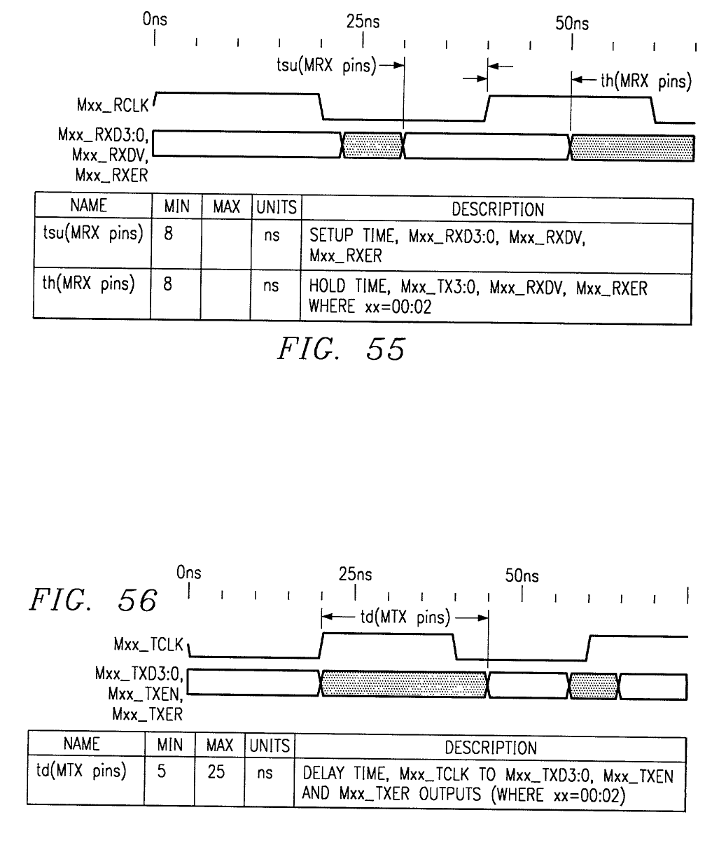

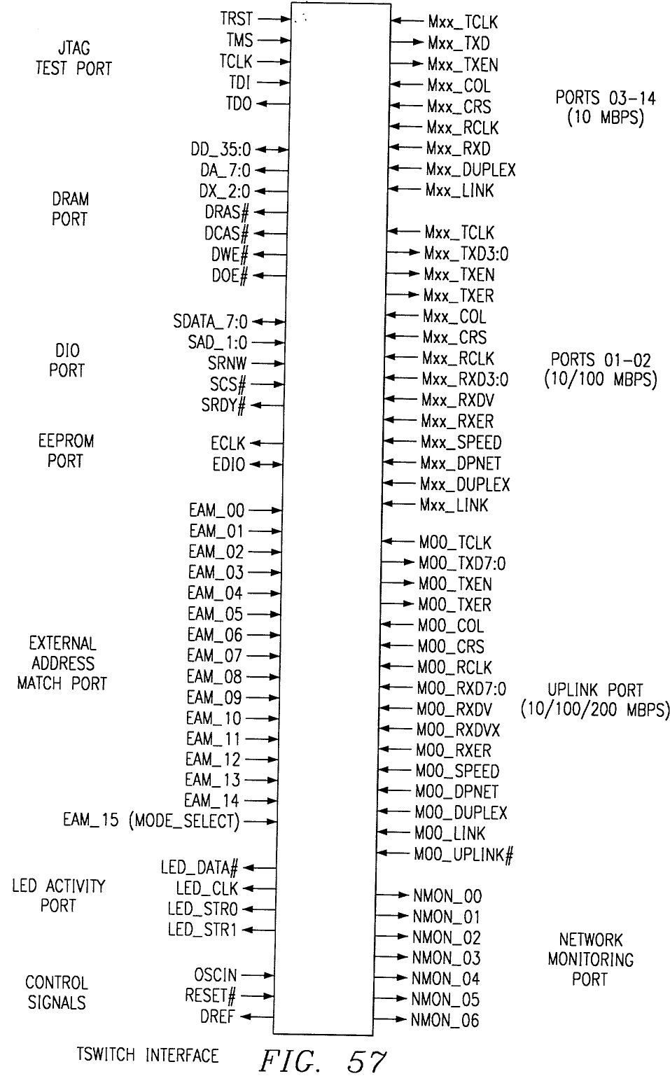

FIG. 56 depicts the 100 Mbps transmit interface timing diagram and includes some of the timing requirements for portions of FIG. 56.

Both MK_CRS and Mxx_COL are driven asynchronously by the PHY. Mxx_TXD3:0 is driven by the reconciliation sublayer synchronous to the Mxx_TCLK Mxx_TXEN Is asserted and deasserted by the reconciliation sublayer synchronous to the Mxx_TCLK rising edge. Mxx_TXER is driven synchronous to the rising edge of Mxx_TCLK (Where xx=00:02).

The above applies to the Uplink (port 00) when operating in 200 Mbps mode, with the exception that Mxx_TXD3:0 becomes Mxx_IXD7:0. The same timing specification will be enforced for the 10 Mbps output signals.

As noted earlier herein in reference to FIG. 15, access to the internal registers of the circuit is available, indirectly, via the four host registers that are contained in the circuit. Table 2 below identifies these four host registers and the signal combination of SAD_{—}1 and SAD_{—}0 for accessing them.

TABLE 2

| SAD_1 | SAD_0 | Host Register |
|---|---|---|
| 0 | 0 | DIO_ADR_LO |
| 0 | 1 | DIO_ADR_HI |
| 1 | 0 | DIO_DATA |
| 1 | 1 | DIO_DATA_INC |

More particularly, the four host registers are addressed directly from the DIO interface via the address lines SAD_{—}1 and SAD_{—}0. Data can be read or written to the address registers using the data lines SDATA_{—}7:0, under the control of Chip Select (SCS#), Read Not Write (SRNW) and Ready (SRDY#) signals.

The details of the DIO Address Register (DIOADR) are provided in Table 29 below.

TABLE 29

| DIO_ADR_HI | | | | | | | | DIO_ADR_LO | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | |
|---|---|---|
| RAM | RAM | ADR_SEL |
| SEL | MAP | |

| Bit | Name | Function |
|---|---|---|
| 15 | RAM_SEL | RAM Address Select: When this bit is set to a one DIO accesses |
| | | are to the Internal SRAMs, if this bit is set to a zero DIO accesses |
| | | are to Internal TSWITCH registers. |
| 14 | RAM_MAP | Internal SRAM mapping select bits. |
| thru | | 00 - Statistics Ram access |
| 13 | | 01 - FIFO Ram access (FIFO block 3) fifo 13-14 |
| | | 10 - FIFO Ram access (FIFO block 1), fifo 15 + fifo 0-4 |
| | | 11 - FIFO Ram access (FIFO block 2), fifo 5-fifo 12 |
| | | When the RAM_MAP field is 00, accesses are to the STATISTICS |
| | | SRAM. When non-zero one of three different fields of the FIFO |
| | | RAM is accessible. The FIFO SRAM can only be accessed whilst |
| | | TSWITCH is reset (RESET in the system control register is set to |
| | | one). Accesses to the SRAM whilst TSWITCH is not reset are |
| | | undefined: writes will be ignored and reads will return unknown |
| | | data |
| 12 | ADR_SEL | This field contains the internal DIO address to be used on |
| thru | | subsequent accesses to the DIO_DATA or DIO_DATA_INC |
| 0 | | registers. This field will auto-increment (by one) on all accesses to |
| | | the DIO_DATA_INC register. |
| | | For Register accesses the M.S. 6 bits (12 to 8) of ADR_SEL |
| | | are ignored. The L.S. 8 bits (7 to 0) indicate the DIO address of |
| | | the register. |
| | | For FIFO RAM accesses the M.S. 10 bits (12::4) indicate the |
| | | RAM Row address, and the L.S. 4 bits (2::0) indicate the RAM |
| | | word address of the Data field. If bit 3 is set the Flag byte is |
| | | accessed. |
| | | For STATISTICS RAM accesses the M.S. bits 12 of ADR_SEL |
| | | is ignored. The L.S. 3 bits (2 to 0) indicate the RAM Word |
| | | address, and the remaining 8 bits (11 to 3) indicate the RAM |
| | | Row address. |

The Statistics RAM is composed of 320 64 bit words. Bits (11 to 3) of ADR_SEL indicate the RAM ROW address. Bits (2 to 0) indicate which byte of the 64 bit word is to be accessed.

The FIFO RAM is composed of 1152 72 bit words. Bits 12 to 4 of ADR_SEL indicate the RAM ROW address for a given block of FIFO RAM as determined by Bits 14 to 13. Bits 3 to 0 indicate which part of the 72 bit word is to be accessed as shown below.

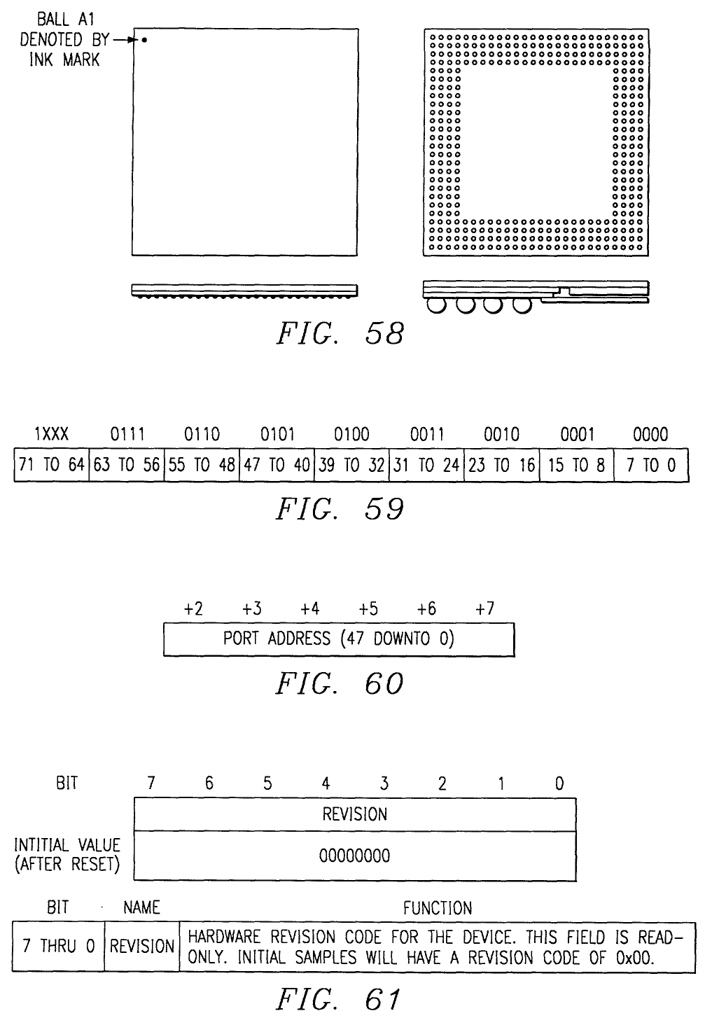

FIG. 59 depicts the DIO RAM access address mapping: The ram accessed via the DIO_ADR register is dependent upon bits 14:13 or the DIO_ADR register according to the values in Table 30 below.

TABLE 30

| DIO ADR | | |
|---|---|---|
| Bits 14::13 | Addressed Block | Address Range |
| 11 | 2nd FIFO Ram | Fifo Ram Address 0x200- |
| | block | 0x3FF |
| 10 | 1st FIFO Ram | Fifo Ram Address 0x000- |
| | block | 0x1FF |
| 01 | 3rd FIFO Ram | Fifo Ram Address 0x400- |
| | block | Ox5FF |
| 00 | STATISTIC Ram | Stats. Ram Addresses |
| | block | 0x000-0x140 |

The DIO Data Register (DIO_DATA register) address allows indirect access to internal registers and SRAM. There is no actual DIO_DATA register, accesses to this address are mapped to an internal bus access at the address specified in the DIO_ADR register described in reference to Table 29 and FIG. 59.

The DIO Data Increment Register (DIO_DATA_INC register) address allows indirect access to internal registers and SRAM. Accesses to this register cause a post-increment of the ADR_SEL field of the DIO_ADR register described in reference to Table 29 and FIG. 59.

Table 31 below depicts the arrangement and name of the internal registers and a corresponding DIO address.

TABLE 31
DIO Address

| | |
|---|---|
| Port 0 registers | 0x00-0x07 |
| Port 1 registers | 0x08-0x0F |
| Port 2 registers | 0x10-0x17 |
| Port 3 registers | 0x18-0x1F |
| Port 4 registers | 0x20-0x27 |
| Port 5 registers | 0x28-0x2F |
| Port 6 registers | 0x30-0x37 |
| Port 7 registers | 0x38-0x3F |
| Port 8 registers | 0x40-0x47 |
| Port 9 registers | 0x48-0x4F |
| Port 10 registers | 0x50-0x57 |
| Port 11 registers | 0x58-0x5F |
| Port 12 registers | 0x60-0x67 |
| Port 13 registers | 0x68-0x6F |
| Port 14 registers | 0x70-0x77 |
| System registers | 0x80-0xA3 |
| VLAN registers | 0xA4-0xC1 |
| System registers | 0xC3-0xC2 |
| Reserved | 0xC4-0xD3 |
| Test registers | 0xD4-0xFF |

Each of the port registers listed in Table 31 have the structure noted in Table 32 below.

TABLE 32

| +3 | +2 | +1 | +0 | 8*N+ |
|---|---|---|---|---|
| Port | Port | Port Status | Port Control | 0 |
| Address | address | | | |
| (39 to 32) | (47 to 40) | | | |
| Port | Port | Port | Port | 4 |
| address | address | address | address | |
| (7 to 0) | (15 to 8) | (23 to 16) | (31 to 24) | |

The system register listed in Table 31 has the structure noted in Table 33 below.

TABLE 33

| +3 | +2 | +1 | +0 | DIO Address |
|---|---|---|---|---|
| TXQ_1 length | | TXQ_0 length | | 0x80 |
| TXQ_3 length | | TXQ_2 length | | 0x84 |
| TXQ_5 length | | TXQ_4 length | | 0x88 |
| TXQ_7 length | | TXQ_6 length | | 0x8C |
| TXQ_9 length | | TXQ_8 length | | 0x90 |
| TXQ_11 length | | TXQ_10 length | | 0x94 |
| TXQ_13 length | | TXQ_12 length | | 0x98 |
| TXQ_15 length | | TXQ_14 length | | 0x9C |
| Reserved | NMON | XCTRL/SIO | Rev Reg | 0xA0 |

The VLAN register listed in Table 31 has the structure noted in Table 34 below.

TABLE 34

| | | | | |
|---|---|---|---|---|
| +3 | +2 | +1 | +0 | DIO Address |

| VLAN_1_mask | | VLAN_0_mask | 0xA4 |
|---|---|---|---|
| VLAN_3_mask | | VLAN_2_mask | 0xA8 |
| VLAN_5_mask | | VLAN_4_mask | 0xAC |
| VLAN_7_mask | | VLAN_6_mask | 0xB0 |
| VLAN_9_mask | | VLAN_8_mask | 0xB4 |
| VLAN_11_mask | | VLAN_10_mask | 0xB8 |
| VLAN_13_mask | | VLAN_12_mask | 0xBC |
| System Ctl | RAM Size | VLAN_14_mask | 0×C0 |

The test register listed in Table 31 has the structure noted in Table 35 below.

TABLE 35

| +3 | +2 | +1 | +0 | DIO Address |
|---|---|---|---|---|
| DRAM_data | | | | 0xD4-0xD7 |
| DRAM addr | | | DRAM_flag | 0xD8-0xDB |
| INITST | PACTST | DIATST | Reserved | 0xDC-0xDF |

| | | |
|---|---|---|
| TX_1 rbof | TX_0 rbof | 0xE0-0xE3 |
| TX_3 rbof | TX_2 rbof | 0xE4-0xE7 |
| TX_5 rbof | TX_4 rbof | 0xE8-0xEB |
| TX_7 rbof | TX_6 rbof | 0xEC-0xEF |
| TX_9 rbof | TX_8 rbof | 0xF0-0xF3 |
| TX_11 rbof | TX_10 rbof | 0xF4-0xF7 |
| TX_13 rbof | TX_12 rbof | 0xF8-0xFB |
| BOFRNG | TX_14 rbof | 0xFC-0xFF |

The content of each one of the port registers of Table 31 may also be represented as listed in Table 36 below. This is a rearrangement of Table 32.

TABLE 36

| | DIO Address |
|---|---|
| Port Control | 8*N + 0 |
| Port Status | 8*N + 1 |
| Port address (47 to 40) | 8*N + 2 |
| Port Address (39 to 32) | 8*N + 3 |
| Port address (31 to 24) | 8*N + 4 |
| Port address (23 to 16) | 8*N + 5 |
| Port address (15 to 8) | 8*N + 6 |
| Port address (7 to 0) | 8*N + 7 |

The uplink port (port 0) does not have a port address. The port address registers for port 0 (DIO addresses) cannot be written, and will always be read as zero.

The content of a port control register of Table 36 which is representative one of the ports is listed in Table 37 below.

TABLE 37

| | Bit | | | | | | | |
|---|---|---|---|---|---|---|---|---|
| | 7 | 6 | 5 | 4 | 3 | 2 | 1 | 0 |
| | DISABLE | ENABLE | STFORTX | STFORRX | ADRDIS | MWIDTH | TXPACE | FORCEHD |
| Initial Value | 0 | 0 | 0 | 0 | 0 | 0 | 0 | 0 |
| (After RESET) | | | | | | | | |
| M00_UPLINK# = 1 | | | | | | | | |
| Initial Value | 0 | 0 | 0 | 1 | 1 | 0 | 0 | 0 |
| (After RESET) | | | | | | | | |
| M00_UPLINK# = 0 | | | | | | | | |
| Ports 01-14 | | | | | | | | |
| Initial Value | 0 | 0 | 0 | 1 | 0 | 0 | 0 | 0 |
| (After RESET) | | | | | | | | |
| M00_UPLINK# = 0 | | | | | | | | |
| Port 00 | | | | | | | | |

| Bit | Name | Function |
|---|---|---|
| 7 | DISABLE | Port Disable: Writing a one to this bit position disables the port. |
| | | Frames will not be forwarded from or to a disabled port. The port |
| | | will, however attempt to transmit any previously queued frames. |
| | | The disable bit will be a latched bit. It will be set to zero by both |
| | | hard and soft reset (default state is for the port to be disabled). The |
| | | bit may be cleared by setting the enable bit. It may be set by |
| | | setting the disable bit. |
| 6 | ENABLE | Port Enable: Writing a one to this bit position enables the port |
| | | providing the disable bit is not currently set. Writing a zero to this |
| | | bit has no effect. This bit is always read as zero |
| 5 | STFORTX | Store and Forward on transmission. Cut through to this port will not |
| | | be allowed when this bit is set. |
| 4 | STFORRX | Store and Forward on Receive. Cut through from this port will be |
| | | disabled when this bit is set. |
| 3 | ADRDIS | Address Match Disable: When set, the port will not take part in |
| | | addressing matching activity. Addresses will not be captured for |
| | | this port, any stored address will be invalidated. Frames will not be |
| | | forwarded to the port, except by EAM or BRUN functions. |
| | | This permits selection between the ports that use external and the |
| | | ports that use internal address mappings. This allows the external |
| | | address match engine to be restricted to a sub set of TSWITCH |
| | | ports, using the internal single address lookup otherwise. If all |
| | | ADRDIS bits are set (all ports rely on the external address match |
| | | hardware) subsequently if a no-match code is received the frame |
| | | will be discarded. If the uplink ADRDIS bit is set and a frame |
| | | address has not been matched, the frame will be discarded. |
| | | This bit should be set for all ports handled by external address |
| | | hardware. |
| 2 | MWIDTH | MII Interface width selection: Only valid on 10/100 capable ports |
| | | (ports 0,1,2). When MWIDTH is high, and the port is operated in 10 |
| | | Mbps mode, the interface is operated in nibble serial mode. When |
| | | low the interface is operated in bit serial mode. |
| 1 | TXPACE | Transmit pacing: When high, the port will use transmission pacing. |
| | | to enhance performance. When low transmit pacing is disabled. |
| 0 | FORCEHD | Force Half Duplex: When high, the DUPLEX pin is pulled down |
| | | (open collector pull down on the input), forcing the PHY to operate |
| | | in Half Duplex mode. |

The content of a port status register of Table 36 which is representative one of the ports is listed in Table 38 below.

TABLE 38

Bit

| | | | | | | | |
|---|---|---|---|---|---|---|---|
| 8 | 6 | 5 | 4 | 3 | 2 | 1 | 0 |

| | | | | | | |
|---|---|---|---|---|---|---|
| | UPDATE | NLINK | DPNET | SPEED | DUPLX | Port State |
| Initial Value | — | — | — | — | — | 100 |
| (After RESET) | | | | | | |

| Bit | Name | Function |
|---|---|---|
| 7 | UPDATE | TxQ length Update pending: This bit indicates when the TxQ length |
| | | information for this port has been updated. This bit is set pending a |
| | | TxQ length initialization and whenever a Q length update is |
| | | pending. It is cleared when the update is complete. Any port that is |
| | | link down will not be updated. |
| 6 | NLINK | Not Link: This bit indicates that the ports link is inactive. This bit |
| | | reports the inverse of the state of the ports Mxx_LINK pin. |
| 5 | DPNET | Demand Priority Network: This bit indicates the network protocol in |
| | | use on the port. When set to a one it indicates Demand Priority |
| | | (802.12). When set to a zero it indicates CSMA/CD (802.3). This bit |
| | | is a direct reflection of the state of the ports Mxx_DPNET pin (non- |
| | | 10 Mbps ports). 10 Mbps-only ports always have a zero in this bit. |
| 4 | SPEED | Network Speed: This bit indicates the speed of a network port. |
| | | When set to a one it indicates 100 Mbps. When set to a zero it |
| | | indicates 10 Mbps. This bit is a direct reflection of the state of the |
| | | ports Mxx_SPEED pin (non-10 Mbps ports). 10 Mbps-only ports |
| | | will always have a zero in this bit. |
| 3 | DUPLX | Full Duplex Network: This bit indicates that a network port is |
| | | operating in Full-Duplex mode. When set to a one it indicates Full- |
| | | Duplex. When set to a zero it indicates Half-Duplex. This bit is a |
| | | direct reflection of the state of the ports Mxx_DUPLEX pin. |
| 2 | Port | This field indicates the state of the port: |
| thru | State | 000: Enabled |
| 0 | | 001: Suspended due to link failure |
| | | 010: Suspended due to address duplication |
| | | 011: Suspended due to address mismatch |
| | | 100: Disabled by management |
| | | 101: Disabled due to internal error |
| | | 110: Disabled due to address duplication |
| | | 111: Disabled due to address mismatch |
| | | Reset places all ports in state “100” (Disabled by management). |
| | | Completion of buffer memory initialization (START complete), will |
| | | place all ports in state “000” (Enabled). Unless the port DISABLE |
| | | bit is set. |

However, the uplink port (port 0) does not have a port address, so it cannot enter either address mismatch state. It can receive frames with source addresses securely assigned to other ports. In such cases if the SECDIS bit is set, the port will enter state (010), disabled due to address mismatch. Port suspension is not supported as a network port will naturally receive frames with differing source addresses, so waiting for the source address to change is not a useful option.

A further description of the port states code of Table 38 is listed in Table 39 below.

TABLE 39
Port State

| | |
|---|---|
| 000 | Enabled: |
| | This is the normal state of a port. This is the only port state in |
| | which frames are forwarded to and from the port. In all other |
| | states no new frames will be forwarded to or from the port. |
| 001 | Suspended due to link failure: |
| | The port has been suspended due to the absence of link activity |
| | at the port, as indicated by an inactive (zero) state of the ports |
| | Mxx_LINK pin. This may indicate cable failure, or simply that |
| | there is no station attached to the port. |
| | The port will be re-enabled once link activity is detected at the |
| | port, as indicated by an active (one) state of the ports Mxx_LINK |
| | pin. If link is lost during transmission of a frame, transmission will |
| | continue until the start of the next frame (the transmitted frame |
| | will be lost). |
| 010 | Suspended due to address duplication: |
| | The port has been suspended due to the reception at the port of a |
| | frame with a source address securely assigned to another port. |
| | The port will be re-enabled if a frame is received at the port with a |
| | source address NOT securely assigned to another port. A port in |
| | this state may also be re-enabled by writing a one to the ENABLE |
| | control bit or by link down |
| 011 | Suspended due to address mismatch: |
| | The port has been suspended due to the reception at the port of a |
| | frame with a source address different from that securely assigned |
| | to it. |
| | The port will be re-enabled if a frame is received at the port with a |
| | source address equal to the address securely assigned to it. A |
| | port in this state may also be re-enabled by writing a one to the |
| | ENABLE control bit. |
| 100 | Disabled by management: |
| | The port has been explicitly disabled by a DISABLE control bit |
| | write, or it is in the buffer initialization state. |
| | In this state the port can only be re-enabled by writing a one to |
| | the ENABLE control bit, or clearing the disable bit. |
| 101 | Reserved |
| 110 | Disabled due to address duplication: |
| | The port has been disabled due to the reception at the port of a |
| | frame with a source address securely assigned to another port. In |
| | this state no frames will be forwarded to or from the port, and no |
| | address learning will take place. |
| | A port In this state can only be re-enabled by writing a one to the |
| | ENABLE control bit. |
| 111 | Disabled due to address mismatch: |
| | The port has been disabled due to the reception at the port of a |
| | frame with a source address different from that securely assigned |
| | to it. In this state no frames will be forwarded to or from the port. |
| | A port In this state can only be re-enabled by writing a one to the |
| | ENABLE control bit. |

The content of a port address register of Table 36 which is representative one of the ports is depicted in FIG. 60. These 6 byte-wide registers hold the port's assigned source address, and are used to control address assignment and security for the port. Together these 6 registers contain a 47 bit IEEE802 Specific MAC address and a security enable bit. This bit is in the addresses G/S (Group/Specific) bit. The G/S bit is the first bit of address from the wire, but because of the L.S. bit first addressing scheme of Ethernet this corresponds to the L.S. bit of the first byte, or address bit 40.

The security enable bit, port address (40) is used to indicate the use of secure addressing on a port. In the secure addressing mode, once an address is assigned to a port, that source address can be used only with that port, and that port only with that source address. Use of that source address on another port will cause it to be suspended or disabled. Use of a different source address on the secured port will cause it to be suspended or disabled.

An address can be assigned to a port in two different ways: explicitly or dynamically. An address is explicitly assigned by writing it to the Port Address registers. An address is assigned dynamically by the circuit hardware loading the register from the source address field of received frames. If a port is in secured mode, the address will be loaded only once, from the first frame received. In unsecured mode the address is updated on every frame received. The circuit will never assign a duplicate port address. If the address is securely assigned to another port, then this port is placed in an unaddressed state; the address is set to zero—Null Address. If the address is assigned to another port, but not securely, then the other port is placed in an unaddressed state.

Writing 0x00.00.00.00.00.00 to the registers places the port in an unsecured, unaddressed state.

Writing 0x01.00.00.00.00.00 to the registers places the port in a secured, unaddressed state.

Writing a non-zero address (with bit 40 clear) sets the port address, in an unsecured state.

Writing a non-zero address (with bit 40 set) sets the port address, in a secured state.

In order to prevent dynamic updating of the port address during DIO writes to the address registers, which would create a corrupt address, dynamic updating is disabled by writes to the first address register (47-40), and re-enabled by writes to the last (7-0). Care should be taken that all 6 bytes are always written, and in the correct order.

The Transmit Queue Length (TXQ_xx) registers in Table 33 will now be described. The transmit queues use a residual queue length to control their behavior. Its value indicates how many more buffers can be added to the queue, rather than how many buffers are on the queue. This has the advantage that it easy to detect that the queue is full (length goes negative), and can be adjusted dynamically (2's complement addition to the length).

The initial transmit queue length value is set to the maximum number of data buffers that can be waiting on the queue. As frames are placed on the queue, the transmit queue length is decremented by the number of buffers enqueued. As buffers are loaded into the FIFO (and freed-up) the transmit queue length is incremented. Should the transmit queue length become negative (MSB set) the queue is full, no new frames will be added (Until the length becomes positive by the transmission of buffers ). It should be noted that because a maximum size frame (1518 bytes) is 24 buffers long, and whole frames are enqueued based on the current transmit queue length value, then the queue may consume 23 more buffers than the initial residual length (i.e., if the transmit queue is set to length=1, a full size ethernet frame can still be enqueued).

The transmit queue length registers are used to initialize, alter, and provide status on transmit queue lengths. They are used in three different ways

To assign initial transmit queue length value. The value in the register is used as its initial value, when the first frame is put on the Queue.

To indicate current transmit queue length value. The register is loaded with the transmit queue length value whenever it is updated.

To adjust transmit queue length.

After transmit queue initialization, a value written to this register will be added to the current transmit queue length value, the next time it is updated. The update bit in port status can be used to detect that initialization or an update operation has completed. The operation is a signed 16 bit addition, allowing the current queue length to be increased or decreased. The update operation is only enabled when the M.S. byte of the register (15 to 8) is written to prevent possible length corruption. Care should be taken that length bytes are always written LS byte first.

TXQ_{—}15 length is the queue length of the broadcast channel. This is the queue used for transmission of all broadcast or multicast frames in IOB mode. Its value may be initialized and altered just like all other TXQ lengths.

After reset, all the TX queue length registers are initialized to zero.

The content of the revision register of Table 33 is depicted in FIG. 61.

The content of the XCTRL/SIO register of Table 33 is listed in Table 41 below.

TABLE 41

| | Bit | | | | | | | |
|---|---|---|---|---|---|---|---|---|
| | 7 | 6 | 5 | 4 | 3 | 2 | 1 | 0 |
| | XCTRL Reg | | | | SIO Reg | | | |
| | Bit | | | | | | | |
| | 7 | 6 | 5 | 4 | 3 | 2 | 1 | 0 |
| | WUPLINK | CUT100 | RXARB | BRUN | ETEST | ECLOK | EXTEN | EDATA |
| Initial Values | — | 0 | 0 | 0 | 0 | 0 | 0 | 0 |
| (After RESET) | | | | | | | | |

| Bit | Name | Function |
|---|---|---|
| 7 | WUPLINK | Wide Uplink mode. This bit reflects the status of the M00_UPLINK# |
| | | strapping pin. (Note that M00_UPLINK# is active low). High = Wide |
| | | Uplink Mode (This bit is read only) |
| 6 | CUT100 | Single buffer Cut through on 100 Mbps ports only. Disables single |
| | | buffer cut through operation for frames received on a 10 Mb source |
| | | ports. A frame will only be transmitted when two buffers have been |
| | | transferred to the transmit fifo or an end of frame (prior to two |
| | | buffers) has been received. Whilst increasing latency, enabling this |
| | | reduces the likelihood of dropping frames due to FIFO underrun in |
| | | heavy bursty traffic. |
| 5 | RXARB | Prioritize Receive Arbitration mode. When set, the queue manager |
| | | state machine is reprioritized, giving priority to RX frames over |
| | | pending TX frames. Transmit frames that are in progress are |
| | | allowed to finish at the same priority, before the priority is lowered |
| | | after their completion. Transmission will only start when no RX |
| | | traffic is in progress, with RXARB set high. This reduces the |
| | | possibility of dropping frames in bursty conditions whilst requiring a |
| | | greater depth of DRAM buffer memory. |
| 4 | BRUN | Broadcast to Unassigned ports. If no port address is matched, |
| | | when set, this bit forces TSWITCH to broadcast a unicast frame to |
| | | all ports with unassigned addresses. When this bit is reset, all |
| | | unmatched frames are sent to the UPLINK port. (This option |
| | | requires the IOBMOD bit to be set) |
| 3 | ETEST | EEPROM Clock Speed: This is a manufacturing test function. For |
| | | normal operation this bit is reset and the EEPROM clock is derived |
| | | from the main clock divided by 511. When set, the EEPROM clock |
| | | is derived from the main clock divided by 6, reducing |
| | | manufacturing test time. |
| 2 | ECLOK | EEPROM SIO Clock: This bit controls the state of the ECLK pin. |
| | | When this bit is set to a one, ECLK is asserted. When this bit is set |
| | | to a zero ECLK is deasserted. |
| | | This bit is also used to determine the state of the EEPROM |
| | | interface. If the EEPROM port is disabled, then this bit will always |
| | | be read as a zero, even if a value of one is written to the bit. |
| | | TSWITCH detects that the EEPROM port is disabled by sensing |
| | | the state of the EDIO pin during reset. If the EDIO pin is read as a |
| | | zero during reset (due to an external pull-down resistor), then the |
| | | EEPROM interface is disabled and no attempt is made to read |
| | | configuration information. |
| 1 | ETXEN | EEPROM SIO Transmit Enable: This bit controls the direction of |
| | | the EDIO pin. When this bit is set to a one, EDIO is driven with the |
| | | value in the EDATA bit. When this bit is set to a zero the EDATA bit |
| | | is loaded with the value on the EDIO pin. |
| 0 | EDATA | EEPROM SIO Data: This bit is used to read or write the state of the |
| | | EDIO pin. When ETXEN is set to a one, EDIO is driven with the |
| | | value in this bit. When ETXEN is set to a zero this bit is loaded with |
| | | the value on the EDIO pin. |

The content of the system NMON register of Table 33 is listed in Table 42 below.

TABLE 42

| | Bit | | | | | | |
|---|---|---|---|---|---|---|---|
| 7 | 6 | 5 | 4 | 3 | 2 | 1 | 0 |

| | | | | |
|---|---|---|---|---|
| | Reserved | MONRXTX | MONWIDE | NMON |
| Initial Values | 00 | 0 | 0 | 0000 |
| (After RESET) | | | | |

| Bit | Name | Function | | | |
|---|---|---|---|---|---|
| 7 | Reserved | | | | |
| thru | | | | | |
| 6 | | | | | |
| 5 | MONRXTX | Selection of RX or TX signals when monitoring ports 0,1,2 | | | |
| | | operating in nibble interface format. | | | |
| 4 | MONWIDE | Selection of monitor port format. When low the NMON interface | | | |
| | | provides the SNI data format (only available for ports operating | | | |
| | | in SNI). When MONWIDE is high | | | |
| | | the NMON interface is configured for nibble data. (If | | | |
| | | MONWIDE is high when a port operating in SNI mode is | | | |
| | | monitored, only NMON_00 is driven with data, NMON_01 | | | |
| | | thru 03 will be undriven. | | | |
| | | NMON_06 is driven with an indication of the speed of the | | | |
| | | port, low = 10 Mbps, high = 100 Mbps. | | | |
| | | NMON Pin | MONWIDE = 0 | MONWIDE= 1 | MONWIDE= 1 |
| | | Name | | MONRXTX = 0 | MONRXTX = 1 |
| | | NMON_00 | Mxx_RXD | Mxx_RXD[0] | Mxx_TXD[0] |
| | | NMON_01 | Mxx_CRS | Mxx_RXD[1] | Mxx_TXD[1] |
| | | NMON_02 | Mxx_RCLK | Mxx_RXD[2] | Mxx_TXD[2] |
| | | NMON_03 | Mxx_TXD | Mxx_RXD[3] | Mxx_TXD[3] |
| | | NMON_04 | Mxx_TXEN | Mxx_RXDV | Mxx_TXEN |
| | | NMON_05 | Mxx_TCLK | Mxx_RCLK | Mxx_TCLK |
| | | NMON_06 | Mxx_COL | Mxx_SPEED | Mxx_SPEED |

| | | This nibble controls which port is monitored when using the | |
|---|---|---|---|
| | | network monitoring function. | |
| 3 | NMON | NMON field code | Description |
| thru | | 0000-1110 | Ports 00-14 selected for monitoring. |
| 0 | | | (Note port 00 (uplink) can only |
| | | | monitored when M00_UPLINK# is high.) |
| | | 1111 | Disable the NMON function |

The VLAN registers hold broadcast destination masks for each source port when IOB is in operation.

Each bit in the VLAN register (with exception of bit 15) directly corresponds to a port (bit 14=port 14 thru bit 00=port 0). Broadcast and multicast frames will be directed according to the VLAN register setting for the port on which the broadcast or multicast frame was received.

Each VLAN register is initialized at reset to send frames to all other ports except itself. After reset the registers contain the values in Table 44 below.

TABLE 44

Initial Value

| | | |
|---|---|---|
| Register Name | Bit 15 | Bit 0 |

| | |
|---|---|
| VLAN_1_MASK | 0111111111111110 |
| VLAN_2_MASK | 0111111111111101 |
| VLAN_3_MASK | 0111111111111011 |
| VLAN_4_MASK | 0111111111110111 |
| VLAN_5_MASK | 0111111111101111 |
| VLAN_6_MASK | 0111111111011111 |
| VLAN_7_MASK | 0111111110111111 |
| VLAN_7_MASK | 0111111101111111 |
| VLAN_8_MASK | 0111111011111111 |
| VLAN_9_MASK | 0111110111111111 |
| VLAN_10_MASK | 0111101111111111 |
| VLAN_11_MASK | 0111011111111111 |
| VLAN_12_MASK | 0110111111111111 |
| VLAN_13_MASK | 0101111111111111 |
| VLAN_14_MASK | 0011111111111111 |

When EAM bit mask direction is in use, the VLAN registers are used to store the bit mask from the EAM.

The VLAN registers can only be loaded before DRAM initialization (before the START bit is set).

The RAM size register (found in Table 34) format and content is listed in Table 45 below.

TABLE 45

| | | | | | | | | |
|---|---|---|---|---|---|---|---|---|
| Bit | 7 | 6 | 5 | 4 | 3 | 2 | 1 | 0 |

| | | |
|---|---|---|
| | Reserved | RSIZE |
| Initial | X | 0100 |
| Values | | |
| (After | | |
| RESET) | | |

| Bit | Name | Function |
|---|---|---|
| 7 thru 4 | Reserved | |
| 3 thru 0 | RSIZE | RAM Size select: This field indicates the size of the external DRAM, |
| | | and therefore the number of 64 byte data buffers available¹. This |
| | | field is used by TSWITCH to determine how many buffers to initialize. |
| | | Code values are: |
| | | 0. 1K bytes, 15 buffers. |
| | | 1. 2K bytes, 30 buffers. |
| | | 2. 4K bytes, 60 buffers. |
| | | 3. 8K bytes, 120 buffers. |
| | | 4. 16K bytes, 240 buffers. |
| | | 5. 32K bytes, 480 buffers. |
| | | 6. 64K bytes, 960 buffers. |
| | | 7. 128K bytes, 1,920 buffers. |
| | | 8. 256K bytes, 3,840 buffers. |
| | | 9. 512K bytes, 7,680 buffers. |
| | | 10. 1M bytes, 15,360 buffers. |
| | | 11. 2M bytes, 30,720 buffers. |
| | | 12. 4M bytes, 61,440 buffers. |
| | | 13. 8M bytes, 122,880 buffers. |
| | | 14. 16M bytes, 245,760 buffers. |
| | | 15. Reserved |
| | | The lower ram size values (<64 Kbytes) are included only to |
| | | reduce the logic simulation time required while functionally |
| | | testing, |

The system control register (found in Table 34) format and content is listed in Table 46 below.

Bit 7 6 5 4 3 2 1 0

¹Buffers are 68 bytes long (4 bytes of forward pointer). 15 68 byte buffers are allocated per 1K byte page. The first word of every 1K byte page is not used. Buffers therefore never straddle page boundaries.

TABLE 46

| | | | | | | | | |
|---|---|---|---|---|---|---|---|---|
| | RESET | LOAD | START | CLRSTS | STMAP | SECDIS | LONG | IOBMOD |
| Initial Value | 0 | 0 | 0 | 0 | 0 | 0 | 0 | 0 |
| (After | | | | | | | | |
| RESET) | | | | | | | | |

| Bit | Name | Function |
|---|---|---|
| 7 | RESET | Reset system: Writing a one to this bit places TSWITCH in a |
| | | software reset state. Writing a zero clears the reset state. |
| | | Software reset resets all internal state machines, FIFOs, and |
| | | protocol handlers. Any data in TSWITCH is lost. Setting this bit |
| | | does not affect any of the DIO or HOST registers. The DIO and |
| | | HOST registers are only cleared by hardware reset (pulling the |
| | | RESET#pin low). |
| | | This bit is not auto-loaded. It is always set to zero by |
| | | auto-load. |
| | | (Software reset will set the port state to ‘disable by management.’ |
| | | in the port status register.) |
| 6 | LOAD | Load system: Writing a one to this bit causes the TSWITCH DIO |
| | | registers to be auto-loaded from an external EEPROM (if present). |
| | | All registers in the DIO address range 0x00-0xA3 are loaded from |
| | | the corresponding EEPROM locations. Writing a zero to this bit has |
| | | no effect. This bit will be read as a one until the auto-load is |
| | | complete. |
| | | This bit is not auto-loaded. It is always set to zero by |
| | | auto-load. |
| 5 | START | Start system: Writing a one to this bit causes TSWITCH to begin |
| | | operation. This bit will be read as a one until buffer memory |
| | | initialization is complete. Whilst buffers are being initialized all ports |
| | | are disabled. Writing a zero to this bit has no effect. |
| 4 | CLRSTS | Clear statistics: Writing a one to this bit causes TSWITCH to clear |
| | | all its statistics counters. TSWITCH will repeat clearing the statistic |
| | | counters until this bit is cleared. |
| 3 | STMAP | Statistic Mapping: Selects which statistic is recorded in multiple |
| | | function statistic counters (currently only Tx Data Errors). Setting |
| | | this bit to a one, selects the statistic to record the number of Tx |
| | | Frames discarded on Tx due to lack of resources. If the bit is set to |
| | | a zero, the statistic will record the number of data errors at Tx. |
| 2 | SECDIS | Disable Ports on Security violations: When this bit is set to a one, |
| | | address security violations will cause a port to be disabled. When |
| | | this bit is set to a zero, address security violations will cause a port |
| | | to be suspended. Suspended ports will be re-enabled when the |
| | | offenading condition is removed, Disabled ports can only be re- |
| | | enabled by management (setting port ENABLE bit). |
| 1 | LONG | Long frame handling: When high, all ports will handle frames up to |
| | | 1531 bytes (to support 802.10). The statistic counter for giant |
| | | frames will be recorded in the Rx + Tx Frame 1024-1518 bucket |
| | | counter, which for this mode will be redefined to become Rx + Tx |
| | | Frames 1024-1531. Frames exceeding 1531 bytes will be |
| | | truncated. |
| 0 | IOBMOD | In Order Broadcast Mode: When this bit is set to a one, |
| | | broadcast/multicast frames are sent to a destination “In order” with |
| | | respect to unicast frames from the same source port, using the lOB |
| | | buffer in linking mechanism. When set to zero frames are sent out- |
| | | of-order using the OOB broadcast channel mechanism. |

Test Registers

The DRAM_data register (found in Test Registers of Table 35) format and content is listed in Table 48 below.

TABLE 48

| Bit | 31:0 |
|---|---|
| | DRAM_data |

| Bit | Name | Function |
|---|---|---|
| 31 thru 0 | DRAM_data | Holds a 32 bit data value that maps to the forward pointer field of a |
| | | DRAM buffer when accessed in DRAM test access mode. |

The DRAM_flag register (found in Test Registers of Table 35) format and content is listed in Table 49 below.

TABLE 49

| Bit | 7 | 6 thru 4 | 3 thru 0 |
|---|---|---|---|
| | D | Reserved | DRAM_FLAG |
| | R | | |
| | A | | |
| | M | | |
| | A | | |
| | C | | |
| | T | | |

| Bit | Name | Function |
|---|---|---|
| 7 | DRAMACT | DRAMACT contains the status of a DRAM test access READ or |
| | | WRITE. When this activity bit is high the DRAM access is being |
| | | performed. When this bit is low the DRAM access has completed. |
| | | After a DRAM test access buffer read the user should detect a |
| | | falling edge on this bit before proceeding to use the accessed data |
| 3 | DRAM_flag | Holds a 4 bit data value that maps to the flag field of a DRAM |
| thru | | buffer when accessed in DRAM test access mode. |
| 0 | | |

The DRAM_addr register (found in Test Registers of Table 35) format and content is listed in Table 50 below.

TABLE 50

| Bit | 23 | 22-0 |
|---|---|---|
| | R/W | DRAM Address |

| Bit | Name | Function |
|---|---|---|
| 23 | R/W | DRAM test access Read/Write bit. Determines whether the |
| | | contents of Channel 0's FIFO, DRAM_data & DRAM_flag are read |
| | | from DRAM or written to DRAM. when high the write operation is |
| | | performed. When low a read operation is performed. |
| 22 thru 0 | DRAM | 23 bit DRAM address marking the starting word location for a |
| | Address | DRAM test access buffer operation. |

The DRAM address space as used in this register is not flat. It is partitioned as listed in Table 51 below.

TABLE 51

| 22 | 21 | 20 | 19 | 18 | 17 | 16 | 15:8 | 7:0 |
|---|---|---|---|---|---|---|---|---|
| RESERVED | DX02 RAS | DX02 CAS | DX01 RAS | DX01 CAS | DX00 RAS | DX00 CAS | Row Address | Column |
| | | | | | | | (8 bits) | Address |
| | | | | | | | | (8 bits) |

| Bit | Name | Function |
|---|---|---|
| 22 | Reserved | |
| 21 | DX02 | Extended address bit 2 (RAS) |
| 20 | DX02 | Extended address bit 2 (CAS) |
| 19 | DX01 | Extended address bit 1 (RAS) |
| 18 | DX01 | Extended address bit 1 (CAS) |
| 17 | DX00 | Extended address bit 0 (RAS) |
| 16 | DX00 | Extended address bit 0 (CAS) |
| 15 | RAS | Row address for DRAM (msb = bit 15) |
| thru 8 | | |
| 7 | CAS | Column address for DRAM (msb = bit 15) |
| thru 0 | | |

Table 52 lists the fields of the test registers that may be employed for DRAM test access operations.

TABLE 52

| +3 | +2 | +1 | +0 | DIO Address |
|---|---|---|---|---|
| DRAM_data | | | | 0xD4-0xD7 |
| DRAM_addr | | | DRAM_flag | 0xD8-0xDB |
| INITST | PACTST | DIATST | Reserved | 0xDC-0xDF |

The system/user can test the external memory by the following procedure:

Soft Reset, but do not set the start bit.

Place in the Tx FIFO 0, Channel 0 the data which is to be written to the DRAM buffer (Only the first 64 bytes are used (both TX and RX FIFOs)).

Data burst write 17 words to the DRAM. In normal operation the first word of the seventeen contains the forward pointer information. Since the FIFO does not contain this information, the DRAM_data register maps to the contents of this first word.

Write to the DRAM_addr register. Note all addresses in the address space are accessible not only those that are the circuit buffer aligned. All updates to this register should be performed from the lowest to the highest byte address. When the high byte address is written the DRAM access operation is performed (either a DRAM buffer write or a DRAM buffer read depending on the state of the MSB of the DRAM_addr register.)

If the system/user is performing a buffer read operation. The Information in Rx FIFO 0, DRAM_data and DRAM flag will only be valid when the DRAM activity bit (MSB of DRAM_flag is low).

Alternatively if the system/user is performing a buffer write operation. The write operation has completed only when the activity bit is low.

Perform a further soft reset following the DRAM test access to ensure correct initialization when the start bit is set.

The DRAM access relies on the buffer burst mode employed for normal data transfer, thus a 17 word buffer must be written each time. By loading FIFO 0, DRAM_data and DRAM_flag accordingly a memory can be quickly patterned by only updating the DRAM_addr register alone. The data in Rx and Tx FIFO 0 can be written or read by using the direct FIFO memory access mode.

The DIATST register (found in Test Registers of Table 35) format and content is listed in Table 53 below.

TABLE 53

| | | | | | | | | |
|---|---|---|---|---|---|---|---|---|
| Bit | 7 | 6 | 5 | 4 | 3 | 2 | 1 | 0 |

| | | | | |
|---|---|---|---|---|
| | Reserved | D | I | O |
| | | P | N | V |
| | | W | T | E |
| | | R | W | R |
| | | A | R | T |
| | | P | A | S |
| | | | P | T |
| Initial Value | X | 0 | 00 | 0 |
| (After Reset) | | | | |

| Bit | Name | Function |
|---|---|---|
| 7 | Reserved | |
| thru | | |
| 4 | | |
| 3 | DPWRAP | Duplex wrap mode. When high, all ports are forced into full duplex |
| | | mode, so all ports can receive frames they transmit, thus enabling |
| | | external wrap testing at the PHY. |
| 2 | INTWRAP | Internal Wrap Mode. Ports 1 thru 14 internally wrap back according |
| thru | | to the two bit coding (intwrap (1:0) (bits 2, bit 1 diatst respectively). 00 No internal wrapping |
| 1 | | 01 All ports internally wrapped except Port 00 (Uplink) |
| | | 10 All ports internally wrapped except Port 02 |
| | | 11 All ports internally wrapped except Port 14 |
| | | (The port that is not wrapped (00, 02 or 14) should be used to |
| | | inject and observe test data frames from the internally |
| | | wrapped ports.) |
| 0 | OVERTST | Over Run Test. When high, this bit forces the DRAM refresh |
| | | controller to continuously request and be granted the DRAM bus, |
| | | causing the FIFOs to over run and under run. This is an artificial |
| | | mode of operation to simulate DRAM bandwidth congestion. It |
| | | enables the designers to easily simulate and reproduce these error |
| | | conditions. |

The PACTST register (found in Test Registers of Table 35) format and content is listed in Table 54 below.

TABLE 54

| | | | | | | | | |
|---|---|---|---|---|---|---|---|---|
| Bit | 7 | 6 | 5 | 4 | 3 | 2 | 1 | 0 |

| | | | | |
|---|---|---|---|---|
| | F | F | R | INITPACE |
| | L | L | E | |
| | A | A | S | |
| | G | G | E | |
| | 1 | 1 | R | |
| | 0 | 0 | V | |
| | 0 | | E | |
| | | | D | |
| Initial Value | — | — | x | 11111 |
| (After Reset) | | | | |

| Bit | Name | Function |
|---|---|---|
| 7 | FLAG100 | Pacing flag comparison for all 100 Mb ports. This is the ‘OR’ of all |
| | | the 100Mb port compare signals resulting from the comparison |
| | | between the pacing register and the Initpace value. When high this |
| | | bit indicates an error, if all ports are involved in pacing and have |
| | | experienced exactly similar traffic. Note whilst an error is detected, |
| | | no information is given as to which port s signal was in error. |
| 6 | FLAG10 | Pacing flag comparison for all 10 Mb ports. This is the ‘OR’ of all |
| | | the 10 Mb port compare signals resulting from the comparison |
| | | between the pacing register and the Initpace value. When high this |
| | | bit indicates an error, if all ports are involved in pacing and have |
| | | experienced exactly similar traffic. Note whilst an error is detected, |
| | | no information is given as to which ports signal was in error. |
| 5 | Reserved | |
| 4 | INITPACE | Pacing Register Initial value. At reset bits 4 thru 0 are inverted and |
| thru | | loaded into the pacing register (the default value for the register is |
| 0 | | 00000, the default loaded value after reset is 11111. Following |
| | | reset, the bits 4 thru 0 are used to compare to the contents of the |
| | | pacing register, the result of the comparison is returned and ‘OR’ed |
| | | to form bits 6 and 7 of the PACTST register. |

The INITST register (found in Test Registers of Table 35) format and content is listed in Table 55 below.

TABLE 55

| | | | | | | | | |
|---|---|---|---|---|---|---|---|---|
| Bit | 7 | 6 | 5 | 4 | 3 | 2 | 1 | 0 |

| | | |
|---|---|---|
| | RAM INIT (21:15) | RAM INIT |
| | | (14:8) |
| Initial Value | 0000000 | 0 |
| (After RESET) | | |

| Bit | Name | Function |
|---|---|---|
| 7 | RAMINIT | At DRAM initialization, bits (7:1) of the INITST register are loaded |
| thru | (21:15) | into the bits (21:15) of the DRAM Buffer Initialization address |
| 1 | | register. This permits the upper bits of the DRAM buffer |
| | | initialization to be tested without incurring high test overhead times. |
| 0 | RAMINIT | At DRAM initialization, bit 0 of the INITST register is used to fill bits |
| | (14:8) | (14:8) of the DRAM buffer initialization address register. This |
| | | permits roll over testing of these bits to be made. (Bits 7:0 of the |
| | | DRAM are not controllable, these are incremented when defining |
| | | the 17 word buffer pointer within a 256 word page.) |

The Bofrng register (found in Test Registers of Table 35) format and content is listed in Table 56 below.

TABLE 56

| 0xFF | | | | | | | | 0xFE | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | |
|---|---|---|
| H | ATTEMPT | Bofrng |
| A | | |
| L | | |
| T | | |

Initial Values (After RESET)

| | | |
|---|---|---|
| 0 | 0000 | 000000000000 |

| Bit | Name | Function |
|---|---|---|
| 15 | HALT | Halt Random number generator: When this bit is set to a one, the |
| | | Backoff Random Number Generator is halted (does not count), and |
| | | can be loaded. Writing this bit takes effect on the next cycle: It is |
| | | not possible to halt the generator and load its MS bits on the same |
| | | byte write. This bit is reset to zero by hardware reset. |
| 14 | Attempt | Collision attempt: The value in this field is used as the initial |
| thru | | collision attempt count used in all TSWITCH Ethernet transmit |
| 11 | | operations. This field is reset to zero by hardware or software |
| | | reset. Writing this field is not dependent on the HALT bit. |
| 10 | Bofrng | Backoff Random Number Generator: This field allows the Backoff |
| thru | | Random Number Generator to be loaded, or read. This field can |
| 0 | | only be written when the HALT bit is (already) set. Reading this |
| | | field returns the generators current value. |

The address map or content of the statistics RAM is listed in Table 57 below.

TABLE 57

| | DIO Address |
|---|---|
| Port 0 statistics | 0x000-0x07F |
| Port 1 statistics | 0x080-0x0FF |
| Port 2 statistics | 0x100-0x17F |
| Port 3 statistics | 0x180-0x1FF |
| Port 4 statistics | 0x200-0x27F |
| Port 5 statistics | 0x280-0x2FF |
| Port 6 statistics | 0x300-0x37F |
| Port 7 statistics | 0x380-0x3FF |
| Port 8 statistics | 0x400-0x47F |
| Port 9 statistics | 0x480-0x4FF |
| Port 10 statistics | 0x500-0x57F |
| Port 11 statistics | 0x580-0x5FF |
| Port 12 statistics | 0x600-0x67F |
| Port 13 statistics | 0x680-0x6FF |
| Port 14 statistics | 0x700-0x77F |
| Rx Over_Run & Collision Statistics | 0x780-0x7FF |
| TXQ structures | 0x800-0x87F |
| IMQ structures | 0x880-0x8FF |
| RXQ structures | 0x900-0x97F |
| Reserved | 0x980-0x9FF |

The content a port statistics register of Table 57 which is representative one of the ports is listed in Table 58 below.

TABLE 58

| | | | | | | | | | |
|---|---|---|---|---|---|---|---|---|---|
| ADR (2 to 0) | 111 | 110 | 101 | 100 | 011 | 010 | 001 | 000 | Address |

| | | |
|---|---|---|
| Goodt Rx frames | Rx Octets | +0x00-0x07 |
| Multicast Rx frames | Broadcast Rx frames | +0x08-0x0F |
| Rx Align/Code errors | Rx CRC errors | +0x10-0x17 |
| Rx Jabbers | OverSize Rx frames | +0x18-0x1F |
| Rx Fragments | UnderSize Rx frames | +0x20-0x27 |
| Frames 65-127 | Frames 64 | +0x28-0x2F |
| Frames 256-511 | Frames 128-255 | +0x30-0x37 |
| Frames 1024-1518 | Frames 512-1023 | +0x38-0x3F |
| SQE test errors | Net Octets | +0x40-0x47 |
| Good Tx frames | Tx Octets | +0x48-0x4F |
| Multi-Collision Tx frames | Single Collision Tx | +0x50-0x57 |
| | frames | |
| Deferred Tx frames | Carrier sense errors | +0x58-0x5F |
| Excessive Collisions | Late Collisions | +0x60-0x67 |
| Multicast Tx frames | Broadcast Tx frames | +0x68-0x6F |
| TX data errors² | Filtered Rx frames | +0x70-0x77 |
| Address changes/ | Address duplications | +0x78-0x7F |
| mismatches | | |

The content a Rx Over_Run and Collision statistics register of Table 57 is listed in Table 59 below.

TABLE 59

| | | | | | | | | | |
|---|---|---|---|---|---|---|---|---|---|
| ADR (2 to 0) | 111 | 110 | 101 | 100 | 011 | 010 | 001 | 000 | Address |

| | | |
|---|---|---|
| # Rx Over_Run Port 00 | Collision Port00 | +0x00-0x07 |
| # Rx Over_Run Port 01 | Collision Port01 | +0x08-0x0F |
| # Rx Over_Run Port 02 | Collision Port02 | +0x10-0x17 |
| # Rx Over_Run Port 03 | Collision Port03 | +0x18-0x1F |
| # Rx Over_Run Port 04 | Collision Port04 | +0x20-0x27 |
| # Rx Over_Run Port 05 | Collision Port05 | +0x28-0x2F |
| # Rx Over_Run Port 06 | Collision Port06 | +0x30-0x37 |
| # Rx Over_Run Port 07 | Collision Port07 | +0x38-0x3F |
| # Rx Over_Run Port 08 | Collision Port08 | +0x40-0x47 |
| # Rx Over_Run Port 09 | Collision Port09 | +0x48-0x4F |
| # Rx Over_Run Port 10 | Collision Port10 | +0x50-0x57 |
| # Rx Over_Run Port 11 | Collision Port11 | +0x58-0x5F |
| # Rx Over_Run Port 12 | Collision Port12 | +0x60-0x67 |
| # Rx Over_Run Port 13 | Collision Port13 | +0x68-0x6F |
| # Rx Over_Run Port 14 | Collision Port14 | +0x70-0x77 |
| Reserved | Reserved | +0x78-0x7F |

When accessing the statistics values from the DIO port, it is necessary to perform four 1 byte DIO reads, to obtain the full 32 bit counter. To prevent the chance of the counter being updated whilst reading the four bytes, the system/user should access the low byte first, followed by the upper 3 bytes. On reading the low byte, the counter statistic value is transferred to a 32 bit holding register, before being placed on the DIO bus. The register is only updated when reading the low byte of the counter statistic. When accessed in this way, spurious updates will not be occurring as will otherwise be the case.

The content of the TXQ structures address register of Table 57 is listed in Table 60 below.

TABLE 60

| | | | | | | | | | |
|---|---|---|---|---|---|---|---|---|---|
| ADR(2 to 0) | 111 | 110 | 101 | 100 | 011 | 010 | 001 | 000 | Address |

| | | | |
|---|---|---|---|
| TXQ_0 head | TXQ_0 tail | TXQ_0 len | 0x800-0x807 |
| TXQ_1 head | TXQ_1 tail | TXQ_1 len | 0x808-0x80F |
| TXQ_2 head | TXQ_2 tail | TXQ_2 len | 0x810-0x817 |
| TXQ_3 head | TXQ_3 tail | TXQ_3 len | 0x818-0x81F |
| TXQ_4 head | TXQ_4 tail | TXQ_4 len | 0x820-0x827 |
| TXQ_5 head | TXQ_5 tail | TXQ_5 len | 0x828-0x82F |
| TXQ_6 head | TXQ_6 tail | TXQ_6 len | 0x830-0x837 |
| TXQ_7 head | TXQ_7 tail | TXQ_7 len | 0x838-0x83F |
| TXQ_8 head | TXQ_8 tail | TXQ_8 len | 0x840-0x847 |
| TXQ_9 head | TXQ_9 tail | TXQ_9 len | 0x848-0x84F |
| TXQ_10 head | TXQ_10 tail | TXQ_10 len | 0x850-0x857 |
| TXQ_11 head | TXQ_11 tail | TXQ_11 len | 0x858-0x85F |
| TXQ_12 head | TXQ_12 tail | TXQ_12 len | 0x860-0x867 |
| TXQ_13 head | TXQ_13 tail | TXQ_13 len | 0x868-0x86F |
| TXQ_14 head | TXQ_14 tail | TXQ_14 len | 0x870-0x877 |
| ³TXQ_15 head | TXQ_15 tail | TXQ_15 len | 0x878-0x87F |

³TXQ_15 is the broadcast transmit queue

The content of the IMQ structures address register of Table 57 is listed in Table 61 below.

TABLE 61

| | | | | | | | | | |
|---|---|---|---|---|---|---|---|---|---|
| ADR(2 to 0) | 111 | 110 | 101 | 100 | 011 | 010 | 001 | 000 | Address |

| | | | |
|---|---|---|---|
| IMQ_0 head | IMQ_0 tail | IMQ_0 len | 0x880-0x887 |
| IMQ_1 head | IMQ_1 tail | IMQ_1 len | 0x888-0x88F |
| IMQ_2 head | IMQ_2 tail | IMQ_2 len | 0x890-0x897 |
| IMQ_3 head | IMQ_3 tail | IMQ_3 len | 0x890-0x89F |
| IMQ_4 head | IMQ_4 tail | IMQ_4 len | 0x8A0-0x8A7 |
| IMQ_5 head | IMQ_5 tail | IMQ_5 len | 0x8A8-0x8AF |
| IMQ_6 head | IMQ_6 tail | IMQ_6 len | 0x8B0-0x8B7 |
| IMQ_7 head | IMQ_7 tail | IMQ_7 len | 0x8B8-0x8BF |
| IMQ_8 head | IMQ_8 tail | IMQ_8 len | 0x8C0-0x8C7 |
| IMQ_9 head | IMQ_9 tail | IMQ_9 len | 0x8C8-0x8CF |
| IMQ_10 head | IMQ_10 tail | IMQ_10 len | 0x8D0-0x8D7 |
| IMQ_11 head | IMQ_11 tail | IMQ_11 len | 0x8D8-0x8DF |
| IMQ_12 head | IMQ_12 tail | IMQ_12 len | 0x8E0-0x8E7 |
| IMQ_13 head | IMQ_13 tail | IMQ_13 len | 0x8E8-0x8EF |
| IMQ_14 head | IMQ_14 tail | lMQ_14 len | 0x8F0-0x8F7 |

| | |
|---|---|
| Reserved | 0x8F8-0x8FF |

The content of the RXQ structures address register of Table 57 is listed in Table 62 below.

TABLE 62

| | | | | | | | | | |
|---|---|---|---|---|---|---|---|---|---|
| ADR(2 to 0) | 111 | 110 | 101 | 100 | 011 | 010 | 001 | 000 | Address |

| | | | |
|---|---|---|---|
| RXQ_0 head | RXQ_0 tail | RXQ_0 len | 0x900-0x907 |
| RXQ_1 head | RXQ_1 tail | RXQ_1 len | 0x908-0x90F |
| RXQ_2 head | RXQ_2 tail | RXQ_2 len | 0x910-0x917 |
| RXQ_3 head | RXQ_3 tail | RXQ_3 len | 0x918-0x91F |
| RXQ_4 head | RXQ_4 tail | RXQ_4 len | 0x920-0x927 |
| RXQ_5 head | RXQ_5 tail | RXQ_5 len | 0x928-0x92F |
| RXQ_6 head | RXQ_6 tail | RXQ_6 len | 0x930-0x937 |
| RXQ_7 head | RXQ_7 tail | RXQ_7 len | 0x938-0x93F |
| RXQ_8 head | RXQ_8 tail | RXQ_8 len | 0x940-0x947 |
| RXQ_9 head | RXQ_9 tail | RXQ_9 len | 0x948-0x94F |
| RXQ_10 head | RXQ_10 tail | RXQ_10 len | 0x950-0x957 |
| RXQ_11 head | RXQ_11 tail | RXQ_11 len | 0x958-0x95F |
| RXQ_12 head | RXQ_12 tail | RXQ_12 len | 0x960-0x967 |
| RXQ_13 head | RXQ_13 tail | RXQ_13 len | 0x968-0x96F |
| RXQ_14 head | RXQ_14 tail | RXQ_14 len | 0x970-0x977 |
| | Reserved | | 0x978-0x97F |

Due to the presently preferred memory configuration additional words of statistics RAM memory are created that are unallocated at present.

The remaining discussion herein is for a portion of a communications system of the present invention. More particularly, the remaining discussion is for an external address lookup engine (EALE) 1000. The EALE device provides a glue-less interface with the DRAM interface and external address match (EAM) interface of the network chip (ThunderSWITCH) 200 described earlier herein. The EALE device provides for stand-alone capabilities of at least 28 addresses or up to 277K addresses when used with external SRAM.

The EALE device provides for user-selectable aging thresholds.

The EALE device also provides a DIO interface for management access and control of the address table that provides: (a) address adds/deletes and modifies can be easily accomplished through this interface, (b) user-selectable interrupts to simplify the CPU's management operations, (c) VLAN support for Multicast addresses, (d) spanning tree support, (e) the ability to secure addresses to prevent them from moving ports, (f) an Mu management interface for MII-compliant device management, (g) support for a single or multiple user-selectable uplinks for unmatched addresses, and (h) management access of lookup table statistic registers.

EALE has been designed with an expandable architecture that may be easily modified for varying lookup times and/or larger address capabilities and uses standard off-the-shelf SRAM's. EALE determines the RAM size (and number of addresses supported) from an external x24C02 EEPROM or equivalent. Further, EALE provides a low-cost solution for a 1K address matching system. The EALE device also provides an architecture that allows for operation without a CPU by automatically allowing for startup values to be loaded from an attached serial EEPROM.

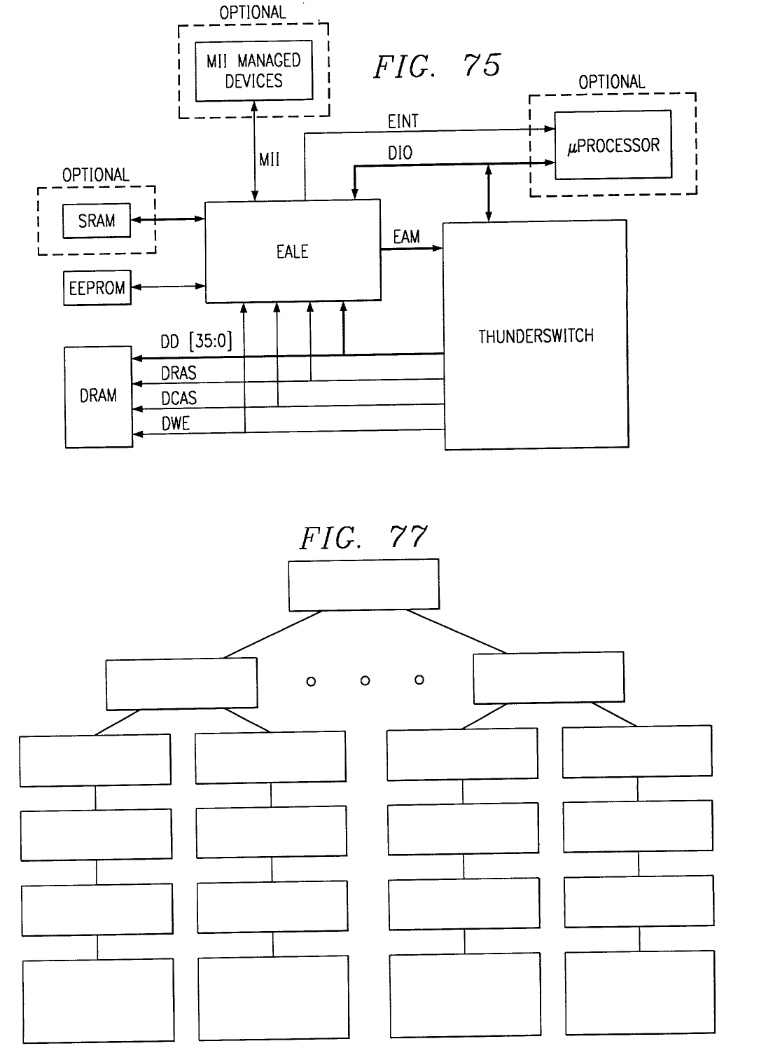

Referring now to FIG. 75, there may be seen a block diagram of a portion of another improved communications system 19 of the present invention. In FIG. 75, the communications system includes a multiport, multipurpose network integrated circuit (ThunderSWITCH) 200 having a plurality of communications ports capable of multispeed operation. The network chip operates in two basic modes, with one mode including address resolution and a second mode that excludes address resolution. The communications system 19 also includes an external address lookup integrated circuit (EALE) 1000 that is appropriately interconnected to the network chip 200. Both the network chip and the address lookup chip each have an external memory 1500, which is preferably EEPROM (not depicted in FIG. 75 for the network chip), appropriately interconnected to provide an initial configuration of each chip upon startup or reset. The communications system 19 also includes an external memory (DRAM) 300 for use by the network chip to store communications data, such as for example, but not limited to, frames or packets of data representative of a portion of a communications message. The communications system may also optionally include an external memory (SRAM) 1600 for use by the address lookup chip to increase its addressing capabilities.

The external address lookup (EALE) device 1000 determines the addresses to be learned and matched from ThunderSWITCH's DRAM bus 88. The address table is maintained on either EALE's internal 8K×8 SRAM or in an optional external SRAM 1600. The frame matching/forwarding information is given to ThunderSWITCH through the EAM interface 186.

EALE is designed to work in either an unmanaged or a managed mode. Unmanaged operation is accomplished through EALE's EEPROM support. Startup options are auto-loaded into EALE's internal registers through its attached EEPROM.

EALE's functions are fully controllable by management which can communicate to EALE's internal registers through a DIO interface 172. In addition EALE is able to interrupt the management processor through user selectable interrupts 1002.

The EALE device also provides optional support for easy management control of IEEE802.3u Media Independent Interface (MII) Managed devices 1200.

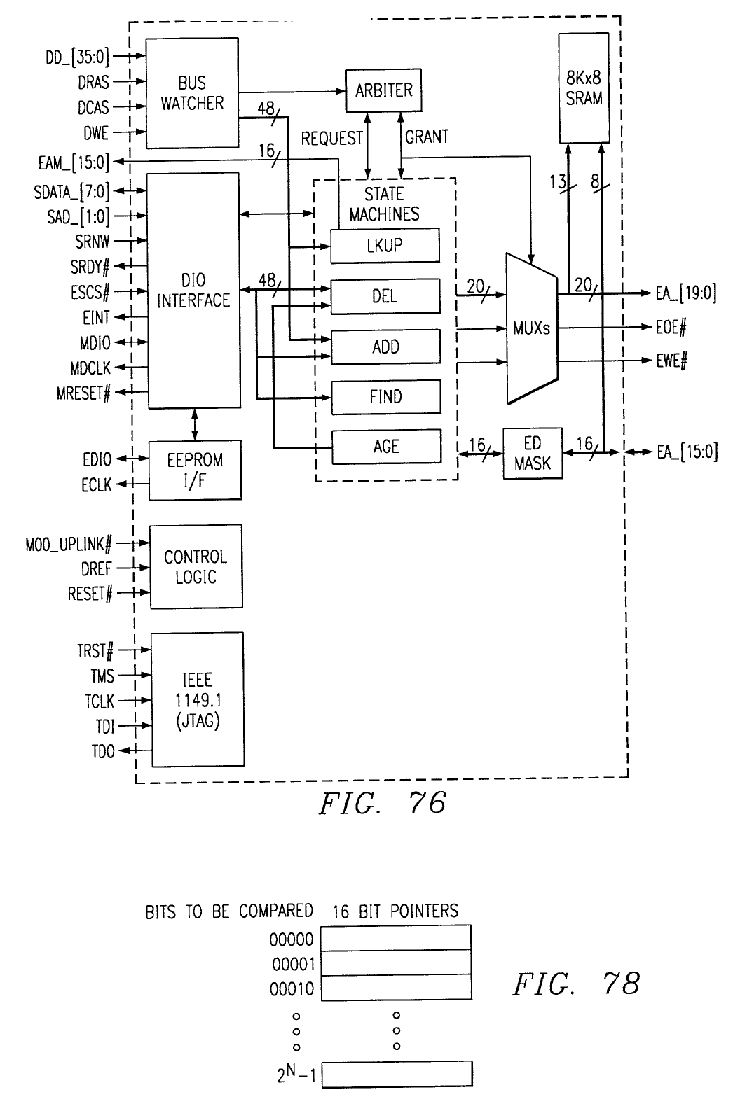

Referring now to FIG. 76, there may be seen a functional block diagram of a circuit 1000 that optionally forms a portion of a communications system of the present invention. More particularly, there may be seen the overall functional architecture of a circuit 1000 that is preferably implemented on a single chip as depicted by the outermost dashed line portion of FIG. 76. As depicted inside the outermost dashed line portion of FIG. 76, this circuit consists of preferably a bus watcher block 1050, an arbiter block 1060, an SRAM memory block 1090, a plurality of multiplexers 1080, an ED mask block 1095, a control logic block 1020, a hardware state machines dashed line block 1070 containing five hardware state machines, an EEPROM interface block 1030, a DIO interface block 1040 and an IEEE 1149.1 (JTAG) block 1010.

More particularly, the bus watcher block 1050 depicted in FIG. 76 interfaces to network chip's memory interface 88 and extracts destination, source addresses and the originating port number. It is responsible for identifying a frame's start of frame. The bus watcher 1050 interconnects with the arbiter block 1060 and the internal state machines 1070 to perform off-the-wire lookups and adds.

The DIO interface block 1040 enables an optional attached microprocessor to access internal registers (not depicted). The DIO interface can be used to select control modes, to read statistics, to receive interrupts, to read/write to attached MII devices, to read/write to an attached EEPROM and to perform management lookups, adds and deletes.

The EEPROM interface block 1030 is responsible for accesses to any attached EEPROM. It is also responsible for auto-loading of selected registers from the EEPROM at statup or when RESET.

The arbiter block 1060 is responsible for managing the SRAM accesses among the internal state machines; it does so by assigning priorities to the state machines. Preferably, wire lookups have the highest priority followed by delete, adds, management lookups and aging. As depicted in FIG. 76, the individual state machines request the bus by asserting a “Request” signal 1062. The arbiter grants 1064 the SRAM bus by controlling the SRAM bus address/data MUXes 1080.

The state machine block is composed of the lookup (LKUP), delete (DEL), add (ADD), find (FIND) and age (AGE) hardware state machines. Each machine is assigned a priority on the SRAM bus and is controlled by the arbiter. The LKUP state machine 1071 has the highest priority and is responsible for wire lookups. The DEL state machine 1073 is responsible for either deletes from the AGE machine or for management delete requests. The ADD state machine 1075 is responsible for wire adds as well as for management add requests. The FIND state machine 1077 is responsible for management searches of the lookup table. The AGE state machine 1079 is responsible for deleting addresses which have had no activity in a determined time period. Each of the state machines is preferably sequential logic configured to realize the functions described herein, responsive to various input signals, as more filly described later herein.

The address/data MUXes 1080 are controlled by the arbiter 1060 and select the state machine which has ownership of the SRAM bus. The ED mask block 1095 masks out the ED lines which fall outside the defined SRAM width (as defined in the RAMSize register).

The chip 1000 integrates an internal SRAM 1090, preferably organized as in 8K×8 configuration, for a low-cost, single-device operation. Additional address learning capability is achieved by using external SRAM.

The JTAG (test-access) port is comprised of five pins that are used to interface serially with the device and the board on which it is installed for boundary-scan testing compliant with the IEEE 1149.1 standard. This device 1000 operates like the network chip 200 for TJAG, as described earlier herein.

The Tables 1-10 below list the pins and their functions. Pin names use the convention of indicating active low signals with a # character.

TABLE 1

| | |
|---|---|
| in | An input only pin |
| out | An output only pin. |
| t/s | Tri-state I/O pin. |
| s/t/s | Sustained Tri-state pin. |
| o/d | Open Drain output pin. |

External Address Match Interface Pins

| Pin | Name | Type | Function |
|---|---|---|---|
| | EAM_15 | out | Single_Port_Code/VLAN_Code Select. Selects the coding |
| | | | on theEAM_[14:0] pins. |
| | | | When high, the EAM interface contains a single port |
| | | | routing mode code. |
| | | | When low, the EAM interface contains a multiple port |
| | | | routing mode code (VLAN) |
| | EAM_[14:0] | out | Port Select Pins. Port routing signal to ThunderSWITCH |
| | | | When EAM_5 is low, the EAM_[14:0] pins contain the |
| | | | multiple port routing code (VLAN) that tells |
| | | | ThunderSWITCH the multiple ports to which the frame |
| | | | should be routed. The bit number on the EAM_[14:0] |
| | | | bus has a one to one correspondence to the port number. |
| | | | A one on the bit signifies that the frame should |
| | | | be routed to that port |
| | | | A zero on the bit signifies that the frame should |
| | | | not be routed to that port |
| | | | When EAM_15 is high, the EAM_[14:0] interface is |
| | | | placed in a single port mode. In this mode the |
| | | | EAM_[4:0] pins encode a single port to which the frame |
| | | | will be routed. |

When EAM_{—}15 is high, the EAM_{—}[4:0] pins will be encoded to select the single port to which the frame should be routed. EAM[14:5] are considered as don't cares by ThunderSWITCH 200 and will be set to zero. The single port EAM[4:0] coding is given below:

TABLE 2

| ThunderSWITCH | EAM_[4:0] (EAM_15 = ‘1’) |
|---|---|
| port | x = don't care |
| Port 0 (Uplink) | 00000 |
| Port 1 | 00001 |
| Port 2 | 00010 |
| Port 3 | 00011 |
| Port 4 | 00100 |
| Port 5 | 00101 |
| Port 6 | 00110 |
| Port 7 | 00111 |
| Port 8 | 01000 |
| Port 9 | 01001 |
| Port 10 | 01010 |
| Port 11 | 01011 |
| Port 12 | 01100 |
| Port 13 | 01101 |
| Port 14 | 01110 |
| Broadcast | 01111 |
| Discard Frame | 1xxxx |

When EAM_{—}15 is low, the EAM[14:0] pins will encode the multiple ports to which the frame will be routed (VLAN). Pin number assignments have a one-to-one correspondence with port number as shown in the following:

TABLES 3-10
EAM bus

| 14 | 13 | 12 | 11 | 10 | 9 | 8 | 7 | 6 | 5 | 4 | 3 | 2 | 1 | 0 |
|---|---|---|---|---|---|---|---|---|---|---|---|---|---|---|
| Port | Port | Port | Port | Port | Port | Port | Port | Port | Port | Port | Port | Port | Port | Port |
| 14 | 13 | 12 | 11 | 10 | 9 | 8 | 7 | 6 | 5 | 4 | 3 | 2 | 1 | 0 |

| | | | |
|---|---|---|---|
| Pin | Name | Type | Function |

ThunderSWITCH DRAM Interface Pins

| | | |
|---|---|---|
| DD_[35:0] | in | DRAM Data Bus. Data bus sourced by ThunderSWITCH. |
| DRAS | in | DRAM Row Address Select. Sourced by ThunderSWITCH. |
| DCAS | in | DRAM Column Address Select. Sourced by |
| | | ThunderSWITCH. |
| DWE | in | DRAM Write Enable. Sourced by ThunderSWITCH. |

EALE's SRAM Interface Pins

| | | |
|---|---|---|
| EA_[19:0] | out | SRAM Address Bus. External SRAM address bus |
| ED_[15:0] | in/out | SRAM Data Bus. External SRAM data bus. |
| EOE# | out | SRAM Output Enable. External SRAM output enable signal. |
| | | (Output enable is active low) |
| EWE# | out | SRAM Write Enable Signal. External SRAM write enable |
| | | signal. (Write enable is active low) |

DIO Interface Pins

| | | |
|---|---|---|
| SDATA_[7:0] | in/out | DIO Data Bus. Byte wide bi-directional DIO port. |
| SAD_[1:0] | in | DIO Address Bus. The SAD signals select EALE's host |
| | | registers |
| SRNW | in | DIO Read/Not Write. Read or write select signal. |
| | | When high, read operation is selected |
| | | When low, write operation is selected |
| SRDY# | out | DIO Ready Signal. When low this signal has the following |
| | | meaning: |
| | | When reading (SRNW = 1), indicates to the host when |
| | | data is valid to be read |
| | | When writing (SRNW = 0), indicates when data has been |
| | | received |
| ESCS# | in | EALE DIO Chip Select. When low this indicates a port access |
| | | is valid for the EALE device. This signal should not be tied to |
| | | any other DIO Chip Select signal (i.e. ThunderSWITCH's Chip |
| | | Select signal SCS#) |
| EINT | out | Interrupt. Interrupt from the EALE to the attached |
| | | microprocessor. The interrupt type can be found from the Int |
| | | register. |

Serial MII Management Interface Pins/EEPROM Pins

| | | |
|---|---|---|
| MDIO | in/out | MII Management Data I/O: Serial management interface data |
| | | to/from the EALE device. The MDIO signal requires an |
| | | external pullup resistor for proper operation. The MDIO |
| | | signal can be disabled (Hi-Z) through the use of the SIO |
| | | register. |
| MDCLK | out | MII Management Data Clock: Serial management interface |
| | | clock from the EALE device |
| MRESET# | out | MII Management Reset: Serial management interface reset |
| | | signal. |
| EDIO | in/out | EEPROM Data I/O. Serial EEPROM Data I/O signal requires |
| | | an external pullup for EEPROM operation. |
| ECLK | out | FEPROM Data Clock. Serial EEPROM clock signal |

Control Pins

| | | |
|---|---|---|
| DREF | in | Oscillator Input. The EALE's clock input (50 Mhz). |
| RESET# | in | Reset. The EALE's reset signal (active low) |

JTAG Interface Pins

| | | |
|---|---|---|
| TRST# | in | Test Reset Pin: Used for Asynchronous reset of the test port |
| | | controller. |
| TMS | in | Test Mode Select Pin: Used to control the state of the test |
| | | port controller |
| TCLK | in | Test Clock Pin: Used to clock state information and test data |
| | | into and out of the device during operation of the test port |
| TDI | in | Test Data Input Pin: Used to serially shift test data and test |
| | | instructions into the device during operation of the test port. |
| TDO | out | Test Data Output Pin: Used to serially shift test data and test |
| | | instructions out of the device during operation of the test port. |

Power Pins

| | | |
|---|---|---|
| Vdd | pwr | Logic Power Pin 3.3V |
| Vss | pwr | Logic Ground Pin |

EALE's operational modes are selected through the Control register. Bits in the control register are used to control decision points in the state machines. The modes available are NAUTO, BVLAN, MVLAN, NIOB, NLRNO and NCRC.

The Not Automatically Add address (NAUTO) mode is implemented to give the management CPU complete control of the lookup table. It does so by disabling the two automatic processes that can affect the lookup table—wire additions and aging.

NAUTO mode disables wire ADDs. The only way addresses can be added in this mode is through the DIO interface. However the add state machine still performs a lookup on the table to determine if the address exists or has changed ports. If the address does not exist, it communicates this to the host through an interrupt.

NAUTO also affects the AGE state machine by disabling it. It is the management's responsibility in this mode to maintain the addresses in the lookup table. Table full conditions can be determined through a FULL interrupt.

Broadcast VLAN (BVLAN) and Multicast VLAN (MVLAN) modes are used to enable the port-based VLAN operations. BVLAN mode affects only routing to the broadcast address 0xFF.FF.FF.FF.FF.FFh. MVLAN mode affects addresses with the multicast bit set, bit 40, but not the broadcast address. These modes affect the LKUP state machine only.

The Not In Order Broadcast (NIOB) mode is intended to avoid using IOB lists in the network chip of the present invention. It is meant to be a performance boosting feature. It does so by replacing any VLAN codes with the single port broadcast code of 0x800Fh. The tradeoff in NIOB mode is that VLAN is not supported and frames that would ordinarily be transmitted to a limited number of ports are now transmitted to all ports. This mode affects the LKUP state machine only.

The No Learn addresses from port 0 (NLRN0) mode is used to disable automatic wire learning from port 0—the uplink port. This mode is useful in applications that make use of the network chip's MUX and wide uplink capabilities. This mode only affects the wire ADD process. The No add-on-good-CRC (NCRC) mode is intended to disable EALE's add-on-only-good-CRC functionality. It is a performance boosting feature for the ADD state machine and it allows it to perform more add operations in the same amount of time. This allows EALE to be better able to add and keep the aging time stamp current on nodes that do not talk frequently on the network—and thereby avoiding unnecessary aging. The tradeoff in this mode is the possibility that corrupt addresses can be added into the lookup table; this condition however does not become critical as the AGE state machine will soon age these addresses.

The lookup table is automatically initialized by EALE without the need for an external processor. The steps for initializing are simple:

Write to RAMSize the size of the attached SRAM (or 0x05h) if using internal SRAM only. Writing to RAMSize can be performed by a CPU or written to the EEPROM.

Assert the START bit in the Control register. Again, this is accomplished either by CPU or EEPROM.

EALE will indicate the completion of the lookup table initialization by asserting the INITD bit in Control.

EALE will clear the lookup table by writing 0x0000h to all available locations. EALE also queues the lookup table. After these operations are done, EALE will automatically start lookups, adding and aging addresses.

The LKUP state machine is designed for two very important tasks: perform time-critical lookups off the wire within ThunderSWITCH's allotted time and forward the frame to the right ports. The LKUP state machine works independently from all other state machines and from the management CPU. Also, to meet the timing requirements, this state machine occupies the highest priority on the SRAM bus.

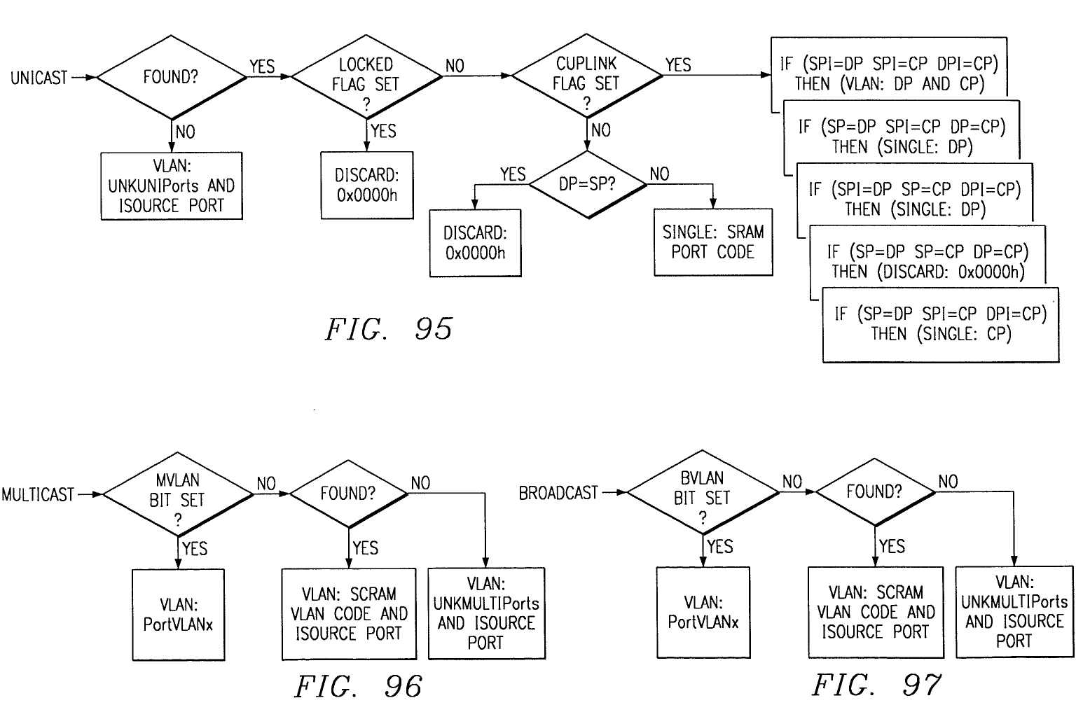

The LKUP state machine performs a lookup on the destination address of the frame and routes traffic accordingly. It can also route frames depending on the port the frame was sourced. The LKUP state machine also routes unicast and multicast destined frames differently. The registers that affect routing options are UNKUNIPorts, UNKMULTIPorts, Control, the PortVLAN registers and the UPLNKPort register. Moreover, the LOCKED and CUPLNK bits contained in the lookup table also affect the routing options. FIGS. 95-97 illustrates how the LKUP table forwards frames.

In FIG. 95, the “Single” label is used to indicate a single-port coding style EAM_{—}15=‘1’. The “VLAN” label is used to indicate when EALE uses a bit-map coding style EAM_{—}15=‘0’. Single port coding styles are used whenever possible to avoid the IOB lists that VLAN style codings generate. EALE must also mask out the source port on all routing codes.

In FIG. 95, the ‘SP’ code refers to the Source Port. The “DP” code refers to the Destination Port, and the “CP” code refers to the Copy Port. The copy port is selected through the UPLNKPort register. The Discard code used is 0x0000h. One additional step not shown in FIG. 94 is when the NIOB bit in Control is set. The NIOB bit disables all VLAN codings and replaces them with the single-port broadcast code of 0x800Fh. The Discard code remains at 0x0000h.

Referring now to FIG. 95, it may be seen the process that the look-up state machine employs if the message is a unicast message. More particularly, if the message is a unicast message, then the state machine looks for an address. If it finds an address, it then checks to see if the locked flag is set for that particular address. If the answer is yes, the message is discarded. If the answer is no, then the copy uplink flag is checked to see if it is set. If the answer to that is no, then it checks to see if the destination address is the same as the port address and if the answer is no then it uses a single source coding. If the answer to that is yes, then the message is discarded.

If the address is not found, then the unicast message is sent using the VLAN mode. If the locked flag is set, then the message is discarded. If the copy uplink flag is set, then there are five different conditions that must be evaluated. Basically the state machine determines if the source port is the same as the destination port or the copy port and determines if the destination port is the same or different than the copy port. The designation of the copy port is basically keyed to the uplink port or register. In FIG. 95 where there are the five choices depending upon what the source port, destination port and copy port are, there is a bar that looks like a one that is used to indicate a not. If all three ports are different, then the VLAN mode is used and it is sent to the destination port and a copy port. If all three ports are the same, then it is discarded. Otherwise, depending upon the circumstances as either a single port coding to the destination port in two cases or the copy port in one case.

Referring now to FIG. 96, this indicates the steps that the state machine employs if the message is a multicast message. More particularly, if it is a multicast message, the MVLAN bit is checked. If it is set, then the state machine uses the VLAN addressing technique to send the message. If it is not set, then it determines if an address is found. If the answer is yes, then it again uses the VLAN for the SRAM and the VLAN code if it is not the source port. If it is not found that it uses the VLAN address but it uses the unknown multiports and not the source port.

Referring now to FIG. 97, there may be seen the steps the state machine employs if it is a broadcast message. More particularly, it may be seen that the BVLAN bit is checked to see if it is set. If the answer is yes, then again the VLAN routing is employed. If the answer is no, it checks to see if there is an address. If the address is found then the VLAN routing for the SRAM is used for the VLAN code and to the source port. If not found, then the VLAN routing is used using the unknown multiports and not the source port.

The FIND state machine 1077 is designed to give the programmer a simple way to find an address or addresses within the lookup table. The FIND state machine is controlled from the following internal registers:

| Byte 3 | Byte 2 | Byte 1 | Byte 0 | DIO Address |
|---|---|---|---|---|
| FindNode | FindNode | FindNode | FindNode | 0x0Ch |
| [23:16] | [31:24] | [39:32] | [47:40] | |

| | | | |
|---|---|---|---|
| FindVLAN/Port | FindNode | FindNode | 0x10h |
| | [7:0] | [15:8] | |

| | | |
|---|---|---|
| FindControl | FindNodeAge | 0x14h |

The interface provides 48 bit read or writeable register FindNode in which the address will be placed, a 16-bit register FindVLAN/Port in which routing information will be placed and a 16-bit register FindNodeAge which contains the age of the node being looked-up. Three commands are available to the programmer—FindFirst, FindNext and Find. They are selected in the FindControl register.

The state machine will perform the command given to it, and it if successfully finds a node it will indicate so by asserting the FOUND bit in FindControl. The FOUND bit indicates that the information in FindNode, FindVLAN/Port and FindNodeAge registers is valid. During the command execution the state machine will lock the registers and not allow reads or writes. Determining when the operation is finished then becomes just a simple task of reading the register since EALE will return the register's data only after the command has completed.

The Find command finds a specific user-defined address in the lookup table. The procedure for the Find command is as follows:

Write the 48 bit address to be queried in the FindNode register

Set the LKUP bit in FindControl. EALE will lock the registers then scan the lookup table for that particular address.

Read the FindControl register. If FOUND is set then the address was found and the node's information placed in the registers. If FOUND is not set then the address was not found within the lookup table.

The FindFirst command finds the first address contained in the lookup table. The procedure for the Find command is as follows: Set the FIRST bit in FindControl. No write to FindNode is required. EALE will lock the registers then scan the lookup table for the first address. Read the FindControl register. If FOUND is set then an address was found and the node's address and information is placed in the registers. If FOUND is not set then an address was not found and the lookup table is empty.

The FindNext command finds the next address from that contained in FindNode. The user can either write a value in FindNode and find the next address or keep the current value and continue finding next addresses. The procedure for the Find command is as follows:

Write the starting address in FindNode (if desired) or keep the currently held address.

Set the NEXT bit in FindControl. EALE will lock the registers then scan the lookup table for the next address after the one contained in FindNode.

Read the FindControl register. If FOUND is set then the next address was found and the node's address and information is placed in the registers. If FOUND is not set then there are no more addresses from this node to the end of the table.

The three commands can be combined to quickly dump the address table. All that is required is a FindFirst followed by FindNext commands until no more addresses are found.

The ADD state machine 1075 is responsible for new address additions to the lookup table, address port changes, modifying the information stored in the lookup table and keeping the address' time-stamp current. EALE implements a single ADD state machine and shares it between automatic adds from the wire and register based additions. EALE prioritizes wire adds over management adds. However it will complete an add request before starting another.

The ADD process is summarized as follows:

ADD performs a lookup to determine if the address exists in the table.

If the address exists, ADD verifies that the port assignment has not changed If the port assignment changes, ADD will update the port. In all cases ADD will update the age stamp.

If the address does not exist, ADD will add the address to the table with the current time stamp.

Adding an address requires the use of lookup tables. The possibility arises that during the adding process no more lookup tables will be available for address additions. In this situation, ADD will kick off AGE, and AGE will delete the oldest address. A FULL interrupt will then be indicated.

The Bus Watcher state machine works closely with the ADD state machine to automatically add addresses from the wire. On wire adds, the ADD state machine will signify the following interrupts:

NEW and NEWM interrupts will be indicated when a new address is found.

CHNG and CHNGM interrupts will be indicated when the address is not new but the port assignment has changed.

SECVIO and SECVIOM interrupts will be indicated when the address is not new, the port assignment has changed and the address was secured.

The following indicate Control options that affect the ADD state machine.

Not Automatically Add (NAUTO) mode is selected by asserting the NAUTO bit in Control. In NAUTO mode the ADD state machine will not add addresses off the wire. The only manner in which addresses can be added is through the register interface.

ADD performs limited functions in NAUTO mode. It still determines if the address exists within the table, but it does not add it if it is not. ADD also verifies port changes, but it does not change ports automatically. ADD still provides NEW, NEWM, CHNG, CHNGM, SECVIO and SECVIOM interrupts to the host in this case.

The ADD state machine will not add addresses from port 0 when the NLRN0 bit in Control is set. The Bus Watcher will not extract these addresses from the DRAM bus. In this mode, the management CPU can still add an address with the port assignment being 0. Since the Bus Watcher does not provide addresses from port 0 to ADD, ADD does not perform any age touches to any addresses in the lookup table from port 0.

The NCRC bit (No CRC) controls whether the Bus Watcher will wait for a complete valid CRC'd frame before giving it to ADD. EALE will perform additions faster in NCRC mode since it does not have to wait for the Good_CRC indication to go by on the bus. There is a possibility that addresses from bad CRC'd frames will be added, but the aging process will delete them eventually.

The ADD state machine 1075 can also add addresses through the DIO interface's Management Add/Edit Address Interface registers.

| Byte 3 | Byte 2 | Byte 1 | Byte 0 | DIO Address |
|---|---|---|---|---|
| | | | AddDelCon | 0x2Ch |
| | | | trol | |
| AddNode | AddNode | AddNode | AddNode | 0x38h |
| [23:16] | [31:24] | [39:32] | [47:40] | |

| | | | |
|---|---|---|---|
| AddVLAN/Port | AddNode | AddNode | 0x3Ch |
| | [7:0] | [15:8] | |

Management adds are used to perform the following functions. The address' flags SECURE, LOCKED and the copy uplink flag, CUPLINK, can be set or cleared through management adds. DIO adds can be used to change the address' port assignment. DIO adds is also the only way multicast and broadcast addresses can be added to the lookup table. DIO adds also writes the current age stamp for the node.

Management add commands are given through the ADD bit in the AddDelControl register. The steps for adding an address is as follows:

Write the node's address in the AddNode registers.

Write the node's flag information and port assignment in AddVLAN/Port if it is a unicast address or . . . Write the node's flag information and port assignment in AddVLAN/Port if it is a unicast address

Assert the ADD bit in AddDelControl.

The ADD state machine will now lock the AddNode and AddVLAN/Ports to ensure that they do not change during the address add. Reads to these registers are still possible. The ADD bit in AddDelControl will remain “stuck” to one until the add is complete.

Having a sticky bit for ADD gives the programmer the opportunity to set-up or perform other register operations without having to wait for the add completion. A polling method is used to find out if the add is finished. This involves reading AddDelControl to determine if the ADD bit has gone low.

There is no significant change when adding unicast and multicast addresses. The method described above still applies. There is however one difference that the programmer must be aware of. EALE stores information for multicast addresses in a different format than that for unicast addresses. Unicast addresses use a four bit code which stores the port number and three flag bits. Multicast addresses store a 15-bit VLAN code.

Both data formats are added through the AddVLAN/Ports register. The format for this register, therefore changes depending on the type of address added. EALE will consider as a multicast any address that has its AddNode[40] bit set to ‘1’.

EALE implements two ways in which to delete addresses from the lookup table. A manageless aging algorithm and through the DIO interface. The DEL state machine 1073 is responsible for deleting addresses from the lookup table. DEL takes its information from the DIO registers for DIO deletes and from the AGE state machine for aging deletes.

EALE implements a 16 bit timer incrementing every second for the aging process. This timer is used to write the time-stamp during adds and for comparing ages.

The AGE state machine 1079 is responsible for automatic address deletes. EALE implements two styles of aging: time-threshold aging and table-full aging. The aging style is selected through the AgingTimer register. A value of 0x0000h or 0xFFFFh in the AgingTimer register selects table-full aging. Any other value selects time-threshold aging. The AGE state machine is disabled whenever EALE is placed in NAUTO mode.

The aging process works as follows:

[image]

AGE scans the table for the oldest address (state=Find Oldest state). AGE determines the oldest address by finding the address in the lookup table with the lowest time-stamp. If more than one address has the same oldest time-stamp, AGE will pick the first address.

The AGE scanning process skips all multicast addresses and unicast addresses which have been secured by having the SECURE flag set. These addresses can only be deleted through a DIO delete command.

Once the oldest address is found, AGE will keep this address, enter a waiting state (state=Wait for Condition) and wait until one of two conditions occur. If the address table has undergone a change by either the ADD state machine performing an address addition/time-stamp update or by DEL deleting an address. AGE will scan the table for the address it considers oldest (state=Scan state). If it determines that ADD has changed this address' time-stamp it then must re-scan the table for a new oldest address (state=Find Oldest). If DEL has deleted this address it again must re-scan the table for a new oldest address (state=Find Oldest). If neither has touched the oldest address then it still remains the oldest address and AGE returns to the wait state (state=Wait for Condition).

The aging condition is met. In this case AGE will call upon the DEL state machine to delete the node from the table. After a successful deletion, AGE will re-scan the table for the next node to age (state=Find Oldest) and then give an interrupt to the host.

The aging condition is different for time-threshold aging and table-full aging and they are discussed below. In time-threshold aging, the aging condition occurs when the address' age is larger than the time threshold entered in AgingTimer. The address' age is not the time-stamp written in the SRAM but the value in the 16 bit timer—time stamp. When this value becomes greater than AgingTimer the address is deleted.

As an example: If the timer is currently at 256₁₀ seconds (0x0100h), the node to be deleted was last time stamped when the timer read 80₁₀ seconds (0x0050h) and if the AgingTimer register is set to age addresses larger than 192₁₀ seconds (0x00C0h). The node would not be aged yet since the node's age (0x0100h−0x0050h=0x00B0h=176₁₀) is less than 0x00C0h. It would take an additional 0x0010h (16₁₀) seconds for the age to hit the threshold of 0x00C0h, and the address to get aged.

Table-full aging was implemented for applications which do not want to use aging based on time, but still require aging. As its name implies, aging in this mode only happens when the lookup table is full and needs additional room to add a new address. The ADD state machine will kick off an aging request when it determines that it does not have enough tables to add the address it currently is working on.

The timer behaves differently in this mode. In table full aging the age timer does not increment every second but whenever a new address is added. Since ADD time-stamps every time it sees a node come through the bus, nodes which are actively transmitting will quickly move up to the new age level. Those nodes that do not transmit will remain at the lower age-stamps. It is exactly these nodes that will get deleted in table-full aging.

The Table below shows the bytes in the DelNode register for controlling the DEL state machine.

| Byte 3 | Byte 2 | Byte 1 | Byte 0 | DIO Address |
|---|---|---|---|---|
| | | | AddDelControl | 0x2Ch |
| DelNode | DelNode | DelNode | DelNode | 0x48h |
| [23:16] | [31:24] | [39:32] | [47:40] | |

| | | |
|---|---|---|
| DelNode | DelNode | 0x4Ch |
| [7:0] | [15:8] | |

The DEL state machine may be controlled through the DelNode registers and the AddDelControl register. Management delete commands are given through the DEL bit in the AddDelControl register. The steps for deleting an address are as follows:

Write the node's address in the DelNode registers.

Assert the DEL bit in AddDelControl.

The DEL state machine 1073 will now lock the DelNode registers to ensure that they do not change during the address add. Reads to these registers are still possible. The DEL bit in AddDelControl will remain “stuck” to one until the add is complete.

Much like the management adds, having a sticky bit for DEL gives the programmer the opportunity to set-up or perform other register operations without having to wait for the delete completion. A polling method is used to find out if the delete is finished. This involves reading AddDelControl to determine if the DEL bit has gone low.

EALE implements interrupts to ease the management processor's tasks. The interrupts are used to indicate changes to the lookup table. It indicates when a new address has been added, when an address has changed ports, when an address has changed ports and the address was secured and when an address has been deleted due to the aging process. It also indicate when the lookup table is full, when the statistic registers are half full and the possibility for an overflow is present.

The Int register is readable at all times and contains all the current EALE interrupts. The Int register clears all interrupts when the MSB of the register is read. Reading the MSB will also cause the LSB of the register to clear.

EALE will indicate interrupts to the CPU by asserting its EINT pin. The EINT pin will be asserted whenever any of the possible interrupt conditions is met. The programmer may be interested in processing some interrupts now while leaving the others for a later time.

EALE will also mask out interrupts. This is accomplished through a masking register, IntMask. The Int and IntMask registers have a one-to-one correspondence. The only manner in which EINT will be asserted is if both Int and IntMask both have a one. The logic for the interrupt masking is shown below.

[image]

Test interrupts are generated by asserting the INT bit in the Int register. The INT bit in IntMask must be set to a one for the interrupt to take effect. The TNT bit was put in place to give the programmer an easy way to test interrupt detection. This bit is the only bit in the Int register that is writeable. It is also cleared when the MSB of the Int register is read.

| Byte 3 | Byte 2 | Byte 1 | Byte 0 | DIO Address |
|---|---|---|---|---|
| NewNode | NewNode | NewNode | NewNode | 0x30h |
| [23:16] | [31:24] | [39:32] | [47:40] | |

| | | | |
|---|---|---|---|
| NewPort | NewNode | NewNode | 0x34h |
| | [7:0] | [15:8] | |

Add interrupts are sourced by the ADD state machine only when performing additions from the wire. ADD will indicate a new address being added by a NEW interrupt, an address changing ports by a CHNG interrupt and a security violation by a SECVIO interrupt. The FULL interrupt indicates that ADD needed to start AGE to free up some table space.

The add interrupts are indicated in Int and the information for the particular interrupt is placed in the NewNode and NewPort register. Since there is only one set of registers that is shared for these interrupts and to ensure that the information placed in these registers is not corrupted during reads, ADD will lock the NewNode and NewPort registers.

Locking these registers means that ADD does not have a place to put information on new events. These events will be missed and they are indicated in the Int register as missed interrupts (NEWM, CHNGM, SECVIOM). The registers are unlocked when the MSB of NewPort is read. The NewPort register contains information about the port on which the address was added. On a CHNG interrupt this register also gives information on which port the address was moved from. On a SECVIO interrupt the address does not move port, but the NewPort register indicates to what port it has tried to move to.

| Byte 3 | Byte 2 | Byte 1 | Byte 0 | DIO Address |
|---|---|---|---|---|
| AgedNode | AgedNode | AgedNode | AgedNode | 0x40h |
| [23:16] | [31:24] | [39:32] | [47:40] | |
| | AgedPort | AgedNode | AgedNode | 0x44h |
| | | [7:0] | [15:8] | |

Aging interrupts are sourced by the AGE state machine. AGE will indicate an interrupt every time that it has aged out a node. It places the information on the node being aged out on the AgedNode and AgedPort registers. These registers will be locked whenever a new interrupt is given in order to protect the information contained.

Missed interrupts due to these registers being locked will be indicated as a AGEM interrupt. These registers will be unlocked whenever the AgedPort register is read.

The statistic interrupt is given whenever one of the statistic registers (except for NumNodes) becomes half-full—the most significant bit becomes a ‘1’. This is an indication to the management CPU that the statistic registers must be read, therefore clearing them.

EALE is designed to store its lookup table in either its internal 8K×8 SRAM 1090 or to an external SRAM 1600. EALE runs its SRAM interface at 25 MHz to enable the use of low-cost 20 ns external SRAM's Each external SRAM access requires 40 ns of time.

The following diagram shows an external SRAM read cycle.

[image]

The following diagram shows an external SRAM write cycle.

The following is a list of EALE registers and their functions. All registers are set to their default values on a hardware reset (de-asserting the RESET# pin). All registers, except the Control register, are also set to their default values on a software reset (asserting the RESET bit in the Control register). The following key is used when defining bit names and functions:

r A readable bit

w A writeable bit

wp A write protected bit. It can only be written to when the START bit in the Control register is zero.

ac An auto-clearing bit. Reading this bit will clear the value stored in this bit.

al An autoloading bit. This bit is auto-loaded from a EEPROM on a hardware reset (RESET#=‘0’) or when the LOAD bit in the Control register is set.

D Default value.

TABLE 11
Host Registers

| | SAD_1 | SAD_0 |
|---|---|---|
| DIO_ADR_LO | 0 | 0 |
| DIO_ADR_HI | 0 | 1 |
| DIO_DATA | 1 | 0 |
| DIO_DATA_INC | 1 | 1 |

TABLE 12
DIO Address Register DIO_ADR

| DIO_ADR_HI | | | | | | | | DIO_ADR_LO | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

ADR_SEL

| Bit | Name | Function |
|---|---|---|
| | DR_SEL | Address Select. (r/w/D:O) This field contains the internal DIO |
| | | address to be used on subsequent accesses to the DIO_DATA |
| | | or DIO_DATA_INC registers This field will be post increment by |
| | | one on all accesses to the DIO_DATA_INC register. The M.S. 9 |
| | | bits (15 to 7) are ignored. The L.S. 7 bits (6 to 0) indicate the DIO address |
| | | of the register. |

The DIO_ADR_HI register is ignored for EALE register accesses. It is implemented so that EALE's Host register space matches that of ThunderSWITCH. In this manner accessing the register locations for both devices is done in the exact manner. DIO Data Register DIO_DATA

The DIO_DATA register address allows indirect access to internal EALE registers and SRAM. There is no actual DIO_DATA register. Accesses to this register are mapped to an internal bus access at the address specified in the DIO_ADR register.

DIO Data Increment Register DIO_DATA_INC

The DIO_DATA_INC register address allows indirect access to internal EALE registers and SRAM. There is no actual DIO_DATA_INC register. Accesses to this register are mapped to an internal bus access at the address specified in the DIO_ADR register. Accesses to this register cause a post, increment of the ADR_SEL field of the DIO_ADR register.

Table 13 below provides a map of the internal registers.

TABLE 13

| Byte 3 | Byte 2 | Byte 1 | Byte 0 | DIO Address |
|---|---|---|---|---|
| AgingTimer | | RAMSize | Revision | 0x00 |
| UNKMULTIPorts | | UNKUNIPorts | | 0x04 |
| | SIO | Control | | 0x08 |
| FindNode | FindNode | FindNode | FindNode | 0x0c |
| [23:16] | [31:24] | [39:32] | [47:40] | |
| FindVLAN/Port | | FindNode | FindNode | 0x10 |
| | | [7:0] | [15:8] | |
| SECVIOCtr | FindControl | FindNodeAge | | 0x14 |
| UNKMULTIctr | | UNKUNICtr | | 0x18 |
| | | NumNodes | | 0x1c |
| MANtest | RAM_addr | | | 0x20 |
| | | RAM_data | | 0x24 |
| IntMask | | Int | | 0x28 |
| | | | AddDelControl | 0x2c |
| NewNode | NewNode | NewNode | NewNode | 0x30 |
| [23:16] | [31:24] | [39:32] | [47:40] | |
| NewPort | | NewNode | NewNode | 0x34 |
| | | [7:0] | [15:8] | |
| AddNode | AddNode | AddNode | AddNode | 0x38 |
| [23:16] | [31:24] | [39:32] | [47:40] | |
| AddVLAN/Port | | AddNode | AddNode | 0x3c |
| | | [7:0] | [15:8] | |
| AgedNode | AgedNode | AgedNode | AgedNode | 0x40 |
| [23:16] | [31:24] | [39:32] | [47:40] | |
| | AgedPort | AgedNode | AgedNode | 0x44 |
| | | [7:0] | [15:8] | |
| DelNode | DelNode | DelNode | DelNode | 0x48 |
| [23:16] | [31:24] | [39:32] | [47:40] | |
| | | DelNode | DelNode | 0x4c |
| | | [7:0] | [15:8] | |

| | | |
|---|---|---|
| PortVLAN1 | PortVLAN0 | 0x50 |
| PortVLAN3 | PortVLAN2 | 0x54 |
| PortVLAN5 | PortVLAN4 | 0x58 |
| PortVLAN7 | PortVLAN6 | 0x5c |
| PortVLAN9 | PortVLAN8 | 0x60 |
| PortVLAN11 | PortVLAN10 | 0x64 |
| PortVLAN13 | PortVLAN12 | 0x68 |
| UPLINKPorts | PortVLAN14 | 0x6c |

The registers shown shaded are auto-loaded from the attached EEPROM when the LOAD bit in Control is set or when EALE is hardware reset by de-asserting the RESET# pin.

The Flash EEPROM interface is provided so the system level manufacturer can optionally provide a pre-configured system to their customers. Customers may also wish to change or reconfigure their system and retain their preferences between system power downs.

The Flash EEPROM will contain configuration and initialization information which is accessed infrequently, typically only at power up and reset.

EALE will use the standard 24C02 serial EEPROM device (2048 bits organized as 256×8). This uses a two wire serial interface for communication and is available in a small footprint package. Larger capacity devices are available in the same device family, should it be necessary to record more information.

Programming of the EEPROM can be effected in two ways:

It can be programmed, via the DIO/host interface using suitable driver software.

It can be programmed directly without need for EALE interaction by suitable hardware provision and host interfacing.

The organization of the EEPROM data roughly follows the same format as EALE registers. The last register loaded is the Control register. This allows a complete initialization to be performed by down loading the contents of the EEPROM into EALE. During the download, no DIO operations are permitted. The LOAD and RESET bits in Control cannot be set during a download, preventing a download loop.

EALE will detect the presence/absence of the EEPROM. If it is not installed the EDIO pin should be tied low. For EEPROM operation the pin will require an external pull up (see EEPROM data-sheet). When no EEPROM is detected EALE will assume default modes of operation at power up, downloading of configuration from the EEPROM pins will be disabled when no EEPROM is present.

The first bit written to or read from the EEPROM is the most significant bit of the byte, i.e. data(7). Therefore, writing the address 0xC0h is accomplished by writing a ‘1’ and then ‘1’, ‘0’, ‘0’, ‘0’, ‘0’, ‘0’, ‘0’.

EALE expects data to be stored in the EEPROM in a specific format. The range from 0x00h to 0x2Ah in the EEPROM are reserved for use by the adapter. The contents of the remaining bytes are undefined. The EEPROM can also be read/written by driver software through the SIO Register.

A 32-bit CRC value must be calculated from the EEPROM data and placed in the EEPROM. EALE uses this 32-bit CRC to validate the EEPROM data. If the CRC fails, EALE registers are set to their default (hardwired) values. EALE will be then placed in a reset state.

The revision register contains the revision code for the device. The initial revision code is 0x01h. This register is read-only and writes to it will be ignored.

TABLE 14
RAMSize Register

| Bit | | | | | | | |
|---|---|---|---|---|---|---|---|
| 7 | 6 | 5 | 4 | 3 | 2 | 1 | 0 |

| | | |
|---|---|---|
| NINT | Reserved | RSIZE |

| Bit | Name | Function | |
|---|---|---|---|
| 7 | NINT | Not Internal SRAM. (r/wp/al/D:0) Asserting this bit allows the | |
| | | use of external SRAM for the lookup tables. | |
| 6 | Reserved | (r/D:0) Writes to this location are ignored and will be read as zero | |
| thru | | | |
| 4 | | | |
| 3 | RSIZE | RAM Size Select. (r/wp/al/D:0) This field indicates the size of the | |
| thru | | SRAM, and therefore the number of addresses that the EALE | |
| 0 | | will support This field is used by EALE to determine how many tables | |
| | | to initialize. | |
| | | Note: This field is auto-loaded from an EEPROM. | |
| | | Code values are: | |
| | | 0x0 | 576x8 int |
| | | 0x1 | 832x8 int |
| | | 0x2 | 1Kx8 int |
| | | 0x3 | 2Kx8 int |
| | | 0x4 | 4Kx8 int |
| | | 0x5 | 8Kx8 int |
| | | 0x6 | 16Kx9 ext |
| | | 0x7 | 32Kx10 ext |
| | | 0x8 | 64Kx11 ext |
| | | 0x9 | 128Kx12 ext |
| | | 0xa | 256Kx13 ext |
| | | 0xb | 512Kx14 ext |
| | | 0xc | 1Mx15 ext |
| | | 0xd-0xf | 2Mx16 ext |

The RAMsize register can only be written to when the START bit in Control is set to zero. The default value of this register at RESET is 0x00h. This register is auto-loaded from the EEPROM when the RESET# pin is asserted low or when LOAD in Control is set.

The AgingTimer register is 16-bits wide and is used to control the aging process. There are two aging modes, and the modes are selected according to the value of this register.

When AgingTimer is zero or 0xFFFFh, EALE performs table-full-aging. EALE will age out the oldest address only when the lookup table becomes full.

When AgingTimer is not zero or 0xFFFFh, EALE performs threshold aging. The value in AgingTimer is the time threshold in seconds. All addresses which are older than this time will be aged out.

Aging will not delete addresses which have been secured, and multicast addresses are also not aged. Aging is disabled when the NAUTO bit in Control is set. It is the system managements responsibility in NAUTO mode to manage the lookup table.

This register is read/writeable and will default to 0x00h during reset. This field is also auto-loaded from the EEPROM when the RESET# pin is asserted low or when LOAD in Control is set.

Unknown Unicast Port Routing Register, UNKUNIPorts

TABLE 15

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | |
|---|---|
| Res. | UNKUNIPorts[14:0] |

The UNKUNIPorts register is used to route unicast frames whose destination address is not found within the lookup table. Normally these frames are broadcast to all ports except to the port which originated the frame. EALE uses the UNKUNIPorts register to route these frames to only selected ports. When EALE uses the UNKUNIPorts register for unicast broadcasting it increments the UNKUNICtr counter. EALE will mask out the originating port when using this register. This prevents ThunderSWITCH from forwarding the frame to its originating port.

The bit numbers in this register have a one to one correspondence with ThunderSWITCH's port number. These registers are read/writeable and are default to 0x7FFFh on reset. This register is auto-loaded from the EEPROM when the RESET# pin is asserted low or when LOAD in Control is set.

Unknown Multicast Port Routing Register, UNKMULTIPorts

TABLE 16

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | |
|---|---|
| Res. | UNKMULTIPorts[14:0] |

The UNKMULTIPorts register is used to route multicast frames whose multicast address is not found within the lookup table. Normally these frames are broadcast to all ports except to the port which originated the frame. EALE uses the UNKMULTIPorts register to route these frames to only selected ports. When EALE uses the UNKMULTIPorts register for multicast broadcasting it. increments the UNKMULTICtr counter. EALE will mask out the originating port when using this register. This prevents ThunderSWITCH from forwarding the frame to its originating port.

The bit numbers in this register have a one to one correspondence with ThunderSWITCH's port number. These registers are read/write and are default to 0x7FFFh on reset. This register is auto-loaded from an EEPROM when the RESET# pin is asserted low or when LOAD in Control is set.

Control Register

| Byte 1 | | | | | | | | Byte 0 | | | | | | | |
|---|---|---|---|---|---|---|---|---|---|---|---|---|---|---|---|
| Bit | | | | | | | | | | | | | | | |
| 15 | 14 | 13 | 12 | 11 | 10 | 9 | 8 | 7 | 6 | 5 | 4 | 3 | 2 | 1 | 0 |

| | RESET | LOAD | START | INITD | NEEPM | NAUTO | BVLAN | MVLAN | NIOB | NLRN0 | NCRC | Reserved |
|---|---|---|---|---|---|---|---|---|---|---|---|---|
| After | 0 | 0 | 0 | 0 | 0 | 0 | 0 | 0 | 0 | 0 | 0 | 00000 |
| RESET | | | | | | | | | | | | |
| No | 0 | 0 | 0 | 0 | 1 | 0 | 0 | 0 | 0 | 0 | 0 | 00000 |
| EEPROM | | | | | | | | | | | | |
| detected | | | | | | | | | | | | |
| Auto- | 1 | 0 | 0 | 0 | 1 | 0 | 0 | 0 | 0 | 0 | 0 | 00000 |
| Loading | | | | | | | | | | | | |
| Fails | | | | | | | | | | | | |

The Control register is Auto-loaded from a EEPROM when the RESET# pin is asserted low or when the LOAD bit is set. Only selected bits in this register are loaded from the EEPROM. RESET and LOAD are not loaded to prevent auto-loading loops. The two status bits, INITD and NEEPM, are also not loadable. If auto-loading fails due to the EEPROM not present, not behaving correctly, or due to a CRC error, Control will have its RESET bit set.

TABLE 17

| Bit | Name | Function |
|---|---|---|
| 15 | RESET | Reset. (w) Writing a one to this bit places the EALE in a |
| | | hardware reset state. This function sets all internal state |
| | | machines to a known state, and clears all registers (except for |
| | | Control). All data from the lookup table will be lost. This bit is |
| | | not auto-loaded from the EEPROM. If EEPROM auto-loading |
| | | fails, then this RESET bit will be set to one. |
| 14 | LOAD | Load System. (w) Writing a one to this bit starts the automatic |
| | | loading of registers from the attached EEPROM. This bit is not |
| | | auto-loaded from the EEPROM. EEPROM auto-loader clears |
| | | his bit to zero, writing a one to this bit has no effect. |
| 13 | START | Start System. (w/al) Writing a one to this bit causes the EALE to |
| | | begin operation. Whilst the SRAM tables are initialized, no |
| | | address checking will be performed. Writing a zero to this bit |
| | | has no effect. |
| 12 | INITD | RAM Initialization Done Signal. This signal becomes high when |
| | | the lookup table SRAM is initialized. EALE will begin |
| | | earning/matching addresses after this signal becomes high. |
| | | This is a read-only bit. |
| 11 | NEEPM | No External EEPROM. This bit indicates if an external EEPROM |
| | | was detected. If this bit is set then no EEPROM is present, or |
| | | EALE was unable to detect it. If this bit is set to zero, then a |
| | | EEPROM was detected. This is a read-only bit |
| 10 | NAUTO | NOT Automatically Add Address Mode Select. (w/al) This bit |
| | | selects the manner in which addresses will be added to the |
| | | lookup table. In NAUTO mode the aging state machine will be |
| | | disabled. It is management's responsibility to manage the |
| | | lookup table in this mode |
| | | When set to one, EALE will only add addresses to the lookup |
| | | table until a DIO ADD command is given to it. |
| | | When set to zero, the EALE will automatically add unknown |
| | | addresses to its lookup table. |
| 9 | BVLAN | Broadcasts to PortVLAN Routing Mode. (w/al) This bit selects |
| | | where the VLAN coding for broadcast frames is taken from. |
| | | When set to a one, EALE uses the PortVLAN register for the |
| | | port which originated the frame for the VLAN coding and the |
| | | value in the lookup table (if found). |
| | | When set to zero, EALE uses the coding in the lookup table (if |
| | | found), or the value in UNKMULTIPorts if not found. |
| 8 | MVLAN | Multicasts to PortVLAN Routing Mode. (w/al) This bit selects |
| | | where the VLAN coding for multicast frames is taken from. |
| | | When set to a one, EALE uses the PortVLAN register for the |
| | | port which originated the frame for the VLAN coding and the |
| | | value in the lookup table (if found). |
| | | When set to zero, EALE uses the coding in the lookup table if |
| | | found, or the value in UNKMULTIPorts if not found. |
| 7 | NIOB | Not In Order Broadcast Coding. (w/al) This bit disables/enables |
| | | VLAN coding on the EAM bus. It is used to enable EALE to |
| | | work with ThunderSWITCH when ThunderSWITCH is not in IOB |
| | | mode. |
| | | When set to a one, EALE uses single-port coding exclusively. |
| | | Broadcasts use the single-port code of 0x800Fh on the EAM |
| | | bus. All VLAN-coded registers as well as VLAN codes in the |
| | | lookup table are ignored |
| | | When set to zero, EALE is in its normal operation and VLAN |
| | | coding are enabled. |
| 6 | NLRN0 | NOT Learn Addresses From Port 0. (w/al) When set, EALE will |
| | | not learn addresses which originate from port 0 (Uplink). |
| 5 | NCRC | No CRC Check. (w/al) This bit enables/disables the add-on- |
| | | only-good-CRC function. |
| | | When set, EALE will add frames immediately after the Source |
| | | Address is found on the DRAM bus. No Good CRC check is |
| | | performed. |
| | | When not set, EALE waits until the EOB/EOF and a Good CRC |
| | | indication before adding addresses. |
| 4 thru 0 | Reserved | Writes to this location are ignored and will be read as zero |

Serial Interface (SIO) Register

TABLE 19
Bit

| 7 | 6 | 5 | 4 | 3 | 2 | 1 | 0 |
|---|---|---|---|---|---|---|---|
| NMRST | MCLK | MTXEN | MDATA | MDIOEN | ECLOK | ETXEN | EDATA |

| Bit | Name | Function |
|---|---|---|
| 7 | NMRST | MII NOT Reset: (r/w/D:0) The state of this pin directly controls |
| | | the state of the MRESET# line (MII Reset). |
| | | If NMRST is set to zero: The MRESET# line is asserted. |
| | | If NMRST is set to one: The MRESET# line is deasserted. |
| | | This bit is not self-clearing and must be manually deasserted. It |
| | | can be set low and then immediately set high. Note that since |
| | | every PHY attached to the MII may not have a reset pin, you |
| | | need to both do NMRST and also individually reset each PHY. |
| | | The default state of this bit is zero (MII is in reset) |
| 6 | MCLK | MII SIO Clock. (r/w/D:0) This bit controls the state of the MDCLK pin. |
| | | When set to a one MDCLK is asserted |
| | | When set to a zero MDCLK is deasserted |
| 5 | MTXEN | MII SIO Transmit Enable. (r/w/D:0) This bit is used in |
| | | conjunction with the MDATA bit to read/write information from/to |
| | | the MDIO pin. |
| | | When set to a one MDIO is driven with the value in the |
| | | MDATA bit. |
| | | When set to a zero MDATA is loaded with the value in the |
| | | MDIO pin. |
| | | Note: The MDIOEN bit must be set to drive MDIO. |
| 4 | MDATA | MII SIO Data. (r/w/D:0) This bit is used in conjunction with |
| | | MTXEN to read/write information from/to the MDIO pin. |
| | | When MTXEN is set to a one, MDIO is driven with the value |
| | | in this bit. |
| | | When MTXEN is set to a zero, this bit is loaded with the |
| | | value on the MDIO pin. |
| | | Note: The MDIOEN bit must be set to drive MDIO. |
| 3 | MDIOEN | MII SIO Data Pin Enable. (r/w/D:0) This bit enables the high-Z |
| | | control of the MDIO pin. Setting this bit to one enables MDIO |
| | | output. Setting this bits to zero places MDIO in a high-Z state. |
| | | The default state of this bit is zero (MDIO is in a high-Z state) |
| 2 | ECLOK | EEPROM SIO Clock. (r/w/D:0) This bit controls the state of the |
| | | ECLK pin. |
| | | When this bit is set to a one, ECLK is asserted. |
| | | When this bit is set to a zero ECLK is deasserted. |
| 1 | ETXEN | EEPROM SIO Transmit Enable. (r/w/D:0) This bit controls the |
| | | direction of the EDIO pin. |
| | | When set to a one, EDIO is driven with the value in the |
| | | EDATA bit. |
| | | When set to a zero, the EDATA bit is loaded with the value |
| | | on the EDIO pin. |
| 0 | EDATA | EEPROM SIO Data. (r/w/D:EDIO)This bit is used to read or write |
| | | the state of the EDIO pin. |
| | | When ETXEN is set to a one, EDIO is driven with the value in |
| | | this bit. |
| | | When ETXEN is set to a zero, this bit is loaded with the value |
| | | on the EDIO pin. |

TABLE 20
Management Table Lookup Registers

| Byte 3 | Byte 2 | Byte 1 | Byte 0 | DIO Address |
|---|---|---|---|---|
| FindNode | FindNode | FindNode | FindNode | 0x0c |
| [23:16] | [31:24] | [39:32] | [47:40] | |

| | | | |
|---|---|---|---|
| FindVLAN/Port | FindNode | FindNode | 0x10 |
| | [7:0] | [15:8] | |

| | | |
|---|---|---|
| FindControl | FindNodeAge | 0x14 |

### (Table 20)

The Management Table Lookup Registers are used to allow the management entity to find information about the node addresses contained in the table.

FindNode Registers

| Byte 3 | Byte 2 | Byte 1 | Byte 0 | DIO Address |
|---|---|---|---|---|
| FindNode | FindNode | FindNode | FindNode | 0x0c |
| [23:16] | [31:24] | [39:32] | [47:40] | |

| | | |
|---|---|---|
| FindNode | FindNode | 0x10 |
| [7:0] | [15:8] | |

The FindNode registers are used to pass addresses between the EALE and any attached microprocessor. The function of FindNode depends on the bit set in FindControl

On FIRST operations, this register will show the first address in the lookup table. Only valid when the FOUND bit in FindControl is a one.

On NEXT operations, this register will show the next address in the lookup table. Only valid when the FOUND bit in FindControl is a one.

On LKUP operations, the lookup state machine will lookup the address stored in this register. If found, the FOUND bit in FindControl will be set to a one.

The FindVLAN/Port Register returns port/VLAN assignment information for the node address contained in FindNode. The definition for the FindVLAN/Port register depends on the type of address stored in the FindNode register.

FindNode is a unicast address.

TABLE 21

| | |
|---|---|
| Byte 3 | Byte 2 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | | |
|---|---|---|---|---|---|
| VALID | SECURE | LOCKED | CUPLNK | PortCode | Reserved |

| Bit | Name | Function |
|---|---|---|
| 15 | VALID | Valid Address Indication: (r/D:0) |
| 14 | SECURE | Secured Address Indication: (r/D:0) This bit shows the security |
| | | level for the address contained in FindNode. Secure addresses |
| | | are not aged-out and cannot move ports. If an address moves |
| | | ports a security violation interrupt will be given to the host, and |
| | | the address will be locked. |
| 13 | LOCKED | Locked Address Indication: (r/D:0) This bit shows the lock status |
| | | for the address contained in FindNode. Locked addresses will |
| | | output a discard code on the EAM interface: |
| | | If M00_UPLINK# pin is set to one, EAM_[15:0] = 0x0000. |
| | | If M00_UPLINK# pin is set to zero, EAM_[15:0] = 0x8010 |
| 12 | CUPLNK | Copy Frames to Uplink Indication. (r/D:0) This bit show the |
| | | Copy Uplink status for the address contained in FindNode. |
| | | Addresses which are tagged for uplink copying use the |
| | | information in the PortCode field and the UPLINKPorts register |
| | | to route frames. |
| 11 | PortCode | Current Port for Node: (r/D:0) This field holds the current port for |
| thru | | the unicast address shown in FindNode. |
| 8 | | |
| 7 | Reserved | (r/D:0) Writes to this location are ignored and will be read as |
| thru | | zero |
| 0 | | |

FindNode is a multicast address

For multicast addresses FindVLAN/Port is defined as follows:

TABLE 22

| | |
|---|---|
| Byte 3 | Byte 2 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | |
|---|---|
| VALID | VLANflag |

| Bit | Name | Function |
|---|---|---|
| 15 | VALID | Valid Address Indication: (r/D:0) |
| 14 | VLANflag | Current VLAN flag for Multicast: (r/D:0) This bit shows the stored |
| | | VLAN flag for the multicast address contained in FindNode. The |
| | | bit values in this field correspond one to one with ThunderSWITCH's port |
| | | assignment |

FindNodeAge Register

| Byte 3 | | | | | | | | Byte 2 | | | | | | | |
|---|---|---|---|---|---|---|---|---|---|---|---|---|---|---|---|
| Bit | | | | | | | | | | | | | | | |
| 15 | 14 | 13 | 12 | 11 | 10 | 9 | 8 | 7 | 6 | 5 | 4 | 3 | 2 | 1 | 0 |

| | NodeAge |
|---|---|
| After | 0000000000000000 |
| RESET | |

The FindNodeAge register is a read only register which holds the current 16 bit age time stamp of the address contained in the FindNode registers.

Lookup Table Search Control Register, FindControl

The management engine uses the FindControl register to scan the lookup table for addresses. Only one command is valid at one time.

Example: a FIRST and a NEXT command cannot be issued at the same time (0x0Ah). EALE will ignore all multiple commands.

TABLE 23

| Bit | | | | | | | |
|---|---|---|---|---|---|---|---|
| 7 | 6 | 5 | 4 | 3 | 2 | 1 | 0 |

| | | | | |
|---|---|---|---|---|
| FOUND | Reserved | FIRST | NEXT | LKUP |

| Bit | Name | Function |
|---|---|---|
| 7 | FOUND | Address Found. (r/D:0) If the address contained in FindNode is |
| | | found in the table, this bit will be asserted. |
| 6 | Reserved | (r/D:0) Writes to this location are ignored and will be read as zero |
| thru | | |
| 3 | | |
| 2 | FIRST | Lookup First Address. (r/w/D:0) When asserted EALE will scan |
| | | the address table for the first valid address. It will return this |
| | | address in FindNode. |
| 1 | NEXT | Lookup Next Addresses. (r/w/D:0) When asserted the EALE will |
| | | scan the address table for the next available address. It will return this |
| | | address in FindNode. |
| 0 | LKUP | Address Lookup. (r/w/D:0) When asserted the EALE will scan |
| | | the address table for the address contained in FindNode. If |
| | | found the FOUND bit will read a one, else it will read a zero. |

Statistics Registers

TABLE 24
Statistics Registers

| | | | | |
|---|---|---|---|---|
| Byte 3 | Byte 2 | Byte 1 | Byte 0 | DIO Address |

| | |
|---|---|
| SECVIOCtr | 0x14h |

| | | |
|---|---|---|
| UNKMULTICtr | UNKUNICtr | 0x18h |
| | NumNodes | 0x1ch |

All registers in this field are read only and their default value after reset is zero.

The SECVIOCtr Security Violation Counter field contains the number of times that a secured address attempts to move ports. This register generates a STAT interrupt (Statistics Overflow Interrupt) when it is half full (Most significant bit in the field is a one). Reading this register auto-clears it and the default value of this register is 0x00h

UNKUNICtr Counter

The UNKUNICtr register counts the number of times that the EALE device broadcasts a frame which has a unicast destination address. These frames are broadcast using the code stored in the UNKUNIPorts register when the EALE is not able to find the destination address in its lookup table. This register generates a STAT interrupt (Statistics Overflow Interrupt) when it is half full (Most significant bit in the field is a one). Reading this register auto-clears it and the default value of this register is 0x0000h

UNKMULTICtr Counter

The UNKMULTICtr register counts the number of times that the EALE device uses the UNKMULTIPorts register to broadcast a frame which has a multicast destination address. Multicast destination addresses are broadcast using UNKMULTIPorts when EALE is not able to find the destination address in its lookup table. This register generates a STAT interrupt (Statistics Overflow Interrupt) when it is half full (Most significant bit in the field is a one). Reading this register auto-clears it and the default value of this register is 0x0000h

NumNodes Counter

The NumNodes counter register contains the number of addresses currently in the lookup table. This register is read-only and its value at reset is 0x0000h.

RAM_addr Register

TABLE 25

| | | |
|---|---|---|
| Byte 2 | Byte 1 | Byte 0 |

| | | | | | | |
|---|---|---|---|---|---|---|
| Bit | 2322212019 | 16 | 15 | 8 | 7 | 0 |

| | | |
|---|---|---|
| I | Res | RAM_ADD |
| N | | |
| C | | |

| Bit | Name | Function |
|---|---|---|
| 23 | INC | Address Auto Increment: Asserting this bit increments the |
| | | RAM_ADD field to access the next location in the SRAM. The |
| | | address is incremented after every time a read or write is |
| | | performed on the RAM_data register. |
| 22 | Reserved | (r/D:0) Writes to this location are ignored and will be read as |
| thru | | zero |
| 20 | | |
| 19 | RAM_ADD | RAM Address: This 20 bit field holds the address of the SRAM |
| thru | | location which is to be read or written to. The data to be read or |
| 0 | | written is placed in the RAM_data register. |

The SRAM accessed (internal or external address) depend on the status of the NINT bit in RAMSize.

TABLE 26
Manufacturing Test (MANtest) Register
Bit

| | | | | | | | |
|---|---|---|---|---|---|---|---|
| 7 | 6 | 5 | 4 | 3 | 2 | 1 | 0 |

| | | | | | | |
|---|---|---|---|---|---|---|
| NOINIT | TMODE | WREG | INCCTR | FMODE | DCNUMN | Reserved |

| Bit | Name | Function |
|---|---|---|
| 7 | NOINIT | NOT Initialize SRAM: (r/w only if TMODE = ‘1’ /D:0). Asserting |
| | | this bit skips SRAM initialization. Writeable only if TMODE is a |
| | | one. |
| 6 | TMODE | Test Mode Lockout Mode: (r/wp/D:0) This bit is only writeable |
| | | when START in Control is a zero. When TMODE = 1, all other |
| | | bits in this register are writeable, else they are locked and writes |
| | | to them are ignored. |
| 5 | WREG | Write Enable for Registers. (r/w only if TMODE = ‘1’ /D:0) |
| | | Asserting this bit allows writing to registers which were |
| | | previously read-only (i.e. Stats). Writeable only if TMODE is a |
| | | one. |
| 4 | INCCTR | Increment Counter Control. (r/w only if TMODE = ‘1’ /D:0) |
| | | Asserting this bit increments all counters by one. Must clear and |
| | | re-write for additional incrementing. Writeable only if TMODE is |
| | | a one. |
| 3 | FMODE | Fast Timer Test Mode. (r/w only if TMODE = ‘1’ /D:0) This bit |
| | | controls the speed in which the internal aging mechanism and |
| | | EEPROM loading operates. Writing a one enables fast aging. A |
| | | zero denotes normal operation. |
| | | When set the EEPROM load error is 1/6th of EALE's clock, |
| | | and fast aging is enabled. |
| | | When not set the load error is 1/5 12th of EALE's clock, and |
| | | the aging clock runs at its normal speed |
| | | Writeable only if TMODE is a one. |
| 2 | DCNUMN | NumNode Counter Decrement bit. (r/w only if TMODE = ‘1’ /D:0) |
| | | This bit decrements the NumNodes register. Must clear and |
| | | re-write for additional decrements. Writeable only if TMODE is a |
| | | one. |
| 1 | Reserved | (r/D:0) Writes to this location are ignored and will be read as zero |
| thru | | |
| 0 | | |

This register is reserved for manufacturing test only. It must be written to 0x00 h for normal operation.

TMODE and the rest of the bits in this register can be written to at the same time.

TABLE 27
RAM_data Register

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

RAM_data

The RAM_data register is used to access the SRAM location held in the RAM_ADD field of the RAM_addr register. This field is 16 bits wide.

Writes are accomplished by writing the data to the RAM_data register

Reads are accomplished by reading the data from the RAM_data register

The SRAM address to be accessed should be placed in RAM_addr. If the INC bit in RAM_addr is set, the address to be accessed will be increased after each time RAM_data is accessed.

The SRAM accessed (internal or external address) depend on the status of the NINT bit in RAMSize.

The Int register is used in conjunction with the IntMask register to provide interrupts to the attached CPU. When EALE asserts the EINT pin, this register will give the reason for the interrupt. Specific interrupts can be masked out by setting the appropriate bit in IntMask. All bits in this register are auto clearing when the MSB of this register is read.

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | | | | | | | | |
|---|---|---|---|---|---|---|---|---|---|---|---|
| NEW | NEWM | CHNG | CHNGM | SECVIO | SECVIOM | AGE | AGEM | INT | Reserved | STAT | FULL |

| Bit | Name | Function |
|---|---|---|
| 15 | NEW | New Node Interrupt. (r/ac/D:0) This bit indicates that a new |
| | | node has been added to the lookup table. The node address is |
| | | given in NewNode, and the node's port is given in NewPort. |
| 14 | NEWM | Missed New Node Interrupt Indication. (r/ac/D:0) This bit |
| | | indicates that a new node interrupt was given, but the |
| | | information was not placed in the NewNode registers since the |
| | | CPU is accessing these registers. |
| 13 | CHNG | Node Port Change Interrupt. (r/ac/D:0) This bit indicates that |
| | | there has been a change in port assignment for a node that |
| | | exists in the lookup table. The node address is given in |
| | | NewNode, and the node's new port is given in NewPort. |
| 12 | CHNGM | Missed Node Port Change Interrupt Indication. (r/ac/D:0) This |
| | | bit indicates that a node port change interrupt was given, but the |
| | | information was not placed in the NewNode registers since the |
| | | CPU is accessing these registers. |
| 11 | SECVIO | Security Violation Interrupt. (r/ac/D:0) This bit indicates that a |
| | | node which has been secured has attempted to move port |
| | | assignments.. The node address is given in NewNode. |
| | | NewPort shows where the node attempted to move to |
| 10 | SECVIOM | Missed Security Violation Interrupt Indication. (r/ac/D:0) This bit |
| | | indicates that a node port change interrupt was given, but the |
| | | information was not placed in the NewNode registers since the |
| | | CPU is accessing these registers |
| 9 | AGE | Age-out Interrupt. (r/ac/D:0) This bit indicates that a node has |
| | | been aged-out (deleted from the lookup table). The node |
| | | address is given in AgedNode. The node's assigned port is |
| | | given in AgedPort. |
| 8 | AGEM | Missed Age-out Interrupt Indication. (r/ac/D:0) This bit indicates |
| | | that an age-out interrupt was given, but the information was not |
| | | placed in the AgedNode registers since the CPU is accessing |
| | | these registers |

TABLE 28

| | | |
|---|---|---|
| 7 | INT | Test Interrupt Request. (r/w/ac-MSB/D:0) Asserting this bit will |
| | | give a test interrupt to the attached CPU. |
| 6 | Reserved | (r/D:0) Writes to this location are ignored and will be read as |
| thru | | zero |
| 2 | | |
| 1 | STAT | Statistics Overflow Interrupt. (r/ac-MSB/D:0) This bit indicates |
| | | that a counter in the statistics is half-full (Most significant bit in |
| | | the counter is a one). This is an indication to the CPU to read |
| | | the statistic counters (thereby clearing them). |
| 0 | FULL | SRAM Full Interrupt. (r/ac-MSB/D:0) This bit indicates that there |
| | | are no available SRAM tables for this address. Due to the |
| | | nature in which node addresses are stored this may/may not |
| | | mean that no more addresses can be added to the tables. |

Interrupt Masking Register IntMask

The IntMask register is used in conjunction with the Int register to select the type of interrupts that should be given to the attached CPU. Bit definitions in IntMask agree one-to-one to bit definitions in the Int register. Only those fields with the bit set will generate an interrupt to the CPU. This register is read/writeable and defaults to 0x0000h at reset.

TABLE 29

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | | | | | | | | |
|---|---|---|---|---|---|---|---|---|---|---|---|
| NEW | NEWM | CHNG | CHNGM | SECVIO | SECVIOM | AGE | AGEM | INT | Reserved | STAT | FULL |

| Bit | Name | Function |
|---|---|---|
| 15 | NEW | New Node Interrupt Mask. (r/w/D:0) When this bit is set a new |
| | | node interrupt will be posted if the NEW bit in the Int register is |
| | | set |
| 14 | NEWM | Missed New Node Interrupt Mask. (r/w/D:0) When this bit is set |
| | | a missed new node interrupt will be posted if the NEWM bit in |
| | | the Int register is set |
| 13 | CHNG | Node Port Change Interrupt Mask. (r/w/D:0) When this bit is set |
| | | a node port change interrupt will be posted if the CHNG bit in the |
| | | Int register is set |
| 12 | CHNGM | Missed Node Port Change Interrupt Mask. (r/w/D:0) When this |
| | | bit is set a missed node port interrupt will be posted if the |
| | | CHNGM bit in the Int register is set |
| 11 | SECVIO | Security Violation Interrupt Mask. (r/w/D:0) When this bit is set a |
| | | security violation interrupt will be posted if the SECVIO bit in the |
| | | Int register is set |
| 10 | SECVIOM | Missed Security Violation Interrupt Mask. (r/w/D:0) When this bit |
| | | is set a missed security violation interrupt will be posted if the |
| | | SECVIOM bit in the Int register is set |
| 9 | AGE | Age-out Interrupt Mask. (r/w/D:0) When this bit is set an age-out |
| | | interrupt will be posted if the AGE bit in the Int register is set |
| 8 | AGEM | Missed Age-out Interrupt Mask. (r/w/D:0) When this bit is set a |
| | | missed age-out interrupt will be posted if the AGEM bit in the Int |
| | | register is set |
| 7 | INT | Test Interrupt Mask. (r/w/D:0) When this bit is set a test interrupt |
| | | will be posted if the INT bit in the Int register is set |
| 6 | Reserved | (r/D:0) Writes to this location are ignored and will be read as |
| thru | | zero |
| 2 | | |
| 1 | STAT | Statistics Overflow Interrupt Mask (r/w/D:0) When this bit is set |
| | | a statistics interrupt will be posted if the STATS bit in the Int |
| | | register is set |
| 0 | FULL | SRAM Full Interrupt. (r/w/D:0) When this bit is set a memory full |
| | | interrupt will be posted if the FULL bit in the Int register is set |

AddDelControl Register

TABLE 30

| Bit | | | | | | | |
|---|---|---|---|---|---|---|---|
| 7 | 6 | 5 | 4 | 3 | 2 | 1 | 0 |

| | | |
|---|---|---|
| Reserved | ADO | DEL |

| Bit | Name | Function |
|---|---|---|
| 7 | Reserved | (r/D:0) Writes to this location are ignored and will be |
| thru | | read as zero |
| 2 | | |
| 1 | ADD | Address Add. (r/w/D:0) When asserted EALE will use |
| | | the information contained in the Management Add/Edit |
| | | Address Interface to add or edit an address in the |
| | | lookup table. This bit remains asserted until the add |
| | | process is complete. |
| 0 | DEL | Address Delete. (r/w/D:0) When asserted EALE will |
| | | use the information contained in the Management |
| | | Delete Address Interface to delete an address from the |
| | | lookup table. This bit remains asserted until the delete |
| | | process is complete. |

TABLE 31
New Node/Port Change/Security Violation Interrupt Interface

| Byte 3 | Byte 2 | Byte 1 | Byte 0 | DIO Address |
|---|---|---|---|---|
| NewNode | NewNode | NewNode | NewNode | 0x30 |
| [23:16] | [31:24] | [39:32] | [47:40] | |

| | | | |
|---|---|---|---|
| NewPort | NewNode | NewNode | 0x34 |
| | [7:0] | [15:8] | |

The New Node/Port Change/Security Violation Interrupt registers are used in conjunction with the Int and IntMask registers to exchange information relating to new addresses being added or modified in the lookup table. These registers are valid on a NEW, CHNG or SECVIO interrupt. These registers are read-only and are default to zero on reset.

NewNode Registers

| Byte 3 | Byte 2 | Byte 1 | Byte 0 | DIO Address |
|---|---|---|---|---|
| NewNode | NewNode | NewNode | NewNode | 0x30 |
| [23:16] | [31:24] | [39:32] | [47:40] | |

| | | |
|---|---|---|
| NewNode | NewNode | 0x34 |
| [7:0] | [15:8] | |

The NewNode registers contain the node address for which the interrupt was given. The default value of this register after reset is 0x00.00.00.00.00h

TABLE 32
NewPort Register

| | |
|---|---|
| Byte 3 | Byte 2 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | |
|---|---|---|---|---|
| VALID | Reserved | PortCode | Reserved | OldPort |

| Bit | Name | Function |
|---|---|---|
| 15 | VALID | Valid Address: (r/D:0) This bit is set whenever the |
| 14 | Reserved | (r/D:0) Writes to this location are ignored and will be read as |
| thru | | zero |
| 12 | | |
| 11 | PortCode | Current Port for Node: (r/D:0) This field holds the assigned port |
| thru | | number for the address contained in NewNode |
| 8 | | |
| 7 | Reserved | (r/D:0) Writes to this location are ignored and will be read as |
| thru | | zero |
| 4 | | |
| 3 | OldPort | Old Port for Address: (r/D:0) When an address moves port |
| thru | | locations this field contains the old port location for the address. |
| 0 | | |
| | | When a security violation interrupt is asserted by EALE |
| | | (SECVIO bit is set in the Int register). This field shows the port |
| | | where the node attempted to move to. |

TABLE 33
Management Add/Edit Address Interface

| Byte 3 | Byte 2 | Byte 1 | Byte 0 | DIO Address |
|---|---|---|---|---|
| AddNode | AddNode | AddNode | AddNode | 0x38 |
| [23:16] | [31:24] | [39:32] | [47:40] | |

| | | | |
|---|---|---|---|
| AddVLAN/Port | AddNode | AddNode | 0x3c |
| | [7:0] | [15:8] | |

The Management Add/Edit Address registers are used in conjunction with the ADD bit in the AddDelControl register to perform CPU adds and edits to the lookup table.

AddNode Registers

| Byte 3 | Byte 2 | Byte 1 | Byte 0 | DIO Address |
|---|---|---|---|---|
| AddNode | AddNode | AddNode | AddNode | 0x38 |
| [23:16] | [31:24] | [39:32] | [47:40] | |

| | | |
|---|---|---|
| AddNode | AddNode | 0x3c |
| [7:0] | [15:8] | |

The AddNode register is a read/writeable register. The unicast or multicast address in this register will be added to the lookup table when the ADD bit in AddDelcontrol is set to one. The default value of this register after reset is 0x00.00.00.00.00.00h

AddVLAN/Port Register

The AddVLAN/Port register is used to change port or VLAN assignment information for the node address contained in AddNode. The definition for the AddVLAN/Port register depends on whether the address stored in the AddNode register is a unicast or multicast address.

AddNode is a unicast address.

TABLE 34

| | |
|---|---|
| Byte 3 | Byte2 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | | | | | |
|---|---|---|---|---|---|
| Res | SECURE | LOCKED | CUPLNK | PortCode | Reserved |

| Bit | Name | Function |
|---|---|---|
| 15 | Reserved | (r/D:0) Writes to this location are ignored and will be read as |
| | | zero |
| 14 | SECURE | Secured Address Flag: (w/r/D:0) This bit is used to change the |
| | | security level for the address contained in AddNode. |
| 13 | LOCKED | Locked Address Flag: (w/r/D:0) This bit locks/unlocks the |
| | | address contained in AddNode on an ADD operation. Locked |
| | | addresses will output a discard code on the EAM interface: |
| | | If M00_UPLINK# pin is set to one, EAM_[15:0] = 0x0000. |
| | | If M00_UPLINK# pin is set to zero, EAM_[15:0] = 0x8010 |
| 12 | CUPLNK | Copy Frames to Uplink Flag. (w/r/D:0) This bit sets the Copy |
| | | Uplink status for the address contained in AddNode. Addresses |
| | | which are tagged for uplink copying use the information in the |
| | | PortCode field and the UPLINKPorts register to route frames. |
| 11 | PortCode | Current Port for Node: (w/r/D:0) This field changes the |
| thru | | destination port for the unicast address shown in AddNode. |
| 8 | | |
| 7 | Reserved | (r/D:0) Writes to this location are ignored and will be read as |
| thru | | zero |
| 0 | | |

AddNode is a multicast address

For multicast addresses AddVLAN/Port is defined as follows:

TABLE 35

| | |
|---|---|
| Byte 3 | Byte2 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| Res | VLANflag | |
|---|---|---|
| Bit | Name | Function |
| 15 | Reserved | (r/D:0) Writes to this location are ignored and will be read as |
| | | zero |
| 14 | VLANflag | Current VLAN flag for Multicast: (w/r/D:0) This bit changes the |
| | | VLAN port assignment for the multicast address contained in |
| | | AddNode. The bit values in this field correspond one to one with |
| | | ThunderSWlTCH's port assignment |

TABLE 36
Aged Node Interrupt Interface

| Byte 3 | Byte 2 | Byte 1 | Byte 0 | DIO Address |
|---|---|---|---|---|
| AgedNode | AgedNode | AgedNode | AgedNode | 0x40 |
| [23:16] | [31:24] | [39:32] | [47:40] | |
| | AgedPort | AgedNode | AgedNode | 0x44 |
| | | [7:0] | [15:8] | |

The Aged Node Interrupt Interface is used in conjunction with the Int and IntMask registers to pass information to the management agent about addresses which have been deleted from the lookup table due to the aging process. The information placed in these registers is only valid when the AGE bit in Int is set to a one. These registers are read-only and are zero after reset.

AgedNode Registers

| Byte 3 | Byte 2 | Byte 1 | Byte 0 | DIO Address |
|---|---|---|---|---|
| AgedNode | AgedNode | AgedNode | AgedNode | 0x40 |
| [23:16] | [31:24] | [39:32] | [47:40] | |
| | | AgedNode | AgedNode | 0x44 |
| | | [7:0] | [15:8] | |

On a AGE interrupt, the AgedNode Registers contain the address of the node that has been deleted from the lookup table. This is a read only register and defaults to 0x00.00.00.00.00.00h after reset.

TABLE 37
AgedPort Register
Bit

| | | | | | | | |
|---|---|---|---|---|---|---|---|
| 7 | 6 | 5 | 4 | 3 | 2 | 1 | 0 |

| | |
|---|---|
| Reserved | PortCode |

| Bit | Name | Function |
|---|---|---|
| 7 | Reserved | (r/D:0) Writes to this location are ignored and will be |
| thru | | read as zero |
| 4 | | |
| 3 | PortCode | Aged Node's Port: (r/D:0) This field displays the |
| thru | | assigned port for the deleted address contained in |
| 0 | | AgedNode |

Management Delete Address Interface DelNode Register

TABLE 38
Management Delete Address Interface DelNode Register

| Byte 3 | Byte 2 | Byte 1 | Byte 0 | DIO Address |
|---|---|---|---|---|
| DelNode | DelNode | DelNode | DelNode | 0x48 |
| [23:16] | [31:24] | [39:32] | [47:40] | |

| | | |
|---|---|---|
| DelNode | DelNode | 0x4c |
| [7:0] | [15:8] | |

The DelNode register is used in conjunction with the DEL bit in AddDelControl to allow for management deletion of an address in the lookup table. To delete an address the address to be deleted is placed in this address and the DEL bit is asserted.

Port-Based VLAN Routing Registers, PortVLAN

TABLE 39
Port-Based VLAN Routing Registers, PortVLAN

| | | | | |
|---|---|---|---|---|
| Byte 3 | Byte 2 | Byte 1 | Byte 0 | DIO Address |

| | | |
|---|---|---|
| PortVLAN1 | PortVLAN0 | 0x50 |
| PortVLAN3 | PortVLAN2 | 0x54 |
| PortVLAN5 | PortVLAN4 | 0x58 |
| PortVLAN7 | PortVLAN6 | 0x5c |
| PortVLAN9 | PortVLAN8 | 0x60 |
| PortVLAN11 | PortVLAN10 | 0x64 |
| PortVLAN13 | PortVLAN12 | 0x68 |
| | PortVLAN14 | 0x6c |

The port-based VLAN registers are used to route multicast and/or broadcast frames to user-selected ports. There is an individual 15-bit register allocated to each port. The most significant bit in each register is reserved and reads as zero. The bit number which corresponds to the port number in each register is also reserved and reads as zero. This is to ensure that EALE does not send frames to the originating port.

If the MVLAN bit in Control is set, EALE will forward multicast frames to the ports specified in the originating port's PortVLAN register and the ports located in the multicast's lookup table (if found). If the node is not found in the table the frame is forwarded to the bits in PortVLAN only. If the bit is not set, EALE will perform a lookup of the multicast address and use the code specified in the lookup table.

If the BVLAN bit in Control is set, EALE will forward broadcast frames to the ports specified in the originating port's PortVLAN register and the ports located in the broadcast's lookup table (if found). If the node is not found in the table the frame is forwarded to the bits in PortVLAN only. If the bit is not set, EALE will perform a lookup of the broadcast address and use the code specified in the lookup table.

| | |
|---|---|
| | Initial Value at RESET |
| Register Name | Bit 15 Bit 0 |

| | |
|---|---|
| PortVLAN0 | 0111111111111110 |
| PortVLAN1 | 0111111111111101 |
| PortVLAN2 | 0111111111111011 |
| PortVLAN3 | 0111111111110111 |
| PortVLAN4 | 0111111111101111 |
| PortVLAN5 | 0111111111011111 |
| POrtVLAN6 | 0111111110111111 |
| PortVLAN7 | 0111111101111111 |
| PortVLAN8 | 0111111011111111 |
| PortVLAN9 | 0111110111111111 |
| PortVLAN10 | 0111101111111111 |
| PortVLAN11 | 0111011111111111 |
| PortVLAN12 | 0110111111111111 |
| PortVLAN13 | 0101111111111111 |
| PortVLAN14 | 0011111111111111 |

These registers are auto-loaded from the EEPROM in a hardware reset (RESET#=‘0’) or when the LOAD bit in Control is set.

Uplink Routing Register UPLINKPorts

TABLE 40

| | |
|---|---|
| Byte 1 | Byte 0 |

Bit

| | | | | | | | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |

| | |
|---|---|
| Res. | UPLINKPorts[14:0] |

The UPLINKPorts register is used to route selected node's frames to user-selectable ports. This register is only valid when the destination address being looked-up has the CUPLNK bit set. EALE will forward frames to the port specified in the lookup table and the ports specified in this register. EALE will mask (not send frames to) the port which originated the frame. This is to ensure that the switch does not forward frames to the originating port.

EALE uses two styles of EAM codings—single port codes and VLAN flags. ThunderSWITCH treats these two types of coding differently. Single port codings forward frames to single ports, and TSWITCH queues these frames to the port queue. VLAN flags forward frames to multiple ports. ThunderSWITCH creates an In Order Broadcast (IOB) list structure to queue this frame to multiple port's queues.

IOB lists use more bandwidth than a regular list because IOB lists require the use of an extra 64 byte buffer to contain all other ports queue pointers. EALE uses single-port codings whenever possible to maximize performance. For a more complete description of IOB lists, refer to the description of them earlier herein.

EALE takes its frame inputs through ThunderSWITCH's DRAM bus. It must recognize a start of frame indication (SOF) on the first flag byte of the frame. Once the SOF is found, EALE latches the first 16 bits of the Destination Address on the next DRAM cycle. From this time, it must complete a lookup cycle, decide the appropriate EAM code and output this code in 440 ns or less. FIG. 89 illustrates the lookup timing.

The Forward Pointer has the following format. EALE first must determine that the frame is a data frame and not an IOB index buffer. It does this by insuring that the IOB bit is 0. The port number that sources the frame is latched from the Channel Code. All the shaded bits are ignored.

| | | | | | | | | | | |
|---|---|---|---|---|---|---|---|---|---|---|
| Cycle | 35 | 34 | 32 | 31 | 29 | 28 | 27 | 24 | 23 | 0 |

| | | | | | | |
|---|---|---|---|---|---|---|
| 0 | IOB | Parity | Res. | T/R | Channel | Forward |
| | | | | | Code | Pointer |

EALE must then determine the start of frame by looking at the flag for the next cycle. The flag is given in the DD_{—}[35:32] pins. The SOF is shown below in cycle 1 as bit[35:34]=0x01b

| | | | | | | | | |
|---|---|---|---|---|---|---|---|---|
| Cycle | 35 | 34 | 33 | 32 | 31 | 16 | 15 | 0 |

| | | | | |
|---|---|---|---|---|
| 1 | 0 | 1 | Reserved | MSB 32 bits of DA |

| | | | |
|---|---|---|---|
| 2 | Channel | MSB 16 bits | LSB 16 bits |
| | Code | SA | DA |

| | | | | |
|---|---|---|---|---|
| 3 | 0 | 0 | Reserved | LSB 32 bits of SA |

| | | | |
|---|---|---|---|
| | Flags | | Data |
| N-1 | EOB | Valid Bytes | Data |
| N | EOF | Frame Status | CRC |

EALE latches the partial Destination Address, begins the table lookup and outputs an EAM code within the allocated 440 ns after the SOF condition is met.

EALE determines the status of the frame when the EOB followed by an EOF is detected. CRC checking is determined from the Frame Status field. The code for a Good_CRC is Frame Status=0x000b. All other Frame Status codings indicate that ThunderSWITCH will abort the frame due to either a CRC error, a FIFO overflow or a network error.

The lookup table is contained in the attached SRAM. All of EALE's state machines must have access to this SRAM. An arbitration scheme is implemented to give all state machines fair access to the SRAM while at the same time meeting the lookup timing requirements.

EALE contains seven state machines and operations that require the use of the SRAM bus. They are: the RAM initialization state machine (INIT), the lookup state machine (LKUP) 1071, the delete state machine (DEL) 1073, the add state machine (ADD) 1075, the management address lookup state machine (FIND) 1077, the RAM registers RAM_addr and RAM_data (REG), and the aging state machine (AGE) 1079.

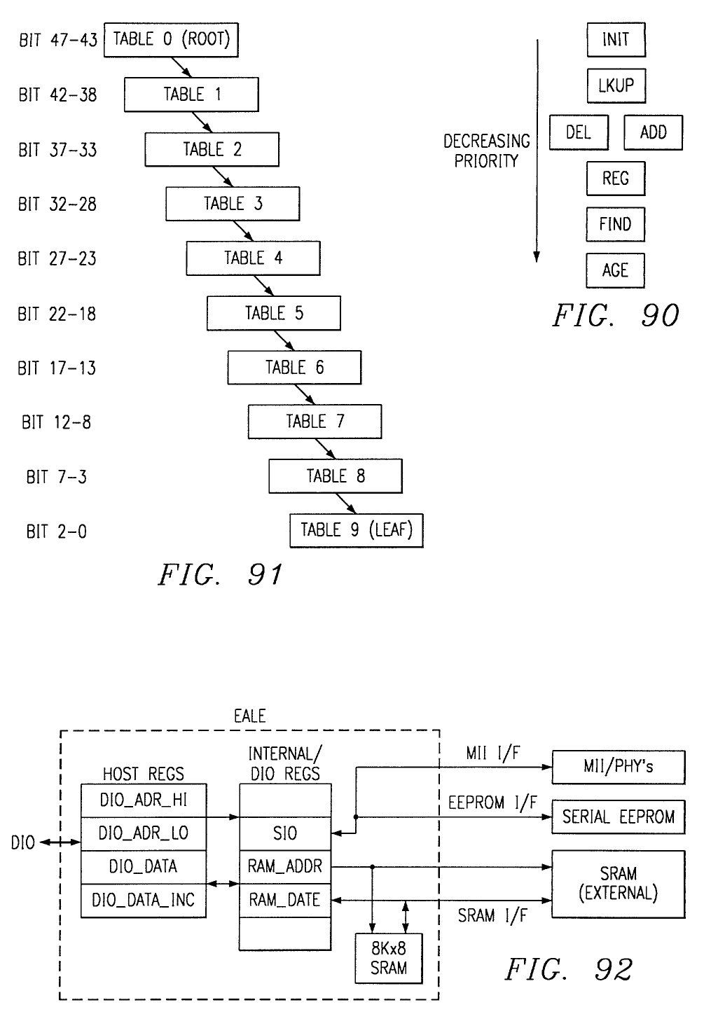

The Arbiter 1060 assigns a priority to each state machine. The highest priority is assigned to the INIT state machine in order to initialize EALE after a Reset. LKUP then becomes the state machine with the highest priority, after initialization. LKUP has the highest priority on the bus since it is the state machine that is the most time critical. The next priority level is shared by ADD and DEL. Register based accesses (REG) are next followed by the FIND state machine. AGE becomes the lowest priority. FIG. 90 shows the priorities of EALE's state machines.

The Arbiter grants the bus to the state machine with the highest priority who is currently requesting the bus. Each state machine requests the bus by asserting its Request signal. The arbiter assigns the bus to the state machine by asserting that state machine's Grant signal. If no state machine is requesting the bus, the Arbiter grants the bus to AGE for background aging operations.

The possibility arises for one state machine to interrupt a lower priority state machine in order to acquire the bus. For example a LKUP operation will interrupt an ADD operation.

For the case of ADD and DEL, where they both have the same priority, the Arbiter grants the bus to the first state machine that requests it. It then grants the bus to that state machine uninterrupted, unless by a LKUP, until the state machine completes. In case both ADD and DEL request the bus at the same time, the bus will be granted to ADD. This ensures that ADD is not interrupted by a DEL operation and vice versa.

The EALE device uses a table-based lookup algorithm. The tables are hierarchical and are linked to the lower tables by threads. Each table can thread to several different tables in the hierarchy. The lowest table in the hierarchy (leaf) does not point to anything and contains information about the address to be matched.

Each level in the hierarchy is assigned to a specific range of bits in the address. Each table contains threads which point to lower tables in the hierarchy. The bits in the range are used as an offset within the table. If a thread exists at that offset, EALE follows that thread. EALE matches an address whenever it finds a complete thread to a leaf. A graphical representation of the thread structure is shown in FIG. 77.

The first level (root level) only has one table out of which it can branch out to 2^{N} possible tables where N is the number of bits compared. Each additional table down in the hierarchy branches out to 2^{N} other possible tables. The second level contains 2^{N} tables and 2^{2N} threads. The third level contains 2^{2N} tables and 2^{3N} threads and so on.

Because of this exponential growth, the threads, the amount of possible paths at each level, soon overtakes' the number of addresses required. If this growth became unchecked, and with a N of 5, the third level would contain 1,024 tables and 32,768 threads. If only 1024 addresses are required we can see that we have more tables allocated that could never be used.

This is checked by determining if the number of tables allocated per level is greater than the number of addresses required. If so then we only allocate the number of tables required to cover the addresses. Since each address requires one complete thread, and in the worst case a table will have a minimum of one thread per table, for the worst case, for each level, one table is needed for each address supported.

Since each table needs to compare 2^{N} possible combinations, it requires 2^{N} pointers. Each table has the format depicted in FIG. 78, assuming 16 bit wide memory:

Each pointer can point to a table in the next level. EALE will use N bits in the address as an offset to this table and if a pointer is found it will use it to go to the next level. We use a pointer of zero to indicate that the entry was not found. In this case the search fails.

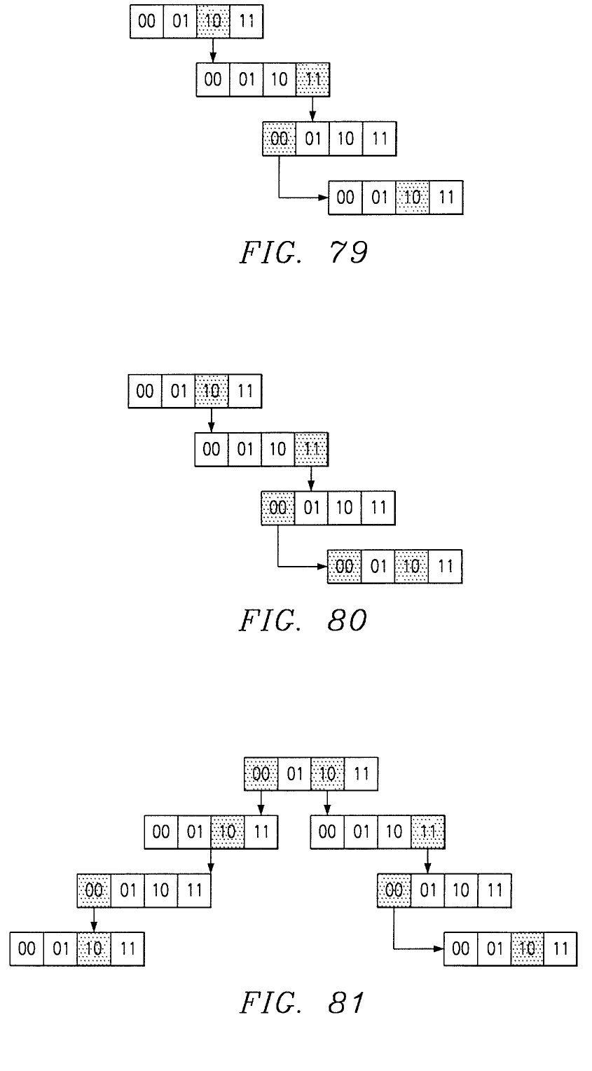

As an example, this method will be used to lookup the number 0xB2h (0x10.11.00.10b) two bits at a time (N=2). Graphically this number would be represented as depicted in FIG. 79.

It can be seen in FIG. 79 that the first table, offset 0x10b points to the second level. The second level uses the second set of bits, 0x11b, and points to the third table. This process continues until the last two bits are matched. Matching 0xB2h two bits at a time uses four tables each containing four possible pointers. Not all locations in the tables are used which can potentially lead to unused memory.

Now consider what happens when we add 0xB0h (0x10.11.00.00b) to the table above. FIG. 80 illustrates the results.

It may be seen that 0xB0h follows exactly the same thread as 0xB2h. The only difference between the two is in the last table. 0xB0h matches offset 0x00b while 0xB2h matches offset 0x10b. There are now two numbers being represented, but we still have the same number of tables allocated (four). Extending this example, one could add 0xB1h and 0xB3h with the same number of tables allocated. Call this the best-case scenario since it can pack the maximum amount of addresses in the minimum amount of memory.

Now consider what happens when 0x22h (0x00.10.00.10b) is added to a lookup table contained in FIG. 80 and results in FIG. 81.

Adding 0x22h requires allocating three additional tables. It now require seven tables to hold two addresses. Compared to numbers that differ in their least significant bits, numbers which differ in their most significant bits require more tables. Again, furthering the example, adding 0xA2h would require an additional three as would 0xE2h. This is the worst-case scenario, and it is the least efficient way of storing addresses.

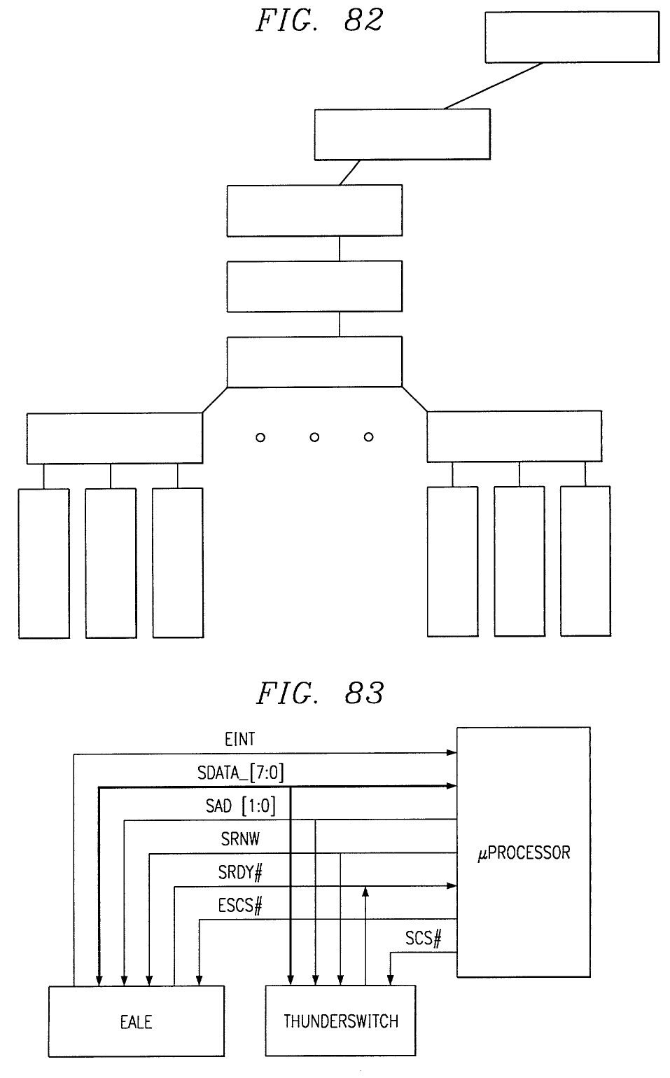

EALE is designed to handle the worst case address distribution. The worst case address distribution is that which requires a separate thread per address. A purely random distribution will create multiple threads at the early levels. However in real networks, there are only a couple of vendor cards that are used. These cards do not have a purely random distribution, but they all share a common set of bits that identifies the vendor. This configuration requires less pointers for the same number of addresses. In such a network the tables look more like FIG. 82.

Obviously one needs to allocate for worst case, but since the worst case is not likely to happen in a real system, the opportunity arises to be able to stuff in more addresses than that for which we allocate.

The actual number of addresses supported in a buffered device will depend on the nature of the nodes in the network. EALE's in networks with nodes from one or few manufacturers will be able to recognize more addresses than those in a purely random address network.

This algorithm has the additional advantage that the lookup time is independent of the amount of addresses stored in the lookup table. Whether the number is one or a million, the lookup time depends on the amount of levels required to match the address.

Initial EALE versions use a 5 bit version of the lookup algorithm described in the previous section. This means that each address requires 10 tables to store a 48 bit value. Each table requires 40 ns to read which gives us a lookup time of 400 ns. This is within our 440 ns of allotted lookup time. Each table has 32 locations corresponding to each of the 2⁵ possible threads. The first 9 tables are used for pointing to the lower levels and the tenth contains the address' data. These tables are depicted in FIG. 91.

The maximum width of each table location is 16 bits. The 16 bits from the table coupled with the 5 bits from the address being looked up make it possible to access 16+5=21 address lines (2M of SRAM).

2M of SRAM is supported through a 16 bit table location. However, for smaller SRAM sizes we do not need a full 16 bits of data width. The minimum width required for 8K of SRAM is 8 bits. EALE masks out the excess, unneeded data bits through its ED_Mask block. The RAM width and depth is controlled by the RAMSize register.

The last level represents only bits 2-0 of the address. This means that only 2³ locations are needed to represent an address in the last table. Since our table size is pre-allocated to 32 locations, this gave us the opportunity to allocate 4 locations to each address. Each location was specified to be only 8 bits wide since this is the guaranteed width for all memory sizes. The 4 bytes per node are allocated as follows for a unicast address:

| Byte 1 | Byte 2 | Byte 3 | Byte 4 |
|---|---|---|---|
| Flags/Port Code | Reserved | MSB Age Stamp | LSB Age Stamp |

Bit

| | | | | | | | |
|---|---|---|---|---|---|---|---|
| 7 | 6 | 5 | 4 | 3 | 2 | 1 | 0 |

| | | | | |
|---|---|---|---|---|
| VALID | SECURE | LOCKED | CUPLNK | PortCode |

The VALID flag is needed in because EALE determines if an address is present in the table by the absence of a 0x0000h on that location. For addresses whose PortCode is 0x0h, an erroneous empty indication would occur. The VALID flag is not user writeable.

For a multicast address the 4 bytes are allocated as:

| Byte 1 | Byte 2 | Byte 3 | Byte 4 |
|---|---|---|---|
| MSB VLAN | LSB VLAN | MSB Age Stamp | LSB Age Stamp |

The data stored for unicasts versus multicast differs in that unicast need only a 4 bit port code while multicasts require a 15 bit VLAN code. To read in the LSB VLAN field for multicasts addresses requires an additional 40 ns to the previous lookup time of 400 ns. This puts us right at the 440 ns lookup time.

Byte 1 for multicasts has the following definition

| Bit | | | | | | | |
|---|---|---|---|---|---|---|---|
| 7 | 6 | 5 | 4 | 3 | 2 | 1 | 0 |

| | |
|---|---|
| VALID | VLANflag [15:8] |

Byte 2 for multicasts has the following definition

| Bit | | | | | | | |
|---|---|---|---|---|---|---|---|
| 7 | 6 | 5 | 4 | 3 | 2 | 1 | 0 |

VLANflag [7:0]:

For the same reason as a multicast and to guard against the case when the VLANflag field is 0x0000h, a VALID indication is needed.

EALE maintains the address lookup table on either its internal 8K×8 SRAM or in the optional external SRAM. The number of addresses that EALE supports is directly dependent on the size of this SRAM. Larger lookup tables are achieved by increasing the size of the external SRAM.

As explained earlier herein, the number of addresses supported by EALE depends on the type of addresses stored. Addresses which are similar and differ in their least significant bits are packed more efficiently within EALE. Addresses which change in their more significant bits are much less efficient in table usage and require more memory.

The scenario where the addresses change in their most significant bits is the worst case scenario. The worst case scenario can be determined by adding the following sequence until no more addresses fit into the table.

0x00.00.00.00.00.00h

0x80.00.00.00.00.00h

0x40.00.00.00.00.00h

0xC0.00.00.00.00.000h

0x20.00.00.00.00.00h

0xA0.00.00.00.00.00h

:

0x70.00.00.00.00.00h

0xF0.00.00.00.00.00h

0x08.00.00.00.00.00h

:

0x7F.FF.FF.FF.FF.FFh

0xFF.FF.FF.FF.FF.FFh

The best case scenario occurs when the addresses change in their least significant bits. The best case scenario is determined by adding the following sequence until no more addresses fit into the table. 0x00.00.00.00.00.00h

0x00.00.00.00.00.01h

0x00.00.00.00.00.02h

:

0x00.00.0.00.00.0Eh

0x00.00.00.00.00.0Fh

0x00.00.00.00.00.10h

:

0xFF.FF.FF.FF.FF.FEh

0xFF.FF.FF.FF.FF.FFh

The address capability for the various RAM sizes is given in the following table. Note that EALE integrates an 8K×8 internal SRAM (RAMSize=0x05h). The RASize options of 0x00h thru 0x04h are intended for manufacturing testing and are not foreseen to be used in most applications.

| RAMSize | | Worst | |
|---|---|---|---|
| Register | RAM size | Case | Best Case |
| 0x00h | 640x8 | 2 | 88 |
| 0x01h | 832x8 | 2 | 136 |
| 0x02h | 1Kx8 | 3 | 184 |
| 0x03h | 2Kx8 | 7 | 432 |
| 0x04h | 4Kx8 | 14 | 920 |
| 0x05h | 8Kx8 | 28 | 1,912 |
| 0x06h | 16Kx9 | 59 | 3,896 |
| 0x07h | 32Kx10 | 123 | 7,872 |
| 0x08h | 64Kx11 | 251 | 15,560 |
| 0x09h | 128Kx12 | 507 | 26,512 |
| 0x0Ah | 256Kx13 | 1,019 | 62,360 |
| 0x0Bh | 512Kx14 | 2,189 | 134,040 |
| 0x0Ch | 1Mx15 | 4,530 | 277,408 |
| 0x0Dh | 2Mx16 | 9,211 | 564,144 |
| to | | | |
| 0x0Fh | | | |

From this table it may be seen that there is a large range between the worst case performance and the best case performance. EALE's internal SRAM is 8K×8 in size which gives a worst case performance of 28 addresses and a maximum of 1,912 addresses.

However, most networks are composed of devices that change towards their least significant bits. This is since most networks make use of only a few number of vendors. The 48 bit Ethernet address of vendors is composed of a 24-bit vendor identifier number which is allocated by the IEEE. The last 24 bits of an address is reserved for the vendor. A device containing Texas Instruments' Ethernet address looks like 0x800028xxh, where xxxxx can be any number.

EALE's address packing capability is summarized in the table below for networks which are composed of addresses which come from a one to five vendors. These numbers are for the worst-case scenario where each vendor has decided to change its addresses by changing the most significant bits of the xxx code. 6 Byte address variation e.g. 123456xxxxx

| RAMSize | | 1 | 2 | 3 | 4 | 5 |
|---|---|---|---|---|---|---|
| Register | RAM size | Vendor | Vendor | Vendor | Vendor | Vendor |
| 0x00h | 640x8 | 3 | 2 | 2 | 2 | 2 |
| 0x01h | 832x8 | 4 | 3 | 2 | 2 | 2 |
| 0x02h | 1Kx8 | 6 | 4 | 3 | 3 | 3 |
| 0x03h | 2Kx8 | 14 | 12 | 11 | 9 | 8 |
| 0x04h | 4Kx8 | 30 | 28 | 27 | 25 | 24 |
| 0x05h | 8Kx8 | 62 | 60 | 59 | 57 | 56 |
| 0x06h | 16Kx9 | 147 | 124 | 123 | 121 | 120 |
| 0x07h | 32Kx10 | 317 | 294 | 271 | 249 | 248 |
| 0x08h | 64Kx11 | 659 | 635 | 612 | 589 | 565 |
| 0x09h | 128Kx12 | 1,341 | 1,318 | 1,295 | 1,271 | 1,248 |
| 0x0Ah | 256Kx13 | 3,036 | 2,683 | 2,660 | 2,637 | 2,613 |
| 0x0Bh | 512Kx14 | 7,096 | 6,073 | 5,391 | 5,367 | 5,344 |
| 0x0Ch | 1Mx15 | 15,324 | 14,265 | 13,206 | 12,147 | 11,088 |
| 0x0Dh | 2Mx16 | 31,708 | 30,649 | 29,590 | 28,531 | 27,472 |
| to | | | | | | |
| 0x0Fh | | | | | | |

From the previous table that the internal 8K×8 RAM is able to learn at least 56 addresses when used in a five-vendor network. This number goes up to at least 62 addresses when used in a single-vendor network.

EALE's address packing capability for networks where each vendor has decided to change its addresses by changing the 16 least significant bits of the address is also summarized. In this case the internal 8Kx8 RAM is able to learn at least 92 addresses when used in a five-vendor network. The single-vendor network's performance now goes up to 120. The 4 Byte address variation (e.g. 12345678xxxx) table is given below:

| RAMSize Register | RAM size | 1 Vendor | 2 Vendors | 3 Vendors | 4 Vendors | 5 Vendors |
|---|---|---|---|---|---|---|
| 0x00h | 640x8 | 4 | 2 | 2 | 2 | 2 |
| 0x01h | 832x8 | 6 | 4 | 2 | 2 | 2 |
| 0x02h | 1Kx8 | 8 | 6 | 4 | 3 | 3 |
| 0x03h | 2Kx8 | 24 | 17 | 15 | 13 | 11 |
| 0x04h | 4Kx8 | 56 | 49 | 42 | 35 | 32 |
| 0x05h | 8Kx8 | 120 | 113 | 106 | 99 | 92 |
| 0x06h | 16Kx9 | 248 | 241 | 234 | 227 | 220 |
| 0x07h | 32Kx10 | 753 | 497 | 490 | 483 | 476 |
| 0x08h | 64Kx11 | 1777 | 1,507 | 1,237 | 995 | 988 |
| 0x09h | 128Kx12 | 3825 | 3,555 | 3,285 | 3,015 | 2,745 |
| 0x0Ah | 256Kx13 | 7921 | 7,651 | 7,381 | 7,111 | 6,841 |
| 0x0Bh | 512Kx14 | *65,536 | 15,843 | 15,573 | 15,303 | 15,033 |
| 0x0Ch | 1Mx15 | *65,536 | *131,072 | *196,608 | 31,687 | 31,417 |
| 0x0Dh to 0x0Fh | 2Mx16 | *65,536 | *131,072 | *196,608 | *262,144 | *327,680 |

*Note: All addresses in the range can be learned. Capability is greater than this, but we do not have any more addresses to learn.

Although EALE is designed to work in a CPU-less environment, access to the internal registers is useful for.

Dynamic change to the various routing registers for VLAN's

Management based access and control of the lookup table

Statistic Gathering

Diagnostic operations.

To communicate with attached PHY's through the MII interface

To read/write to an external EEPROM.

FIG. 92 shows the various register spaces provided by and accessed through EALE.

The DIO interface has been kept simple and made asynchronous, to allow easy adaptation to a range of microprocessor devices and computer system interfaces. EALE's DIO interface is designed to be operated from the same bus as ThunderSWITCH's DIO interface. In this manner both devices can be accessed using the same DIO read and write routines. Each device is selected for DIO reads and writes through independent Chip Select signals. ThunderSWITCH's chip select is named SCS# while EALE's chip select is named ESCS#. FIG. 83 illustrates how EALE and ThunderSWITCH share the DIO interface.

The SDATA bus maps directly to the bit numbers inside EALE. That is SDATA_{—}[7] corresponds to the MSb of the register byte written to. SDATA_{—}[0] corresponds to the LSb of the register byte written to.

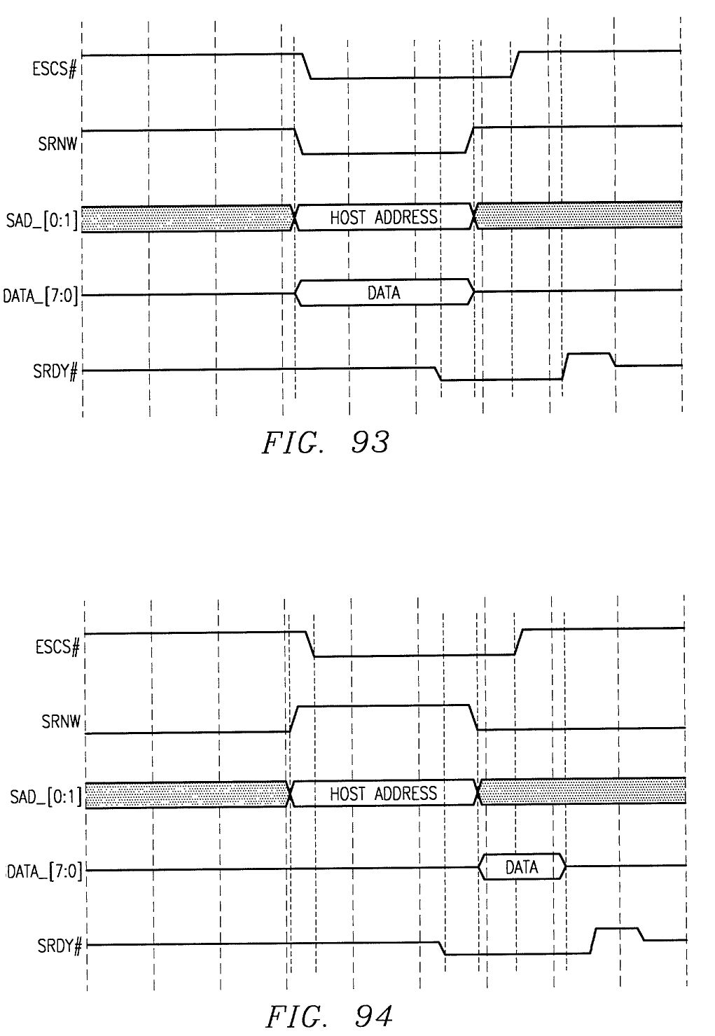

A Write Cycle is depicted in FIG. 93.

EALE Host register address SAD_{—}[1:0] and data SDATA_{—}[7:0] are asserted, SRNW is taken low.

After setup time, ESCS# is taken low initiating a write cycle. EALE pulls SRDY# low as the data is accepted

SDATA_{—}[7:0], SADA_{—}[1:0] and SRNW signals can be deasserted after the hold time has been satisfied.

ESCS# taken high by the host completes the cycle, causing SRDY# to be deasserted, SRDY# is driven high for one cycle before tristating.

A Read Cycle is depicted in FIG. 94.

EALE Host register address SAD_{—}[1:0] is asserted whilst SRNW is held high.

After setup time, ESCS# is taken low initiating the read cycle.

After delay time, from ESCS# low, SDATA_{—}[7:0] is released from tristate. SDATA_{—}[7:0] is driven with valid data and SRDY# is pulled low. The host can access the data.

ESCS# taken high by the host signals completion of the cycle, causes SRDY# to be deasserted. SRDY# is driven high for one clock cycle before tristating. SDATA_{—}[7:0] is also tristated.

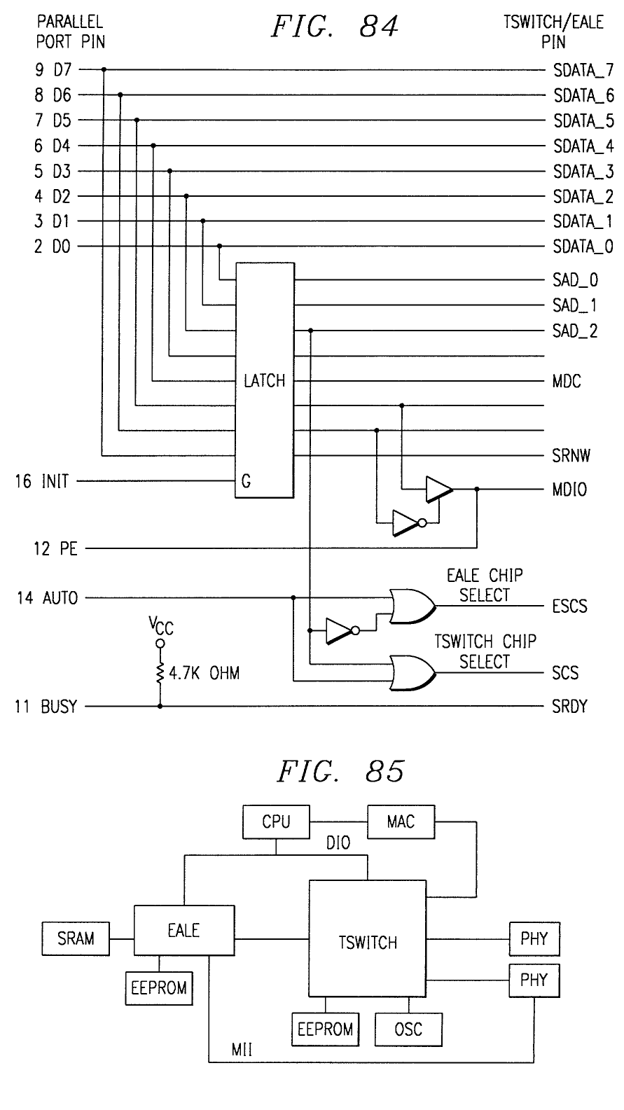

FIG. 84 is an example of how ThunderSWITCH and EALE can be accessed through a PC Parallel Port Interface. The use of the 74×125 device for MDIO is not necessary when using EALE since the SIO register can provide the MII management signals, but can be used in a build option if an EALE-less switch is desired. The use of a 74×126 can eliminate the inverter on the enable, but may result in a part lead time issue.

EALE's registers, SRAM (internal or external) and EEPROM are indirectly accessed through the Host registers. The Host registers are written/read to through the DIO interface. There are four byte-wide Host registers. They are individually selected through the SAD bus and the registers are read/written through the SDATA bus.

| SAD | SAD | Description |
|---|---|---|
| _1 | _0 | |
| 0 | 0 | DIO_ADR_LO |
| 0 | 1 | DIO_ADR_HI |
| 1 | 0 | DIO_DATA |
| 1 | 1 | DIO_DATA_INC |

Two bytes, DIO_ADR_LO and DIO_ADR_HI, are used to select the address (DIO_ADR) of the Internal register being selected. DIO_ADR_HI is the MSB of DIO_ADR and DIO_ADR_LO is the LSB. The DIO_ADR register is byte-writeable. What this means is that the user does not have to write to both DIO_ADR locations for each access to the Internal registers. This saves time in register accesses. Up to 2¹⁶ possible locations can be accessed through the DIO_ADR register.

The next two bytes, DIO_DATA and DIO_DATA_INC, are used to read and write data to the byte-wide Internal register selected in DIO_ADR. Both DIO_DATA and DIO_DATA_INC can be effectively used to read and write the data, but the DIO_DATA_INC register provides additional functionality over DIO_DATA. Access to the DIO_DATA_INC register provides a post-increment to the DIO_ADR register. This is useful for reading/writing to a block of registers.

As an example, in order to access a single byte-wide register such as the SIO register (DIO address=0x0Ah) the operations needed are:

Write 0x0h to DIO_ADR_HI

Write 0xAh to DIO_ADR_LO to select DIO address 0x0Ah

Read the SIO register by reading DIO_DATA, or write to the SIO register by writing to DIO_DATA.

Multiple byte registers are accessed by reading/writing to it's individual bytes. The Control register (DIO address 0x08h-0x09h) is accessed in the following manner.

Write a 0x0h to DIO_ADR_HI

Write a 0x8h to DIO_ADR_LO to select DIO address 0x08h

Read the LSB of the Control register by reading DIO_DATA, or write to the LSB of the Control register by writing to DIO_DATA.

Write a 0x0h to DIO_ADR_HI

Write a 0x9h to DIO_ADR_LO to select DIO address 0x09h

Read the MSB of the Control register by reading DIO_DATA, or write to the MSB of the Control register by writing to DIO_DATA.

One can improve on the above steps by writing a 0x00h to DIO_ADR_HI and then only changing DIO_ADR_LO. One can also cut out steps by using the DIO_DATA_INC register to read or write to contiguous register bytes. The following shows how to use the auto-incrementing function to access the Control register.

Write a 0x0h to DIO_ADR_HI

Write a 0x8h to DIO_ADR_LO to select DIO address 0x08h

Read the LSB of the Control register by reading DIO_DATA_IVC, or write to the LSB of the Control register by writing to DIO_DATA_INC. The Address in DIO_ADR will now auto-increment to 0x0009h

Read the MSB of the Control register by reading DIO_DATA_INC, or write to the MSB of the Control register by writing to DIO_DATA_INC.

Use of the auto-incrementing function is most useful when reading or writing to a large number of adjacent registers such as the 48 bit address registers or when reading the Statistics block.

The Internal registers are used to initialize and/or Reset EALE, to set EALE startup and routing options, to maintain the number of nodes within EALE and statistics, to enable management-based operations on the lookup table, to interface with the on-chip or external SRAM, the EEPROM and any MII managed devices.

The Internal registers are described in detail herein. This section will describe how to use the Internal Registers to access the SRAM, MII devices and EEPROM.

| | | | | |
|---|---|---|---|---|
| Byte 3 | Byte 2 | Byte 1 | Byte 0 | DIO Address |

| | |
|---|---|
| RAMSize | 0x00h |

| | |
|---|---|
| RAM_addr | 0x20h |

| | |
|---|---|
| RAM_data | 0x24h |

EALE's SRAM (Internal or External) can be accessed through the Internal Registers through the R_addr and RAM_data registers. The algorithm for reading and writing to the RAM is similar to that for reading and writing to the Internal Registers: the address of the location to access is placed in RAM_addr and the data can be read from or written to RAM_data.

To select between internal or external RAM, the NINT bit in RAMSize is used. This interface also has an auto-increment function which is selected from the INC bit in RAM_addr.

The DIO based RAM accesses must request the SRAM bus in order to perform reads and writes. A small state machine is implemented to do this. The state machine will only write to the RAM after the MS byte of RAM_data has been written. It will read the RAM when either byte of RAM_data is read.

Serial Interface - MII Managed Devices

| | | | | |
|---|---|---|---|---|
| Byte 3 | Byte 2 | Byte 1 | Byte 0 | DIO Address |

| | |
|---|---|
| SIO | 0x08h |

EALE gives the programmer an easy way to implement a software-controlled bit-serial interface. This interface is most appropriate in implementing a Media Independent Interface serial management interface.

MII devices which implement the management interface consisting of MDIO and MDCLK can be accessed in this way through the SIO register. In addition, for PHY's which support this, EALE implements a third MII management signal, MRESET#, to hardware reset MII PHY's.

The MDIO signal requires an external pullup for operation. The I/O direction is controlled by the MTXEN bit and the data is read from MDATA. In addition the complete serial interface (MDIO,MDCLK,MRESET#) can be placed in a High-Z state through the MDIOEN bit in SIO. High-Z support is needed in order to avoid contention when two devices drive the MII bus.

EALE does not implement any timing. or data structure on its serial interface. Appropriate timing and frame format must be assured by the management software by setting or clearing bits at the right times. Refer to the IEEE802.3u specification and the datasheet for the MII managed device for the nature and the timing of the MII waveforms.

x24C02 EEPROM

x24C02 EEPROM

| | | | | |
|---|---|---|---|---|
| Byte 3 | Byte 2 | Byte 1 | Byte 0 | DIO Address |

| | | |
|---|---|---|
| SIO | Control | 0x08h |

The Flash EEPROM interface is provided so the system level manufacturer can optionally provide a pre-configured system to their customers. Customers may also wish to change or reconfigure their system and retain their preferences between system power downs. The Flash EEPROM will contain configuration and initialization information that is accessed infrequently typically at power up and reset.

EALE uses the 24C02 serial EEPROM device (2048 bits organized as 256×8). The 24C02 uses a two-wire serial interface for communication and is available in a small footprint package. Larger capacity devices are available in the same device family, should it be necessary to record more information. Programming of the EEPROM can be affected in two ways:

It can be programmed, via the 810 register using suitable driver software.

It can be programmed directly without need for EALE interaction by suitable hardware provision and host interfacing.

If an EEPROM is not installed the EDIO pin should be tied low. For EEPROM operation EDIO and EDCLK will require an external pull up (see EEPROM data-sheet). EALE will detect the presence or absence of the EEPROM and indicate this in the NEEPM bit of Control.

EALE implements a two-wire serial interface consisting of the EDIO and EDCLK pins to communicate with the EEPROM. Again much like the MII interface, EALE does not implement any timing or data structure on its serial interface. Appropriate timing and frame format must be ensured by the management software by setting or clearing bits at the right times. Refer to the manufacturer's datasheet for the nature and the timing of the EEPROM waveforms.

EALE is designed to be used stand-alone without the need of a management CPU or controlled through an attached microprocessor. It can be reset and initialized in both cases. This section deals with the steps necessary to bring EALE up to operating conditions.

If VLAN flags are used then ThunderSWITCH's IOBMOD bit in SYSCTL must be set. EALE does give the user the ability to use single-port codings only by setting the NIOB bit in Control. However, use of this bit forces EALE to use either single-port codes or the all-ports broadcast code of 0x800Fh.

The user must also disable ThunderSWITCH's internal address matching when using EALE. This is accomplished by writing a one to the ADRDIS bit in each of the port's Port Control register.

EALE is hardware reset by asserting the RESET# pin low. EALE will come out of reset when RESET# becomes high. During a hardware reset no access to the Internal registers is allowed. All Host registers and Internal registers are initialized to their default values.

EALE will begin the EEPROM auto-loading process after a hardware reset. No DIO operations are allowed during auto-loading.

EALE is software reset by asserting the RESET bit in the Control register. EALE will remain in the reset state until this bit is cleared. All Internal registers are initialized to their default values during a software reset except for the Control register which keeps its current value. Reading the internal registers is allowed during in a software reset, but the user is not able to write to any register (except for Control).

The EEPROM auto-loading process does not start during a software reset. The user must assert the LOAD bit in Control for auto-loading to start.

EALE will auto-load selected registers from an attached EEPROM after a hardware reset or when the LOAD bit in Control is set. EALE auto-loads from an attached 24C02 EEPROM. Up to eight 24C02 EEPROM's can be connected across the same serial interface. They are distinguished by separate addresses—selectable by pulling up or down address pins. EALE expects the auto-loaded information to be placed in device number 0x000b.

EALE will then determine if the EEPROM device is present. Several conditions may cause EALE to determine that a device is not present. If the EDIO pin is pulled-down, then auto-loading will fail. If the EEPROM fails to Ack on data writes, then it is determined not to be present. Finally if the CRC in the EEPROM does not match the internally calculated CRC then the EEPROM is determined not to be present.

When no EEPROM is detected EALE will assert the NEEPM bit in Control. If a CRC error occurs then EALE will be placed in a reset state (RESET and NEEPM are set in Control). If no EEPROM is detected or if the CRC does not match the registers will assume their default values.

The organization of the EEPROM data is roughly equivalent to EALE registers 0x01h-0x09 and 0x50h-0x6Dh. The auto-loader reads the register values from the EEPROM and programs EALE accordingly. The last register written is the Control register. This is to give the programmer a way to auto-start EALE from the auto-loader. The auto-loader can initialize and start-up EALE if the START bit in Control is programmed in the EEPROM. This allows for manageless initialization and startup.

During the auto-loading, no DIO operations are permitted. The download bit, LOAD, reset bit and any other read-only or reserved bits cannot be set during auto-loading. However, the CRC for the EEPROM must be calculated using the information written in the EEPROM despite the fact that this information may not be written to EALE. As an example, a value of 0x8Fh or 0xFFh in the EEPROM for RAMSize will both be written as 0x8Fh in EALE, since bits 6,5 and 4 are reserved, but the calculated CRC for each case will be different.

The last four bytes read by the auto-loader correspond to a 32-bit CRC value for the information stored in the EEPROM. The CRC value can be calculated by using the following C routine:

#include <stdio.h>
#include <dos.h>
#include <stdlib.h>
main()
{
fixcrc();
}
fixcrc()
{
long crc;
int i,j;
int eeprom[0x26];
eeprom[0x00] = 0x00; //RAMSize
eeprom[0x01] = 0x02; //AgingTimer LSB
eeprom[0x02] = 0x03; //AgingTimer MSB
eeprom[0x03] = 0x04; //UNKUNIPorts LSB
eeprom[0x04] = 0x05; //UNKUNIPorts MSB
eeprom[0x05] = 0x06; //UNKMULTIPorts LSB
eeprom[0x06] = 0x07; //UNKMULTIPorts MSB
eeprom[0x07] = 0x08; //PortVLAN0 LSB
eeprom[0x08] = 0x09; //PortVLAN0 MSB
eeprom[0x09] = 0x0a; //PortVLAN1 LSB
eeprom[0x0a] = 0x0b; //PortVLAN1 MSB
eeprom[0x0b] = 0x0c; //PortVLAN2 LSB
eeprom[0x0c] = 0x0d; //PortVLAN2 MSB
eeprom[0x0d] = 0x0e; //PortVLAN3 LSB
eeprom[0x0e] = 0x0f; //PortVLAN3 MSB
eeprom[0x0f] = 0x10; //PortVLAN4 LSB
eeprom[0x10] = 0x11; //PortVLAN4 MSB
eeprom[0x11] = 0x12; //PortVLAN5 LSB
eeprom[0x12] = 0x13; //PortVLAN5 MSB
eeprom[0x13] = 0x14; //PortVLAN6 LSB
eeprom[0x14] = 0x15; //PortVLAN6 MSB
eeprom[0x15] = 0x16; //PortVLAN7 LSB
eeprom[0x16] = 0x17; //PortVLAN7 MSB
eeprom[0x17] = 0x18; //PortVLAN8 LSB
eeprom[0x18] = 0x19; //PortVLAN8 MSB
eeprom[0x19] = 0x1a; //PortVLAN9 LSB
eeprom[0x1a] = 0x1b; //PortVLAN9 MSB
eeprom[0x1b] = 0x1c; //PortVLAN10 LSB
eeprom[0x1c] = 0x1d; //PortVLAN10 MSB
eeprom[0x1d] = 0x1e; //PortVLAN11 LSB
eeprom[0x1e] = 0x1f; //PortVLAN11 MSB
eeprom[0x1f] = 0x20; //PorLVLAN12 LSB
eeprom[0x20] = 0x21; //PortVLAN12 MSB
eeprom[0x21] = 0x22; //PortVLAN13 LSB
eeprom[0x22] = 0x23; //PortVLAN13 MSB
eeprom[0x23] = 0x24; //PortVLAN14 LSB
eeprom[0x24] = 0x25; //PortVLAN14 MSB
eeprom[0x25] = 0x26; //Control LSB
eeprom[0x26] = 0xe7; //Control MSB
crc = 0xffffffffl;
for (i=0;i<=0x26;i++)

{
crcbyt(eeprom[i],&crc);
}

crc \hat{ }= 0xffffffffl;
printf(“!n CRC Byte 0 -> %02x”,(int)((crc >> 24) & 0x0ffl));
printf(“!n CRC Byte 1 -> %02x”,(int)((crc >> 16) & 0x0ffl));
printf(“!n CRC Byte 2 -> %02x”,(int)((crc >> 8) & 0x0ffl));
printf(“!n CRC Byte 3 -> %02x”,(int)((crc ) & 0x0ffl));
}
crcbyt(dat,crc)
int dat;
long *crc;
{
int i;
for (i=0;i<8;i++)

{
crcbit(dat>>7,crc);
dat = dat <<1;
}

}
crcbit(dat,crc)
int dat;
long *crc;
{
if ( (((*crc>>31) & 1l)\hat{ }((long)dat & 1l)) ==1)

{
*crc \hat{ }= 0x02608edbl;
*crc = *crc << 1;
*crc | = 0x00000001l;
}

else

{
*crc = *crc << 1;
*crc &= 0xfffffffel;
}

}

In this example the values for which the CRC is calculated are placed in the eeprom [symbol] array. The routine crcbyt is called for each byte. After the last byte the resulting CRC value is output on the screen.

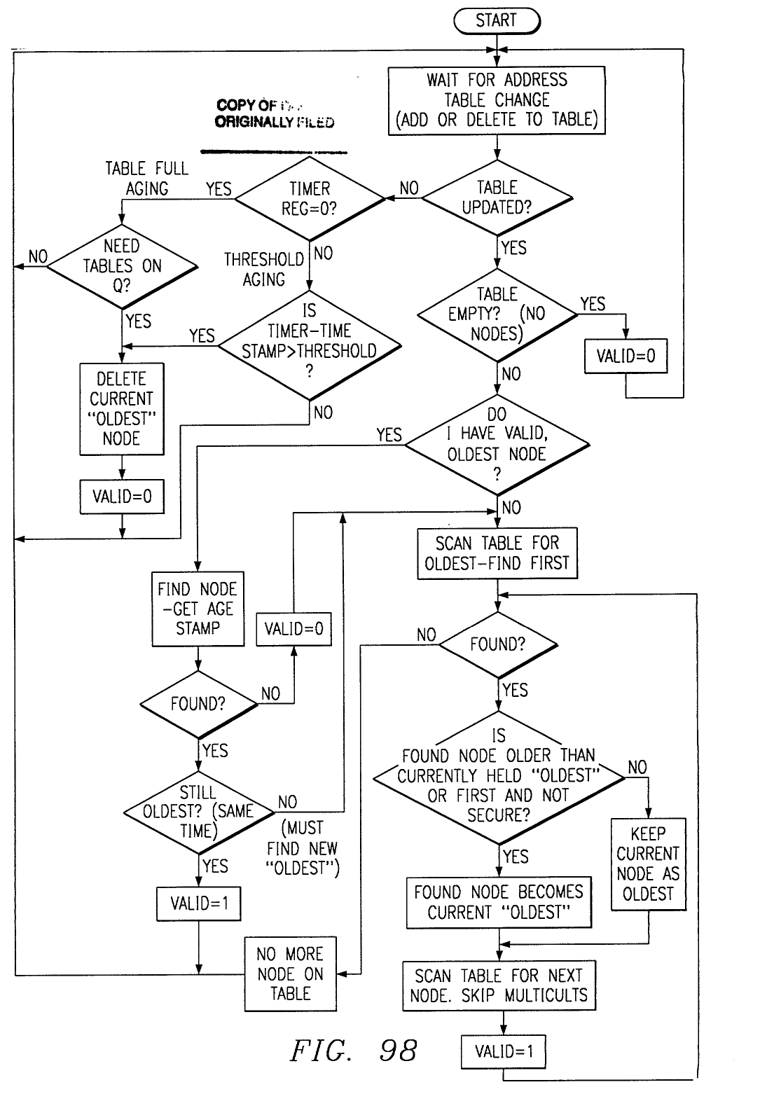

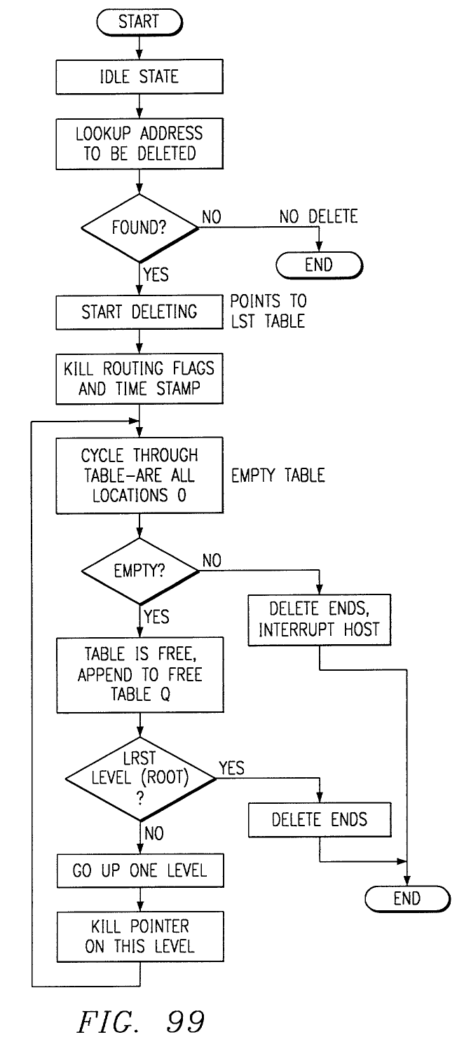

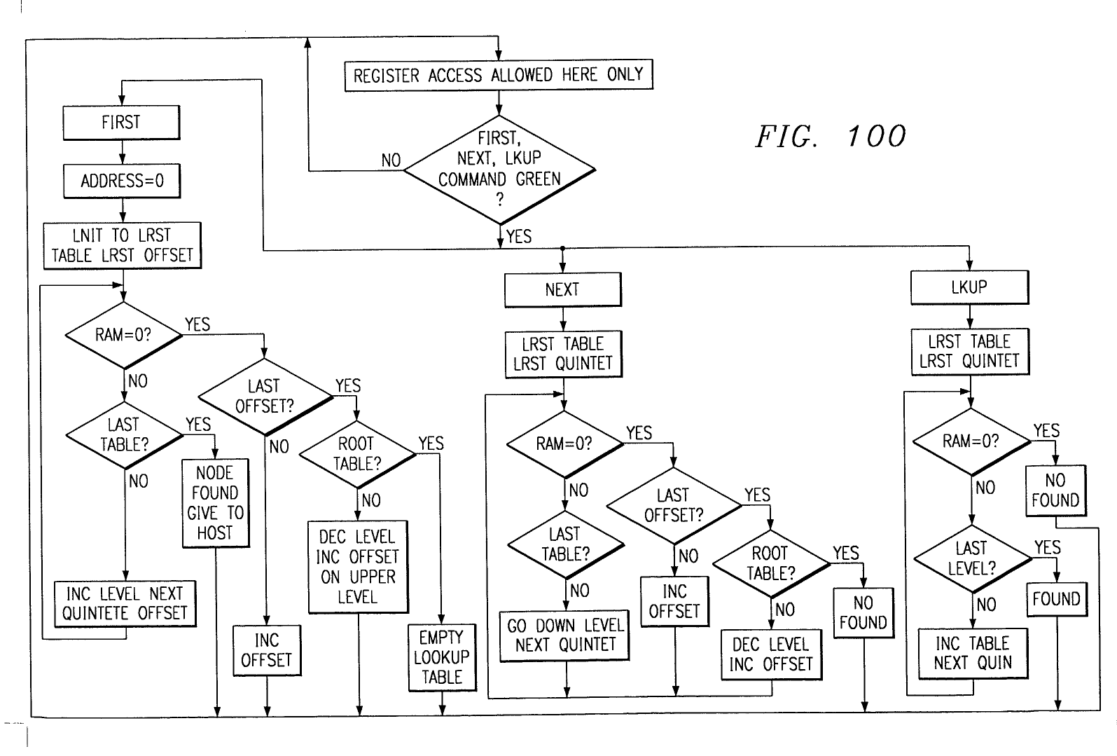

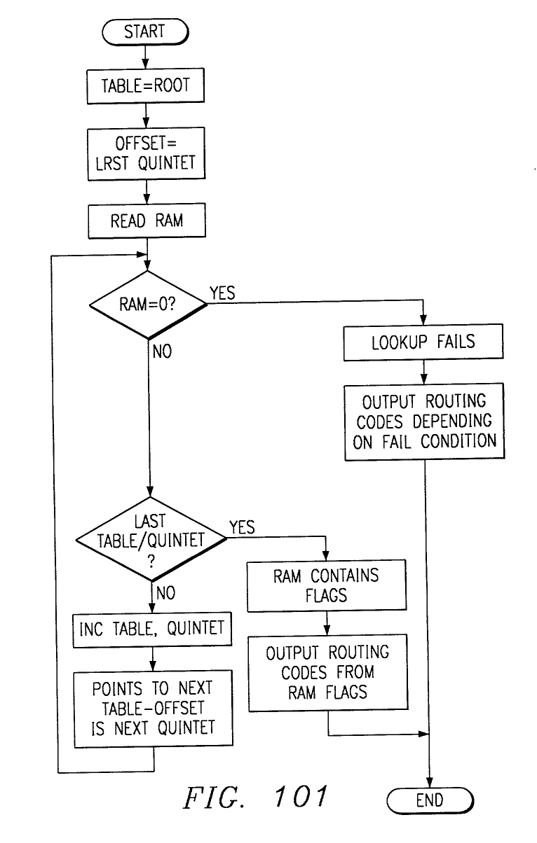

Referring now to FIG. 98, there may be seen a simplified flow diagram that illustrates the internal states of the age state machine 1079. The initial state is to wait for the address table to change. This means that either an add or a delete has been made to the table of addresses. If the table has been updated, then the machine determines that the table is empty. That is, if the table has null nodes. If it has null nodes then it loops back around and waits for the table to change again. If the table is not empty, then it determines whether it has the valid oldest node. If it does, then it finds the node by getting the age stamp. Once it does this, then it determines whether or not it is found. If it is not found, then it has a valid zero and returns to scan the table for the oldest and finds the “first” oldest. If it has found it, then it determines whether it is still the oldest and saves the time. If the answer is no, then it returns back to scan the table for the oldest and find the first. If it is still the oldest, that it is has the same time, then the answer is yes and it has a valid one and then it goes back up to wait for the address table to change again.

After it determines that it does not have the oldest node, it scans the table for the oldest node and finds the first. If it finds one, then it determines if the found node is older than the currently held oldest node or is it the first and not secure. If it is yes, then the found node becomes the current oldest node. If the answer is no, then it keeps the current node as the oldest. Both these points then go into scan the table for the next node and skip multi-cuts. This then results in a valid state which then loops back around and determines whether or not the oldest has been found. If the oldest has not been found, then it drops down to no more nodes on the table. And if the answer to that is yes, then it loops back around and waits for the address table to change again.

If the address table has not been updated then it goes into whether or not the timer registers zero or not. If the answer to that is yes, then it means that it is doing the table full aging. If it is doing table full aging, then it needs tables on the queue and it determines if that is the case. If the answer is no then it loops back around to wait for an address table change. If the answer to that is yes, then it drops down and deletes the current oldest node. That gives it a valid zero and then it goes into the wait for address table change mode again. If the timer register is not equal to zero, then it is doing threshold aging and it drops to the is the timer time stamp greater than some threshold. If the answer is yes, then it deletes the current oldest node and so on. If the answer is no, then it drops out and goes back into the wait for address table change state again.

Referring now to FIG. 99, there may be seen a simplified flow diagram of the internal states of the delete state machine 1073. More particularly, the delete state machine goes from a start state into an idle state. It remains in the idle state until it is given a look-up address. At this point, it has a look-up address to be deleted. It then looks for that address and determines whether it has been found. If the answer is no, then there is no delete and it goes back to the idle state. If the address is found, then it starts the deletion process and points to the last table. It then kills the routing flags on the time stamp associated with that address. It then cycles through the table to determine if all the locations are zero. That is, it determines whether or not the table is empty. If the table is empty, then the table is free and it appends the table queue to the free table queue. If it is not empty, then it deletes the ends and interrupts the host and then drops down to the end and recycles to the idle state again. After moving the table to the free table queue, it determines if this is the last level, i.e. the root level. If no, then it goes up one level and then kills the pointer on that level and then recycles back to the cycle through the table to determine if the locations are empty. If it is the root level, then the answer is yes and the deletion ends, then drops into the end and recycles back to the idle state.

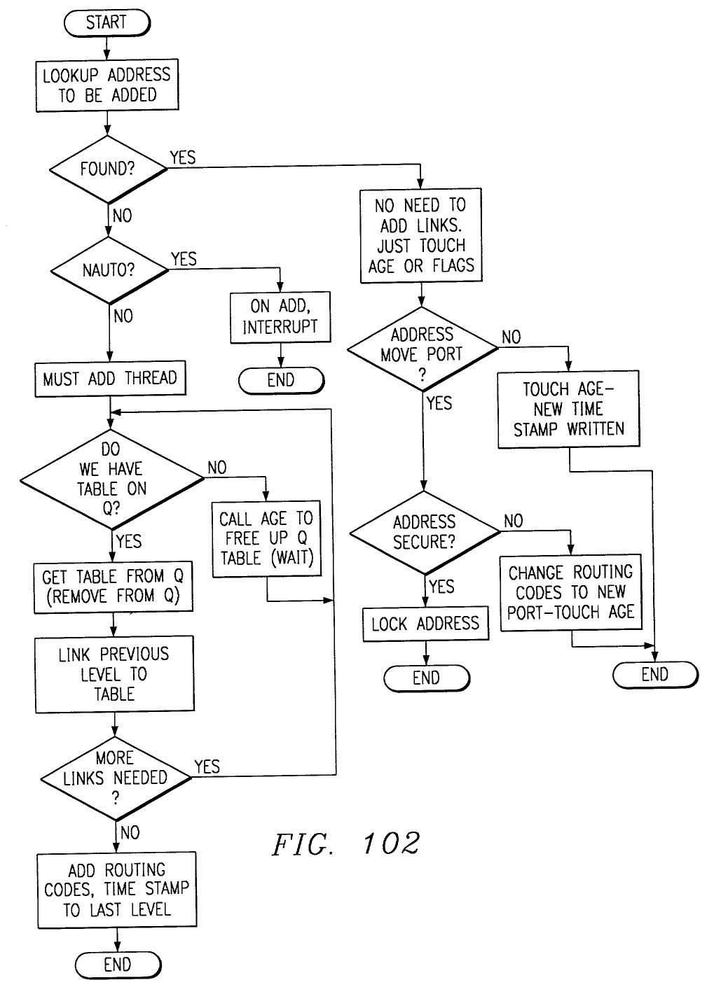

Referring now to FIG. 100, there may be seen a simplified flow diagram of the internal states of the find state machine 1077. The find state machine is used principally for management look-ups. More particularly, it may be seen that it sits initially in a register access allowed state and after that it is then given a command. It first determines whether the command is next look-up or first. If one of those commands has not been given, then it recycles. If one of those commands has been given, then it goes to the chain associated with that particular command.

For the look-up command it then looks through the last table and the last quintet and determines if the memory is zero. If the memory is zero, then it is not found and it recycles back to the register access state. If the answer is no, then it determines whether or not this is the last level. If so, then it answers yes, it returns with found and goes back to register access. If it is not the last level, then it increments the table and looks for the next quintet. It then loops back up to see if that is the last part of the memory.

For the next command, it again looks for the last table and the last quintet, determines whether it is the last part of the memory. If the answer is no, then it determines is it the last table. If the answer to that is no, then it goes down a level to the next quintet and then determines whether that is the last of the RAM. If it is, then it determines if that is the last offset. If the answer is no, then it increments the offset and loops back around to the RAM state again. If the answer is yes, then it asks if this is the root table. If the answer is no, then it increments a level and increments the offset. If the answer is yes, then it is a not found result and it goes back to the register access state.

For the first command, it initially looks to see if the address is equal to zero. It then initializes to the first table and the first offset, then determines if there is more memory. If the answer is yes, then it determines if it is the last offset. If the answer is yes, then it determines if it is the root table. If the answer is yes, then it indicates that it is an empty look-up and moves back to the register access state. If there is more memory, then it determines is this is the last table. If the answer is no, then it increments the level to the next quintet offset and then looks for more memory. If it is the last table, then the node is found and it is given to the host. For the last offset if it is not then it increments the offset and determines if there is more memory. For the root table, if the answer is no, then it decrements a level increments the offset on the upper level and looks for more memory.

Referring now to FIG. 101, there may be seen a simplified flow diagram illustrating the internal states of the look-up state machine 1071. More particularly, the state machine starts and then looks in the table for the root table and then looks for the first quintet offset. It then reads the RAM and determines whether there is more memory. If the answer is no, then it determines whether it is the last table and the last quintet. If the answer is no, then it increments the table into quintet and points to the next table and offset is moved to the next quintet and then it looks for more memory. If it is the last table or quintet, then the RAM contains flags and it outputs routing codes from the flags. It then shifts to an end state which then cycles back to the start. If there is more memory, then the look-up has failed and it outputs routing codes, depending upon the type of failure.

Referring now to FIG. 102, there may be seen a simplified flow diagram of the internal states of the add state machine 1075. More particularly, the add state machine starts in an initial state and then once it is given an address to look up, it then looks for the address for where it should be added. If the address is found, then there is no need to add the links. It just manipulates either the age or the flags associated with that address. It then determines whether the address has moved from that port. If the answer is no, then it touches the age with a new time stamp and that is the end of the routine. If the address has moved, then it determines whether the address is secure. If the answer is no, then it changes the routing codes to the new port and again touches the age. If the address was secure, then it locks the address and that is the end. If the address is not found, then it determines whether or not it's in an nauto mode. If the answer is no, then it adds a thread. If the answer is yes, then there is no add to the table and it interrupts the host and that is the end of the routine. If it must add thread, then it determines whether or not the table is on the queue. If the answer is no, then it calls the age state machine to free up a queue table and waits on this. It then recycles back to the do we have a table on the queue decision block. Once there is a table on the queue then it gets the table from the queue and links the previous level to the table. It then determines if there are more lengths needed. If the answer is no, then it adds the routing code and time stamp to the last level and that is the end of the routine. If it determines that more links are needed, then it loops back up to do we have a table on the queue decision point.

Although the description herein has been for the use of the circuits and methods of the present invention in communication systems employing Ethernet protocols, the circuits and methods of the present invention are not so restricted and may be used in communication systems employing token ring or other types of protocols and in systems employing a combination of such protocols.

### Appendix A

Port Statistics Descriptions

Good Rx Frames:

The total number of good packets (including unicast, broadcast packets and multicast packets) received.

Rx Octets:

This contains a count of data and padding octets in frames that successfully received. This does not include octets in frames received with frame-too-long, FCS, length or alignment errors.

Multicast Rx Frames:

The total number of good packets received that were directed to the multi-cast address. Note that this does not include packets directed to the broadcast address.

Broadcast Rx Frames:

The total number of good packets received that were directed to the broadcast address. Note that this does not include multicast packets.

Rx Align/Code Errors:

For the 10 Mbs ports, the counter will record alignment errors.

For 100 Mbs ports, the counter will record the sum of alignment errors and code errors (frame received with rxerror signal).

Rx CRC Errors:

A count of frames received on a particular interface that are an integral number of octets in length but do not pass the FCS check.

Rx Jabbers:

The total number of packets received that were longer than 1518 octets (excluding framing bits, but including FCS octets),and had either a bad Frame Check Sequence (FCS) with an integral number of octets (FCS error) or a bad FCS with a non-integral number of octets. (Alignment Error). (1532 octets if SYSCTRL option bit LONG is set).

Rx Fragments:

The total number of packets received that were less than 64 octets in length (excluding framing bits, but including ECS octets) and had either a bad frame Check Sequence (FCS) with an integral number of octets (FCS Error) or a bad FCS with a non-integral number of octets (Alignment error).

Oversize Rx Frames:

The total number of packets received that were longer than 1518 octets (excluding framing bits, but including FCS octets) and were otherwise well formed. (1532 octets if SYSCTRL option bit LONG is set)

Undersize Rx Frames:

The total number of packets received that were less than 64 octets long (excluding framing bits, but including FCS octets) and were otherwise well formed.

Rx+Tx Frames 65-127:

The total number of packets (including bad packets) received and transmitted that were between 65 and 127 octets in length inclusive (excluding framing bits but including FCS octets).

Rx+Tx Frames 64:

The total number of packets (including bad packets) received and transmitted that were 64 octets in length (excluding framing bits but including FCS octets).

Rx+Tx Frames 256-511:

The total number of packets (including bad packets) received and transmitted that were between 256 and 511 octets in length inclusive (excluding framing bits but including FCS octets).

Rx+Th Frames 128-255:

The total number of packets (including bad packets) received and transmitted that were between 128 and 255 octets in length inclusive (excluding framing bits but including FCS octets).

Rx+Tx Frames 1024-1518:

The total number of packets (including bad packets) received and transmitted that were between 1024 and 1518 octets in length inclusive (excluding framing bits but including FCS octets).

Note: if the LONG option bit is set, this statistic count frames that were between 1024 and 1536 octets in length inclusive (excluding framing bits but including FCS octets).

Rx+TN Frames 512-1023:

The total number of packets (including bad packets) received and transmitted that were between 512 and 1023 octets in length inclusive (excluding framing bits but including FCS octets).

SQE Test Errors:

A count of times that the SQE TEST ERROR message is generated by the PLS sublayer for a particular interface. The SQE TEST ERROR message is defined in section 7.2.2.2.4 of ANSI/IEEE 802.3-1985 and its generation in 7.2.4.6 of the same.

Net Octets:

The total number of octets of data (including those in bad packets) received on the network (excluding framing bit but including FCS octets). This object can be used as a reasonable indication of Ethernet utilization.

Tx Octets:

This contains a count of data and padding octets of frames that were successfully transmitted.

Good Tx Frames:

The total number of packets (including bad packets, broadcast packets and multicast packets ) transmitted successfully.

Multiple Collision Tx Frames:

A count of successfully transmitted frames on a particular interface for which transmission is inhibited by more that one collision.

Single Collision TX Frames:

A count of the successfully transmitted frames on a particular interface for which transmission is inhibited by exactly one collision.

Deferred X Frames:

A count of the frames for which the first transmission attempt on a particular interface is delayed because the medium was busy.

Carrier Sense Errors:

The number of times that the carrier sense condition was lost or never asserted when attempting to transmit a frame on a particular interface. The count represented by an instance of this object is incremented at most once per transmission attempt, even if the carrier sense condition fluctuates during a transmission attempt.

Excessive Collisions:

A count of frames for which transmission on a particular interface fails due to excessive collisions.

Late Collisions:

The number of times that a collision is detected on a particular interface later than 512 bit-times into the transmission of a packet.

Multicast Tx Frames:

The total number of packets transmitted that were directed to a multicast address. Note that this number does not include packets directed to the broadcast address.

Broadcast Tx Frames:

The total number of packets transmitted that were directed to the broadcast address. Note that this does not include multicast packets.

Tx Data Errors

This statistic will be switchable between:

The number of Transmit frames discarded on transmission due to lack of resources (i.e. the transmit queue was full). This will allow queue monitoring for dynamic Q sizing and buffer allocation.

The number of data errors at transmission. This is incremented when a mismatch is seen between a received good CRC and a checked CRC at transmission. Or when a partial frame is transmitted due to a receive under run.

The function this counter performs is selected by the STMAP bit (bit 3) of the system control register.

Filtered RX Frames:

The count of frames received but discarded due to lack of resources, (TXQ full, Destination Disabled or RX Errors). The number of frames sent to the TSWITCH discard channel for whatever reason.

Address Mismatches/Address Changes:

The sum of:

The number of mismatches seen on a port, between a securely assigned port address and the source address observed on the port. Occurrence of this will cause TSWITCH to suspend the port (See Port Status Register description)

The number of times TSWITCH is required to assign or learn an address for a port.

Address Duplications:

The number of address duplications between a securely assigned port address within TSWITCH and a source address observed on this port. Occurrence of this will cause TSWITCH to suspend the port (See Port Status Register description).

The following statistics are mapped in statistics memory region: 0x780-0x7FF.

# Rx Over_Runs Port {00:14}:

The number of frames lost due to a lack of resources during frame reception. This counter is incremented whenever frame data can not enter the RX FIFO for whatever reason. Frames that over_run after entering the FIFO may also be counted as Rx discards if they are not cut-through.

Collisions Port {00:14}:

The number of times the ports transmitter was required to send a Jam Sequence.

The following counters are implemented in previously described counters.

Tx H/W Errors:

The function of this counter is performed by the t Data Errors' counter.

Rx H/W Errors:

The function of this counter is performed by the Filtered Rx Frames' counter.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A communications system, comprising:
a first memory,
a plurality of protocol handlers,
a bus connected to said protocol handlers,
a second memory connected to said bus,
a memory controller connected to said bus and said second memory for selectively comparing addresses, transferring data between said protocol handlers and said second memory, and transferring data between said second memory and said first memory.

2. A communications system, comprising:
a circuit having a plurality of communications ports capable of multispeed operation and operable in a first mode that includes address resolution and in a second mode that excludes address resolution.

3. An ethernet switch, comprising:
a plurality of protocol handlers each having a serializer and deserializer and a holding latch,
a bus connected to said holding latches,
a memory connected to said bus, and
a memory controller connected to said bus and said memory for selectively comparing addresses, transferring data between said latches and said memory and transferring data between said memory and an external memory.

4. A local area network controller, comprising:
a first circuit having a plurality of communications ports capable of multispeed operation and operable in a first mode that includes address resolution and in a second mode that excludes address resolution, and
an address lookup circuit interconnected to said first circuit.

5. A single chip local area network controller, comprising:
a plurality of protocol handlers each having a serializer and deserializer and a holding latch,
a bus connected to said holding latches,
a memory connected to said bus, and
a memory controller connected to said bus and said memory for selectively comparing addresses, transferring data between said latches and said memory and transferring data between said memory and an external memory.

6. A single chip local area network controller, comprising:
a plurality of protocol handlers,
a bus connected to said protocol handlers,
a memory connected to said bus,
a memory controller connected to said bus and said memory for selectively comparing addresses, transferring data between said protocol handlers and said memory, and transferring data between said memory and an external memory.

7. A network multiplexer/switch on a chip, comprising:
a plurality of protocol handlers (MACs) each having a serializer and deserializer and a holding latch,
a bus connected to said holding latches,
a memory connected to said bus, and
a memory controller connected to said bus and said memory for selectively comparing addresses, transferring data between said latches and said memory, and transferring data between said memory and an external memory.

8. A single chip network protocol handler, comprising:
a first protocol handler having a serializer and deserializer and a holding latch for operating at a first bit rate,
a second protocol handler having a serializer and deserializer and a holding latch for operating at a second bit rate, and
a controller connected to said protocol handlers for selecting one of said protocol handlers based on preselected control signals.
